(19) United States
(12) Patent Application Publication
(10) Pub. No.: US 2025/0315153 A1
(43) Pub. Date: Oct. 9, 2025

(54) Devices, Methods, and Graphical User Interfaces for Displaying Notifications with Summary Content

(71) Applicant: Apple Inc., Cupertino, CA (US)

(72) Inventors: Taylor G. Carrigan, San Francisco, CA (US); Bryn Bowman, Lafayette, CA (US); Christopher P. Foss, San Francisco, CA (US); Marcel van Os, Santa Cruz, CA (US); Caelan G. Stack, Belmont, CA (US)

(21) Appl. No.: 18/896,816

(22) Filed: Sep. 25, 2024

Related U.S. Application Data
(60) Provisional application No. 63/631,375, filed on Apr. 8, 2024.
(60) Provisional application No. 63/657,429, filed on Jun. 7, 2024.
(60) Provisional application No. 63/686,834, filed on Aug. 25, 2024.

(51) Int. Cl. G06F 3/0484; G06F 3/0482; G06F 9/54

(52) U.S. Cl. CPC G06F 3/0484; G06F 3/0482; G06F 9/542

(57) ABSTRACT

A computer system detects occurrence of a first event of a first type, and in response: in accordance with a determination that the computer system is operating in a first mode in which notifications corresponding to events of the first type are permitted, the computer system generates a first notification corresponding to the first event; in accordance with a determination that the computer system is operating in a second mode in which notifications corresponding to events of the first type are suppressed and the first event includes first content that meets relevance criteria, the computer system generates the first notification; and in accordance with a determination that the computer system is operating in a second mode in which notifications corresponding to events of the first type are suppressed and the first event does not include content that meets the relevance criteria, the computer system forgoes generating the first notification.

### RELATED APPLICATIONS

This application claims the benefit of and priority to U.S. Patent Application No. 63/686,834, filed on Aug. 25, 2024, U.S. Patent Application No. 63/657,429, filed on Jun. 7, 2024, and U.S. Patent Application No. 63/631,375, filed on Apr. 8, 2024, each of which is hereby incorporated by reference in its entirety.

### TECHNICAL FIELD

This relates generally to electronic devices with input devices, such as touch-sensitive surfaces, cameras, and/or other sensors for detecting user inputs and contextual conditions, and/or output devices, such as display generation components and audio output devices, including but not limited to electronic devices in communication with touch-sensitive surfaces, displays, and/or audio output devices.

### BACKGROUND

Mobile devices such as smartphones, head-mounted displays, vehicle head units, and smartwatches are used by users throughout the day. Users often benefit greatly from notifications received on such devices, which can help alert users to time-sensitive information, can provide useful reminders to users, and can assist users in managing their time.

Current methods for delivering notifications and notification content are inefficient. For example, while have limited control over whether or not notifications can (e.g., and/or should) be delivered (e.g., via a configurable “Do Not Disturb” mode or similar notification filtering settings), but users have limited control over the actual content of delivered notifications. This often results in users needing to expend additional effort to effectively manage and sift through notifications. For example, some delivered notifications may be unable to include all of the relevant content, which wastes the user's time in reading a notifications that fails to provide all the relevant information the user needs (e.g., and often necessitates the user opening a corresponding application to access the missing information). This results in wasted time, increased cognitive burden on the user, and unneeded power consumption of the device (e.g., performing operations that can be avoided with more efficient and effective content delivery).

### SUMMARY

Accordingly, there is a need for electronic devices with faster, more efficient methods and interfaces for providing summary content, prioritizing content, and/or highlighting content (e.g., in the context of providing notifications or alerts corresponding to events generated by applications and/or the operating system, and/or in the context of providing recommendations and suggestions to a user based on application content and other contextual information). Such methods and interfaces optionally complement or replace conventional methods for delivering notification and/or application content. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device is a head-mounted display device that provides three-dimensional virtual and/or augmented reality experiences. In some embodiments, the device has a touchpad. In some embodiments, the device has a touch-sensitive display (also known as a “touch screen” or “touch-screen display”). In some embodiments, the device has one or more cameras that detect air gestures performed using a user's hand, and, optionally, the gaze of the user. In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with a display generation component and one or more input devices. The method includes detecting a first event that corresponds to first content of a first application. The method includes, after detecting the first event, displaying a first notification for the first event, including a first automatically generated summary that is based on at least the first content of the first application, wherein the first automatically generated summary includes automatically generated content that is not part of the first content of the first application.

In accordance with some embodiments, a method is performed at a computer system that is in communication with a display generation component and one or more sensors for detecting user inputs. The method includes detecting occurrence of a first plurality of events, including a first event and a second event, wherein the first event corresponds to first content and the second event corresponds to second content that is different from the first content. The method includes, after detecting the occurrence of the first plurality of events, detecting that first criteria are met. The method includes, in response to detecting that the first criteria are met: in accordance with a determination that the first event and the second event meet second criteria, displaying, via the display generation component, a first group notification that includes a first automatically generated summary that is based on both the first content and the second content, wherein the first automatically generated summary includes automatically generated content that is not part of the first content or the second content.

In accordance with some embodiments, a method is performed at a computer system that is in communication with a display generation component and one or more sensors for detecting user inputs. The method includes detecting occurrence of a first event of a first event type. The method includes, in response to detecting the occurrence of the first event of the first event type: in accordance with a determination that the computer system is operating in a first mode in which notifications corresponding to events of the first event type are permitted, generating a first notification corresponding to the first event; in accordance with a determination that the computer system is operating in a second mode in which notifications corresponding to events of the first event type are suppressed and the first event includes first content that meets relevance criteria, generating the first notification corresponding to the first event; and in accordance with a determination that the computer system is operating in the second mode in which notifications corresponding to events of the first event type are suppressed and the first event does not include content that meets the relevance criteria, forgoing generating the first notification corresponding to the first event.

In accordance with some embodiments, a method is performed at a computer system that is in communication with one or more output generation components and one or more input devices. The method includes detecting a first event that corresponds to first application content. The method includes, in response to detecting the first event, outputting, via the one or more output generation components, a respective notification for the first event, wherein outputting the respective notification for the first event includes: in accordance with a determination that the first application content exceeds a first content length threshold, outputting, via the one or more output generation components, a first notification that corresponds to the first event, the first notification including a first automatically generated summary that is based on at least the first application content, wherein the first automatically generated summary is not included in the first application content; and in accordance with a determination that the first application content does not exceed the first content length threshold, outputting, via the one or more output generation components, a second notification that corresponds to the first event, wherein the second notification does not include the first automatically generated summary.

In accordance with some embodiments, a method is performed at a computer system that is in communication with one or more display generation components and one or more input devices. The method includes detecting that a first set of conditions for displaying a first user interface that corresponds to a restricted state of the computer system are met. The method includes, in response to detecting that the first set of conditions are met, displaying, via the one or more display generation components, the first user interface that corresponds to the restricted state of the computer system, including: in accordance with a determination that a plurality of notifications available to be displayed in the first user interface includes a first notification with first notification content that meets relevance criteria and a second notification with second notification content that meets the relevance criteria, concurrently displaying a representation of the first notification and a representation of the second notification within a first user interface object. The method includes while displaying the first user interface, including concurrently displaying the representation of the first notification and the representation of the second notification within the first user interface object, detecting a first user input directed to the first user interface object. The method includes, in response to detecting the first user input directed to the first user interface object: in accordance with a determination that the first user input is directed to a location that corresponds to the representation of the first notification in the first user interface object, performing a first operation with respect to the first notification, and forgoing performing the first operation with respect to the second notification; and in accordance with a determination that the first user input is directed to a location that corresponds to the representation of the second notification in the first user interface object, performing a second operation with respect to the second notification, and forgoing performing the second operation with respect to the first notification.

In accordance with some embodiments, an electronic device (or computer system more generally) includes a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device that includes a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), cause the device to perform or cause performance of the operations of any of the methods described herein. In accordance with some embodiments, a graphical user interface on an electronic device with a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators); and means for performing or causing performance of the operations of any of the methods described herein. In accordance with some embodiments, an information processing apparatus, for use in an electronic device with a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), includes means for performing or causing performance of the operations of any of the methods described herein.

Thus, electronic devices and other computer systems with display generation components (e.g., displays, touch-screen displays, and/or head-mounted displays), input device (e.g., touch-sensitive surfaces, touch screen displays, optionally one or more sensors to detect intensities of contacts with the touch-sensitive surface or touch-screen display, one or more cameras, and/or one or more controllers), and one or more output devices (e.g., audio output devices, and optionally, one or more tactile output generators) are provided with improved methods and interfaces for outputting notifications, thereby increasing the effectiveness, efficiency, and user satisfaction with such devices. Such methods and interfaces may complement or replace conventional methods for outputting notifications.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5H illustrate example user interfaces for providing summary content for an event (e.g., a single event), in accordance with some embodiments.

FIGS. 5I-5V illustrate example user interfaces for configuring the operating system and/or one or more applications to enable or disable an available summarization functionality that generates and/or displays summary content for events associated with the one or more applications, in accordance with some embodiments.

FIGS. 6A-6X illustrate example user interfaces for providing summary content for multiple events, in accordance with some embodiments.

FIGS. 7A-7O illustrate example user interfaces for filtering notification and/or summary content, in accordance with some embodiments.

FIGS. 8A-8S illustrate example user interfaces for outputting content via contextually relevant output devices, in accordance with some embodiments.

FIGS. 9A-9Z illustrate example user interfaces for prioritizing and/or highlighting content, in accordance with some embodiments.

FIGS. 10A-10I are flow diagrams for a process for providing summary content for a single event, in accordance with some embodiments.

FIGS. 11A-11I are flow diagrams for a process for providing summary content for multiple events, in accordance with some embodiments.

FIGS. 12A-12E are flow diagrams for a process for filtering notification and/or summary content, in accordance with some embodiments.

FIGS. 13A-13F are flow diagrams for a process for outputting content via contextually relevant output devices, in accordance with some embodiments.

FIGS. 14A-14J are flow diagrams of a process for prioritizing and/or highlighting content, in accordance with some embodiments.

### DESCRIPTION OF EMBODIMENTS

Users receive many notifications via mobile devices such as smartphones and smartwatches. A user often must sift through a large number of notifications, many of which are not relevant to the user at a particular moment. Automatically generated summaries, and notification prioritization/highlighting can assist users in quickly identifying and viewing (e.g., and/or listening to) relevant content. For example, mobile devices can generate automatic summaries of long notifications, which distill the relevant information into short summaries that can be quickly and easily reviewed by the user. This minimizes the need for users to waste time reading through unhelpful or redundant content (e.g., opener and/or filler phrases in emails or other communications), and also minimizes the need for users to open applications to view full application content. These devices can also further assist users by prioritizing and/or highlighting relevant content (e.g., some, or all, of which may be summarized in an automatically generated summary). For example, high priority and/or highlighted content can be displayed in a prominent, distinct, and/or consistent location (e.g., at the top of a list or stack of notifications, or at a particular location in a displayed user interface). Devices can also update the prioritized and/or highlighted content (e.g., over time), adding and/or removing content as it becomes relevant, or as it loses relevance (e.g., based on context). In many cases, the summarization of application content, and/or prioritizing and/or highlighting relevant content are performed by the operating system, e.g., because individual applications do not have such capabilities and/or do not have access to application content across multiple applications and/or across multiple interaction sessions to gain sufficient context to adequately perform such functions. In some embodiments, one or more applications may perform limited summarization functions for content within the application, and the operating system performs additional summarization functions based on the application content provided by the one or more applications which may include limited summarization, and the summary content generated by the operating system includes content that is not included in the application content provided by the one or more applications.

The methods, devices, and GUIs described herein use haptic feedback to improve user interface interactions in multiple ways. For example, they make it easier to for users to quickly locate, view, and/or interact with relevant content (e.g., notification content and/or application content), by providing automatically generated summaries and by displaying priority and/or highlighted content in distinctive (e.g., and consistently placed) user interfaces and/or user interface objects.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

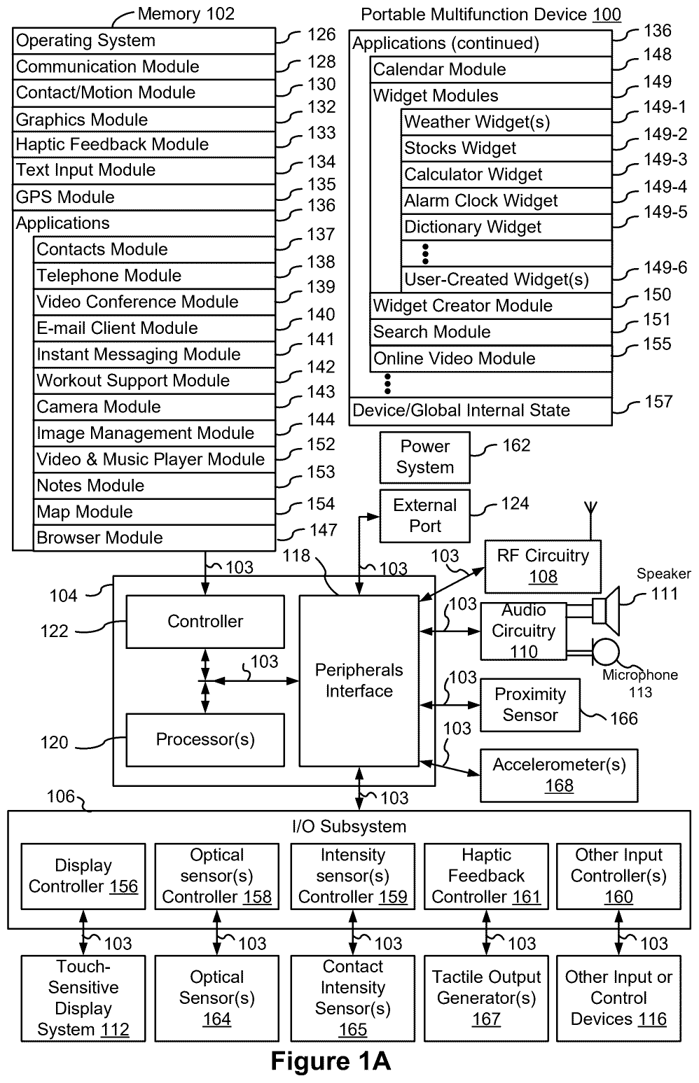

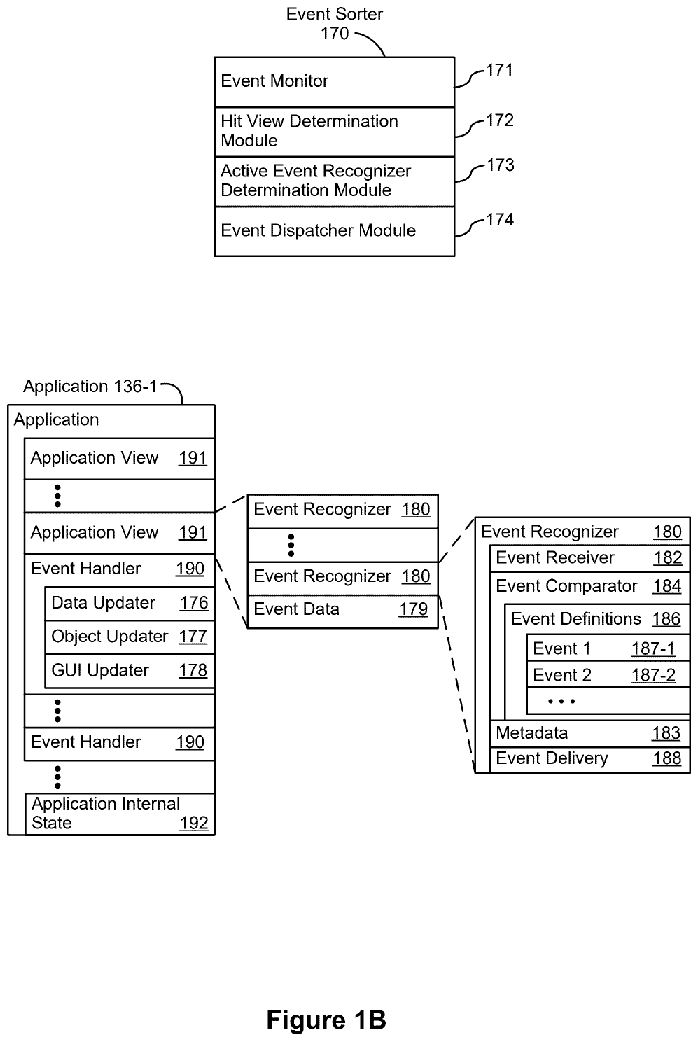

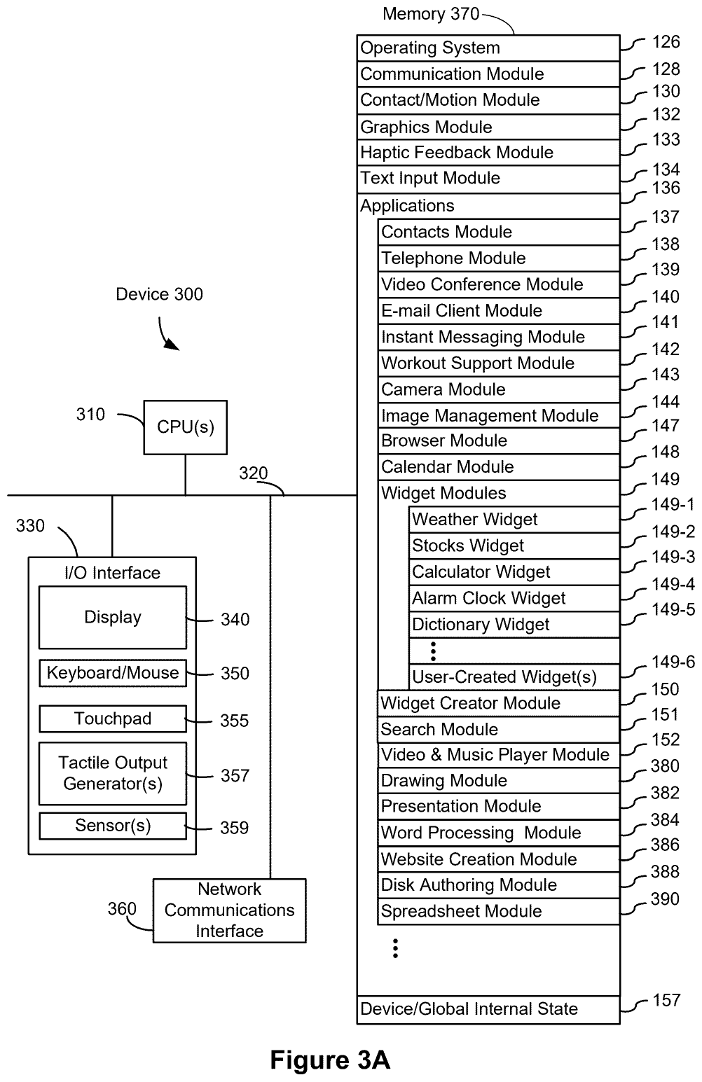

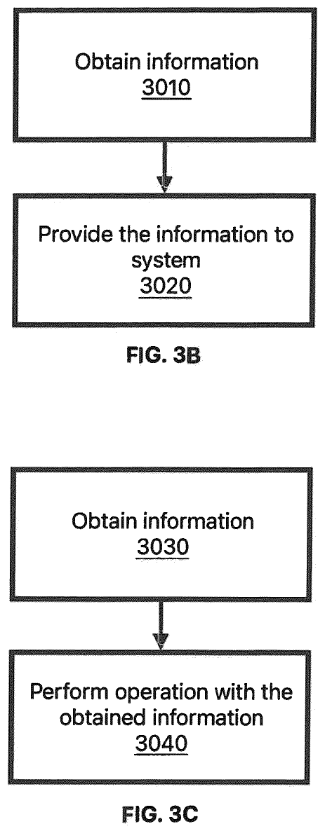

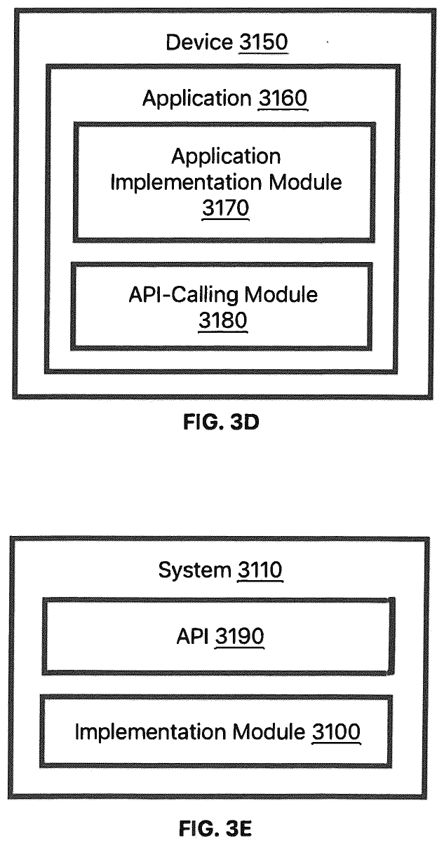

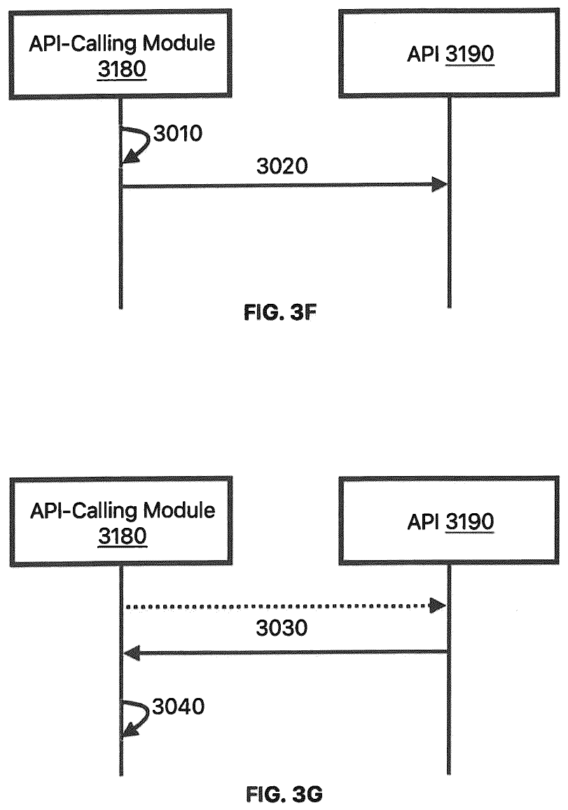

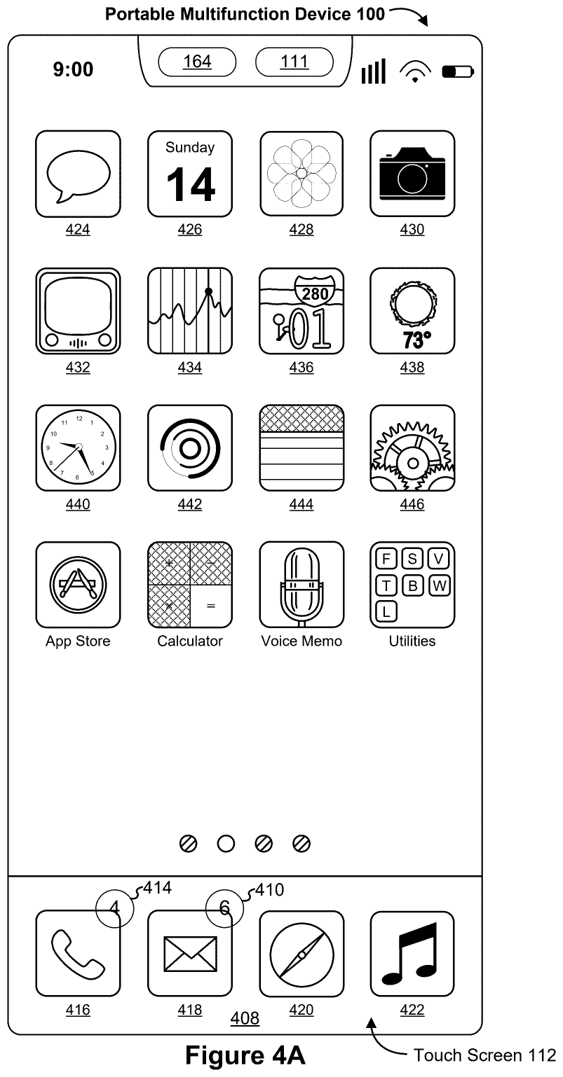

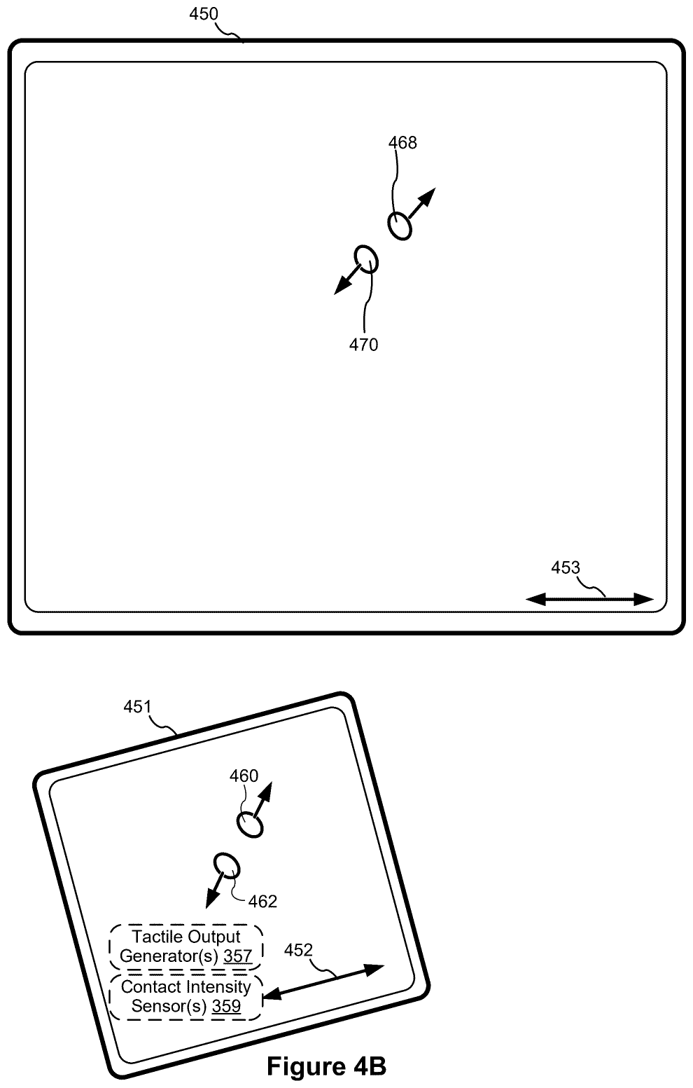

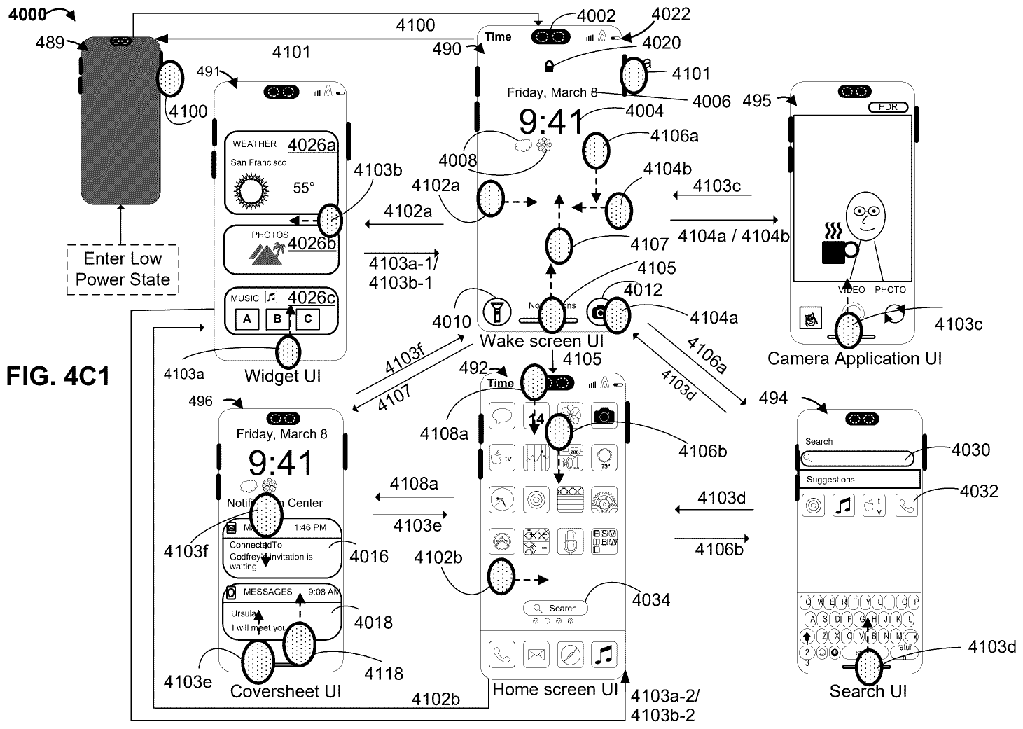

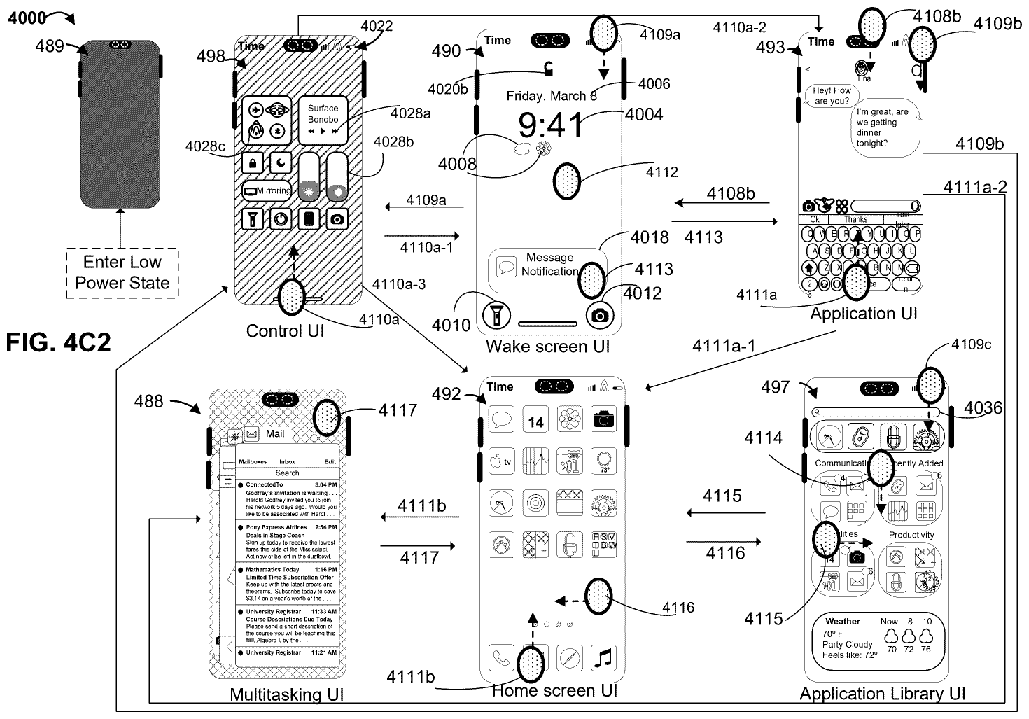

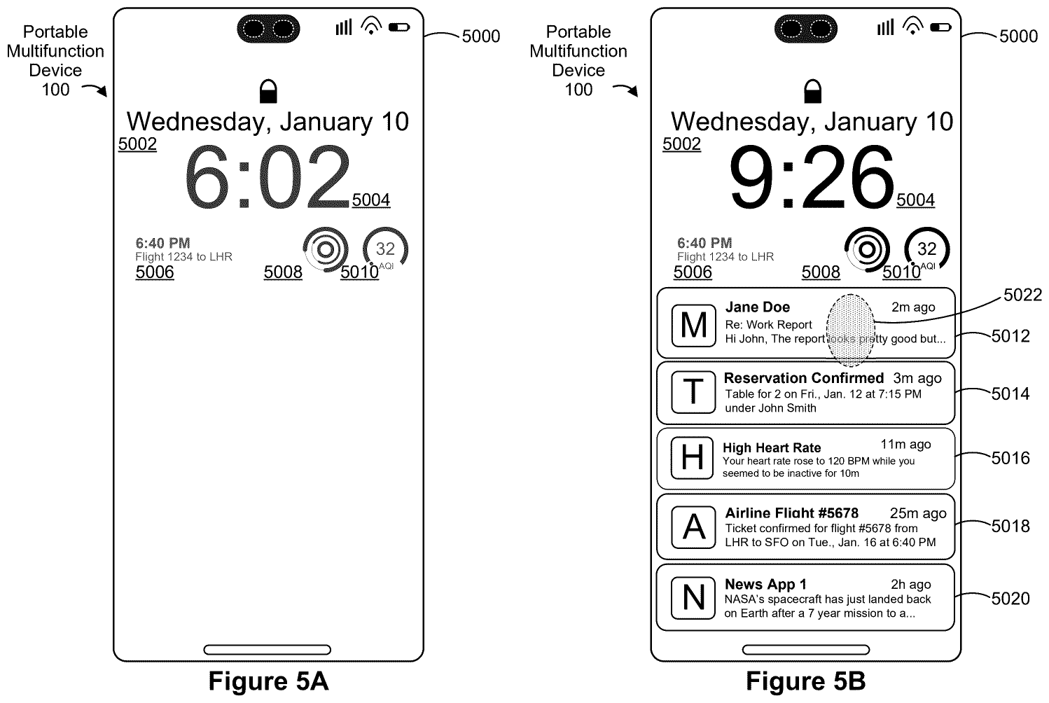

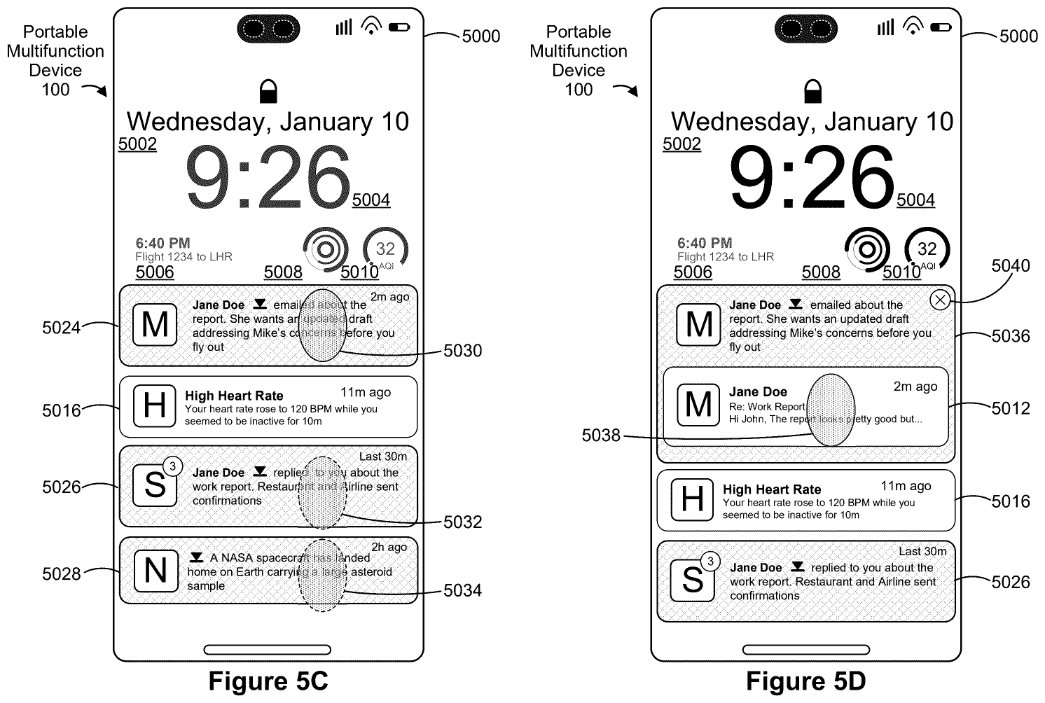

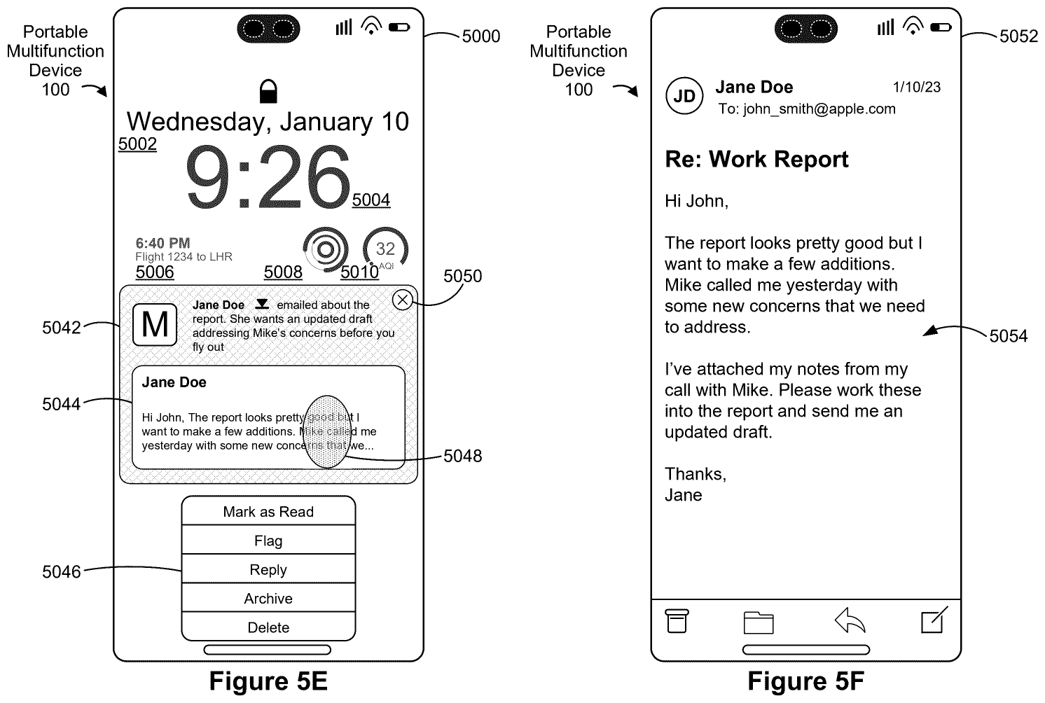

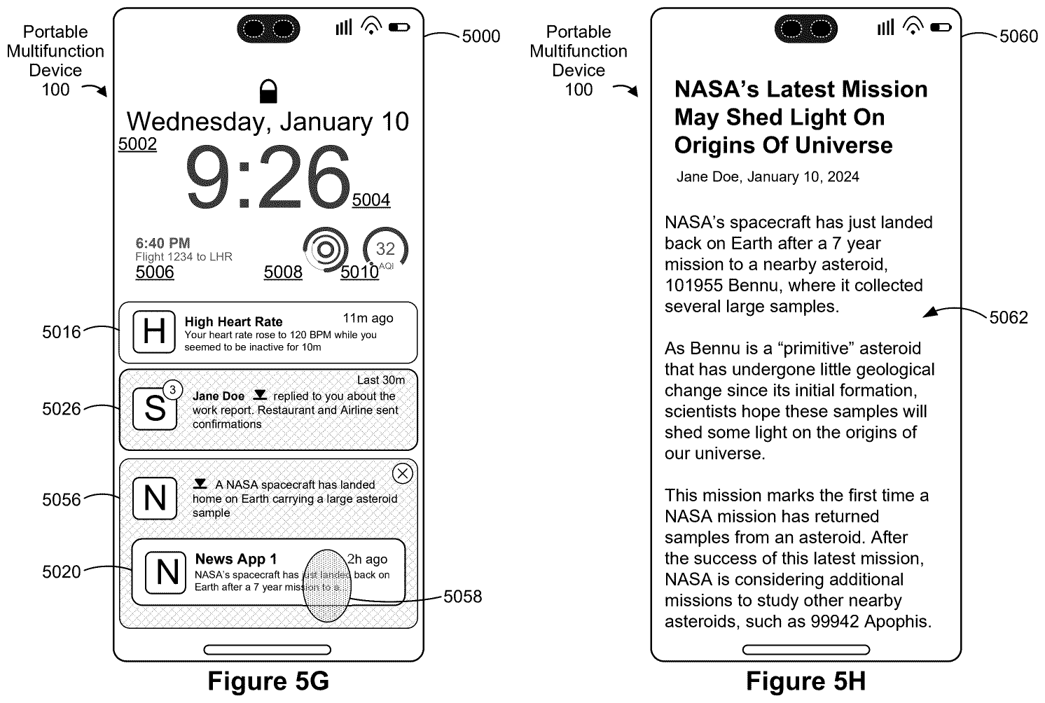

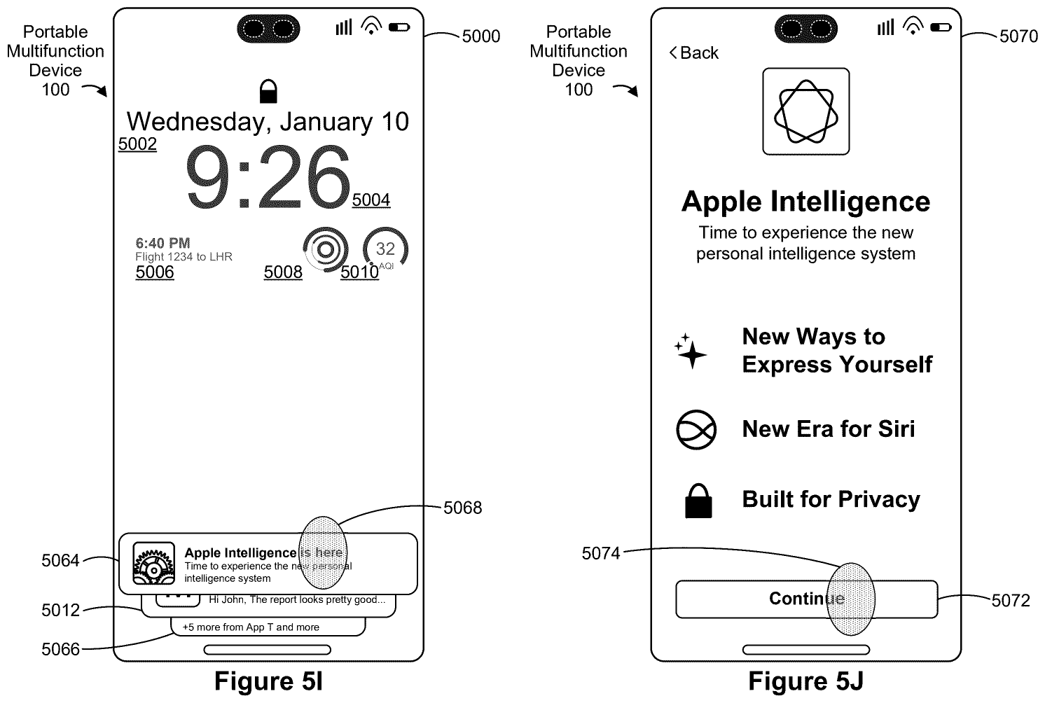

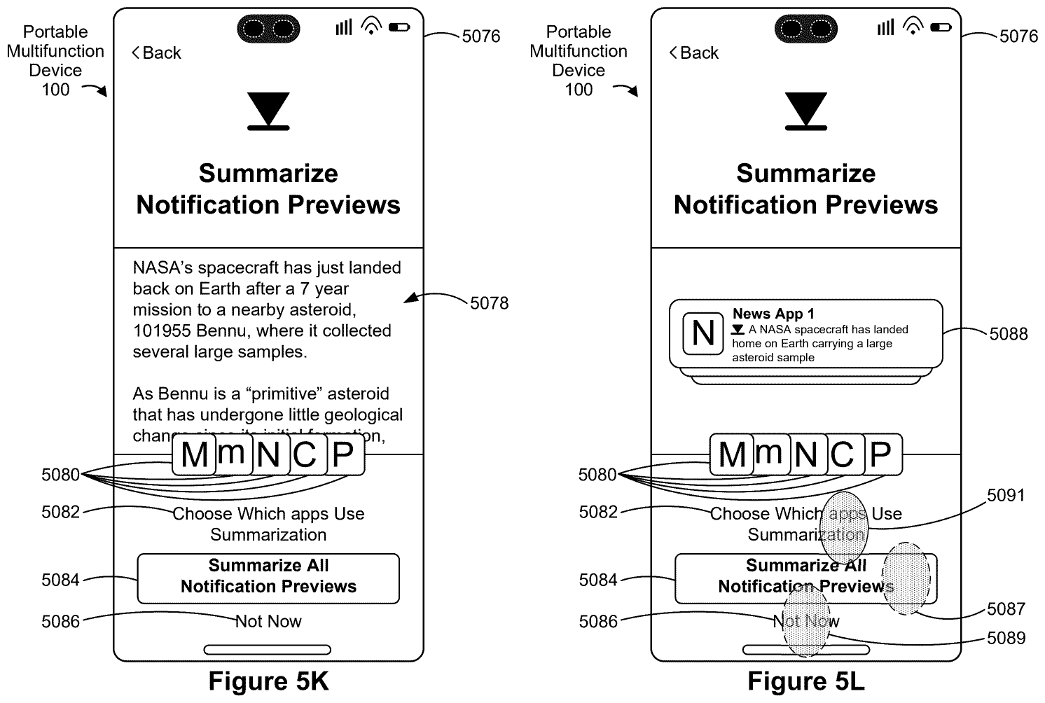

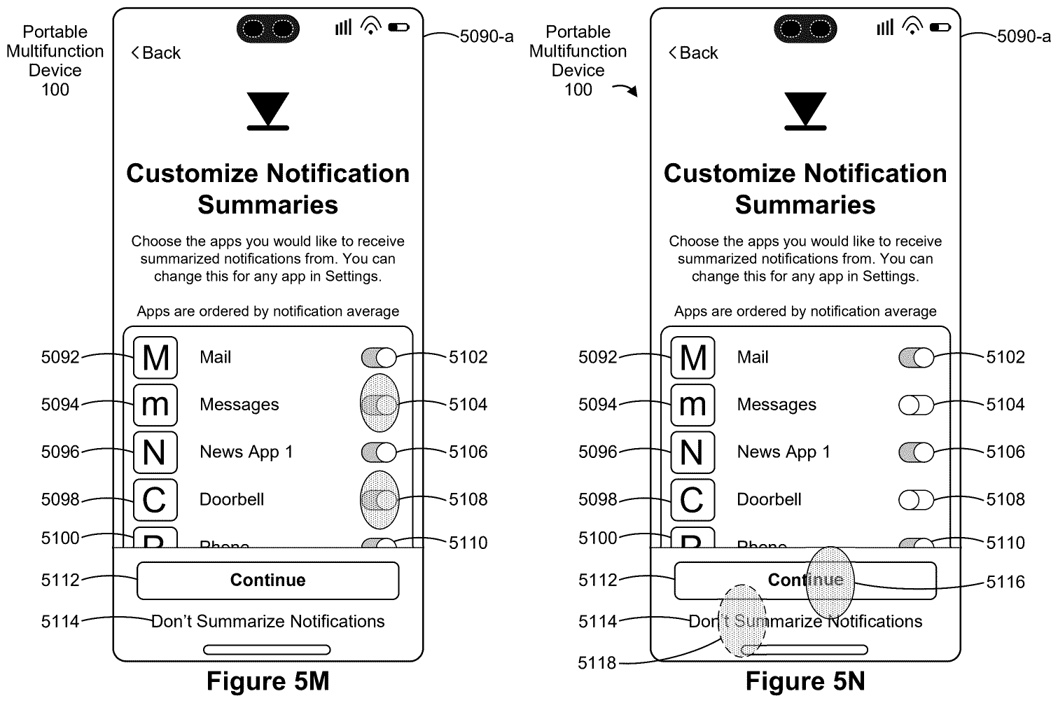

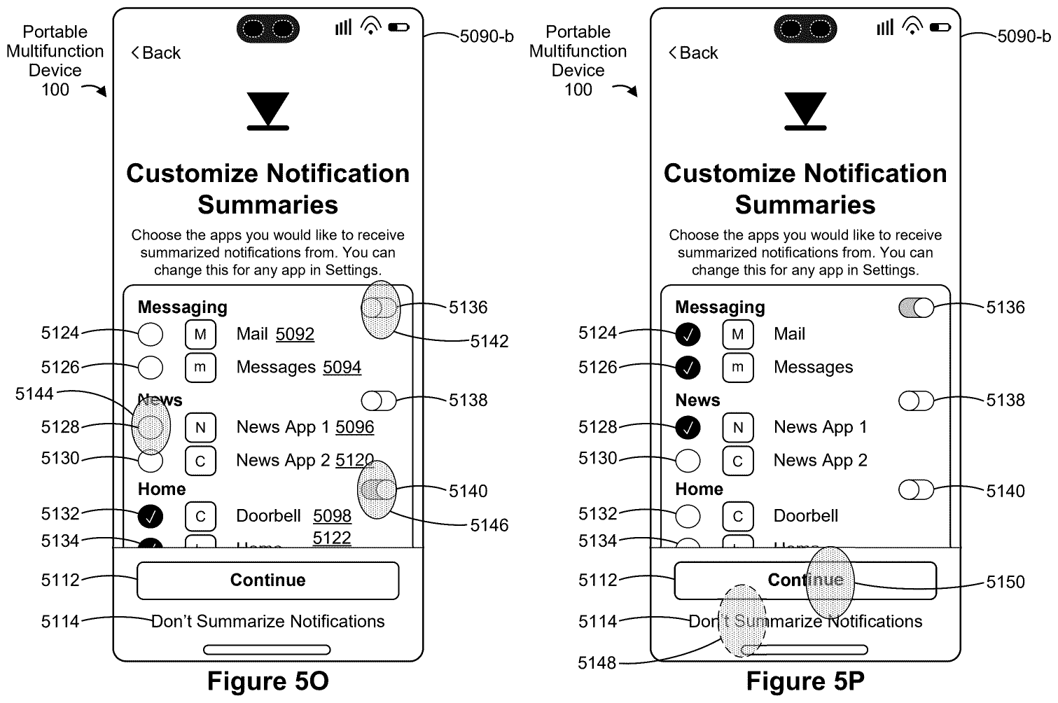

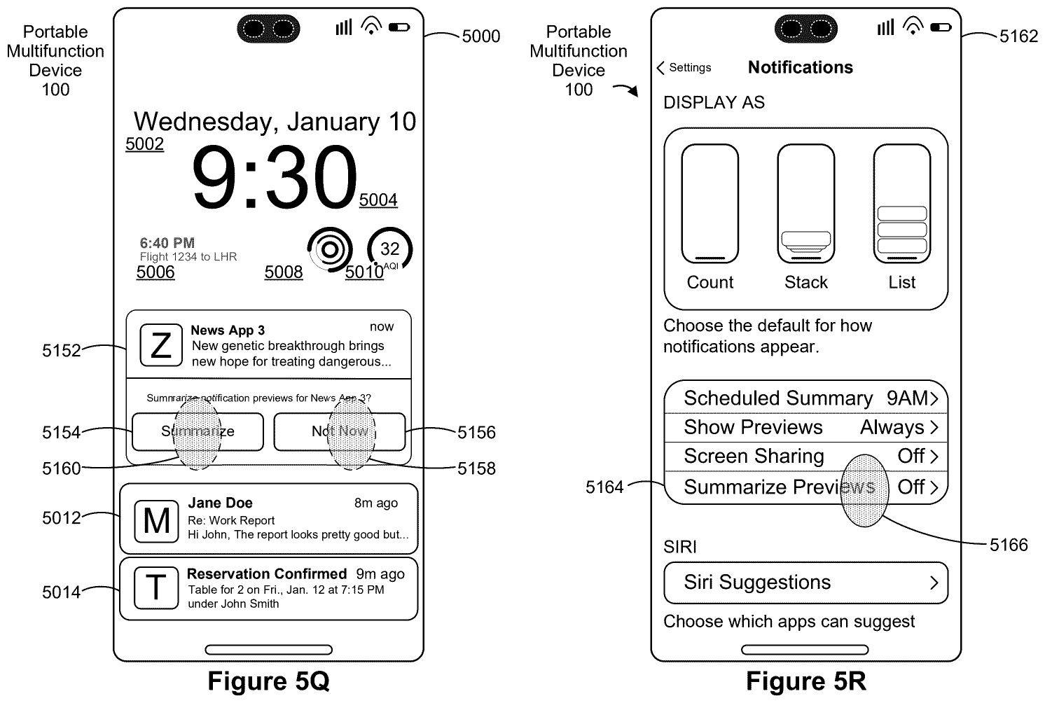

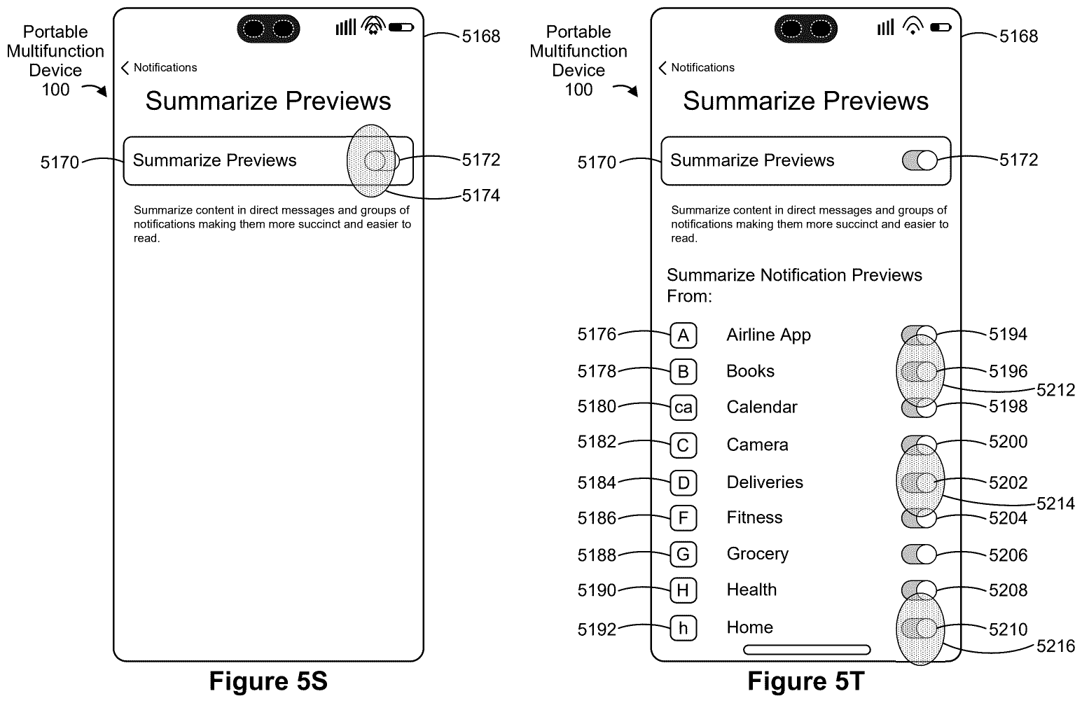

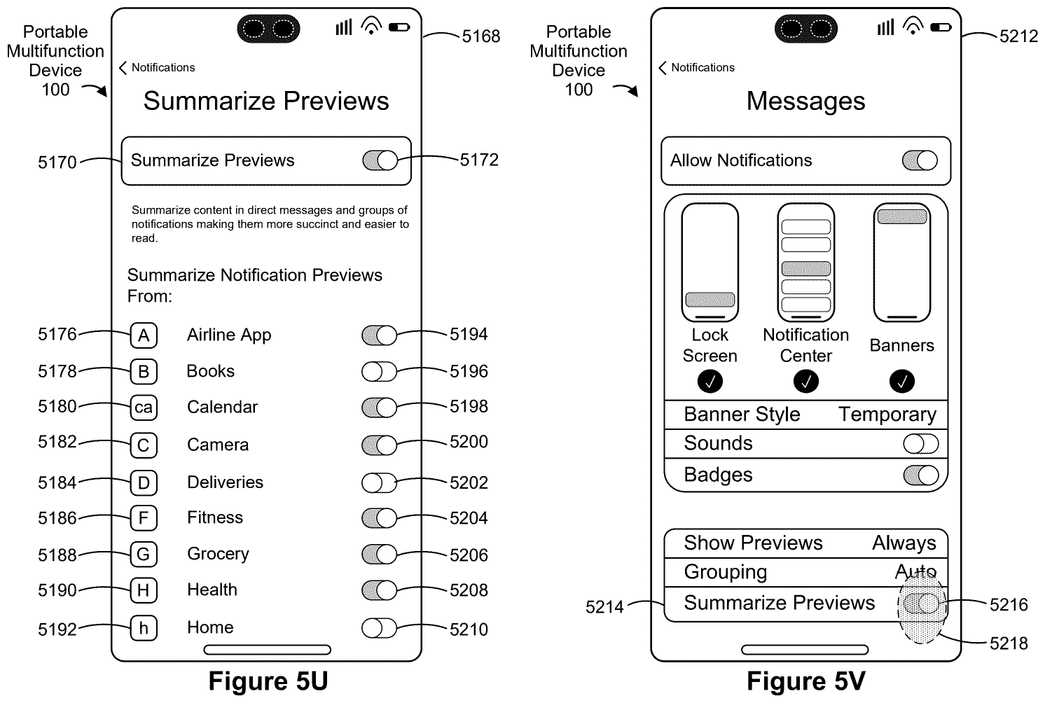

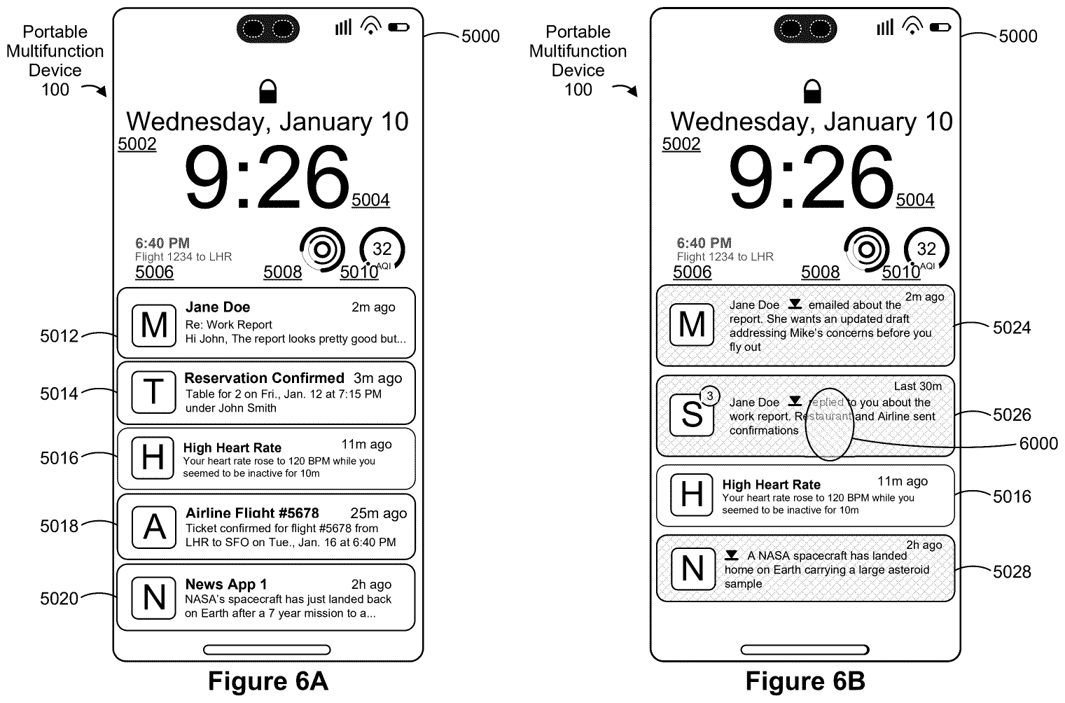

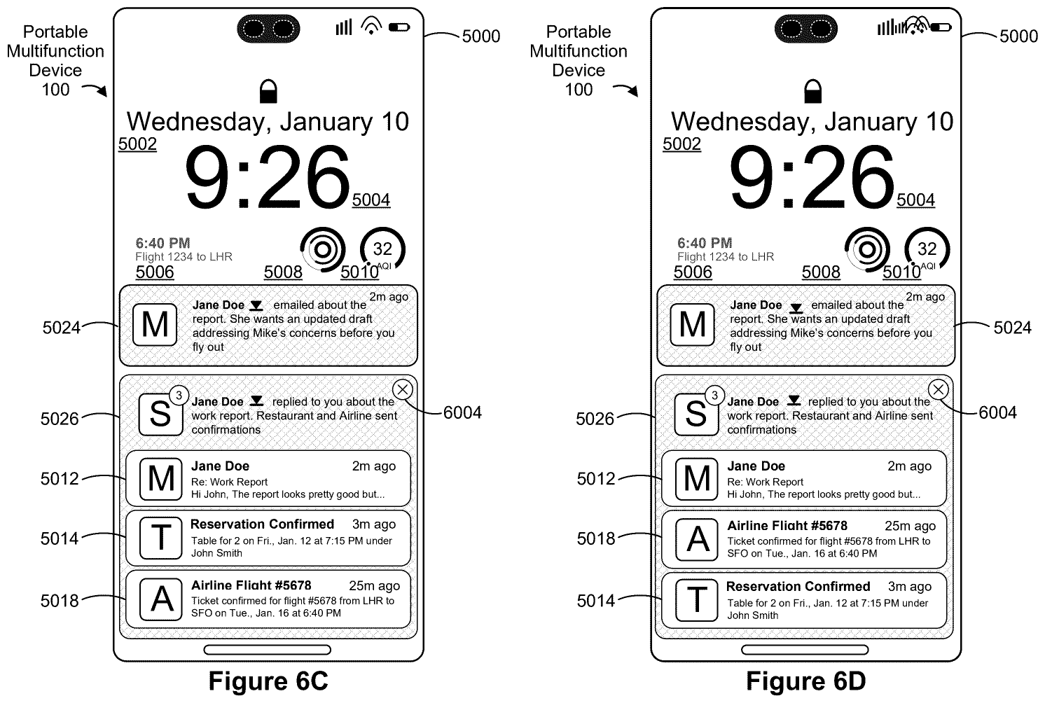

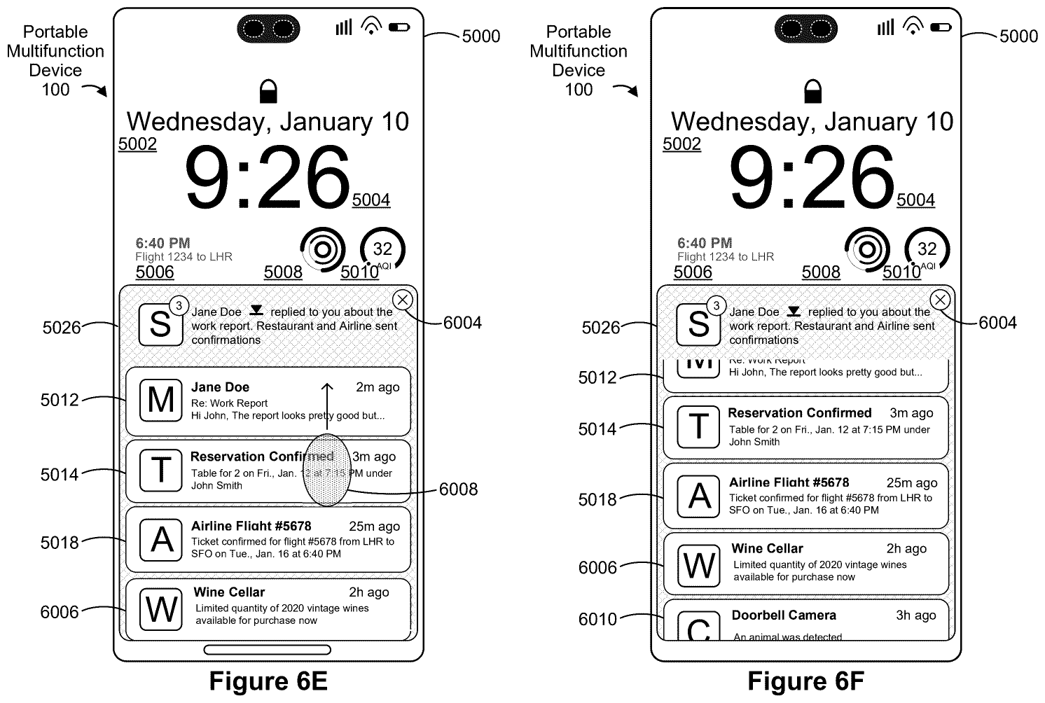

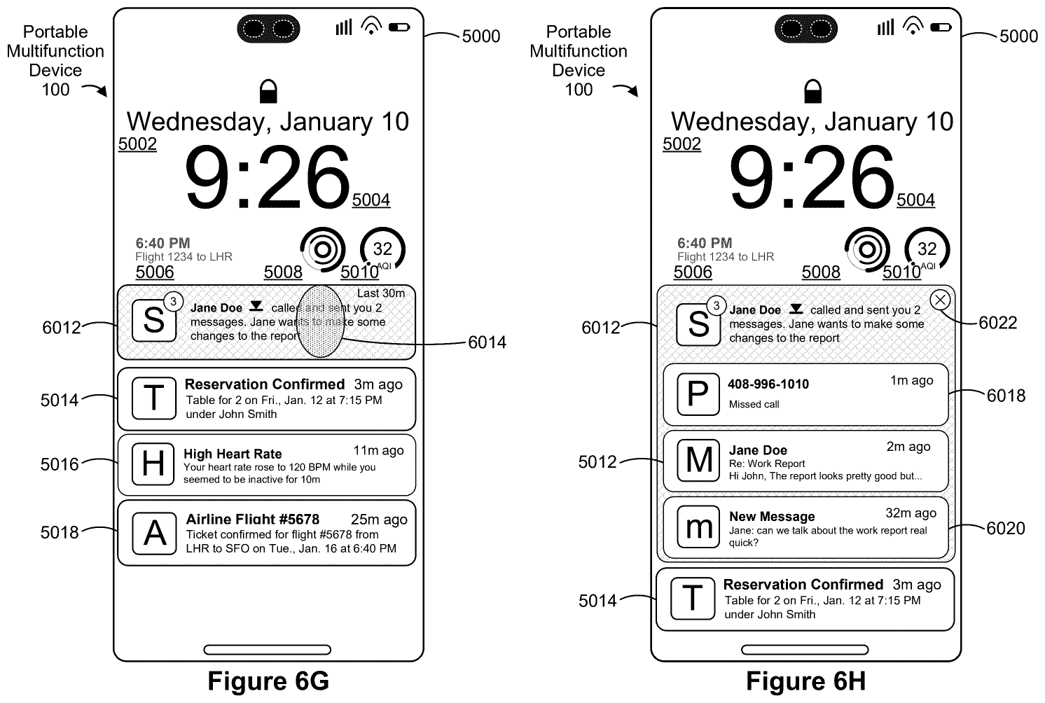

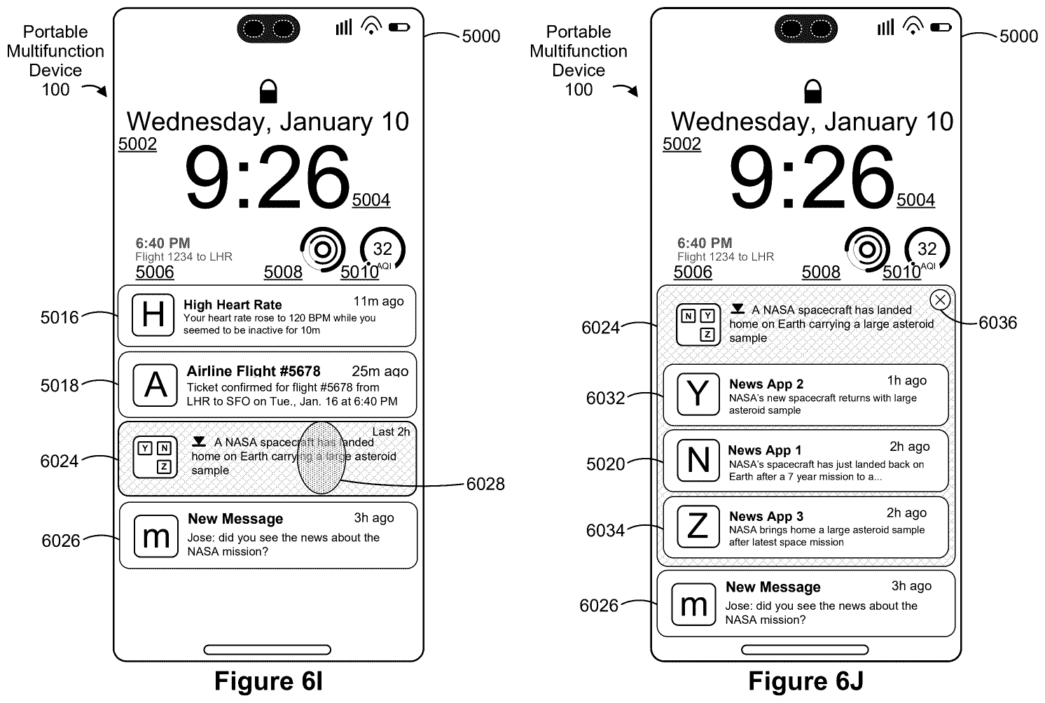

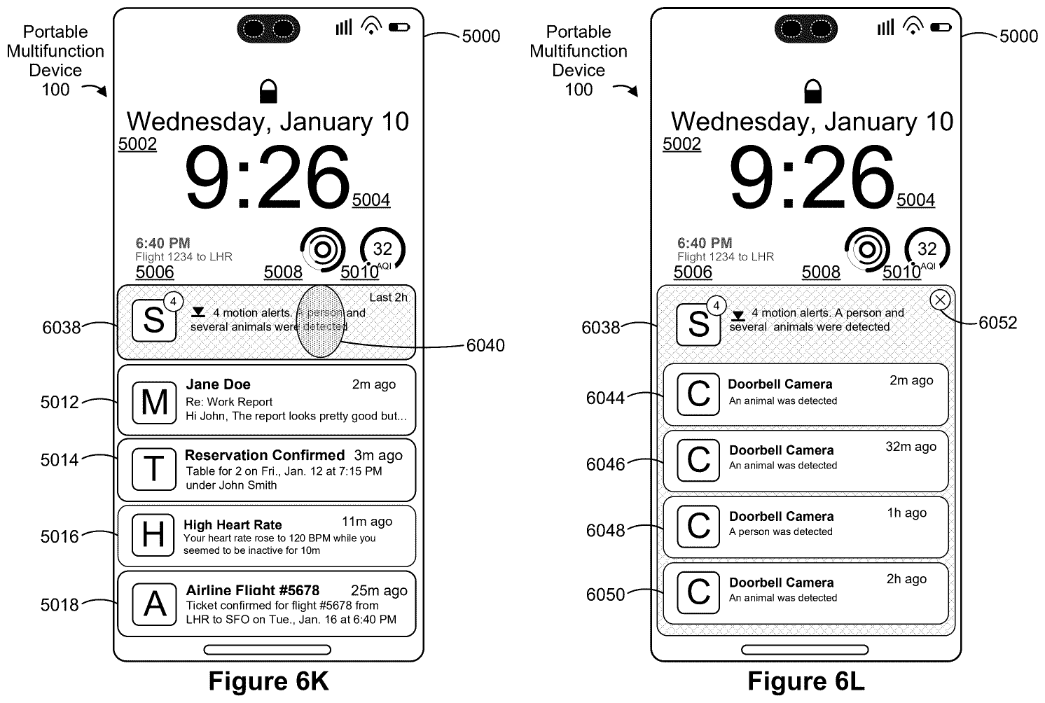

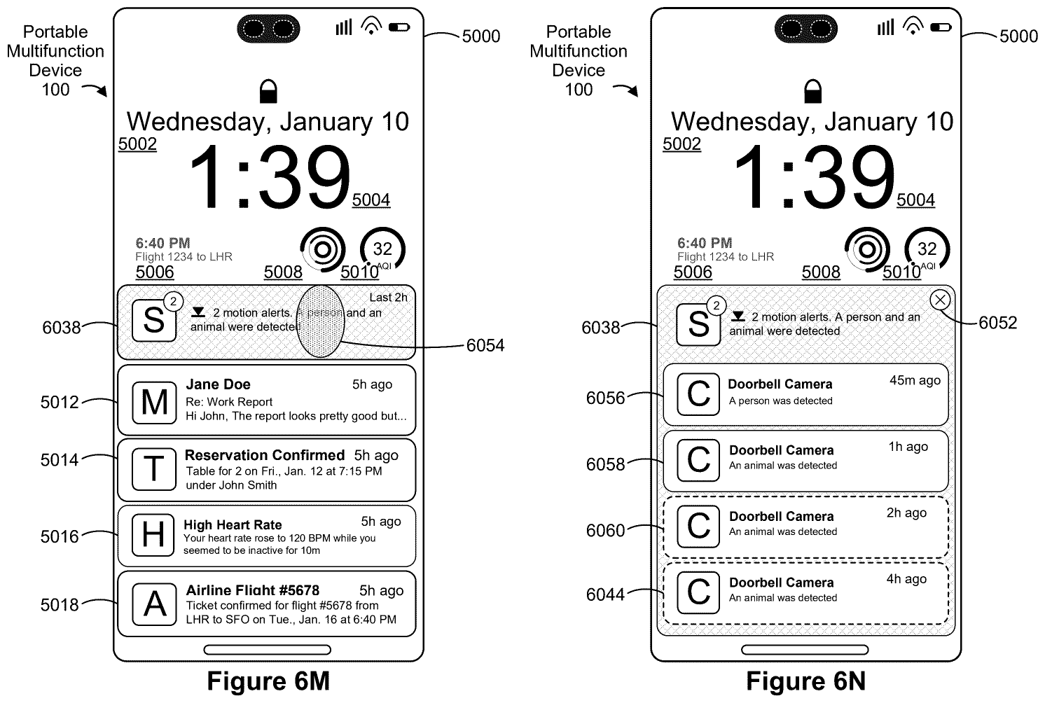

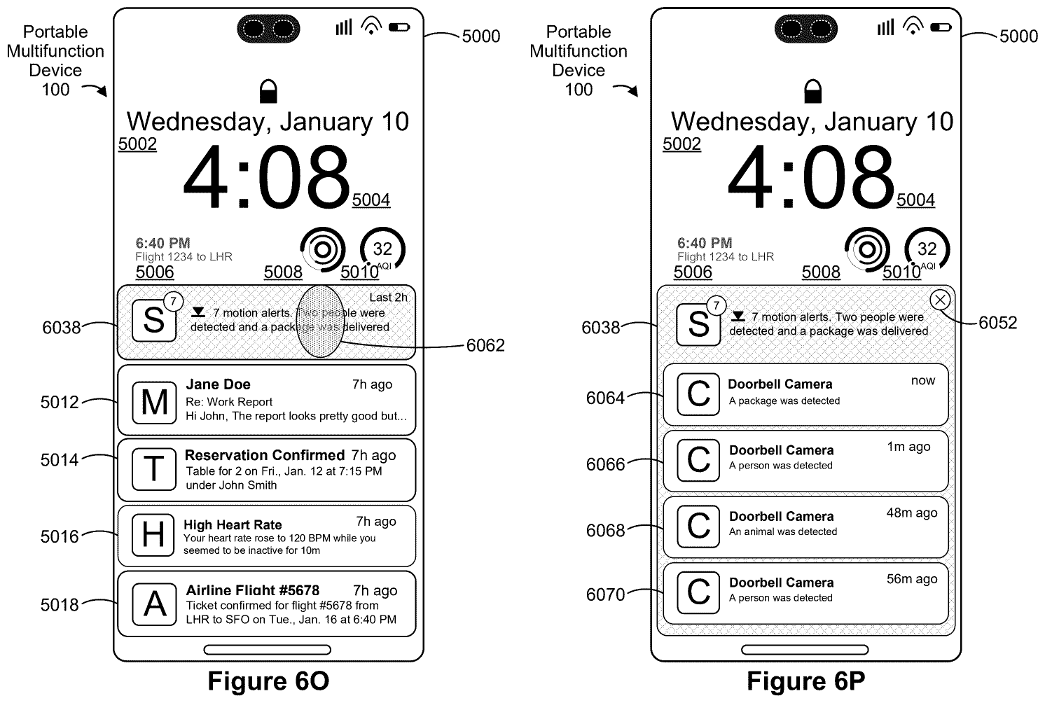

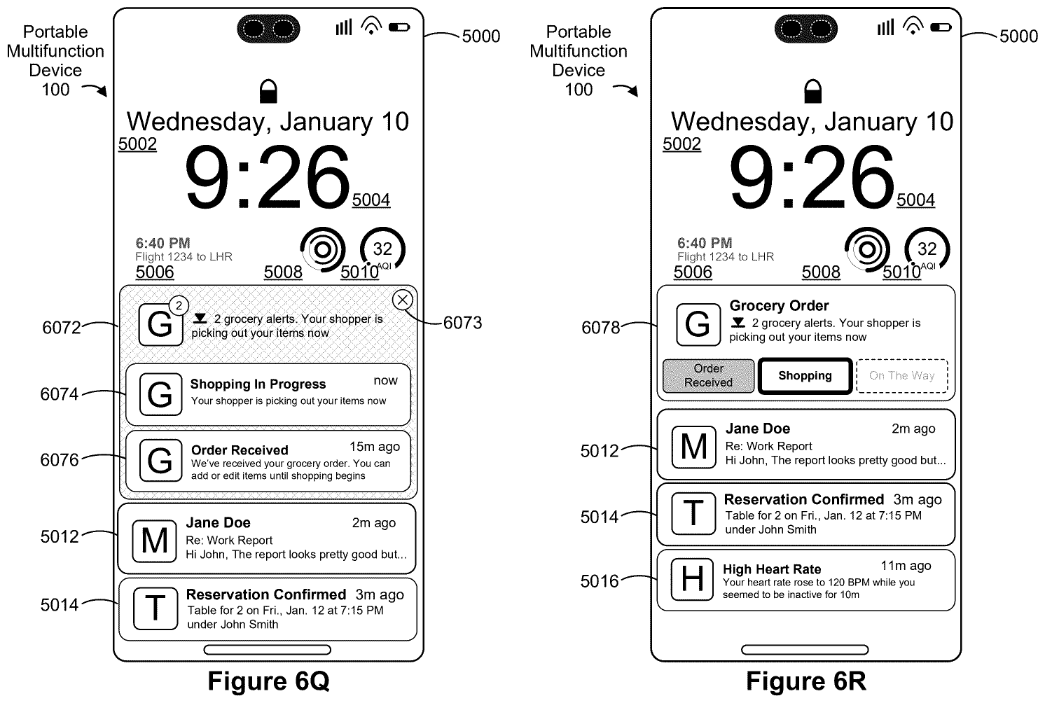

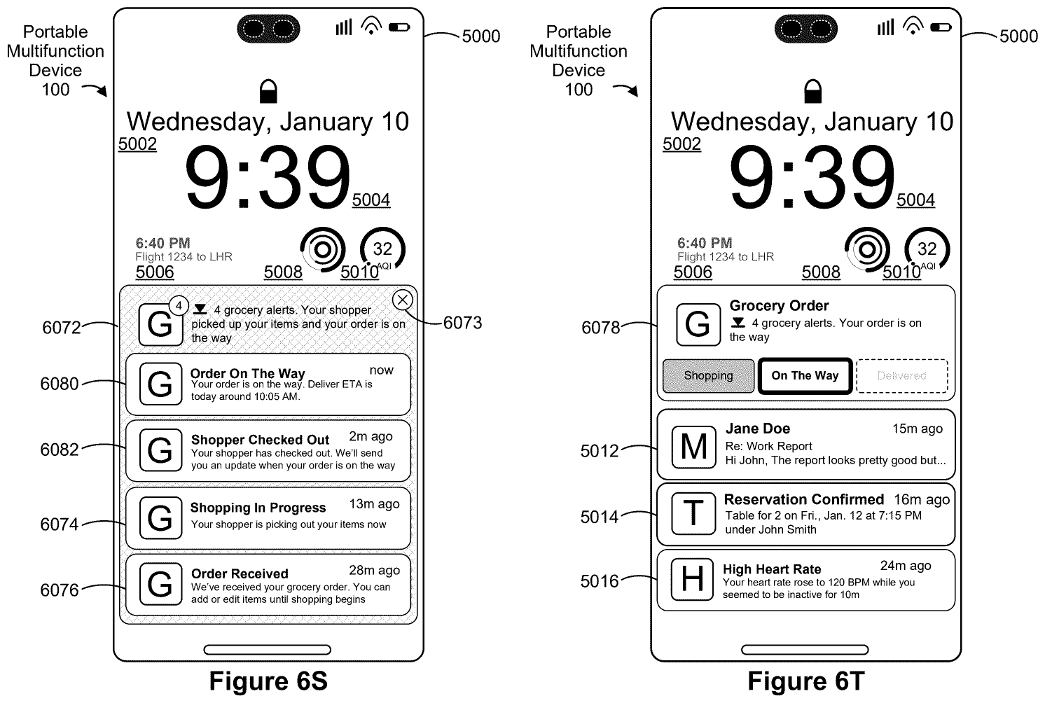

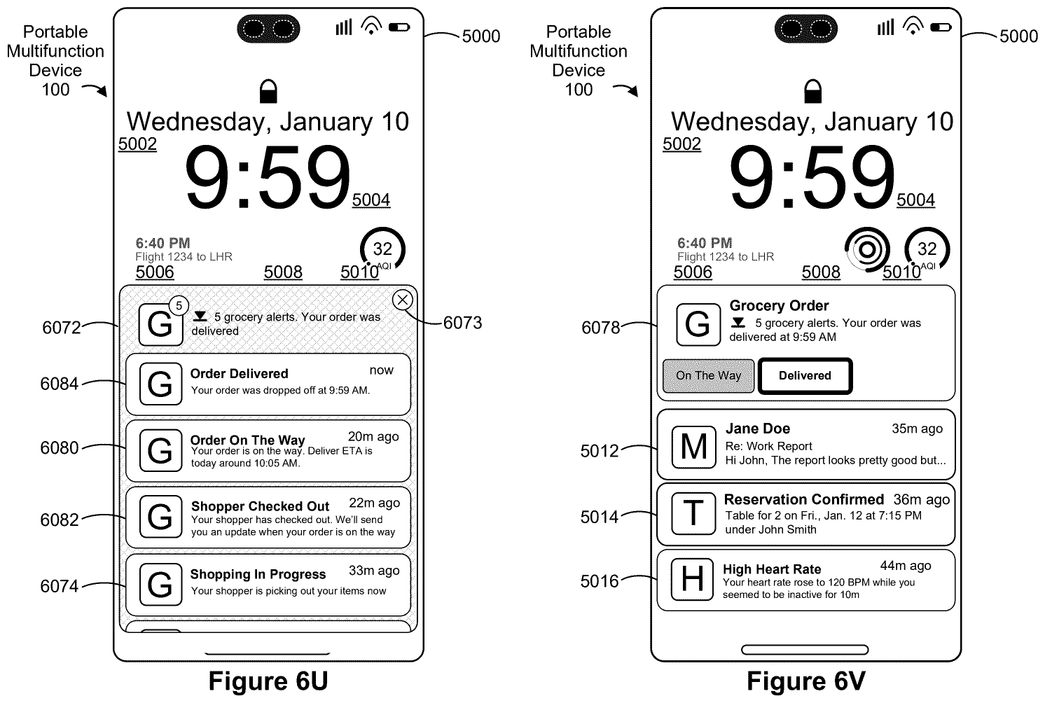

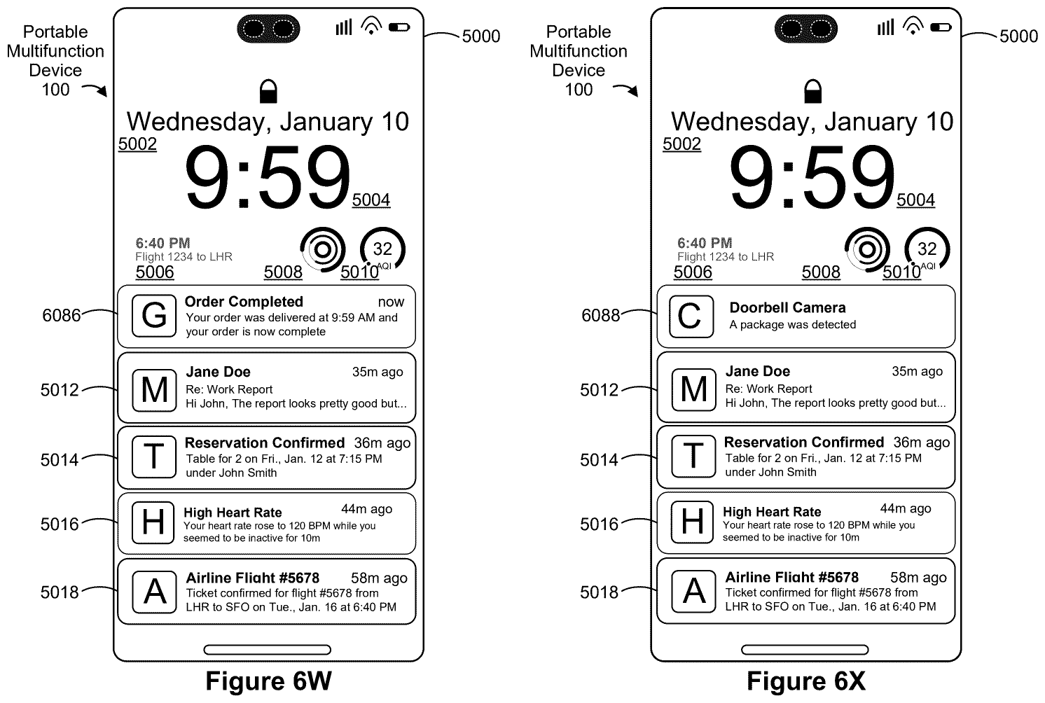

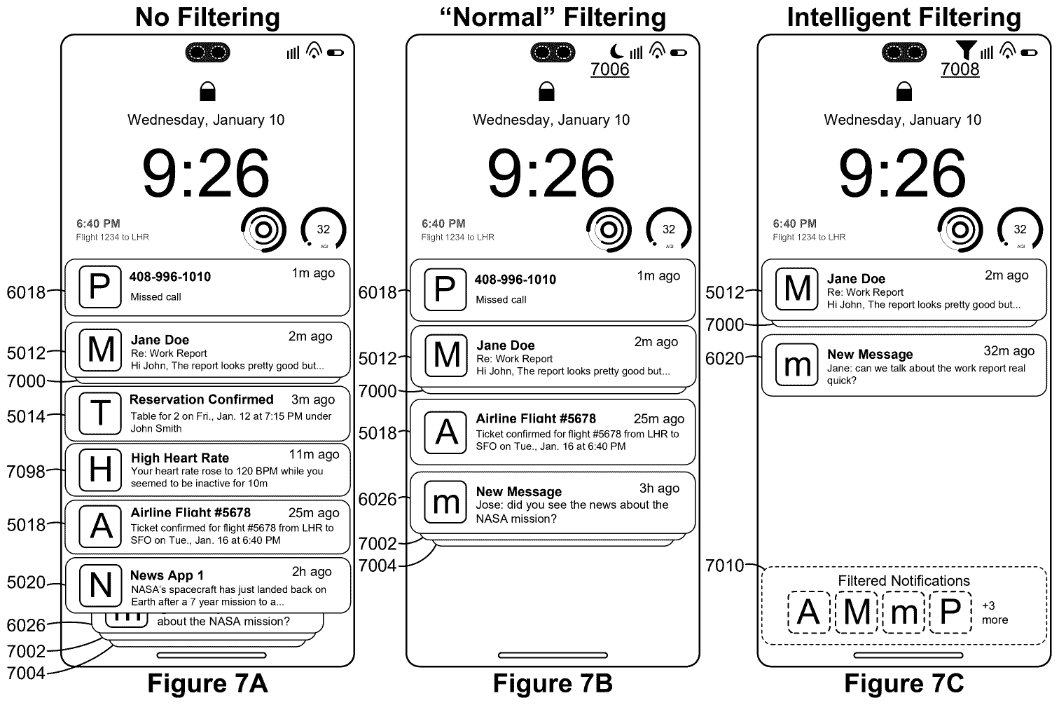

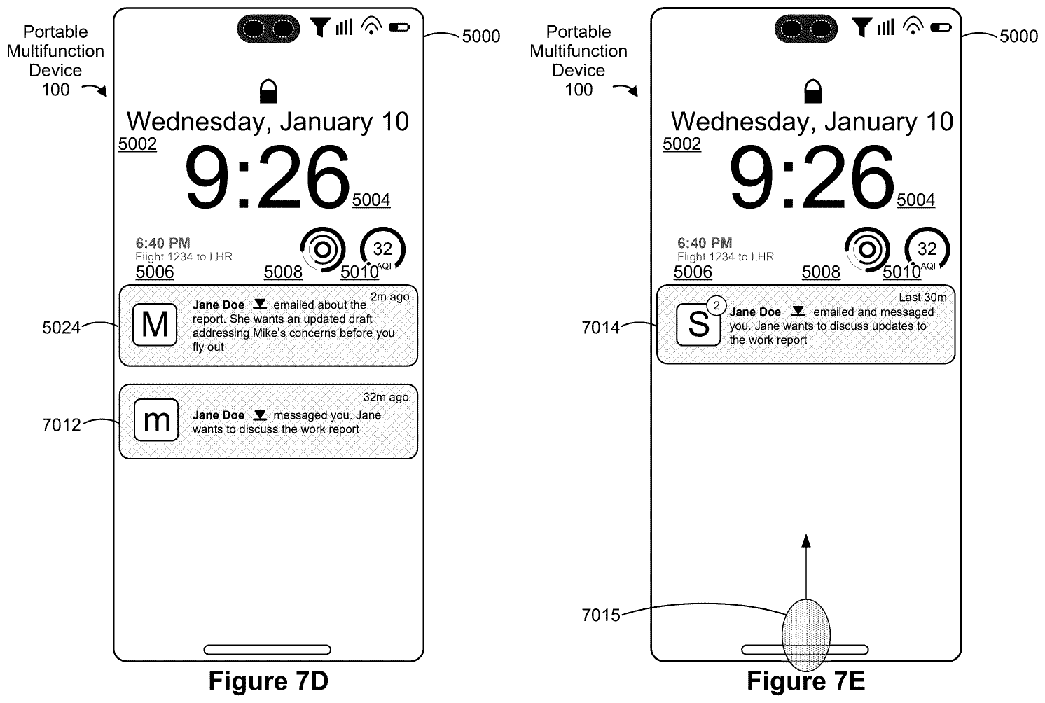

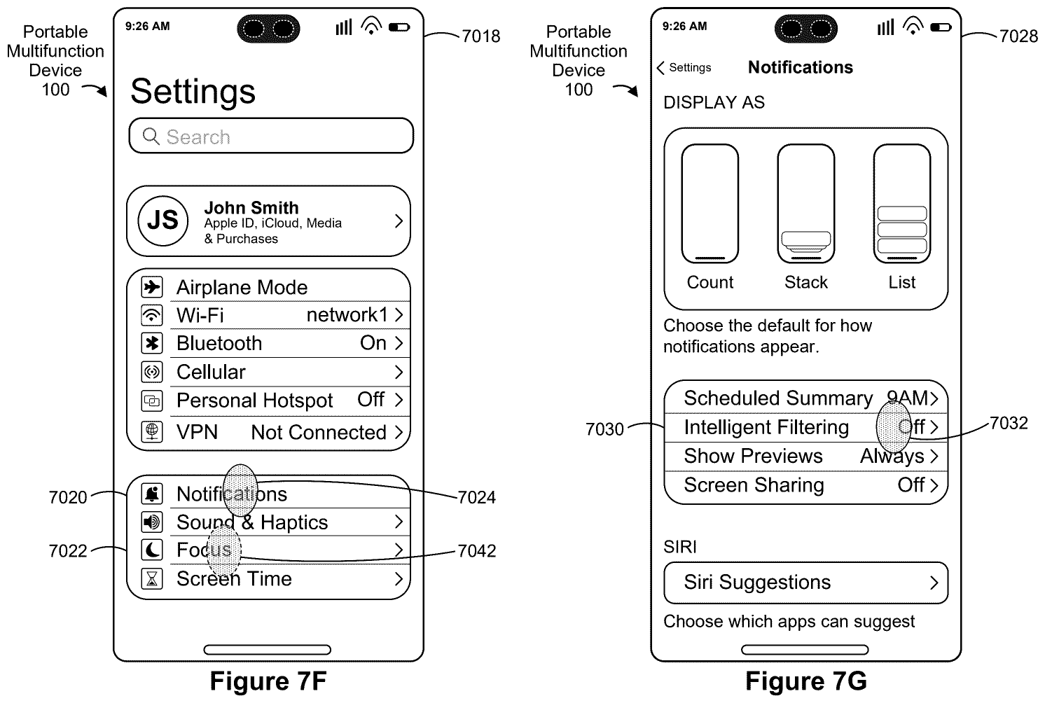

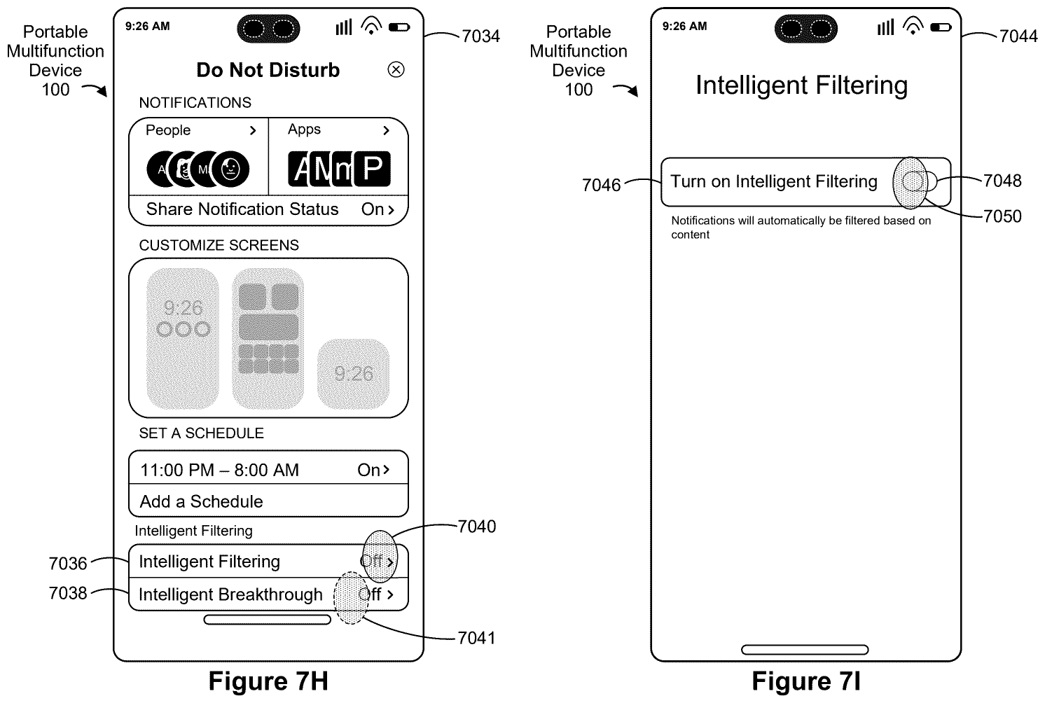

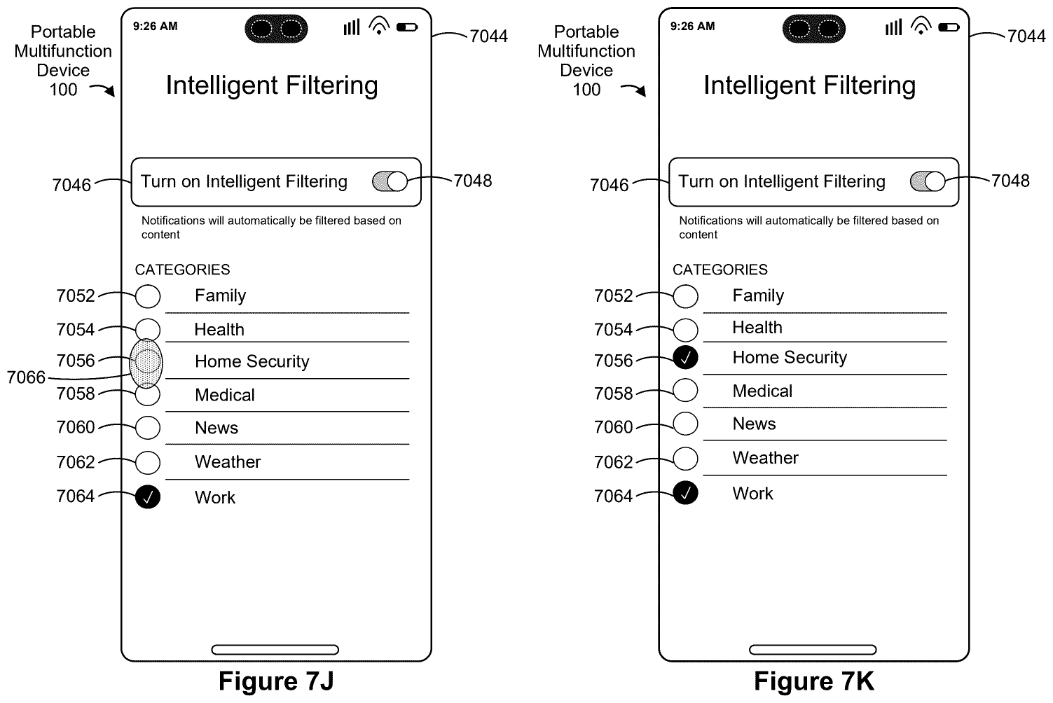

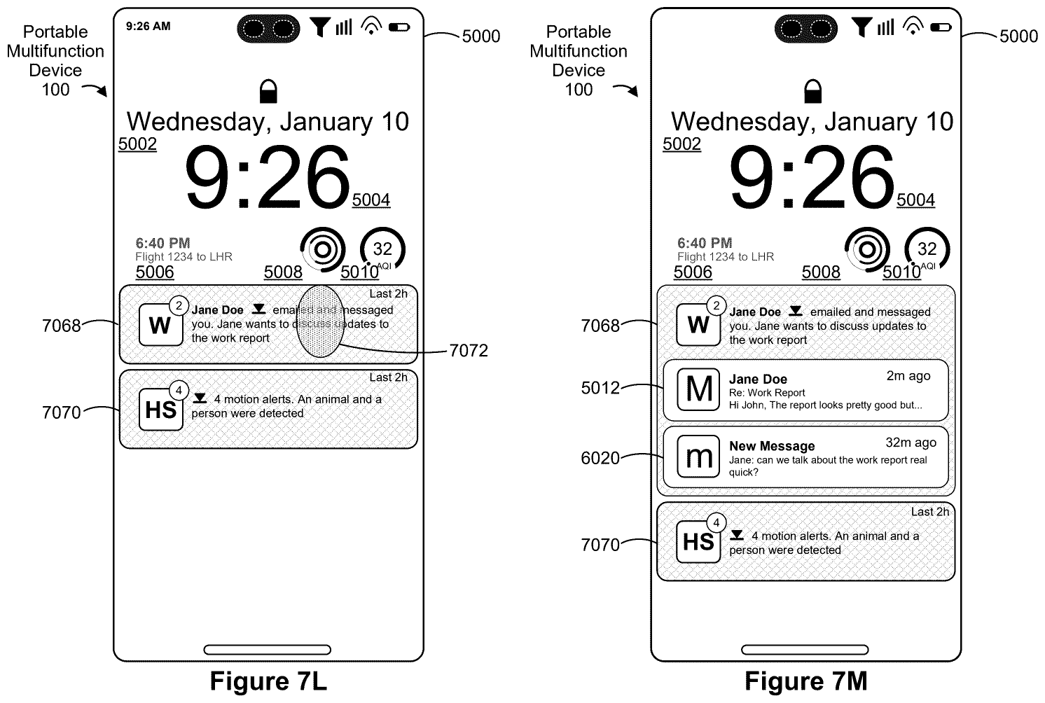

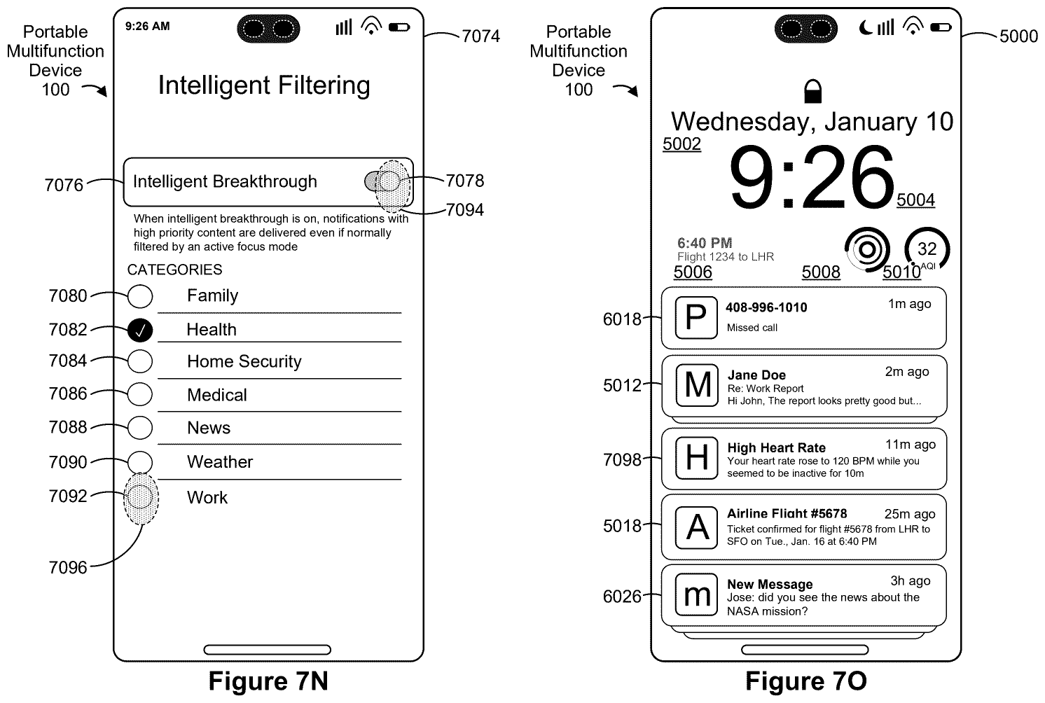

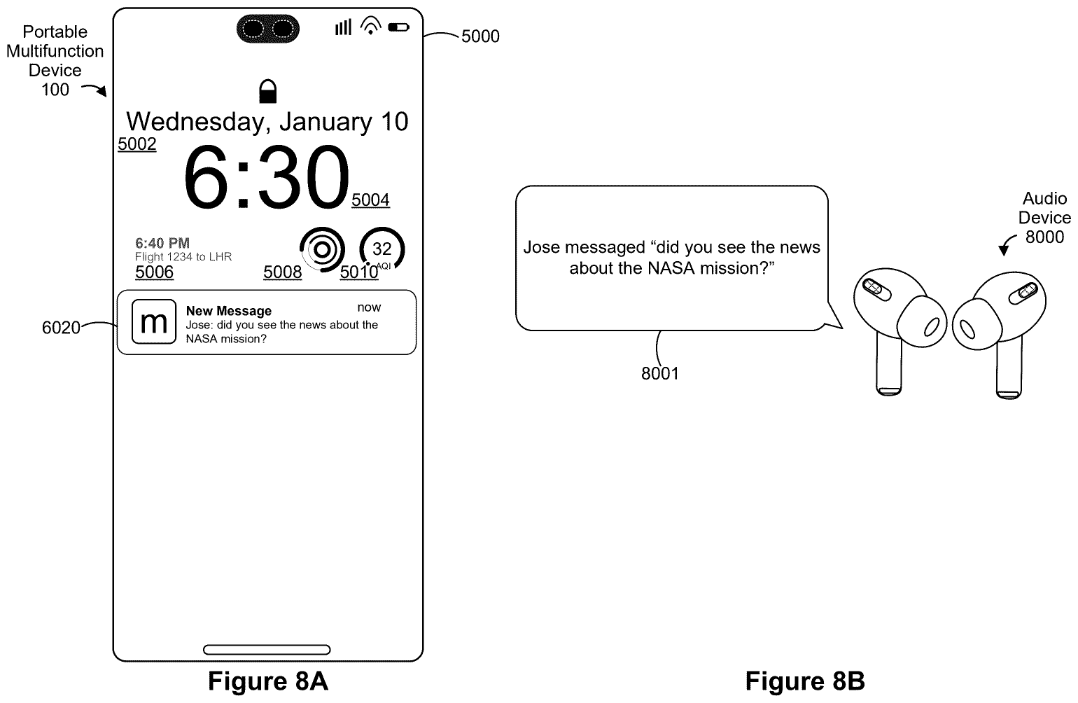

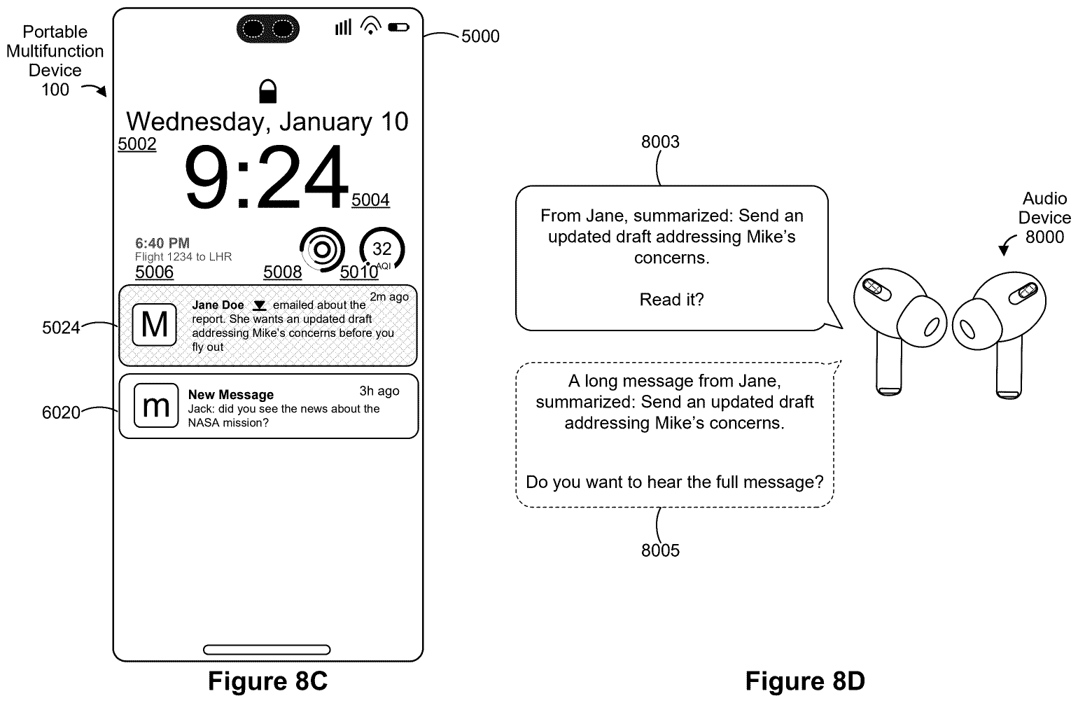

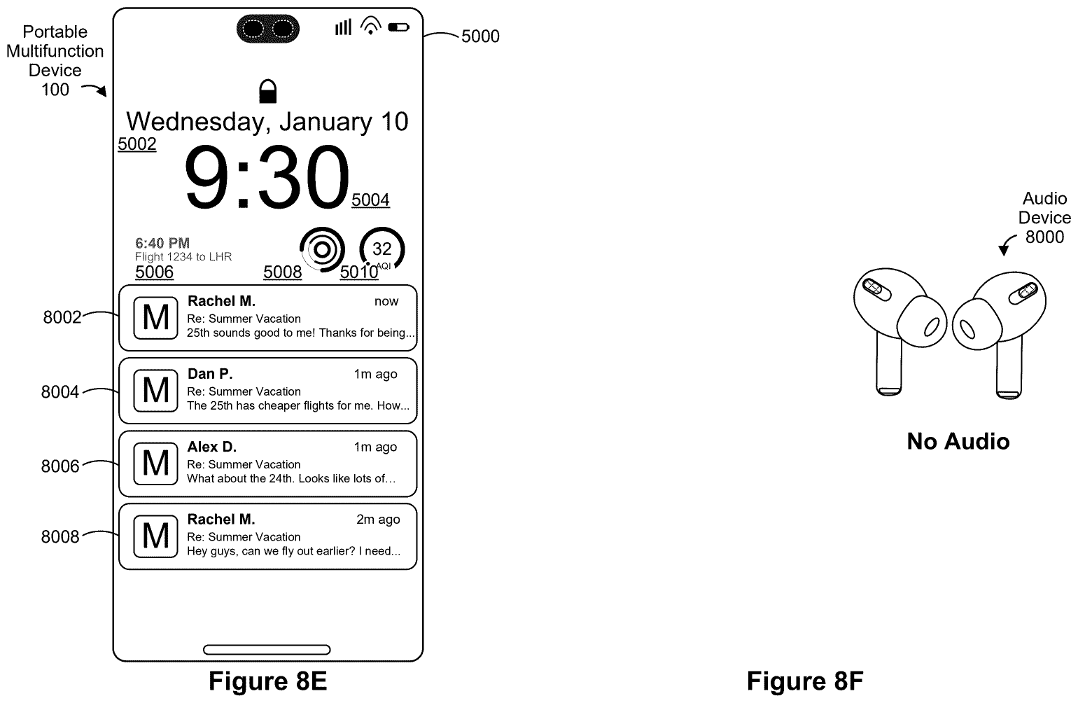

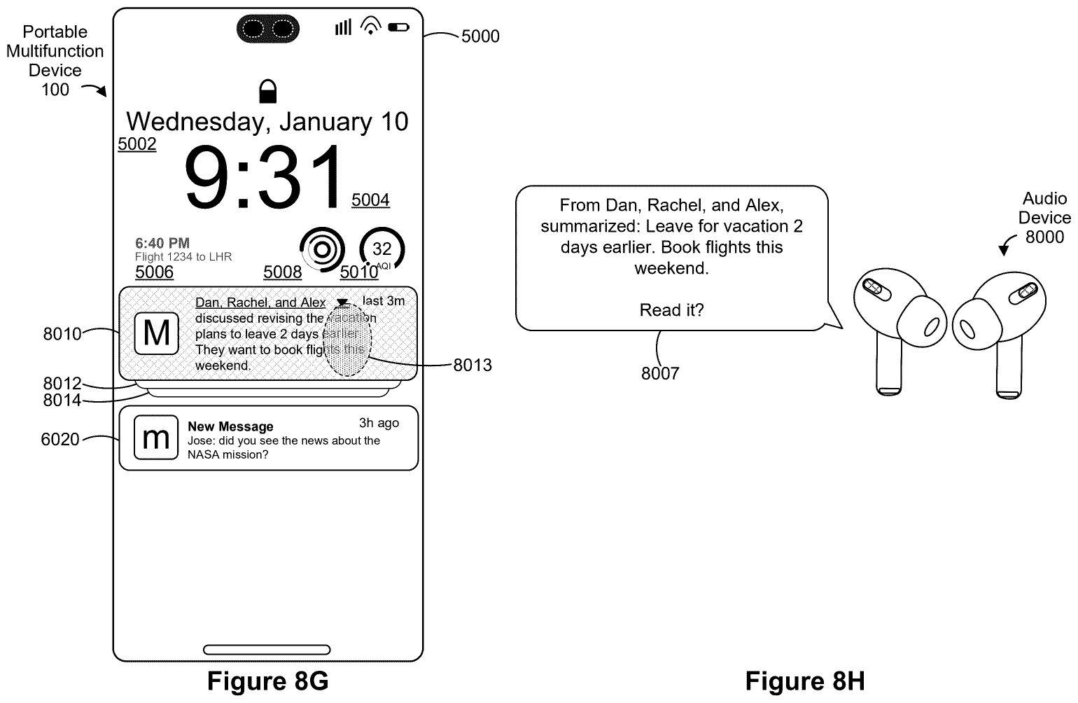

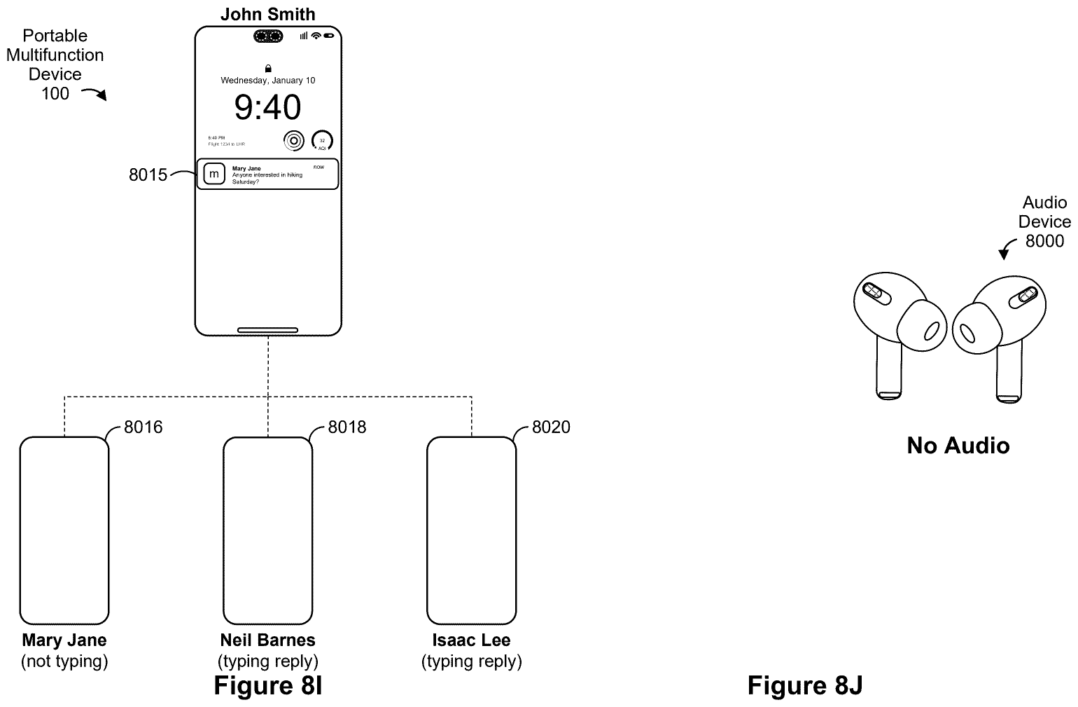

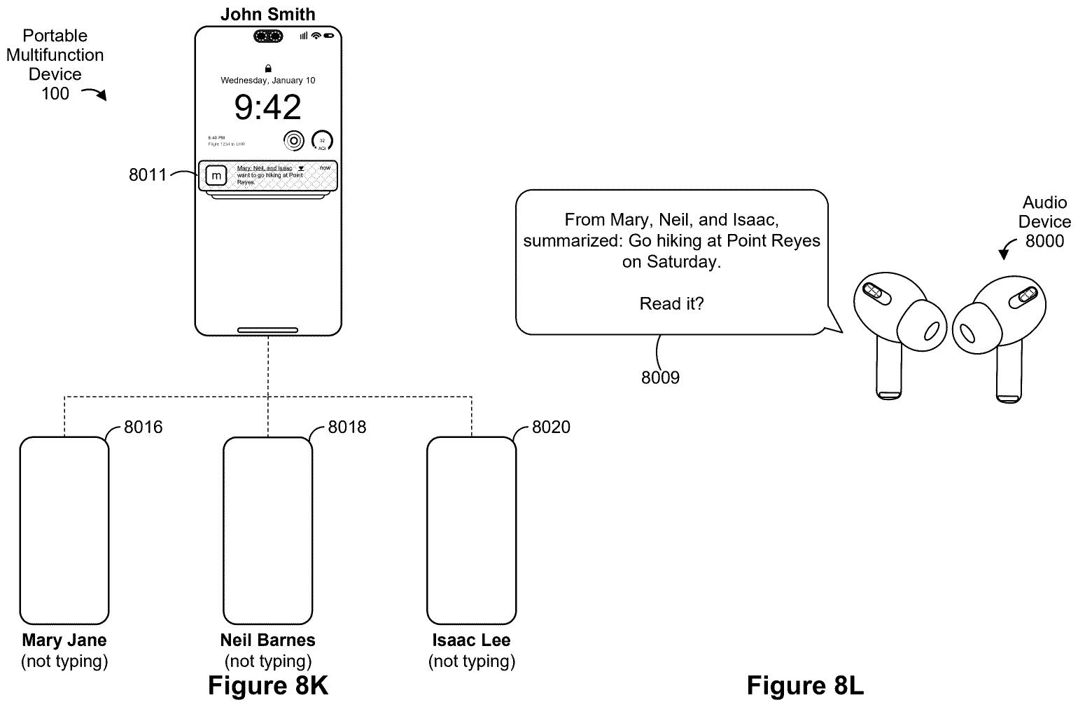

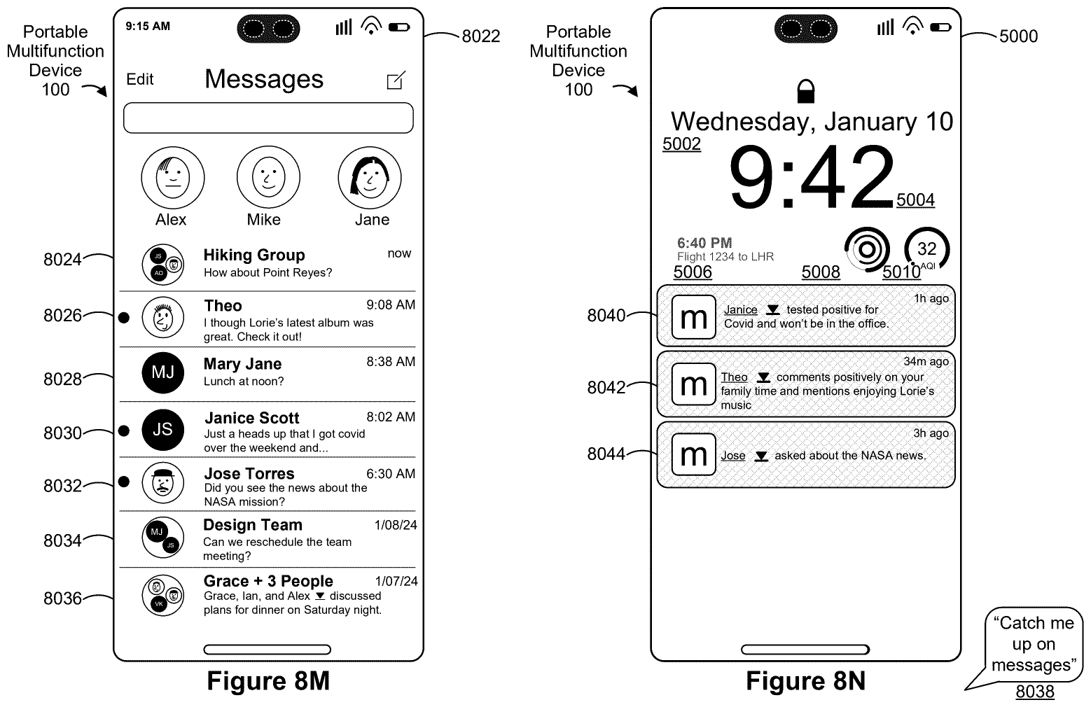

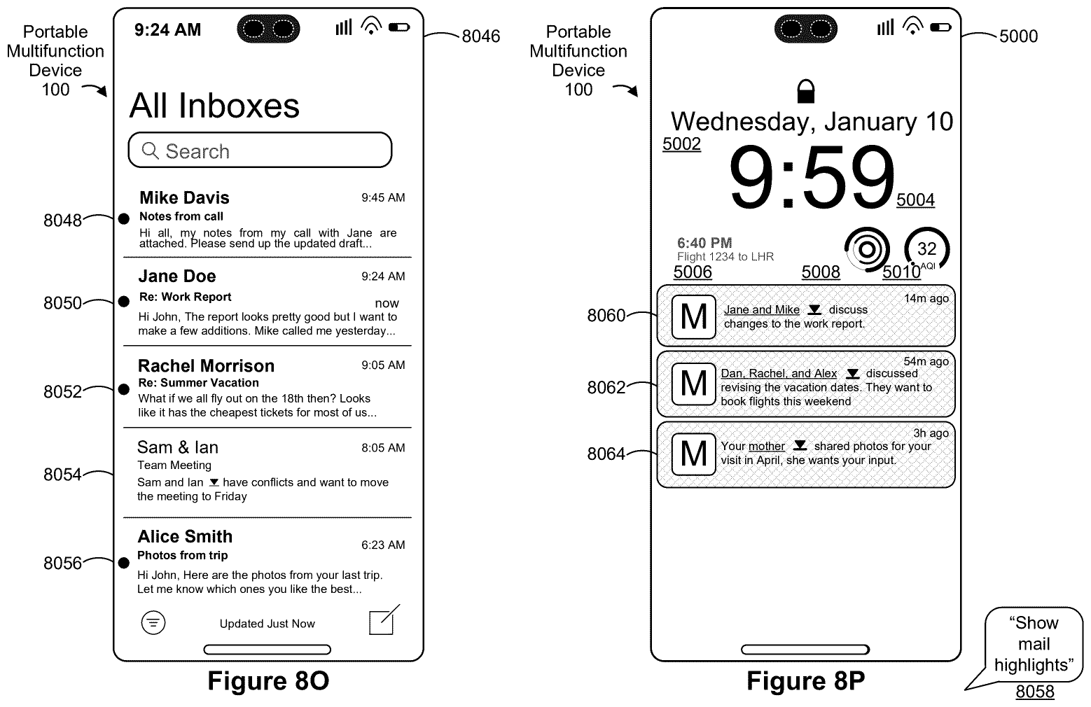

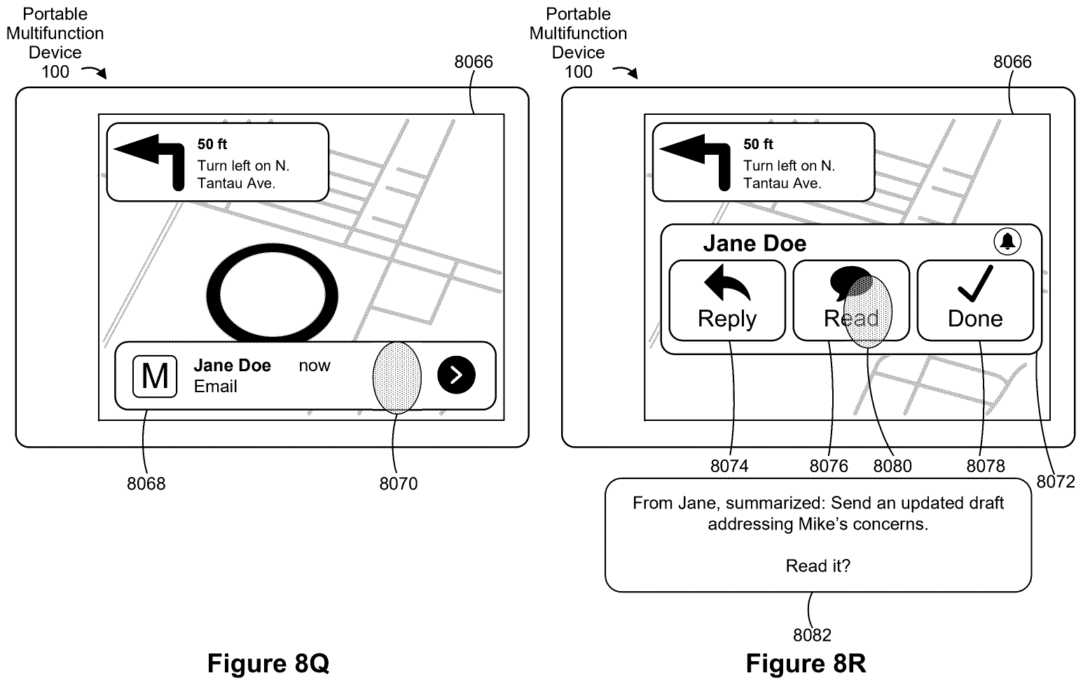

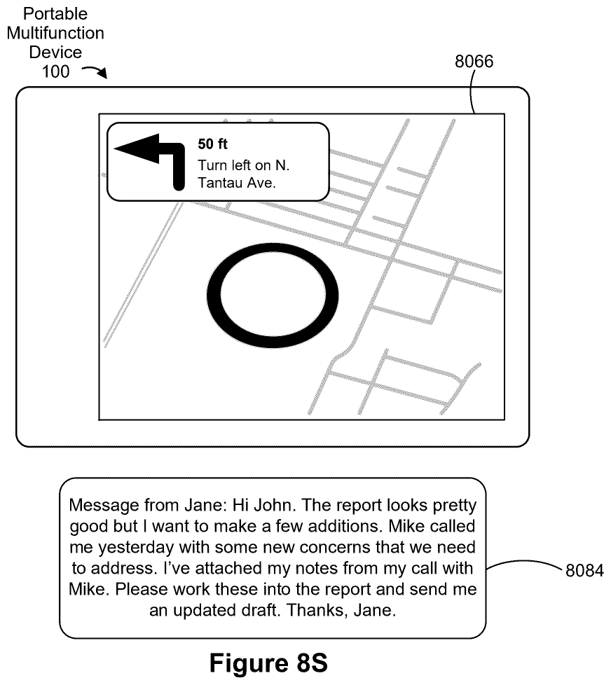

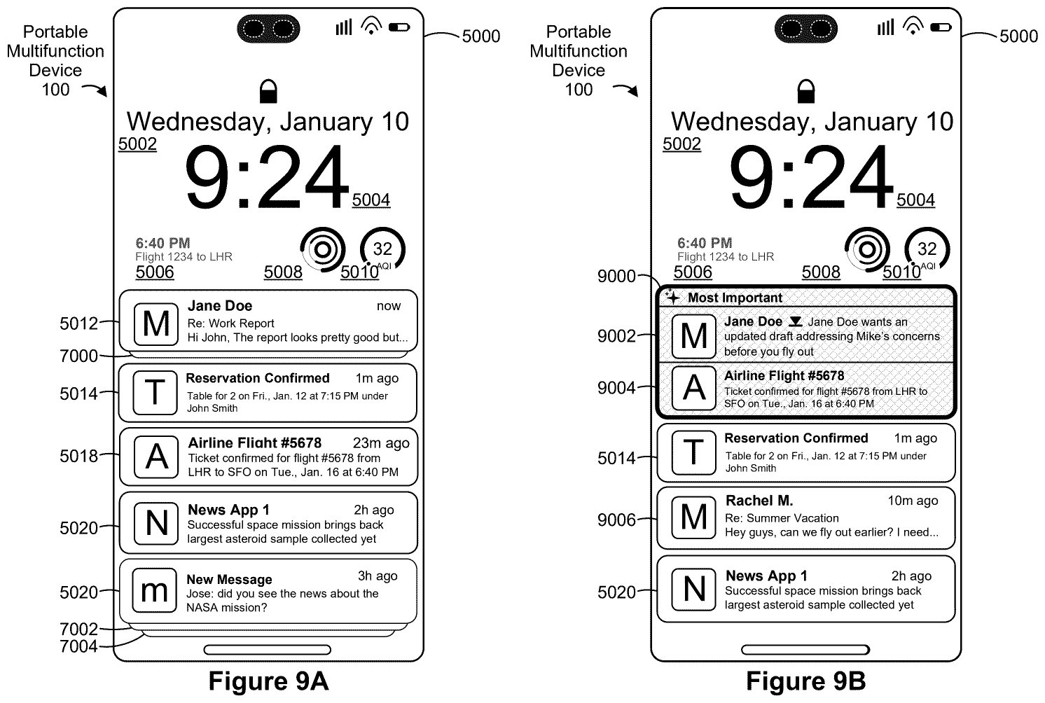

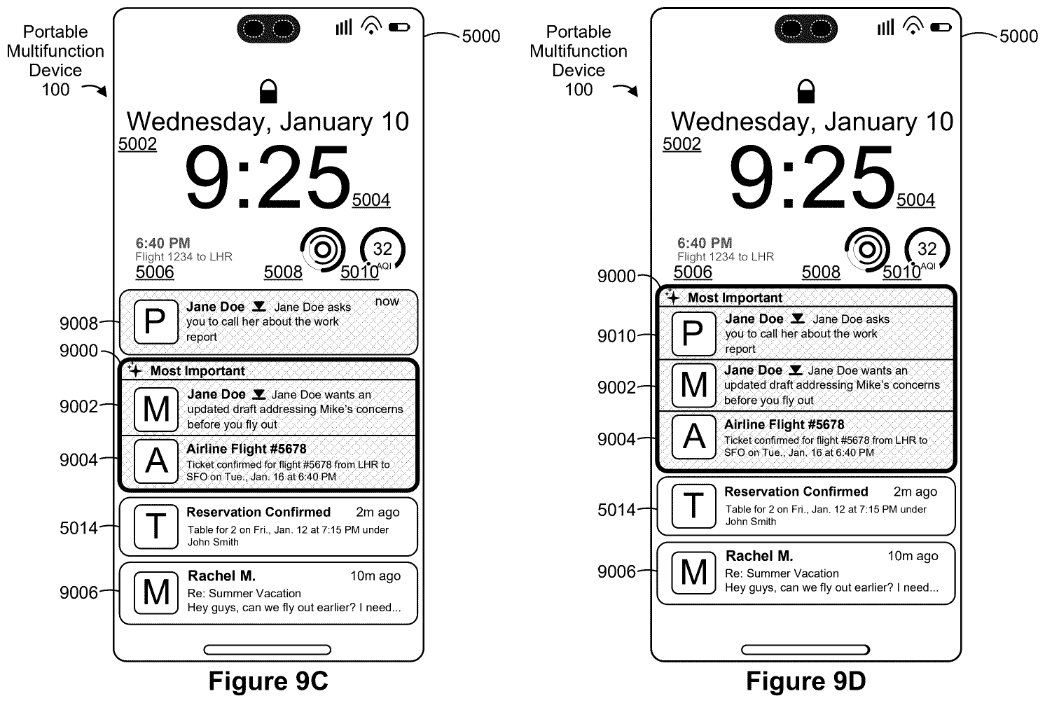

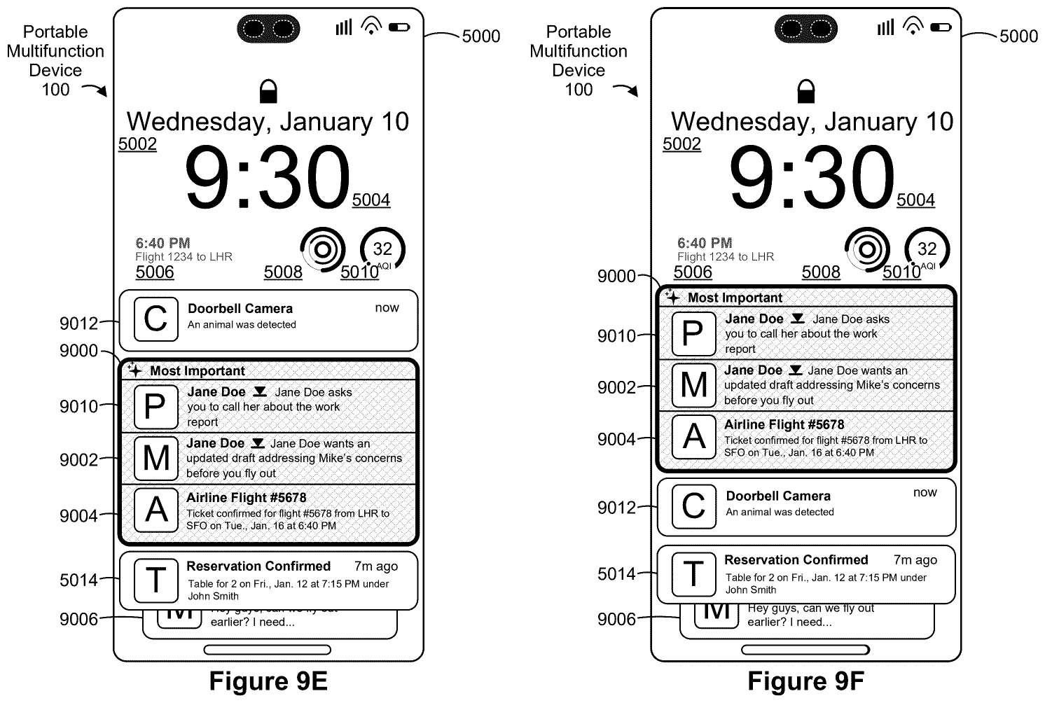

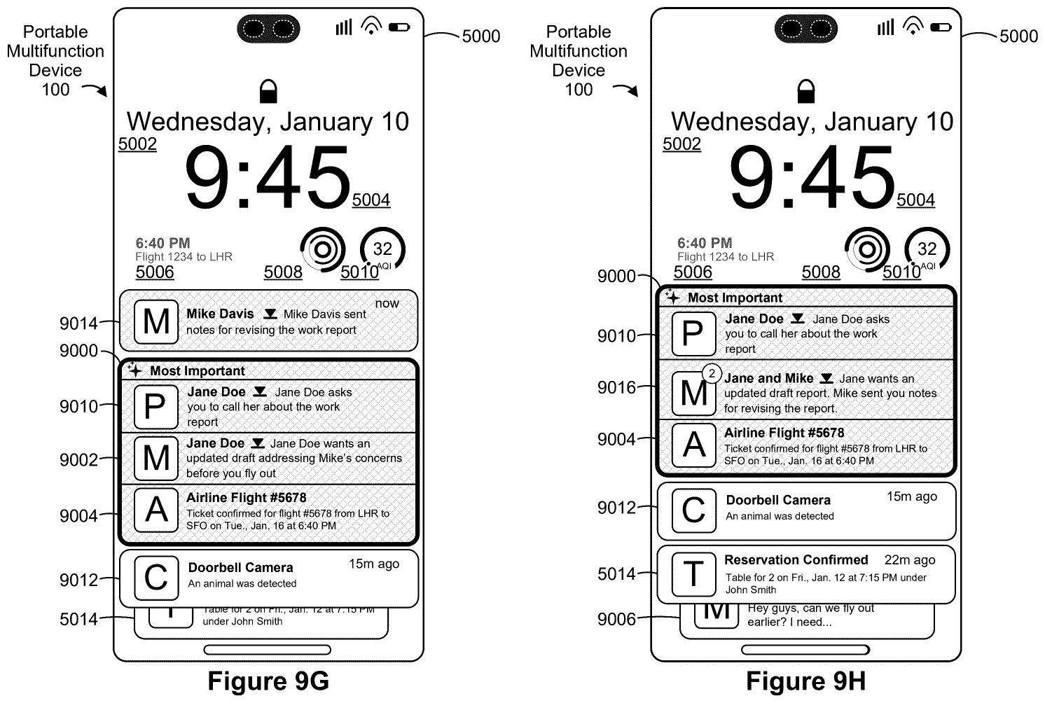

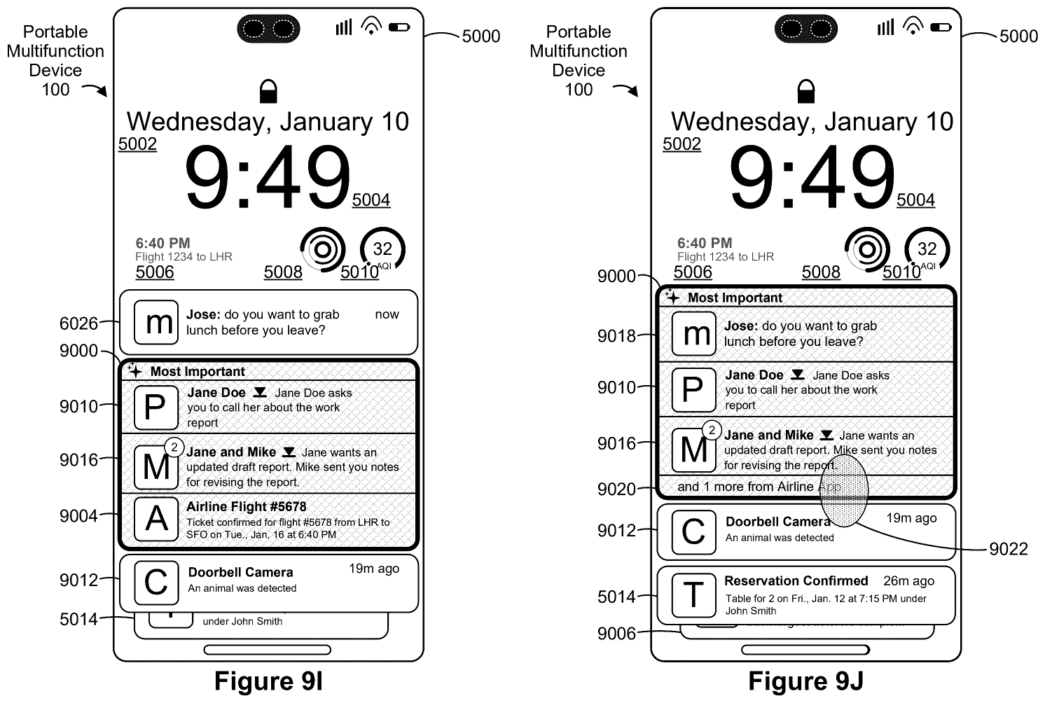

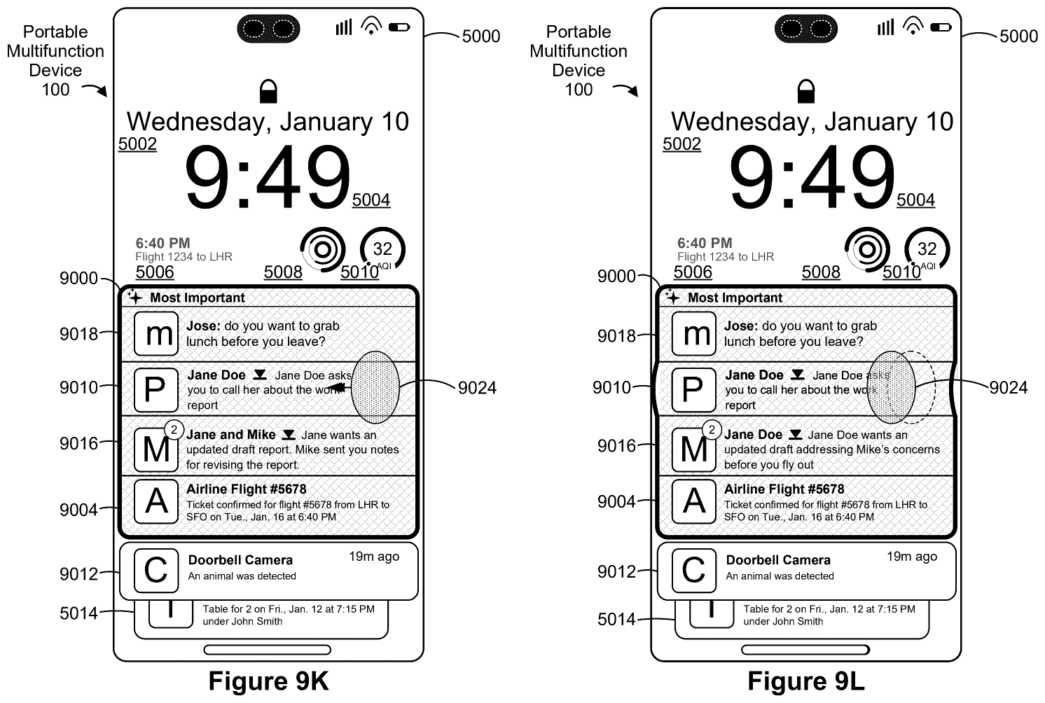

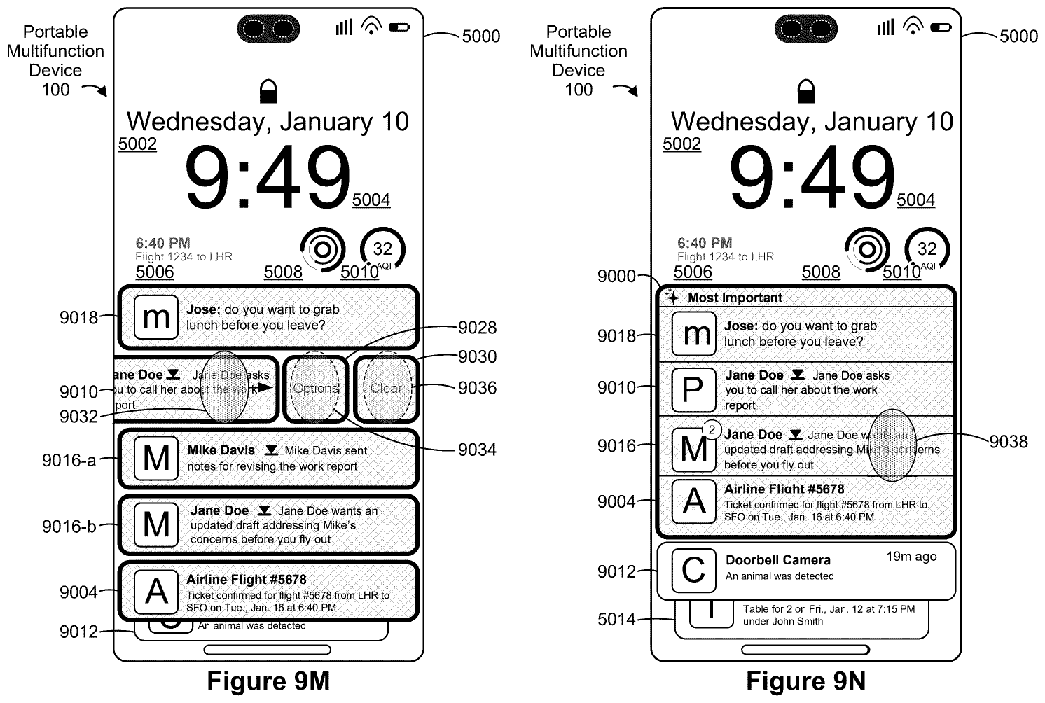

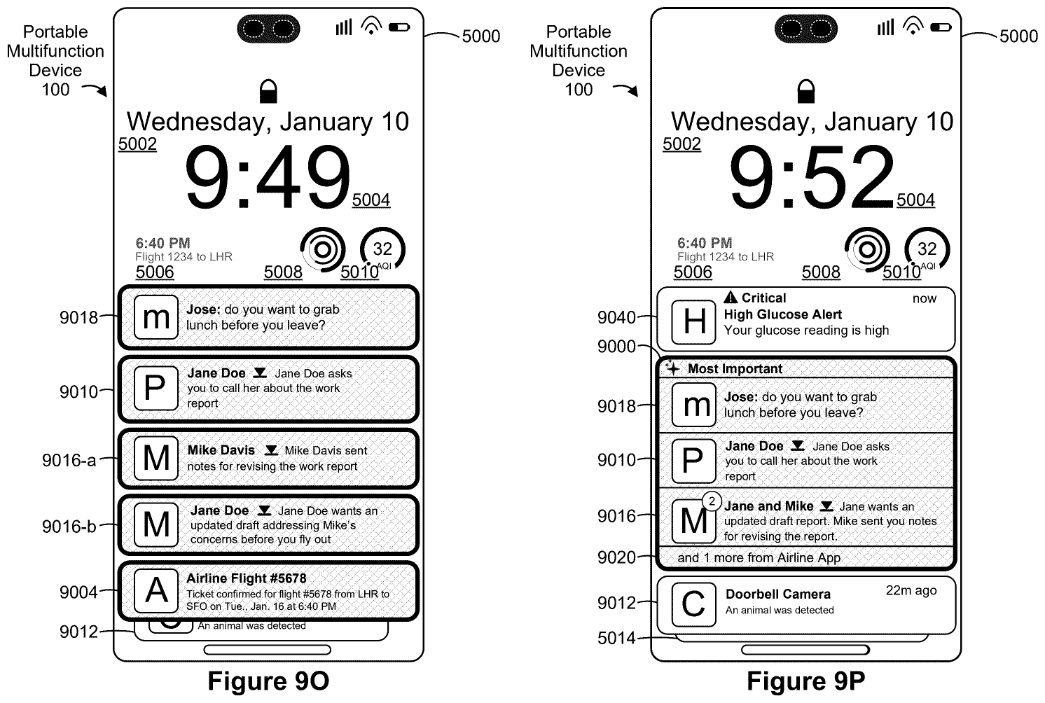

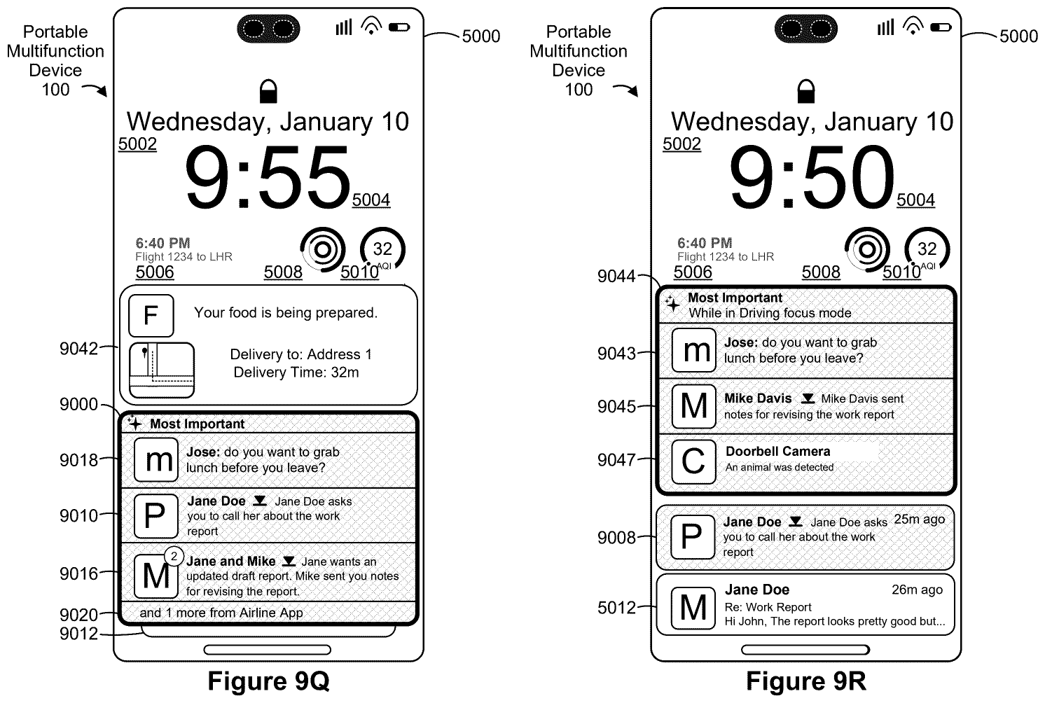

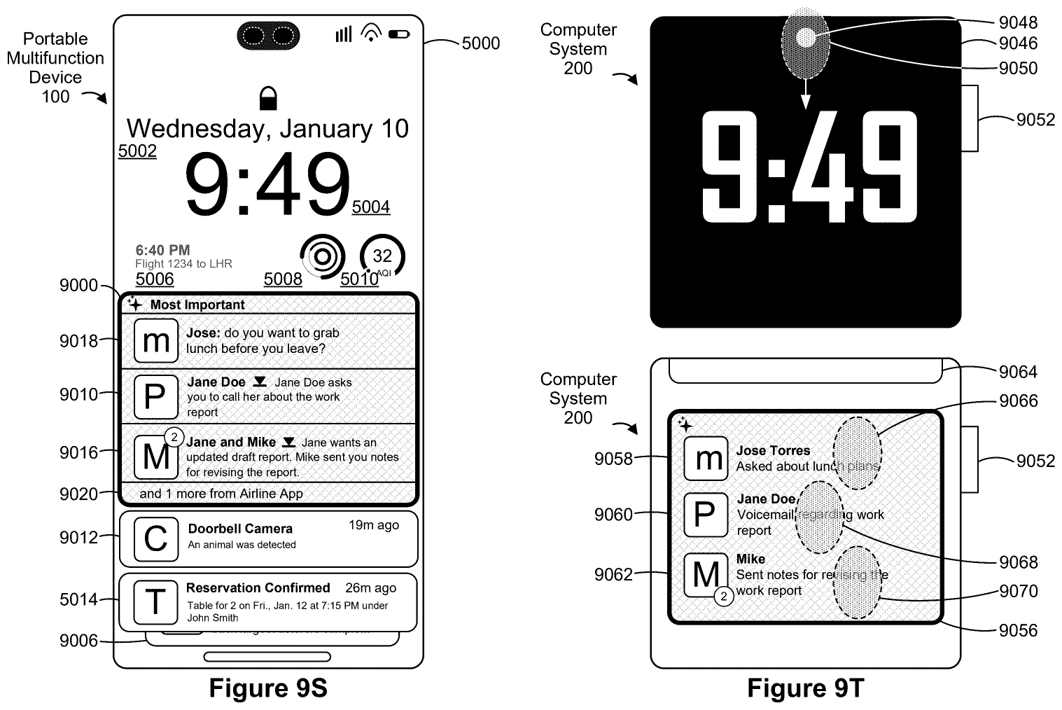

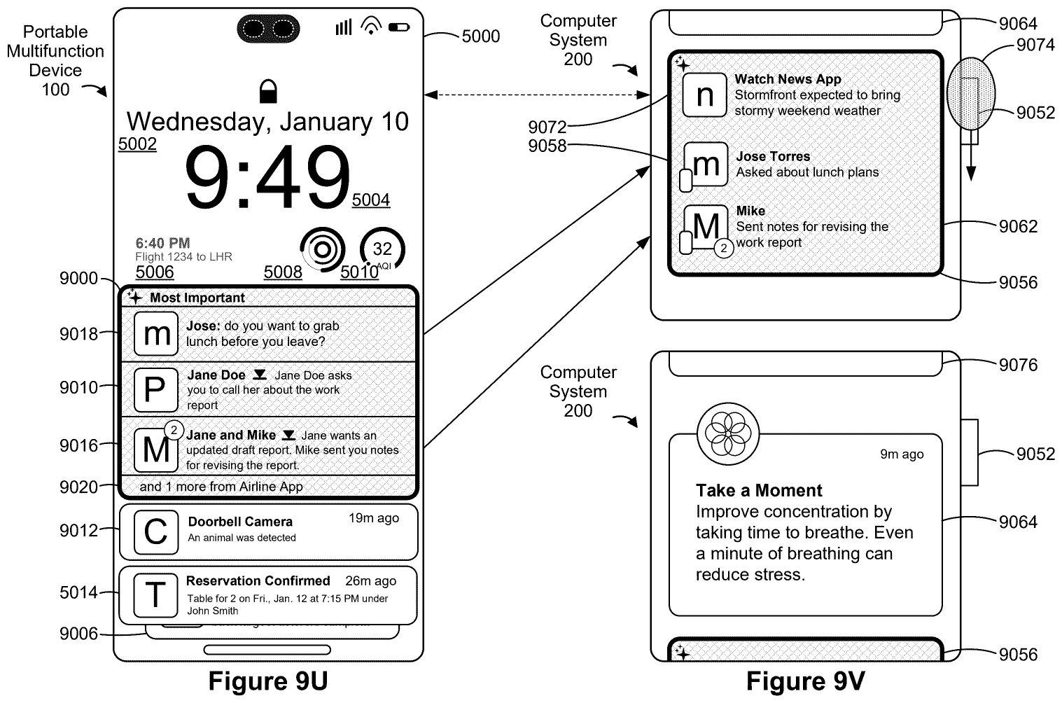

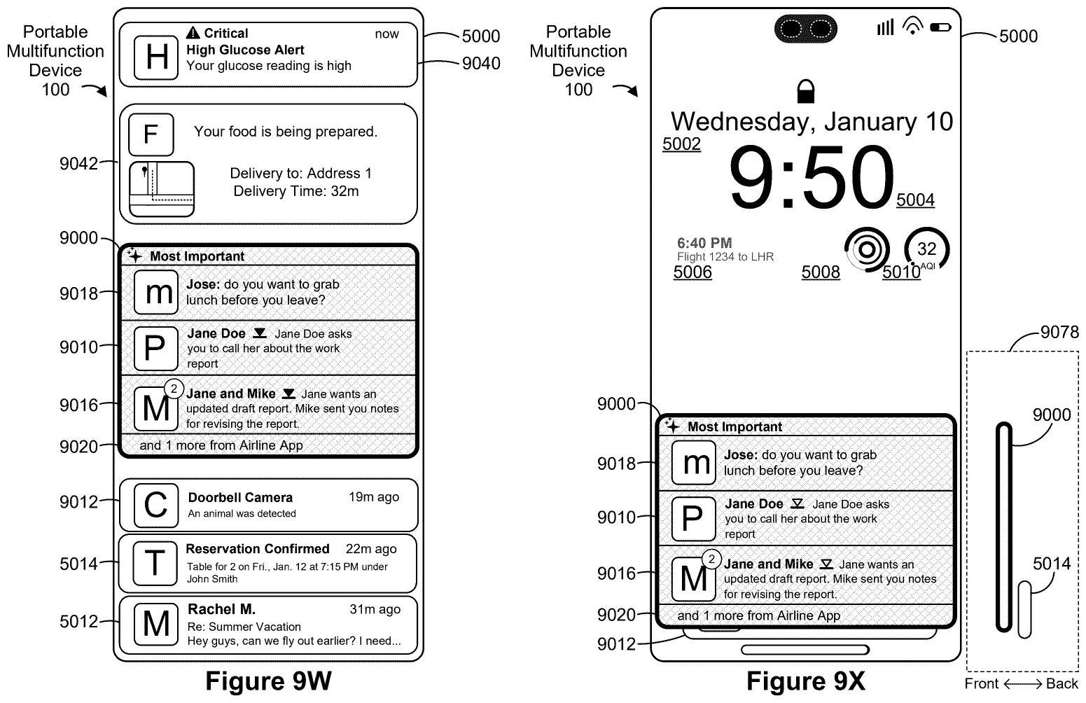

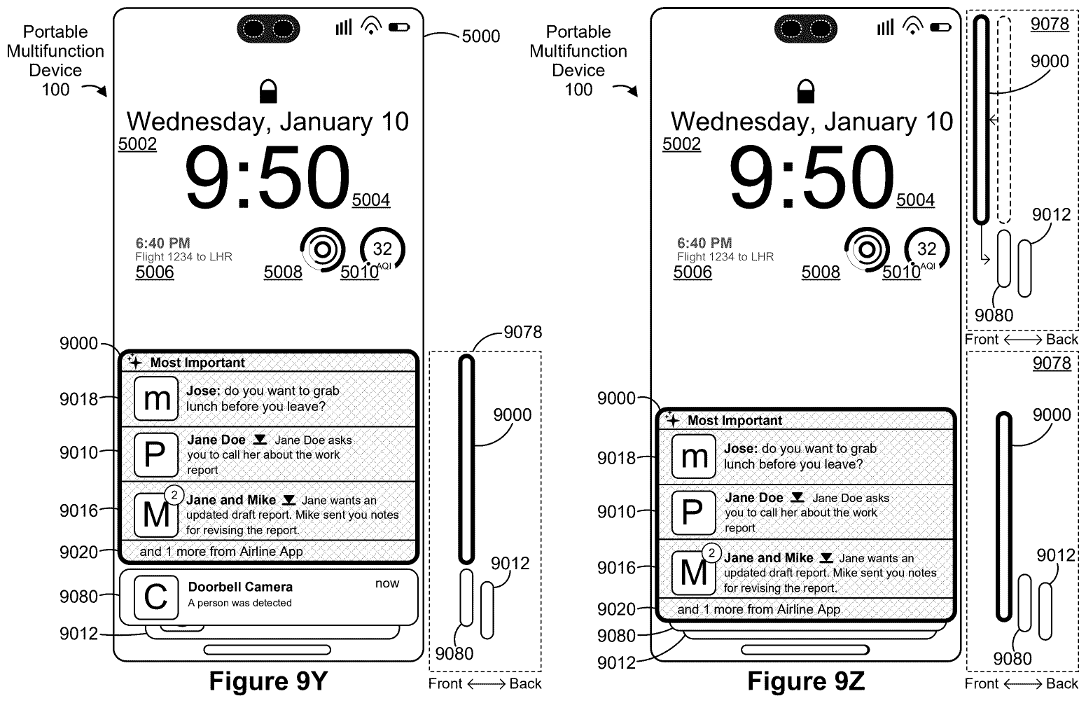

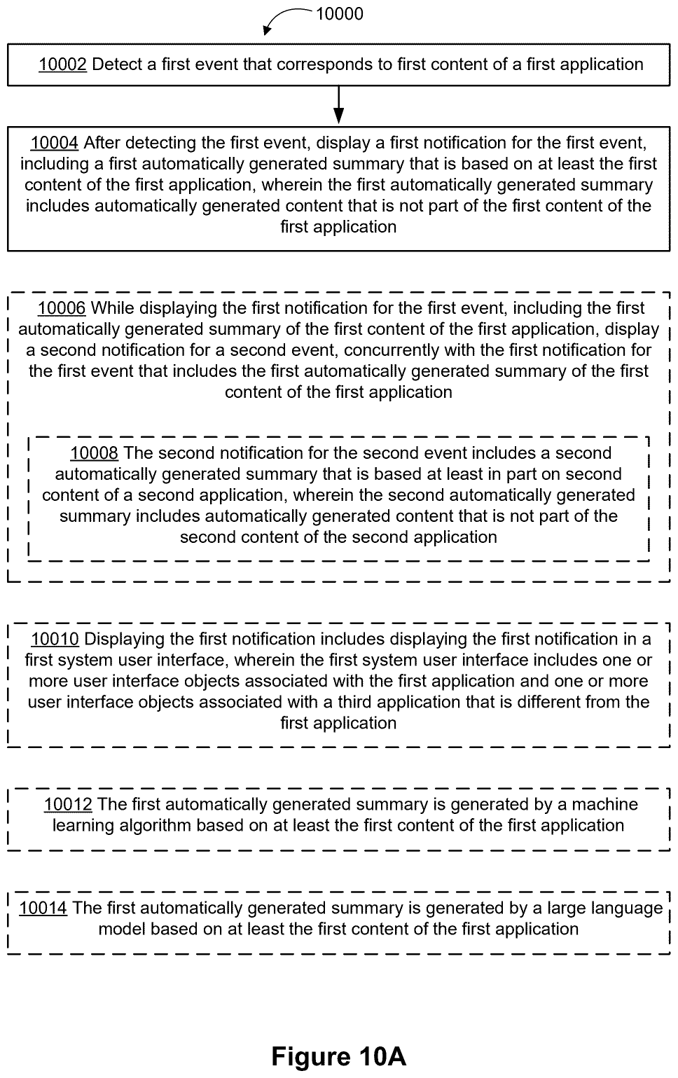

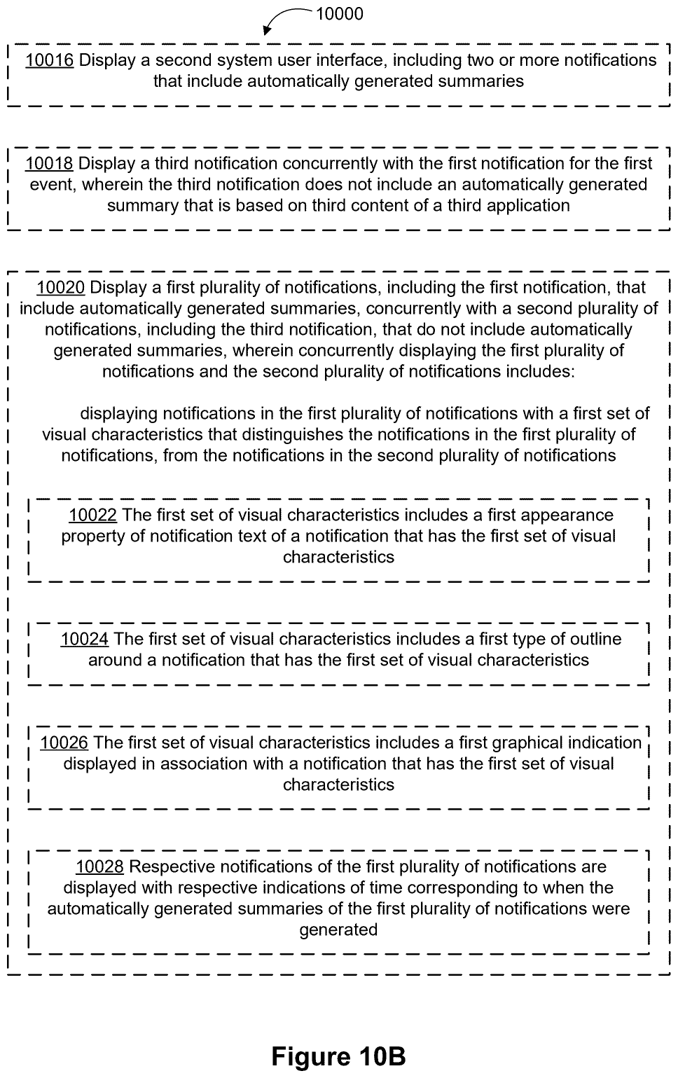

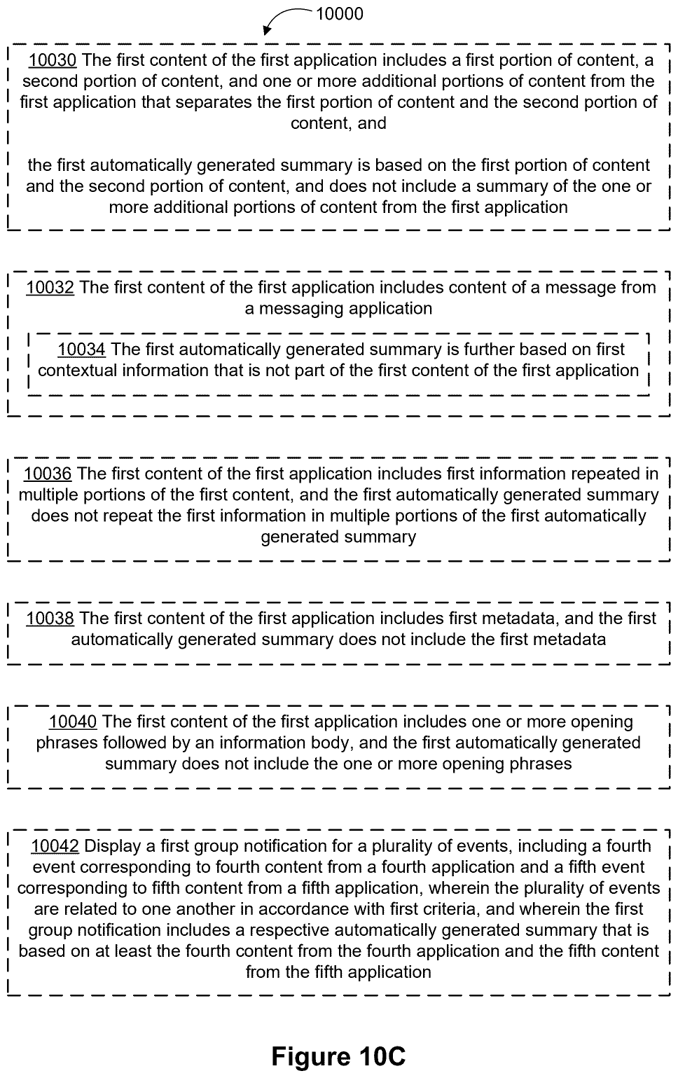

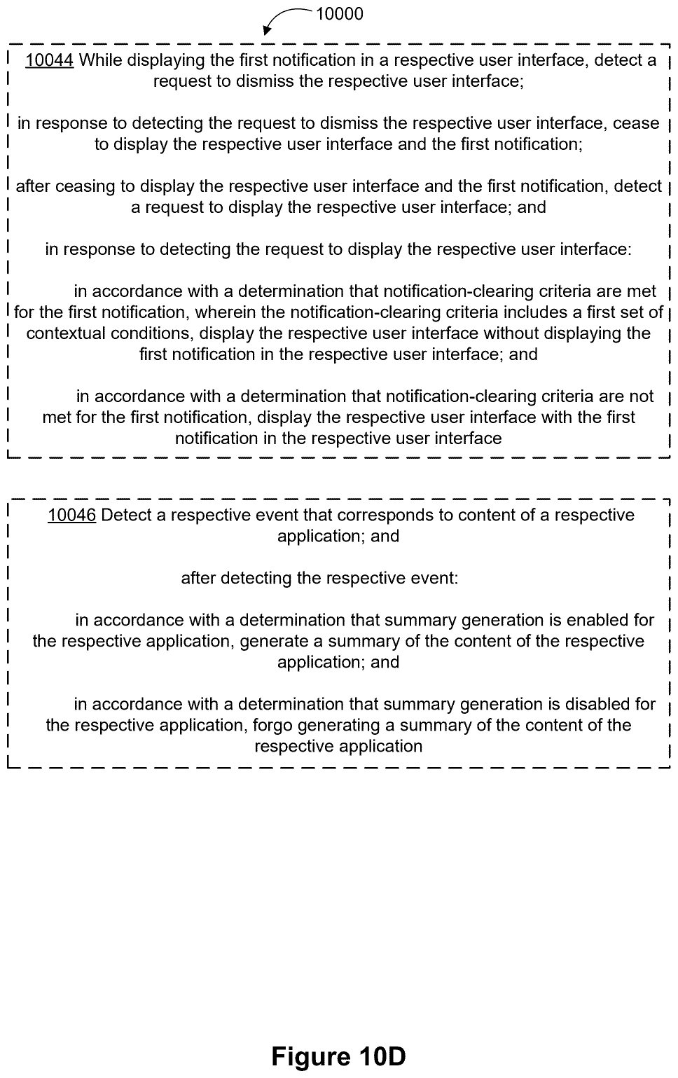

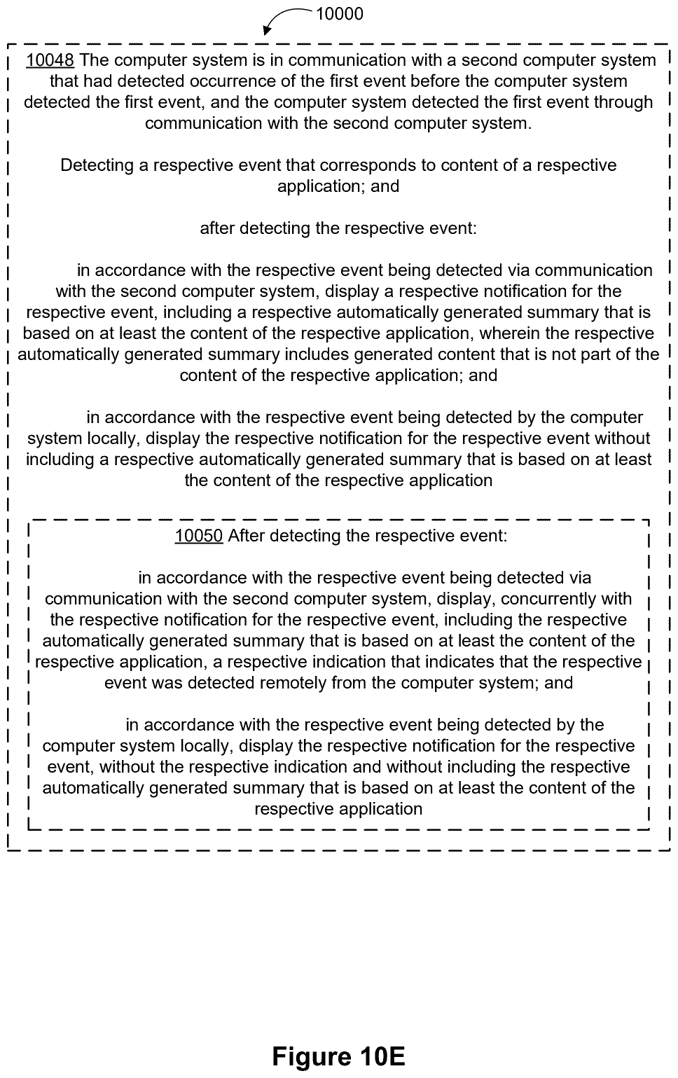

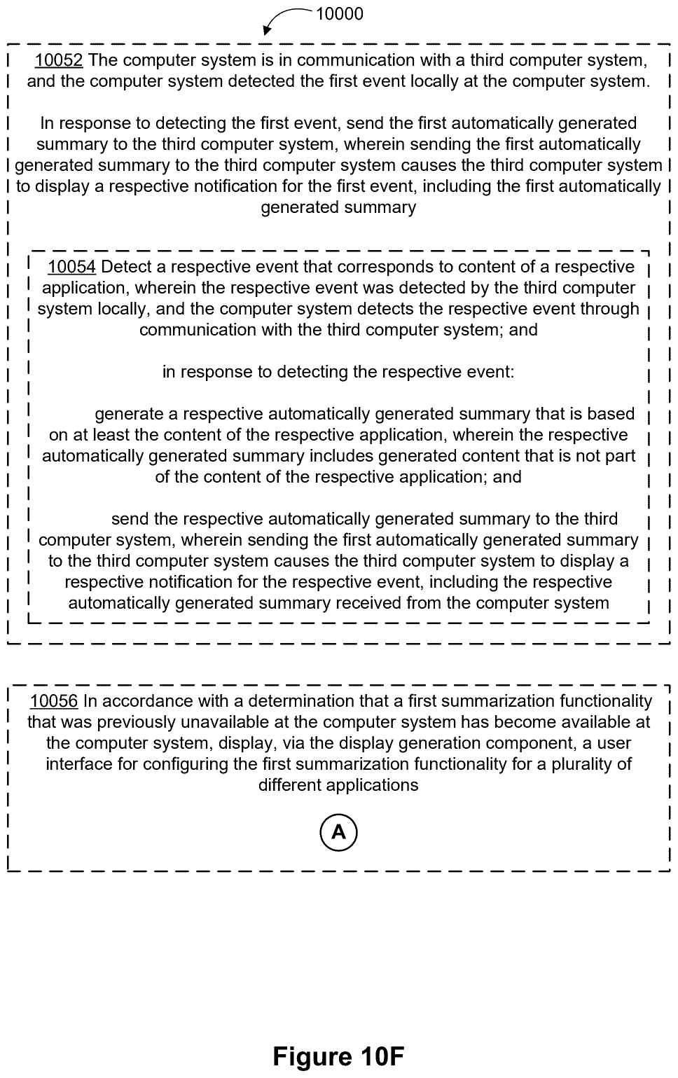

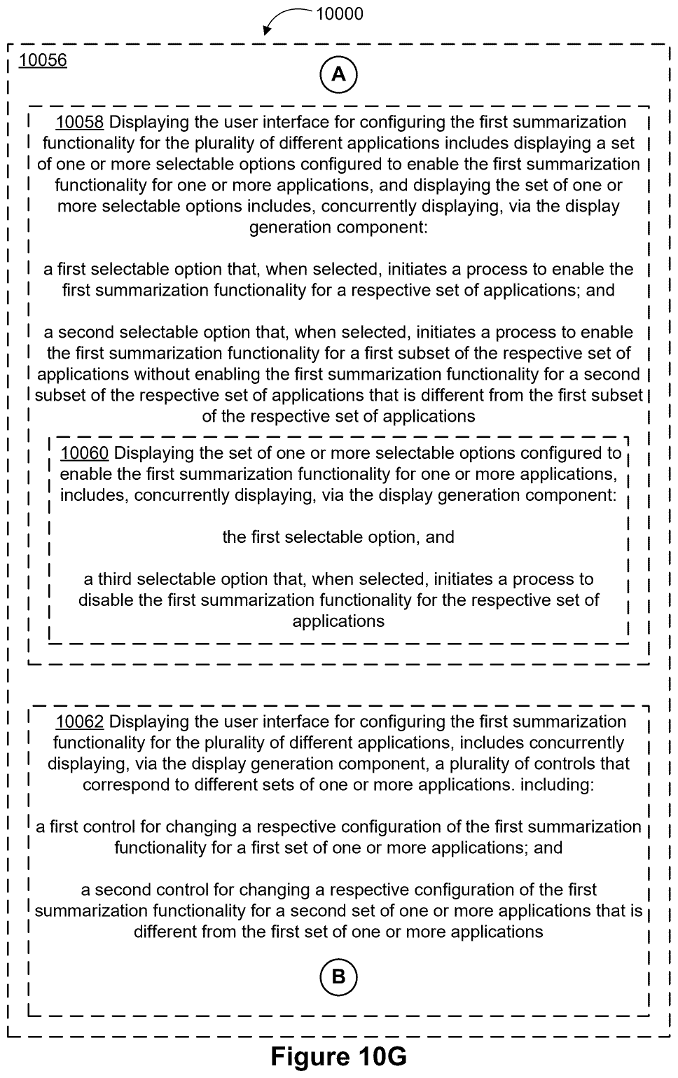

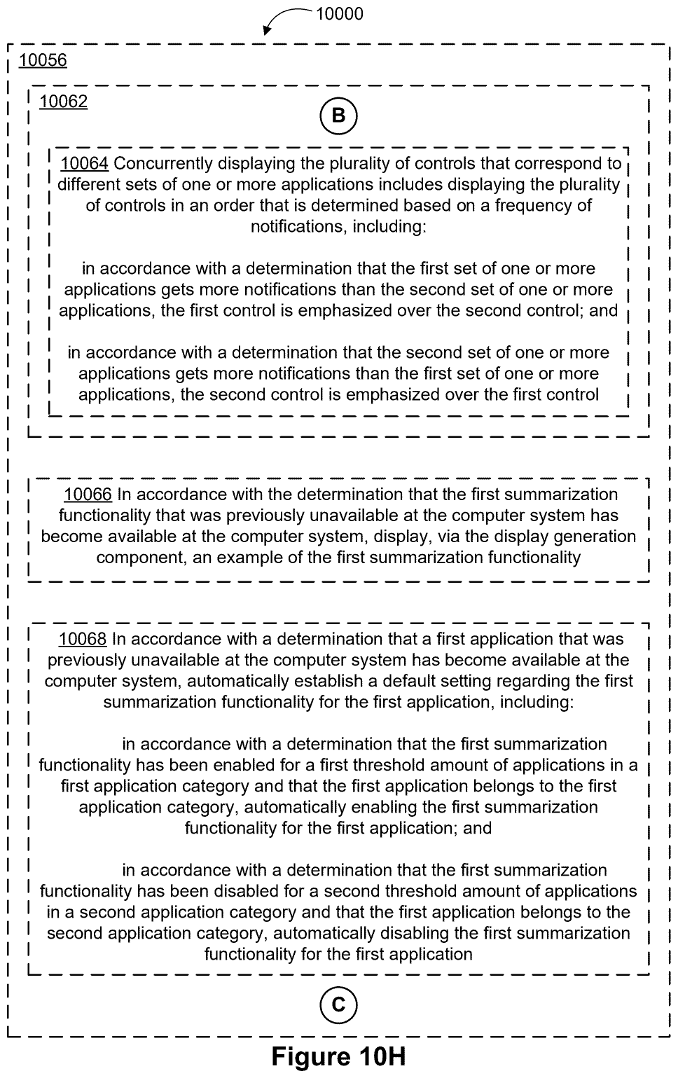

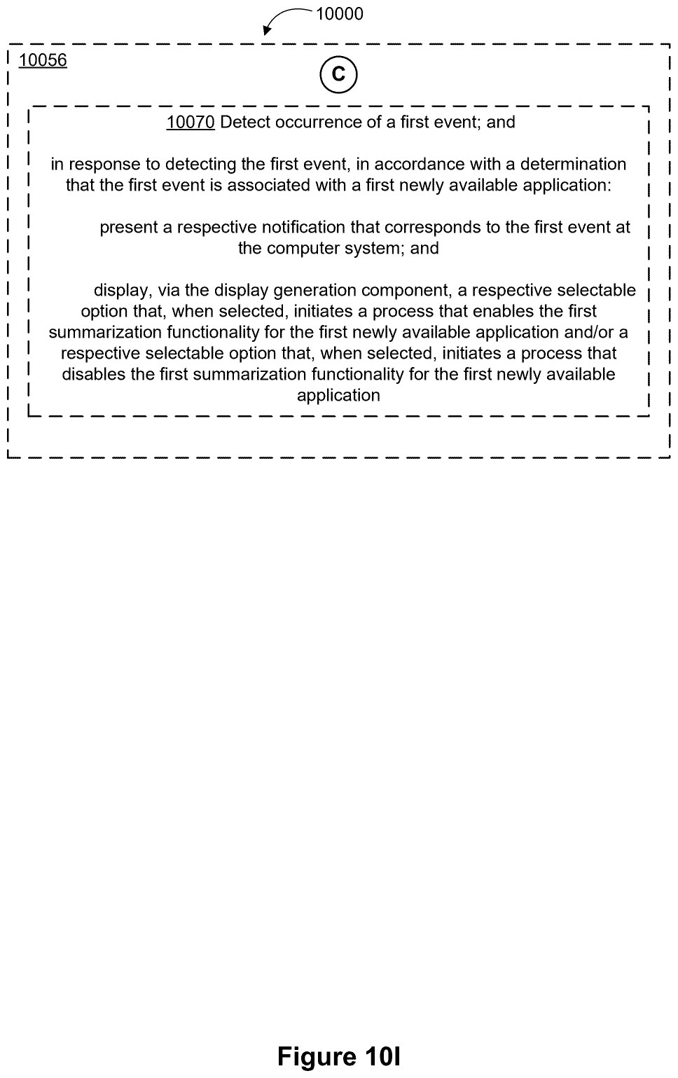

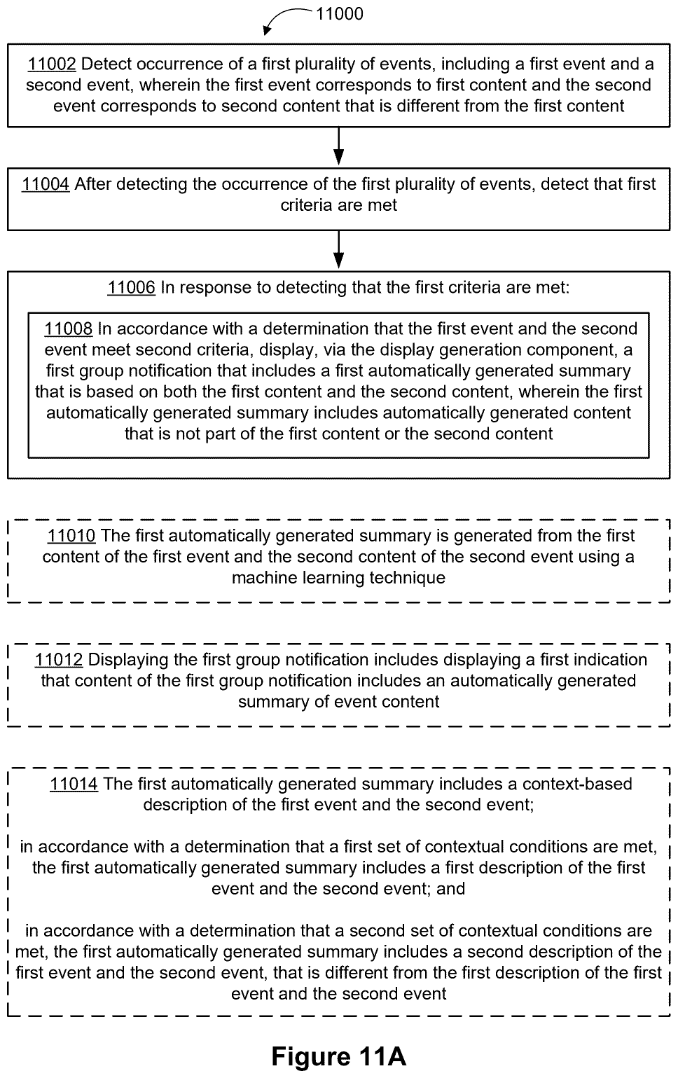

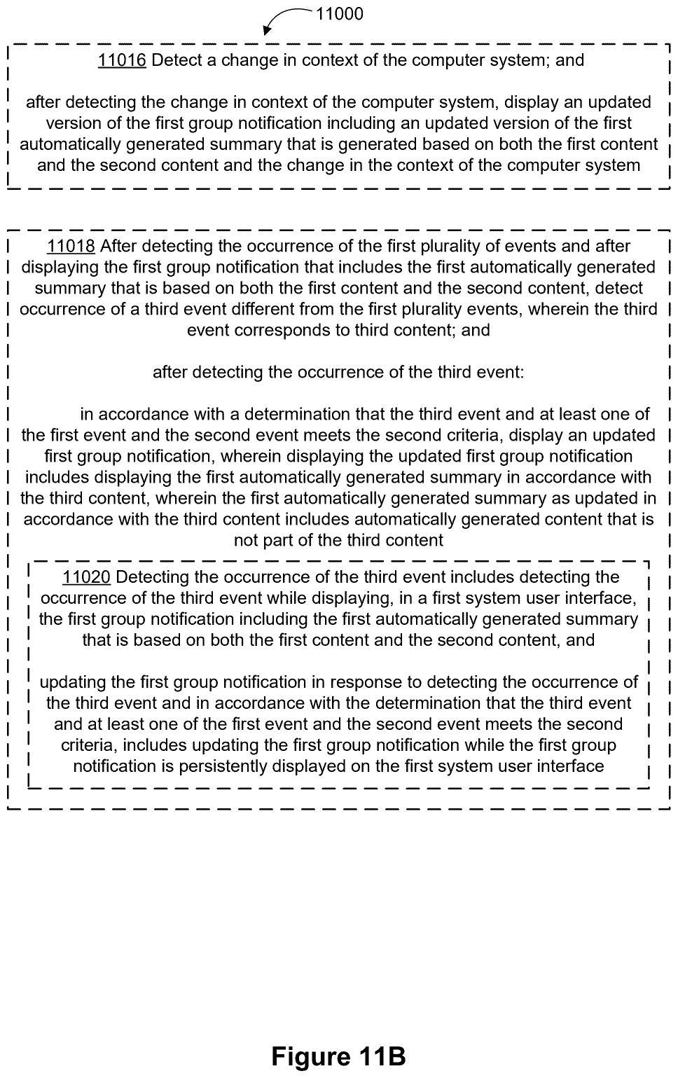

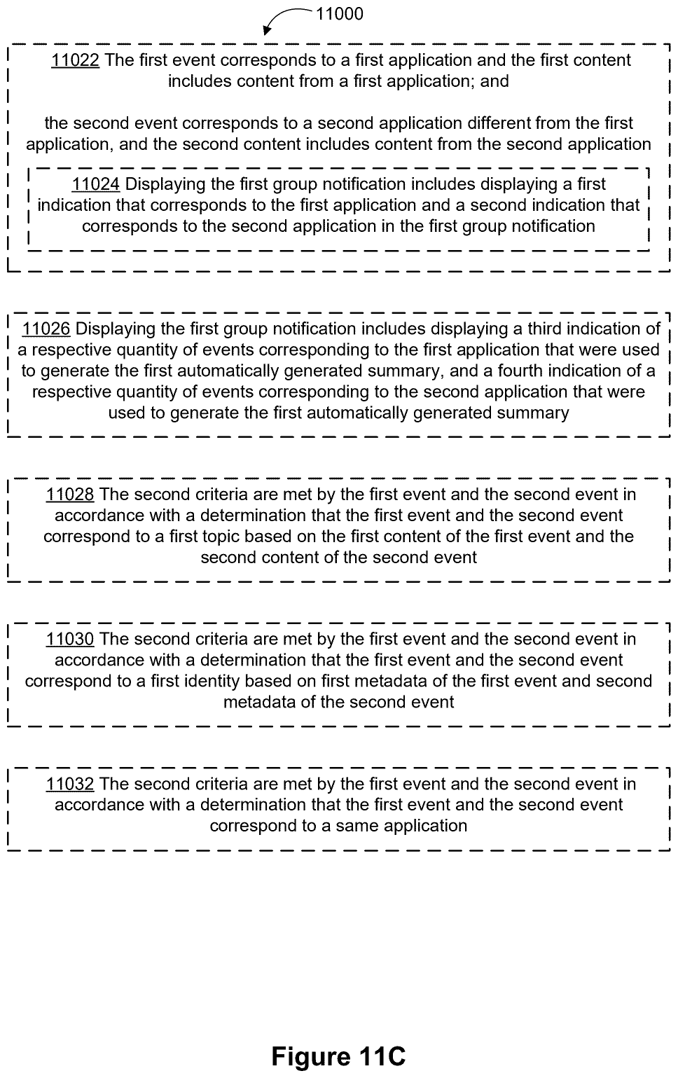

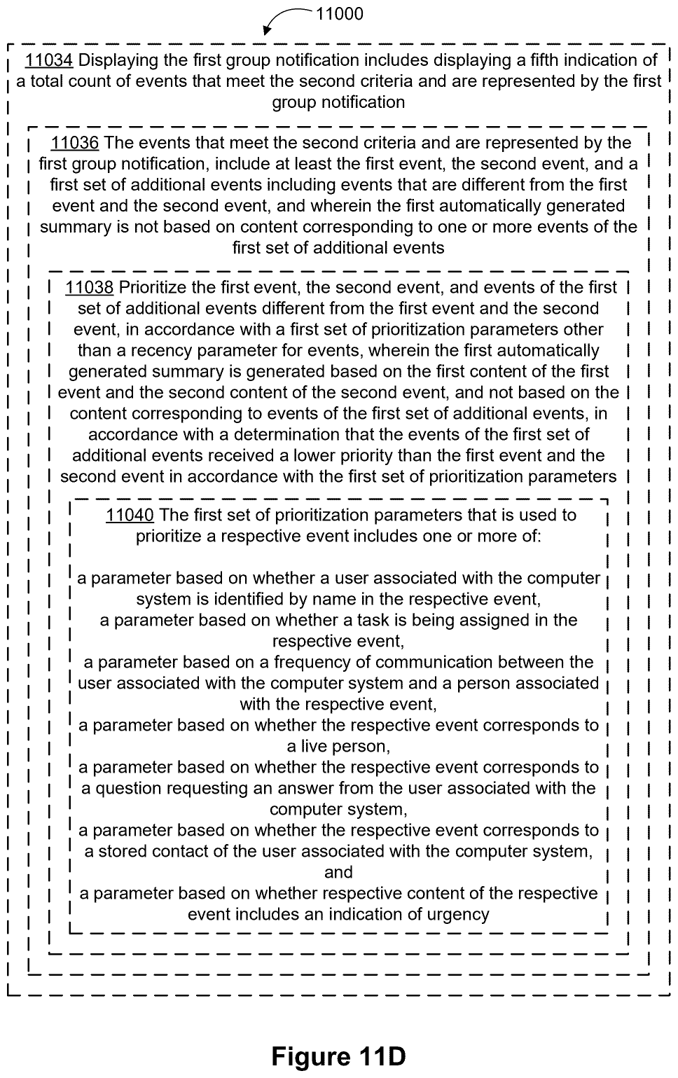

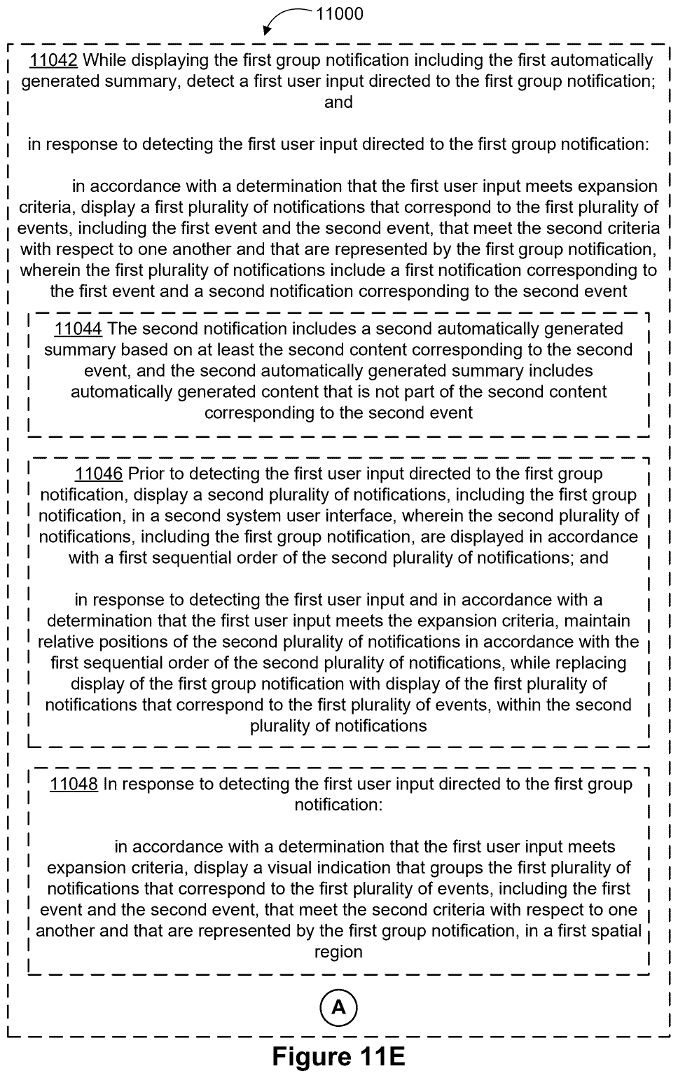

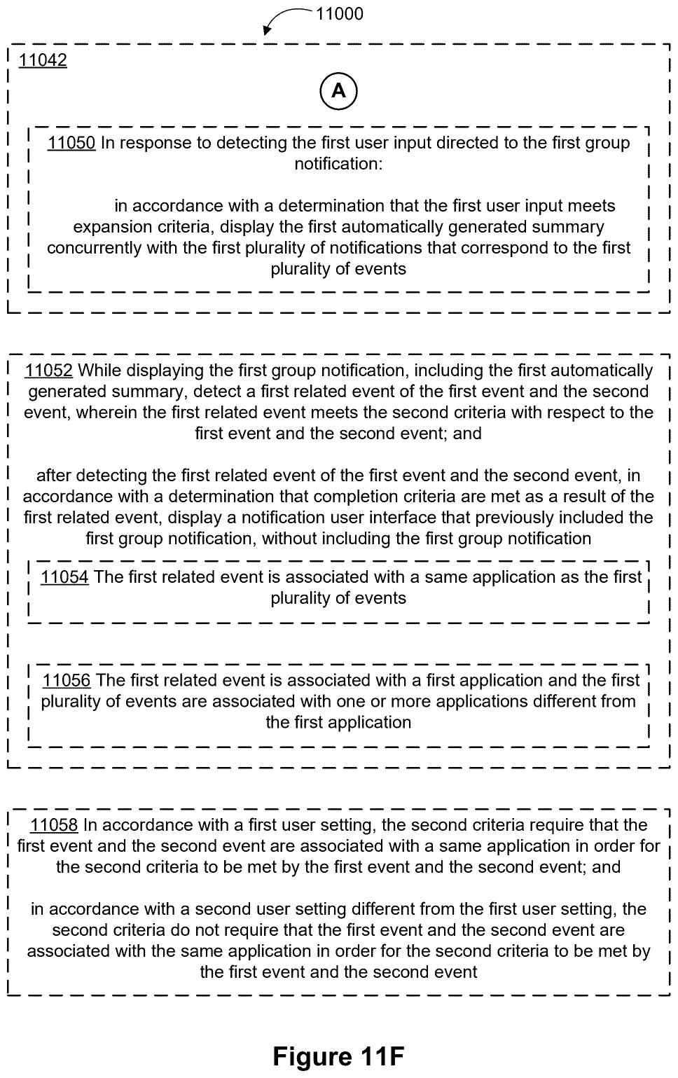

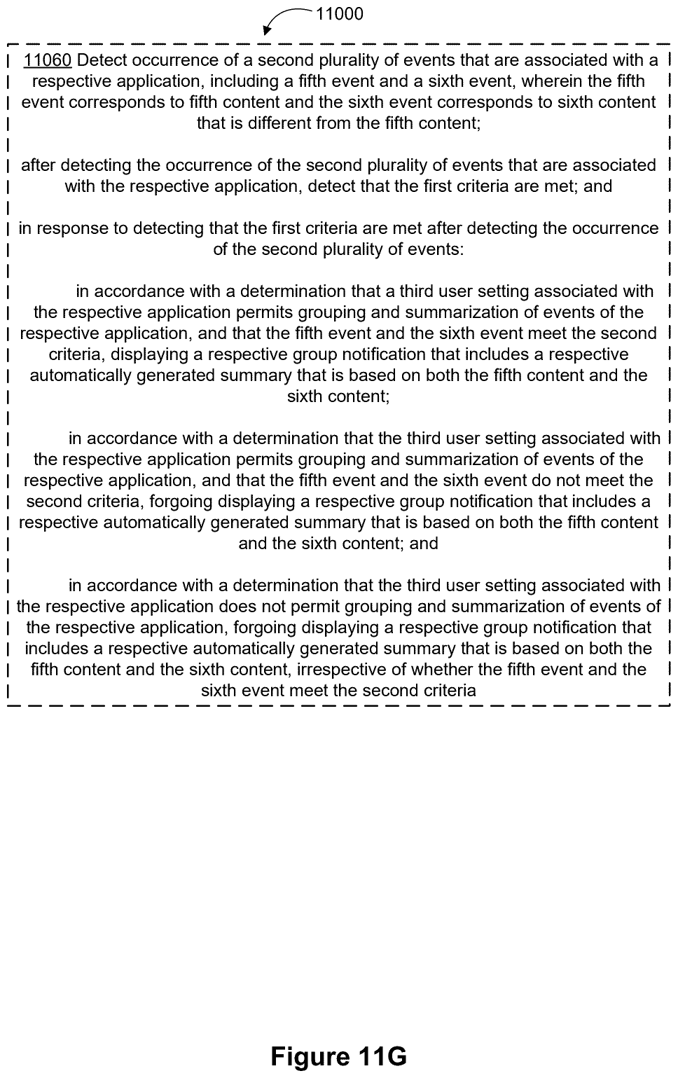

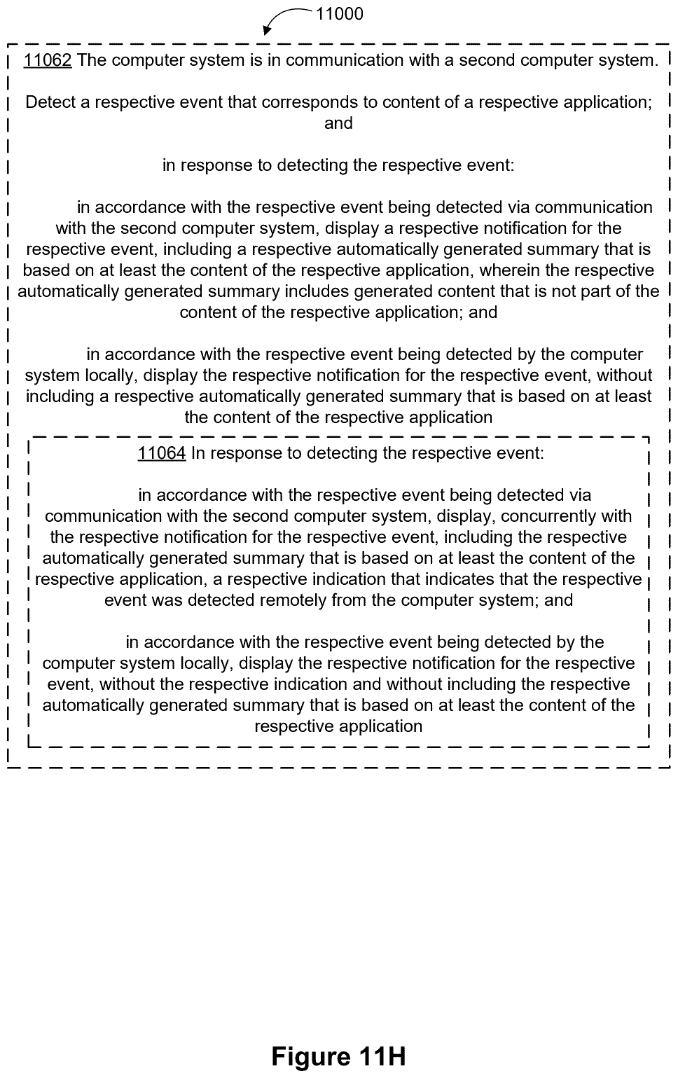

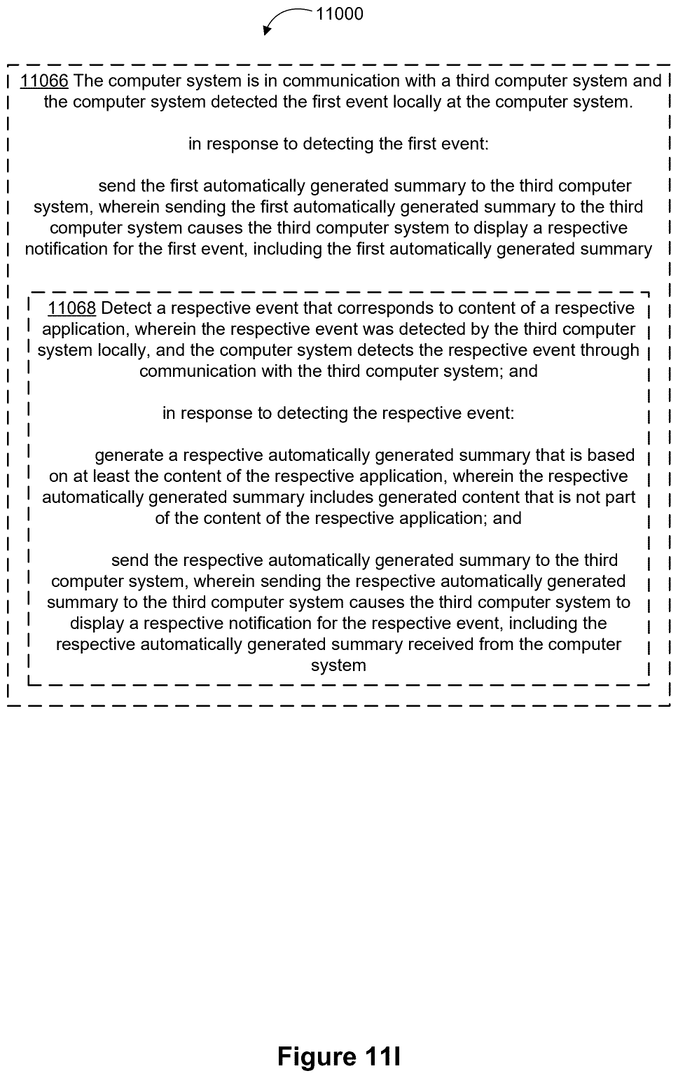

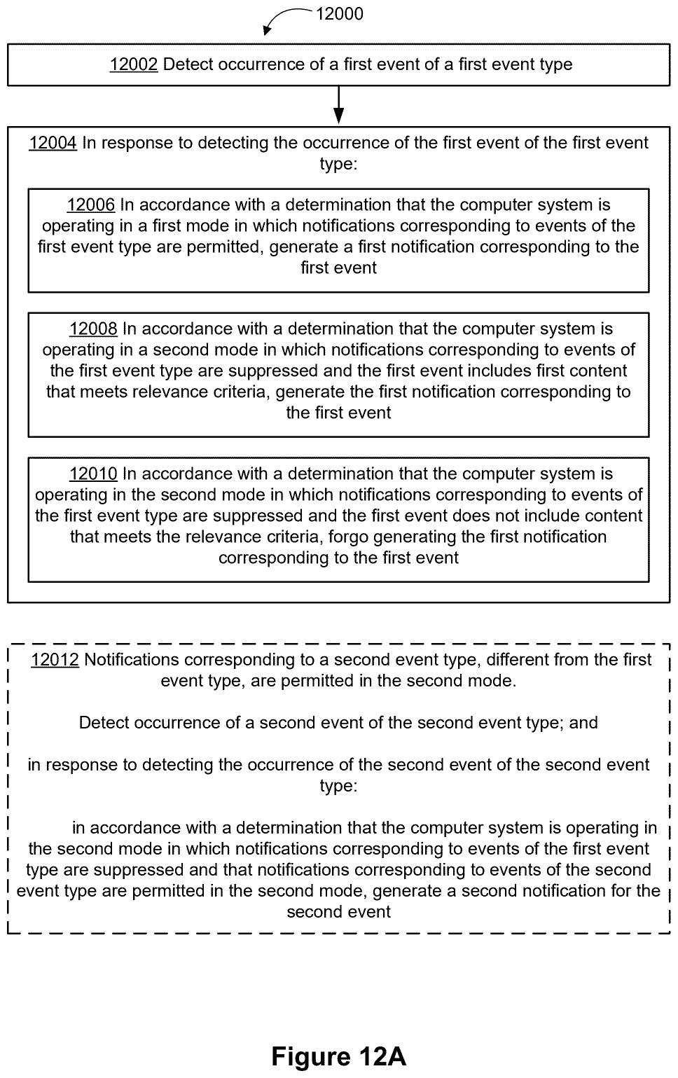

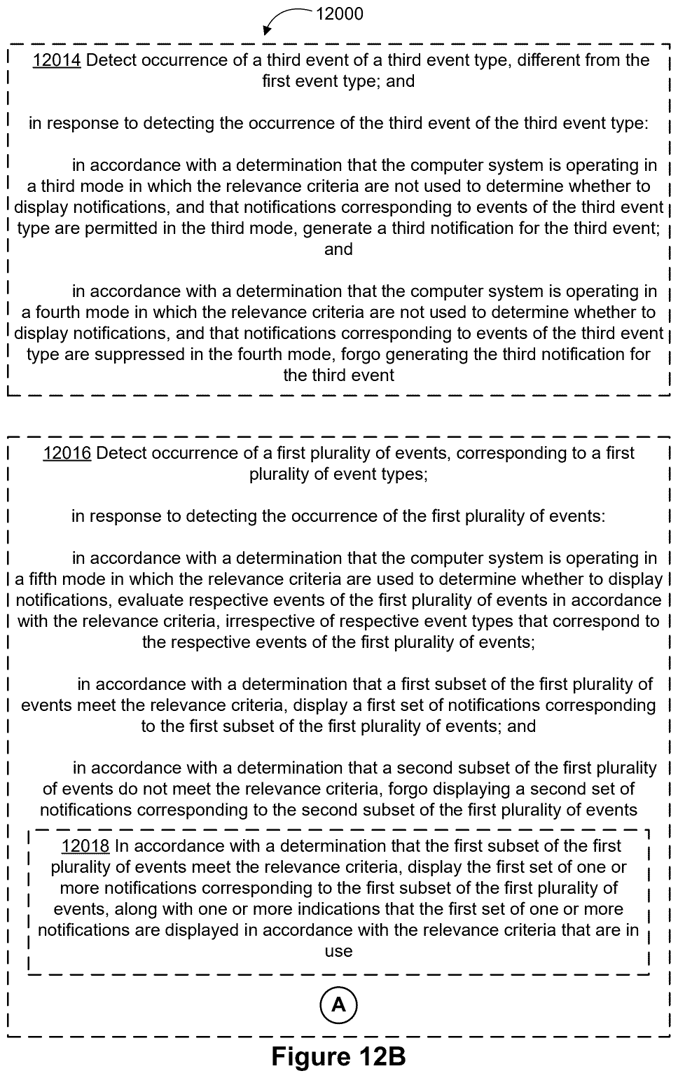

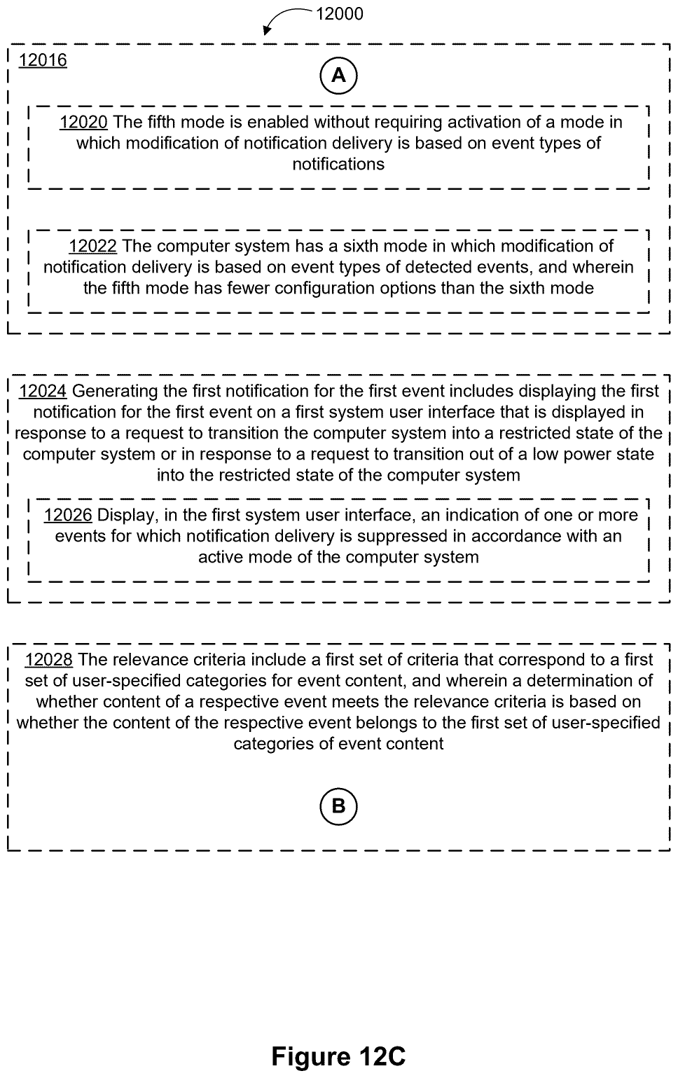

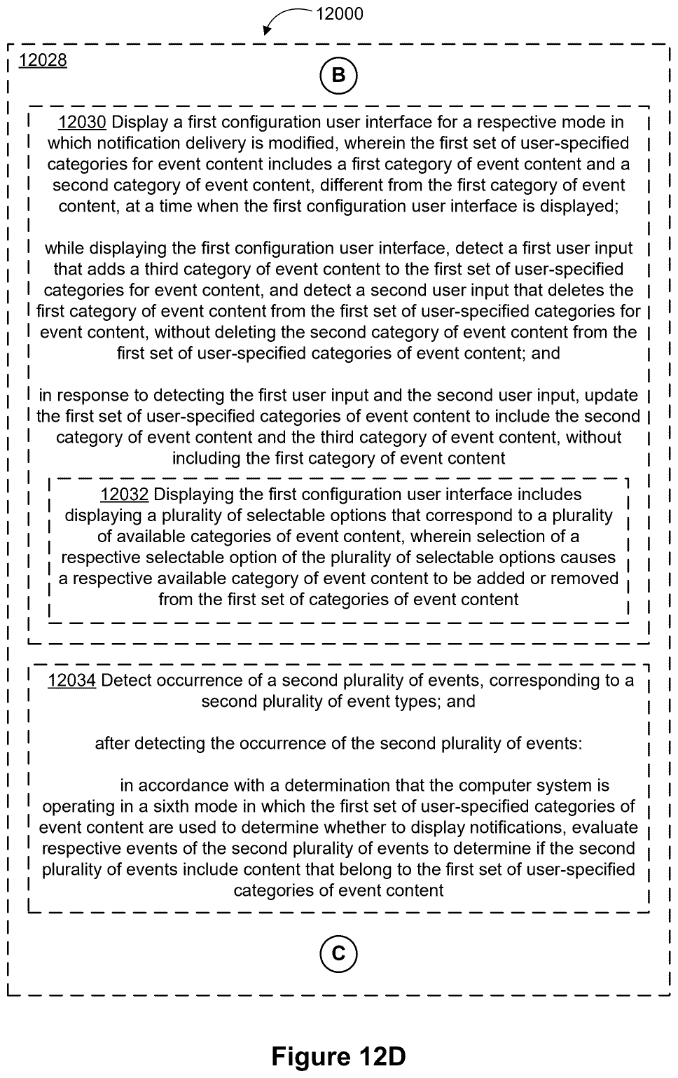

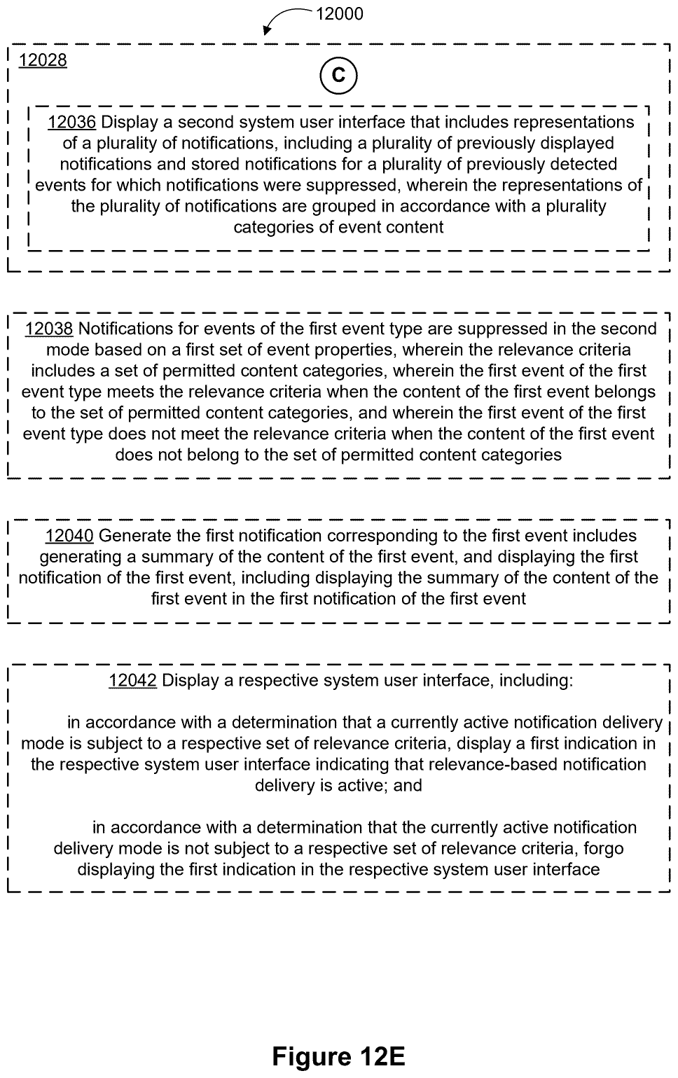

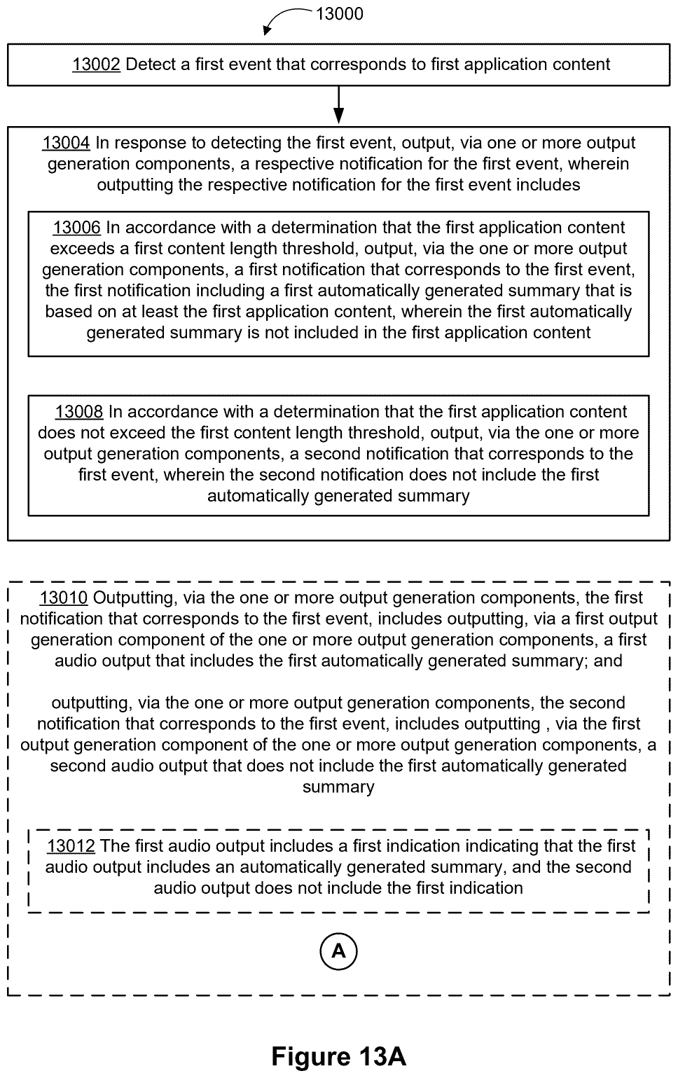

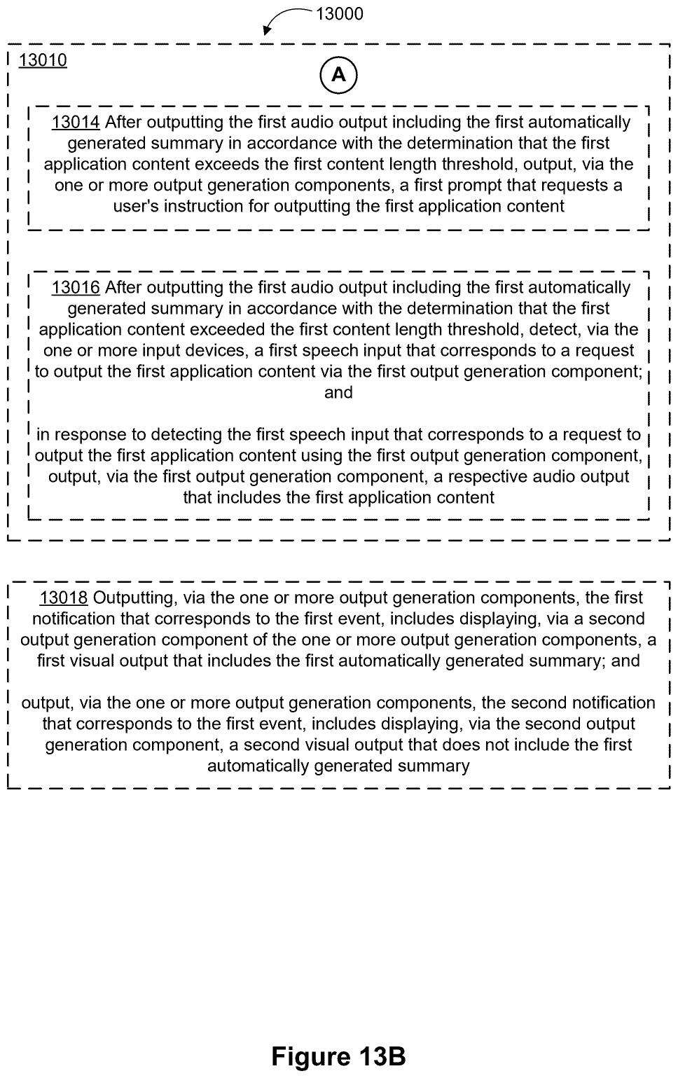

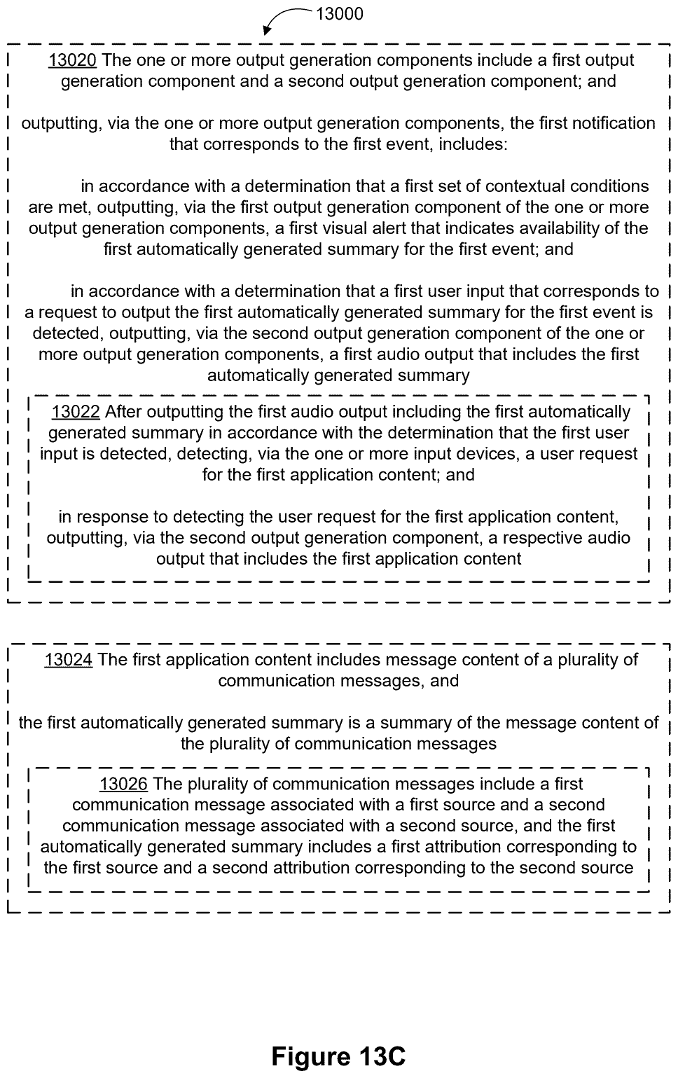

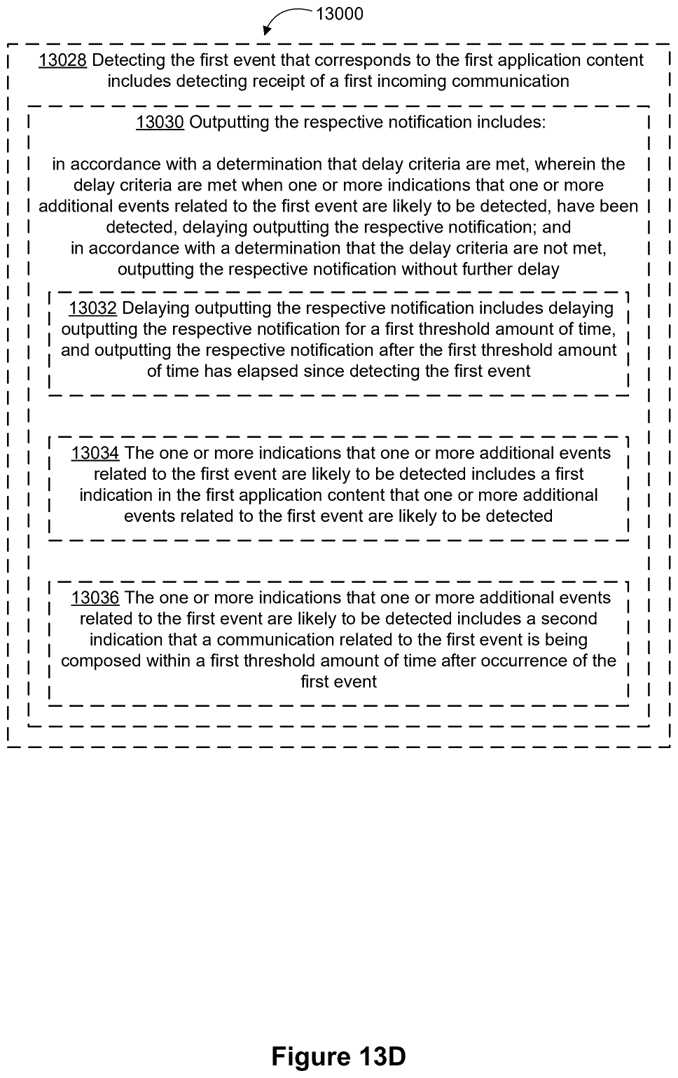

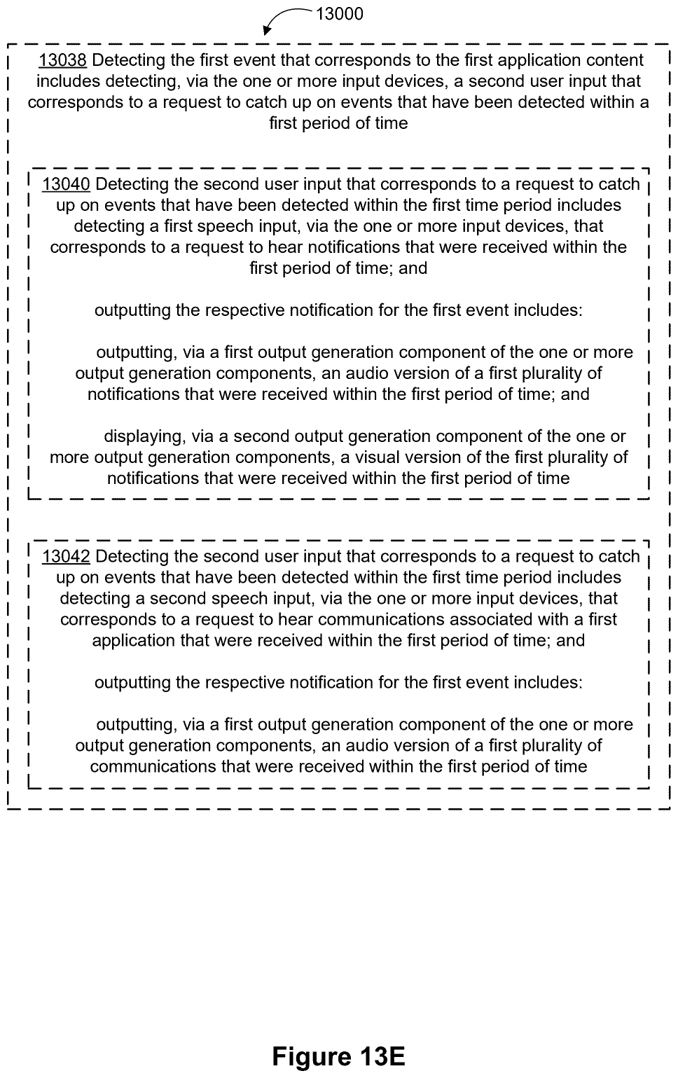

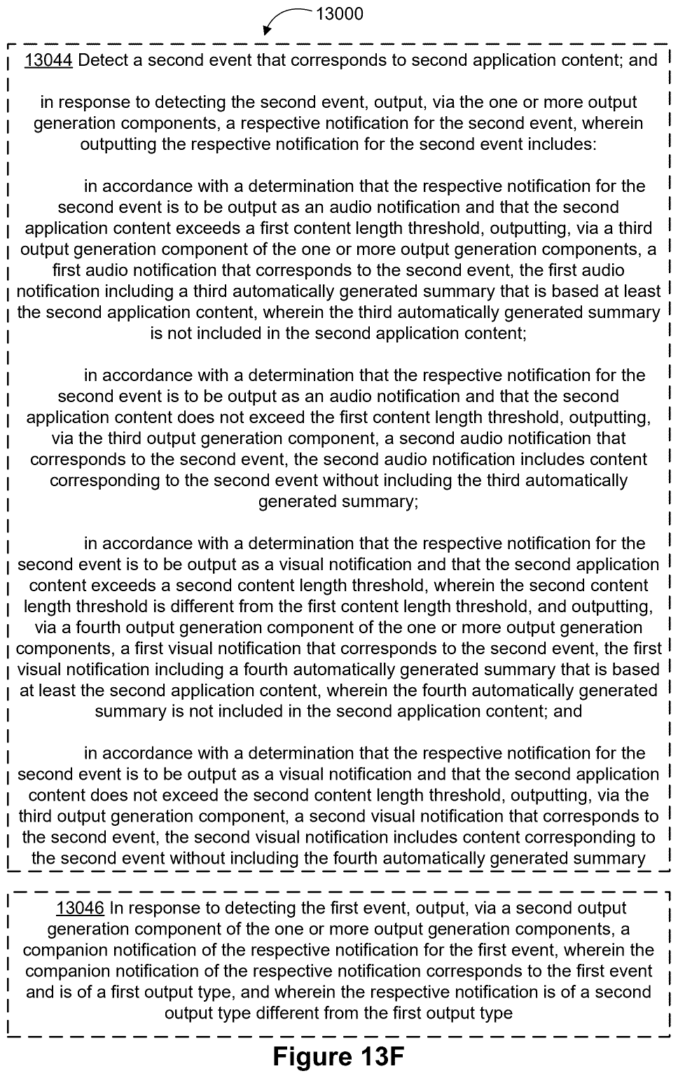

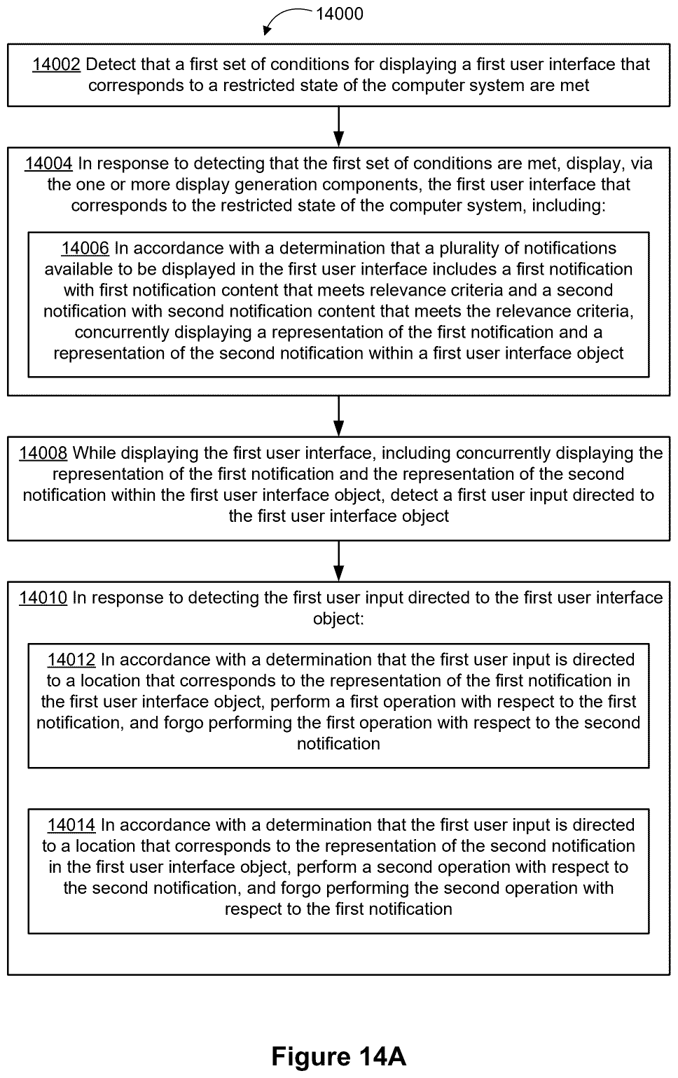

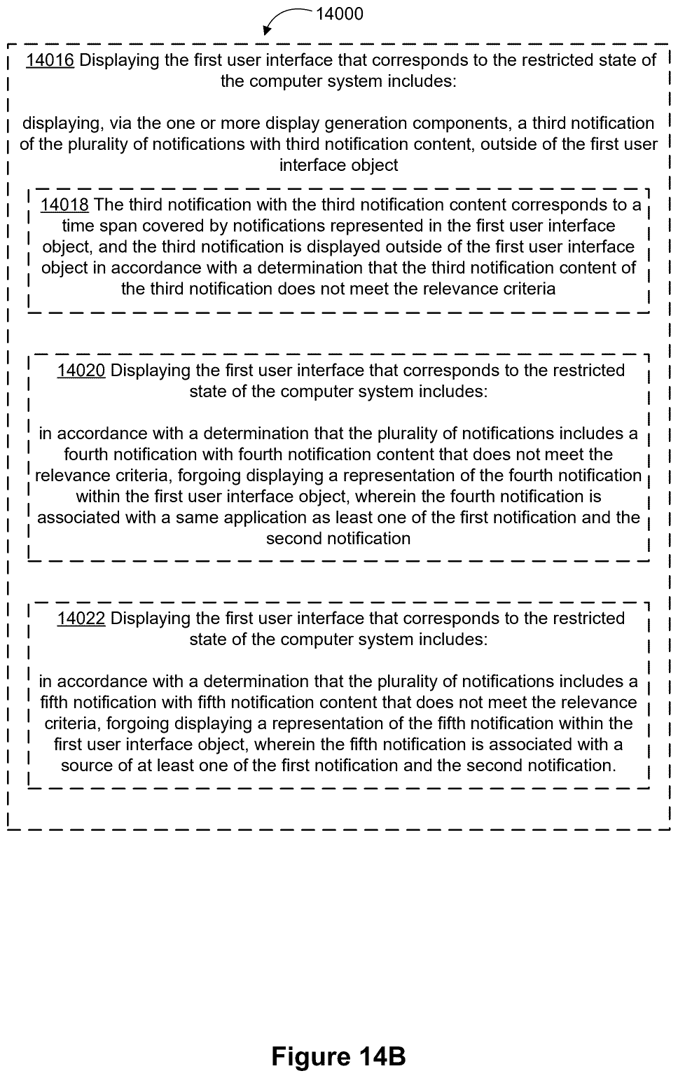

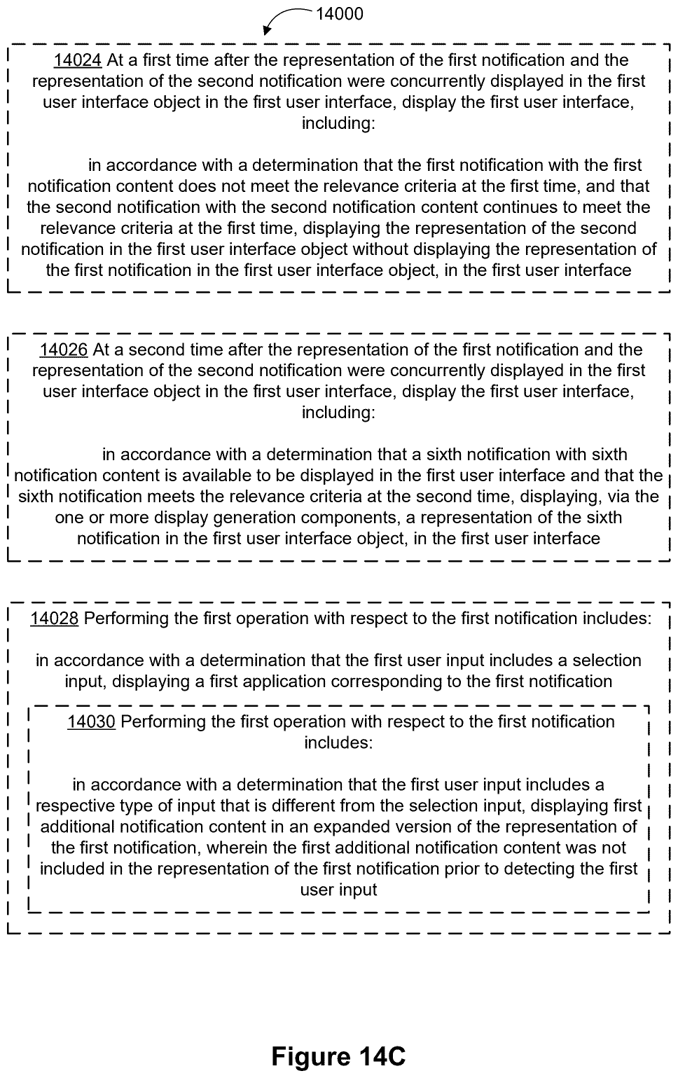

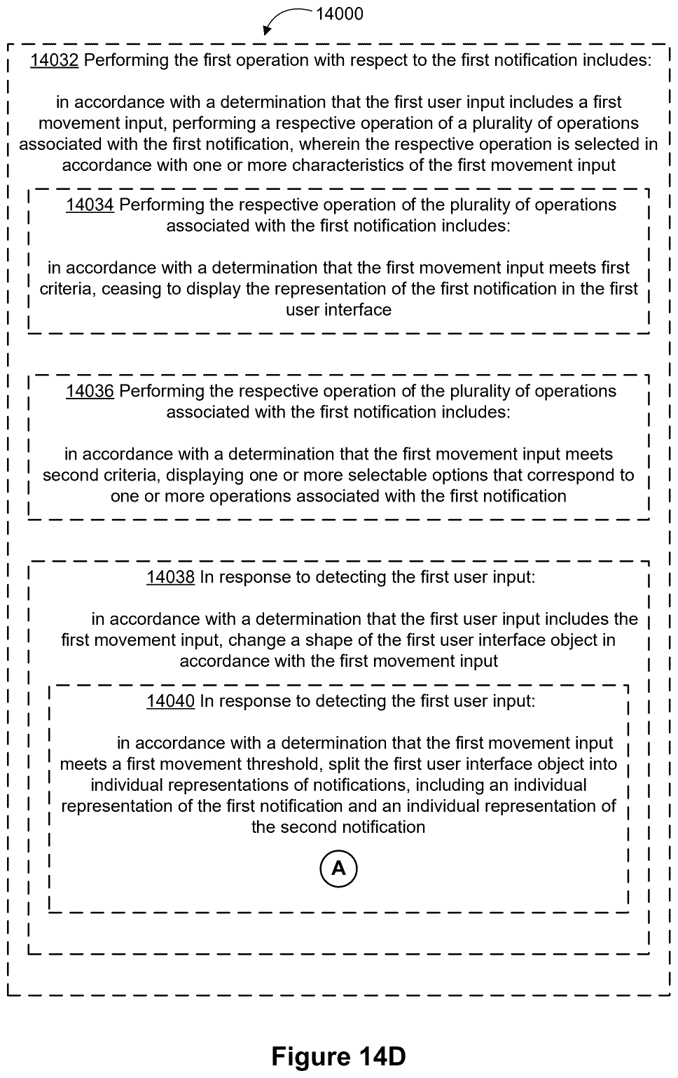

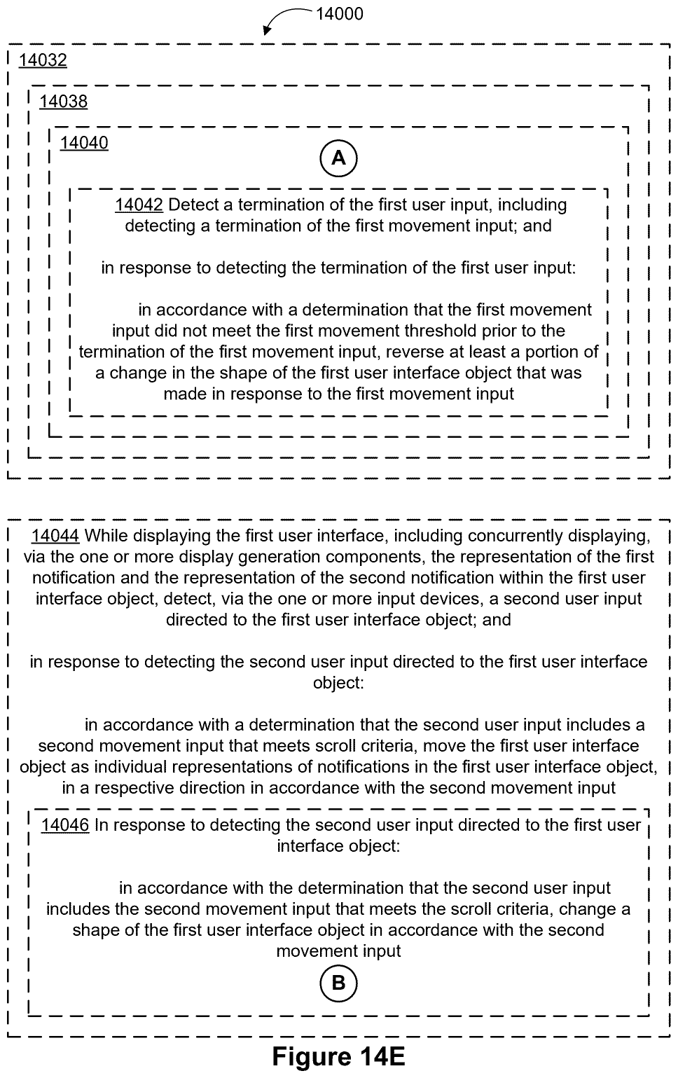

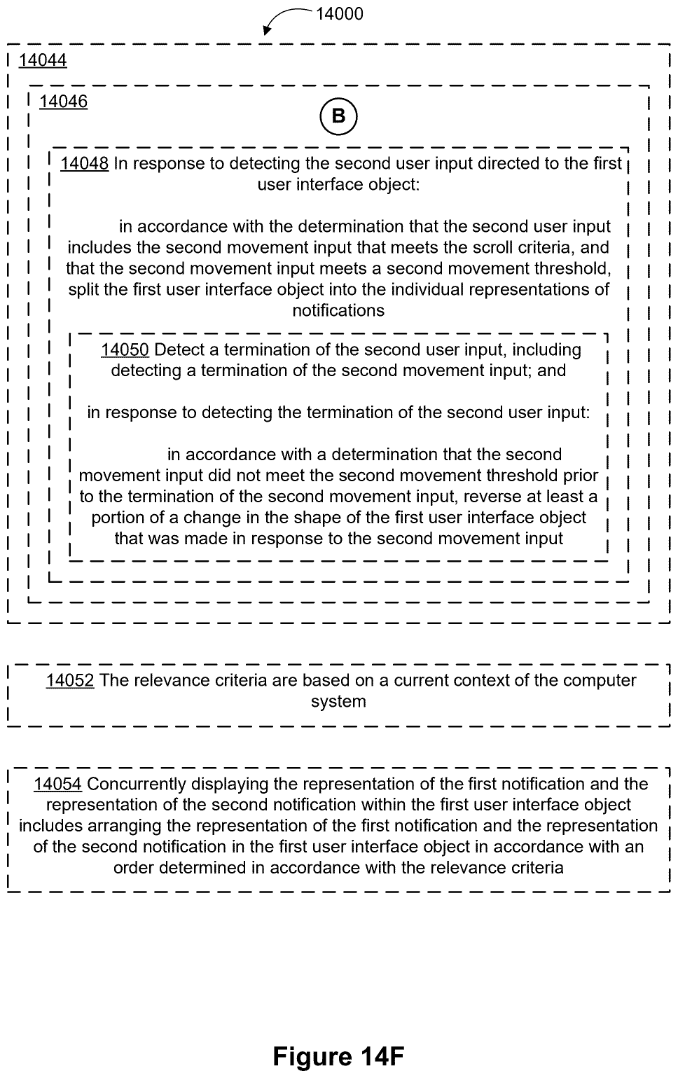

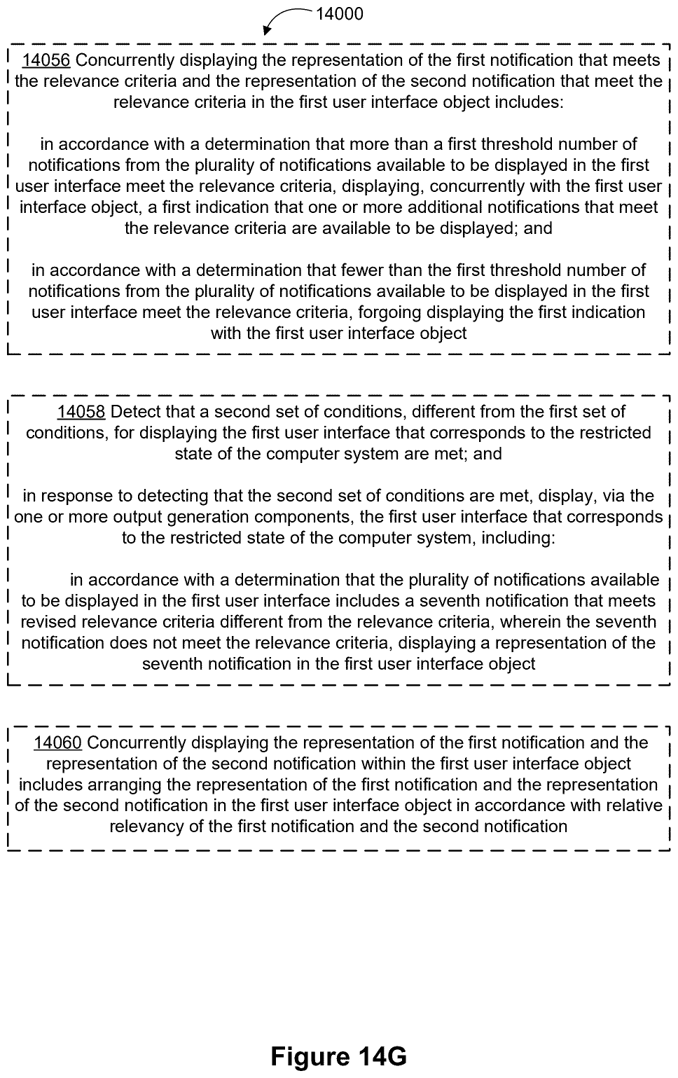

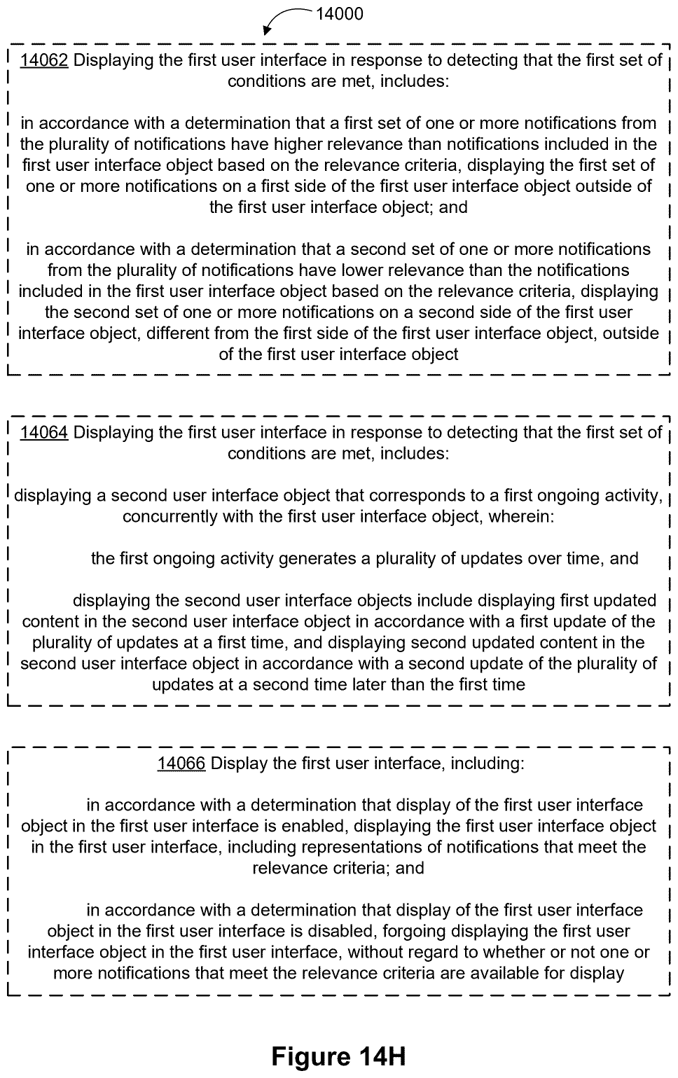

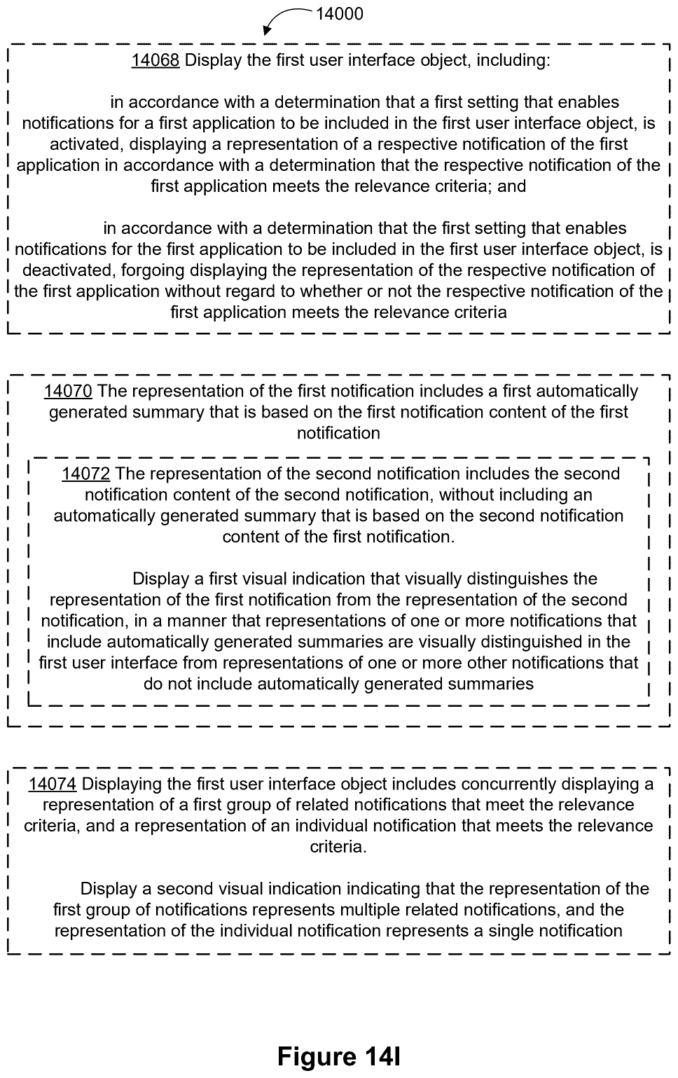

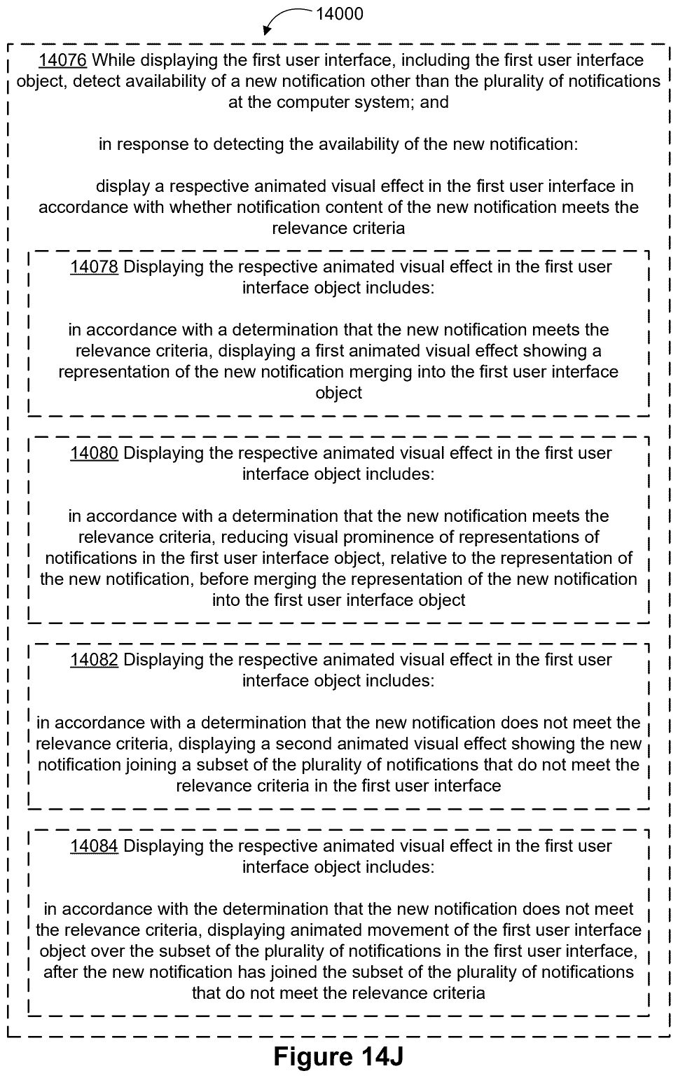

Below, FIGS. 1A-1B, 2, and 3A provide a description of example devices. FIGS. 3B-3G describe the use of Application Programming Interfaces (APIs) to perform operations. FIGS. 4A-4C2 and FIGS. 5A-5H illustrate example user interfaces for providing summary content for a single event, in accordance with some embodiments. FIGS. 5I-5V illustrate example user interfaces for configuring the operating system and/or one or more applications to enable or disable an available summarization functionality that generates and displays summary content for events associated with the one or more applications, in accordance with some embodiments. FIGS. 6A-6X illustrate example user interfaces for providing summary content for multiple events, in accordance with some embodiments. FIGS. 7A-7O illustrate example user interfaces for filtering notification and/or summary content, in accordance with some embodiments. FIGS. 8A-8S illustrate example user interfaces for outputting content via contextually relevant output devices, in accordance with some embodiments. FIGS. 9A-9Z illustrate example user interfaces for prioritizing and/or highlighting content, in accordance with some embodiments. FIGS. 10A-10I are flow diagrams for a process for providing summary content for a single event, in accordance with some embodiments. FIGS. 11A-11I are flow diagrams for a process for providing summary content for multiple events, in accordance with some embodiments. FIGS. 12A-12E are flow diagrams for a process for filtering notification and/or summary content, in accordance with some embodiments. FIGS. 13A-13F are flow diagrams for a process for outputting content via contextually relevant output devices, in accordance with some embodiments. FIGS. 14A-14J are flow diagrams of a process for prioritizing and/or highlighting content, in accordance with some embodiments. The user interfaces in FIGS. 5A-5H and 5I-5V are used to illustrate, for example, the processes in FIGS. 10A-10I, in accordance with some embodiments. The user interfaces in FIGS. 6A-6X are used to illustrate, for example, the processes in FIGS. 11A-11I in accordance with some embodiments. The user interfaces in FIGS. 7A-7O are used to illustrate, for example, the processes in FIGS. 12A-12E in accordance with some embodiments. The user interfaces in FIGS. 8A-8S are used to illustrate, for example, the processes in FIGS. 13A-13F in accordance with some embodiments. The user interfaces in FIGS. 9A-9Z are used to illustrate, for example, the processes in FIGS. 14A-14J in accordance with some embodiments. In addition, unless otherwise stated unambiguously in this disclosure, the various features described with respect to one set of Figures are applicable to the same or analogous features described and/or illustrated in another set of Figures, and the descriptions are not repeated in the interest of brevity.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

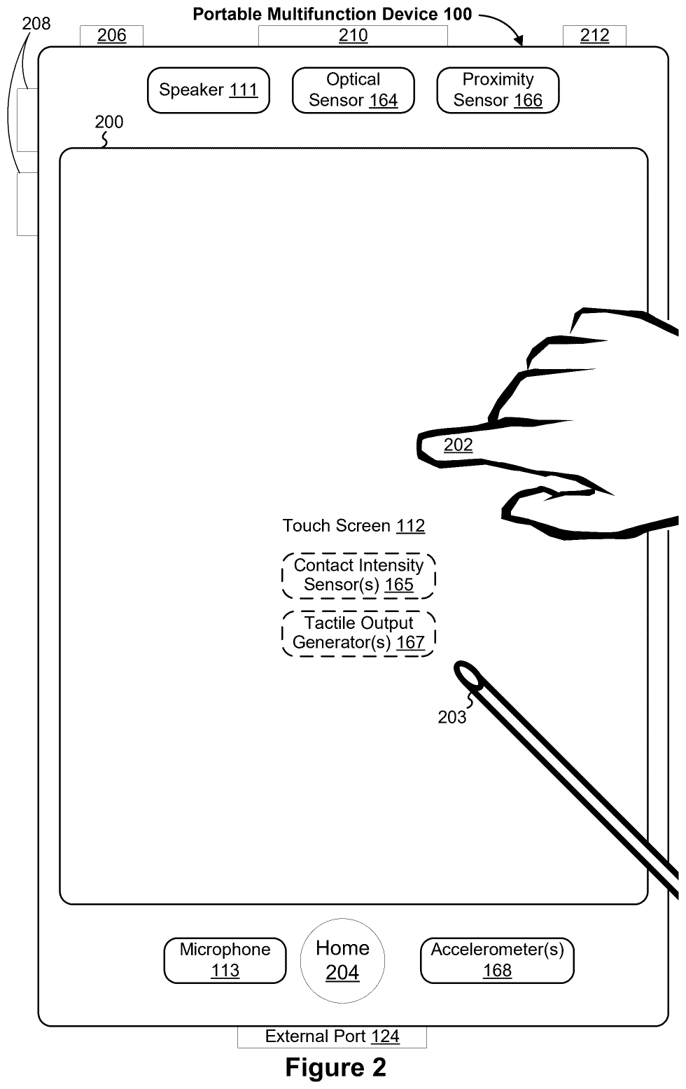

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as V_{X} Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 10000 (FIGS. 10A-10I), method 11000 (FIGS. 11A-11I), method 12000 (FIGS. 12A-12E), method 13000 (FIGS. 13A-13F), and/or method 14000 (FIGS. 14A-14J) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device operates in a standby mode that provides a simplified set of user interfaces and functions, when a set of conditions are met (e.g., device is charging, placed on a docking station, and/or is oriented in a landscape orientation). FIGS. 4C1-4C2 illustrate the navigation states in the normal, non-standby mode. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 for displaying alerts, status updates, and/or current states for various subscribed and/or ongoing events, and/or for various application activities, in real-time or substantially real-time. In some embodiments, the display includes a static status region 4022 for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (FIG. 4A) of the multifunction device 100), the multifunction device displays (4100) the wake screen user interface 490 that is the initially displayed system user interface of the multifunction device 100 when the multifunction device transitions from a power off state to a power on state.

In some embodiments, while the wake screen user interface 490 is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state, while the multifunction device 100 is in the low power state. For example, in the low power state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 in the normal, undimmed state. In some embodiments, the multifunction device automatically returns to the low power mode after a short period of time after displaying the alert, notification, and/or the status update.

In some embodiments, the wake screen user interface 490 displayed in the dimmed always-on state includes the same or substantially the same set of user interface elements as the wake screen user interface 490 displayed in the normal operating state (e.g., as opposed to the dark screen shown in FIGS. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)) In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained). As described in more details below, the notifications displayed in the wake screen user interface may, at various times, include un-summarized notifications where the notification content of an un-summarized notification includes application content corresponding to a respective event that triggered the notification, without including a summary of the application content, and/or summaries of notifications, where the summary content of a summary for a single event includes automatically generated summary of application content corresponding to a respective event that triggered the notification, and the summary of multiple related events includes automatically generated summary of application content corresponding to multiple related events that triggered multiple notifications. Interactions with notifications, including non-summarized notifications and notification summaries are described in more details below.

In some embodiments, the wake screen user interface 490 may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data).

In some embodiments, the upward swipe gesture 4105 is a representative example of a home gesture or dismissal gesture (e.g., other examples include upward swipe gestures 4103a, 4103c, 4103d, 4103e, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492).

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application. In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion of the top edge of the wake screen user interface (e.g., as illustrated in FIG. 4C2) causes (4109a) the multifunction device to display the control user interface 498 overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (WiFi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498).

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492, and another upward swipe gesture that starts from the bottom edge of the home screen user interface 492 does not cause the multifunction device to dismiss the home screen user interface 492 and return to the wake screen user interface 490. In other words, once the navigation from the wake screen user interface 490 to the home screen user interface 492 is completed, the multifunction device is no longer in the restricted state, and access to the application icons displayed on the home screen user interface 492 and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface (e.g., irrespective of whether the home screen user interface was the last displayed user interface prior to displaying the currently displayed user interface).

As shown in FIG. 4C2, once the multifunction device navigates away from the wake screen user interface 490 and displays the home screen user interface 492, the user can access the functions and applications of the multifunction device without restriction. For example, in some embodiments, the home screen user interface 492 includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode.

In some embodiments, while displaying the home screen user interface 492, a downward swipe gesture 4108a that starts from the top edge of the home screen user interface 492 causes (4108a) the multifunction device to cover the home screen user interface 492 with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or displaying application user interfaces of multiple applications in a concurrent-display configuration), a downward swipe gesture 4108b that starts from the top edge of the application user interface(s) causes (4108b) the multifunction device to display the coversheet user interface 496 (FIG. 4C1) (or the wake screen user interface 490 in FIG. 4C2) over the application user interface(s). The multifunction device dismisses the coversheet user interface 496 (or the wake screen user interface 490) and redisplays the application user interface(s) in response to an upward swipe gesture that starts from the bottom edge of the coversheet user interface (or another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

In some embodiments, when the device is placed on a docking station or is connected wirelessly or through a contact-based connection (e.g., via electronic connection, or magnetic connection) to a charging source, rotation of the display when the wake screen user interface is displayed and/or when the device is in the low power state, cause the device to enter a standby mode, where a different set of navigation states are made available. In some embodiments, swiping in the vertical direction causes the device to navigate between different versions of a functional “face” (e.g., a user interface that provides a primary function, such as a “clock” face, a “weather” face, a “calendar” face, a “stock” face, a “photos” face, a “widget” face, or user interface that provides another function), while swiping in the horizontal direction cause the device to navigate between different functional faces. In some embodiments, swiping downward from the upper right corner of the display causes the device to display a “control” face that includes controls for various control functions of the device. Swiping upward from the bottom edge of the display when the “control” face is displayed causes the device to dismiss the “control” face and redisplay the last displayed functional face.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

### User Interfaces and Associated Processes

Attention is now directed towards embodiments of user interfaces (“UI”) and associated processes that may be implemented on an electronic device (or computer system more generally) that is in communication with one or more display generation components, one or more input devices, and one or more output devices, such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5H illustrate example user interfaces for providing summary content for a single event in accordance with some embodiments, and FIGS. 5I-5V illustrate example user interfaces for configuring the operating system and/or one or more applications to enable or disable an available summarization functionality that generates and displays summary content for events associated with the one or more applications, in accordance with some embodiments. The user interfaces in these figures are used to illustrate the processes described below, including the processes in FIGS. 10A-10I. FIGS. 6A-6X illustrate example user interfaces for providing summary content for multiple events, in accordance with some embodiments. The user interfaces in these figures are used to illustrate the processes described below, including the processes in FIGS. 11A-11I. FIGS. 7A-7O illustrate example user interfaces for filtering notification and/or summary content, in accordance with some embodiments. The user interfaces in these figures are used to illustrate the processes described below, including the processes in FIGS. 12A-12E. FIGS. 8A-8S illustrate example user interfaces for outputting content via contextually relevant output devices, in accordance with some embodiments. The user interfaces in these figures are used to illustrate the processes described below, including the processes in FIGS. 13A-13F. FIGS. 9A-9Z illustrate example user interfaces for prioritizing and/or highlighting content, in accordance with some embodiments. The user interfaces in these figures are used to illustrate the processes described below, including the processes in FIGS. 14A-14J. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIGS. 5A-5H illustrate example user interfaces for displaying notifications for events that correspond to application content, where the notifications include summary content (e.g., automatically generated summaries of the application content, and/or summaries that are based at least in part on the application content) that are not part of the application content, in accordance with some embodiments. Although in these examples, the disclosure refers to displaying summary content as a way to present summary content to a user, it is to be understood that, the summary content that is displayable to a user may also be presented to the user using other output means, such as, in an audio output narrated by a digital assistant, or graphical output illustrating the key information conveyed in the summary content. It is to be understood that, where display of textual summaries is explicitly described in the examples, the summary content may also be presented using a corresponding audio output and/or visual illustration (e.g., animated or static images). In some embodiments, the output modality (e.g., textual, audio, or graphical modes) in which summary content is presented causes the computer system to adjust the summary content (e.g., with additional summarization, abstraction, simplification, and/or prioritization) to help the user better understand the information conveyed in the summary content.

FIG. 5A shows a user interface 5000 of a portable multifunction device 100 (hereinafter the computer system 100). In some embodiments, the user interface 5000 is a lock screen user interface, or another system user interface corresponding to a restricted state of the computer system (e.g., a wake screen user interface that is displayed when the computer system exits a lower power state or a dimmed always-on state (e.g., when the device is raised or tapped, or when an event is detected and a corresponding notification is generated), or a cover sheet user interface that temporarily hiders the home screen user interface or an application user interface (e.g., when the power button is activated or a downward swiping gesture is detected at the top edge of the display)). In some embodiments, the user interface 5000 is a system notification user interface or includes a notification display region for displaying system alerts and/or notifications (if and/or when available). In some embodiments, system alerts and/or notifications can be cleared and/or removed from the user interface 5000 (e.g., automatically when a certain amount of time has passed, automatically after the notification has been viewed and/or interacted with by a user, and/or manually by a user). In some embodiments, the user interface 5000 includes a set of system elements arranged in accordance with a layout, such as a current date 5002 and a current time 5004, user interface objects 5006, 5008, and 5010 that includes automatically updated application content (e.g., also referred to as widgets, or wake screen complications, as described herein), and optionally, controls for launching applications (e.g., messages application, telephony application, or media player application), and/or activating control functions (e.g., camera, or flashlight), and/or changing notification delivery modes (e.g., activating a focus mode, a quiet mode, or a DND mode). In some embodiments, the user interface 5000 also includes status indicators for various system functions, such as network connections, battery level, authentication state, and other ongoing activities of the computer system, and optionally, a background, such as a photo, an image, or a color or texture. In some embodiments, the computer system navigates form the user interface 5000 to another user interface of a plurality of destination user interfaces (e.g., a widget user interface, a camera user interface, a home screen user interface, a notification history user interface, a control user interface, or another system user interface or application user interface), in response to user inputs directed to the user interface 5000, depending on the criteria that are met by the user input. More details of the navigation from the user interface 5000 are provided with respect to FIGS. 4C1-4C2, in accordance with some embodiments.

FIG. 5B show the user interface 5000 after some time has passed. At the current time shown by the time element 5004 in FIG. 5B, the user interface 5000 includes multiple notifications, including notifications for multiple different applications received over a period of time: a notification 5012 for an application M (e.g., an email application), a notification 5014 for an application T (e.g., a restaurant reservation application), a notification 5016 for an application H (e.g., a health application), a notification 5018 for an application A (e.g., an airline application), and a notification 5020 for a notification N (e.g., a news application). In FIG. 5B, the notifications displayed in the user interface 5000 are displayed separately as individual notifications (e.g., as separate user interface objects that are spaced apart from one another in the notification display region). In some embodiments (e.g., as shown and described with reference to FIG. 7A below), one or more notifications from the same source (e.g., originating and/or generated by the same application, from the same message thread, or regarding the same topic) may be grouped together in a stack, optionally, displayed among other individual notifications and/or notification stacks. In some embodiments, when there are less than a threshold number of notifications available to be displayed in the user interface 5000, all notifications are concurrently visible in the user interface 5000; and when there are more than the threshold number of notifications available to be displayed in the user interface 5000, only some of the notifications are visible in the user interface 5000 at a given time, while other notifications become visible in the user interface 5000 as the notifications are scrolled in the user interface 5000 in response to one or more scroll inputs (e.g., one or more swipe inputs, or one or more pinch and drag inputs) and/or when stacked notifications are expanded into individual notifications in the user interface 5000 in response one or more expansion inputs (e.g., a tap or scroll input on coalesced notifications or stacked notifications).

In some embodiments, summary content and/or one or more summaries corresponding to one or more of the notifications in the user interface 5000 are available (e.g., have been generated or can be generated on demand based on the application content corresponding to the one or more notifications), but the computer system forgoes including the summaries in the notifications in the user interface 5000 initially, and displays the summaries upon detecting an input requesting the summaries. For example, in response to detecting a user input 5022 directed to the notification 5012 (e.g., a tap input by a contact on the notification 5012, or another type of selection input such as a pinch gesture detected when a gaze is directed to the notification 5012, an air tap gesture detected at a location of the notification 5012, or a mouse click detected when a focus selector is on the notification 5012), the computer system 100 displays summary content corresponding to the notification 5012 (e.g., an automatically generated summary that is based on the application content corresponding to the event that triggered the display of the notification 5012) (e.g., as shown in the user interface 5036 of FIG. 5D, which is described in greater detail below).

FIG. 5C shows an alternative scenario to that shown in FIG. 5B. In FIG. 5C, some notifications include summarized notification content (e.g., a summary based at least in part on, and/or containing portions of, notification content of the notification has been generated and/or application content that corresponds to the event that triggered the notification). For example a summary 5024 is a notification that provides a summary of content from the application M (e.g., a summary corresponding to the notification 5012 in FIG. 5B, which has been replaced by the summary 5024 in FIG. 5C). In some embodiments, summaries have a different visual appearance as compared to non-summarized notifications (e.g., “normal” notifications). For example, the summary 5024 has a bolded border, and an added triangular indicator, as compared to the notification 5016 (e.g., a “normal” notification that does not include summarized application content) shown in the user interface 5000 in FIG. 5C. In some embodiments, summaries (e.g., summary content displayed in and/or corresponding to a summary) are displayed with a different text color, a different text size, and/or a different text font, as compared to content of non-summarized notifications.

In some embodiments, multiple summaries (e.g., a summary 5024, a summary 5026, and a summary 5028) can be concurrently displayed in the user interface 5000. In some embodiments, one or more summaries can be concurrently displayed with a non-summarized notification (e.g., a notification that is not a summary and/or does not include summarized application content) (e.g., the summaries 5024, 5026, and 5028 are concurrently displayed with the notification 5016 that is not a summary).

In some embodiments, summary content is automatically generated using a machine learning (ML) algorithm, a large language model (LLM), and/or another suitable form of artificial intelligence. In some embodiments, summary content is generated by the operating system using a summarization functionality that is available to the operating system (e.g., as part of the operating system, or as an external service utilized by the operating system), and the summarization functionality is applied to application content provided by one or more individual applications and the summary content is generated based on the application content provided by the one or more individual applications and, optionally, based on other available contextual information. In some embodiments, summary content is enabled for one or more applications or all applications installed on the computer system, and when application content from a respective application for which summary content is enabled, becomes available to be presented to a user, the application content is summarized and the summary content is presented to the user in place of, before, or concurrently with the original application content, such as in a notification or alert associated with the respective application. In some embodiments, the summary 5024 includes summary content. In some embodiments, the summary content removes or reduces (e.g., does not include) redundant content (e.g., that would have appeared in a normal notification and/or that is present in application content that would have been included and/or reproduced in a notification). In some embodiments, metadata (e.g., that would have appeared in a normal notification and/or that is present in application content that would have been included and/or reproduced in a notification) is removed when summary content is generated from application content corresponding to an event.

In some embodiments, formalities and/or other human-generated communication phrases (e.g., headers, greetings/salutations, a complimentary close, and/or signatures) are removed when summary content is generated from application content corresponding to an event. For example, in FIG. 5B, the notification 5012 includes the greeting/salutation “Hi John” (e.g., because the email corresponding to the notification 5012 includes the greeting/salutation “Hi John”), but the summary 5024 in FIG. 5C does not include the greeting/salutation “Hi John.”

In some embodiments, a summary (e.g., the summary 5026) includes summarized content that is based on application content corresponding to multiple events or content of multiple notifications (e.g., and optionally, across applications, even if notifications corresponding to different applications would not have been grouped based on notification settings of the computer system 100). In some embodiments, a summary includes a visual notification to indicate that the summary includes content from multiple notifications (e.g., application content corresponding to the events that triggered the multiple non-summarized notifications). For example, the summary 5026 includes a badge with the number “3”, which indicates that the summary content of the summary 5026 includes content from three different notifications (e.g., a notification regarding a reply about the work report, a notification regarding a restaurant reservation, and a notification regarding an airline reservation). In some embodiments, there may be more notifications included in the group of related notifications (e.g., related by meeting the relatedness criteria (e.g., corresponding to the same and/or related applications, senders, sources, topic, and/or subject matter) with respect to one another) that correspond to the summary, but the badge reflects the number of notifications with notification content that is reflected in the summary content in some way. In some embodiments, the badge indicates the total number of notifications included in the group of related notifications (e.g., related by meeting the relatedness criteria (e.g., corresponding to the same and/or related applications, senders, sources, topic, relevant time frame, and/or subject matter) with respect to one another) that correspond to the summary, even if the content of only a subset of the notifications in the group is reflected in (e.g., used to generate) the summary content of the summary.

In some embodiments, a summary includes an indication of a time and/or time duration (e.g., an indication of a time or time frame that corresponds to a time or time frame in which one or more notifications corresponding to the summary (e.g., all of the notifications in the group of related notifications or a subset of the group of related notifications that are more recent and/or relevant, based on a threshold time window or relevance criteria) were generated). For example, the summary 5028 includes a time indicator “2 h ago,” which indicates that the summary was generated 2 hours ago. In contrast, the summary 5026 includes a time indicator “last 30 m,” which indicates that the summary 5026 summarizes content that was received and/or generated over the last 30 minutes (e.g., the three notifications that were generated during the last 30 minutes were summarized).

In some embodiments, a user can interact with a summary via a user input (e.g., a user input 5030 directed to the summary 5024, a user input 5032 directed to the summary 5026, and/or a user input 5034 directed to the summary 5028). In some embodiments, a user input is said to be “directed to” a user interface object or a location, when a target object or target location of the user input includes the user interface object or the location. In some embodiments, a user input targets an object or location in different manners depending on the type of the input. For example, in some embodiments, a touch input performed by a contact targets a location or object when the location of the contact (e.g., a touch-down location, or a contact area or movement path) is on a portion of the touch-sensitive surface or touch-screen display that corresponds to the object or a portion of thereof or a reactive region associated with the location. In some embodiments, an air gesture performed by the hand(s) or finger(s) (e.g., a hand waving, a hand flipping, two hands moving toward each other, two fingers pinching, and/or one finger tapping) targets a location or object when the location of the hand(s) and/or finger(s) are on or near the object or the location. In some embodiments, an air gesture performed by the hand(s) or finger(s) (e.g., a hand waving, a hand flipping, two hands moving toward each other, two fingers pinching, and/or one finger tapping) targets a location or object when the gesture is detected (e.g., when initially detected, or as the gesture continues) while a gaze is detected on the object or the location. In some embodiments, a click input e.g., down-click, and/or up-click) performed by a mouse or trackpad targets a location or object when the click input is detected (e.g., when initially detected, or as the down-click is maintained) while a focus selector (e.g., a pointer, or a cursor, or a gaze) is on the object or the location. In some embodiments, an activation input (e.g., activation of a hardware button, a controller, or another control device) targets an object or location when the activation input is detected (e.g., when initially detected, or as the down-click is maintained) while the object or location has input focus (e.g., is currently selected, and/or when a focus selector (e.g., a contact, a pointer, or a cursor, or a gaze) is on the object or the location). In some embodiments, user inputs are evaluated based on different sets of criteria (e.g., navigation criteria, scrolling criteria, dismissal criteria, activation criteria, selection criteria, resizing criteria, expansion criteria, menu display criteria, removal criteria, and/or other sets of criteria) that correspond to different operations that can be performed with respect to the object, location, and/or the user interface or container object(s) in which the object or location is enclosed. As disclosed herein, when a first type of user input (e.g., a touch input (e.g., a tap, a swipe, a press, a touch and hold gesture) or a click input (e.g., left click, right click, down-click, up-click, double click, click and hold, click-hold and drag)) is described as being directed to an object or location and causing the computer system to perform a first operation in a first operating environment (e.g., in an mobile device operating system, in a smartwatch operating system, and/or on a touch-screen display of a mobile device), it is to be understood that, a second type of user input can be used to target the object or location and cause the same or similar operations to be performed in another operating environment (e.g., in an extended reality operating system, a three-dimensional environment, a desktop environment, in a display of a head-mounted display, and/or other operating environments) in which the second type of user input (e.g., an air gesture (e.g., an air tap, an air pinch, an air pinch and drag, a pinch and hold gesture) with a focus selector, such as a gaze, a pointer, or cursor, or an air gesture performed directly at the target location) is equivalent to the first type of input (e.g., a touch input, or a click input).

In some embodiments, a summary (e.g., the summary 5024) is displayed in accordance with a determination that settings for the computer system 100 enable summaries for the mail application M corresponding to the summary 5024. In some embodiments, the user can configure some (e.g., but not all) applications to enable summaries to be generated for those applications, and can configure some applications to disable summaries for those applications (e.g., notifications will be delivered without summaries for those applications). In the example shown in FIG. 5C, the settings enable summaries for the application S (e.g., as indicated by the summary 5026) and the application N (e.g., as indicated by the summary 5028), as well as the application M (e.g., as indicated by the summary 5024), while disables summaries for the application H (e.g., notification 5016 is displayed without summarized content), in accordance with some embodiments. Additional details regarding configuring the summarization functionality with respect to individual applications, application categories, and/or all applications are provided with respect to FIGS. 5I-5V, in accordance with some embodiments. In some embodiments, whether a summary or a non-summarized notification is outputted depends on whether notification content length of the non-summarized notification exceeds a threshold notification content length, even if notification summary is enabled for an application associated with the non-summarized notification. More details regarding how notifications, including summaries and non-summarized notifications, are output are provided with respect to FIGS. 8A-8S, and FIGS. 9A-9Z and accompanying descriptions.

In some embodiments, the computer system 100 is a peripheral device (e.g., a smartwatch, an earphone, a doorbell, a thermostat, a smart home appliance, or another peripheral device that includes a computer system) that is in communication with another computer system (e.g., a “main” or non-peripheral computer system). In some embodiments, the other computer system generates notifications (e.g., and/or detects events corresponding to the generated notifications), and is configured to forward or otherwise transmit notification content to the computer system 100. In some embodiments, the other computer system summarizes one or more notifications (e.g., generates one or more summaries) and forwards or otherwise transmits the one or more summaries to the computer system 100 (e.g., for display in the user interface 5000). In some embodiments, summaries that are received from the other computer system include a visual indicator (e.g., a badge, an icon, a distinct border, a distinct color, a distinct shape, a distinct text color, and/or a distinct background) indicating that the summary was received from an external source (e.g., the other computer system).

In some embodiments, the computer system 100 is a peripheral device, and is configured to generate notifications locally (e.g., without needing to receive notification content from an external source, such as the other computer system). In some embodiments, the computer system 100 displays locally generated notifications (e.g., and does not display a summary corresponding to the locally generated notification). In some embodiments, the computer system 100 displays at least one locally generated notification (e.g., that is not summarized) and at least one summary (e.g., received from an external source such as the other computer system). In some embodiments, locally generated notifications are not displayed with a visual indicator (e.g., the visual indicator denotes notifications and/or summaries received from an external source, and so is not applied to locally generated notifications).

In some embodiments, the computer system 100 (e.g., a smartwatch, a doorbell, or other types of computer systems) transmits and/or communicates (e.g., content corresponding to) the locally generated notification(s) to the other computer system (e.g., a smartphone, a host device, or other types of computer systems). The other computer system generates a summary corresponding to the (e.g., content corresponding to) the locally generated notification, and transmits the summary back to the computer system 100. The computer system 100 then displays and/or otherwise output the received summary information (e.g., as the summary 5024, the summary 5026, and/or the summary 5028) (e.g., as a displayed summary and/or an audio announcement).

In some embodiments, the computer system 100 (e.g., a smartphone, a head-mounted display, a laptop computer, or another type of computer system) generates a summary (e.g., and/or summary content) and transmits the generated summary/summary content to the other computer system (e.g., a peripheral device such as a smartwatch, a pair of earphones, or other types of computer systems). In response to receiving the generated summary/summary content from the computer system 100, the other computer system 100 displays or otherwise outputs the summary (e.g., or a summary that includes the summary content generated and transmitted by the computer system 100). In some embodiments, the computer system 100 also displays and/or otherwise outputs the generated summary/summary content (e.g., in response to a user input and/or request to display or output summaries and/or notifications).

In some embodiments, a summary is automatically cleared (e.g., removed from the user interface 5000, and no longer displayed or available to be displayed in the user interface 5000) when the summary is no longer relevant (e.g., a set of contextual criteria are met, a set of contextual criteria are no longer met, a current location meets location criteria, a current time meets timing criteria, a threshold amount of time has passed (e.g., since the summary was generated and/or viewed), and/or the user has viewed and/or interacted with the summary). In some embodiments, different notifications, including non-summarized notifications and summaries, are automatically cleared at different times (e.g., automatically removed while the user interface 5000 is displayed, and/or not displayed again when the user interface 5000 is dismissed and displayed again at a later time), depending on their changing relevance.

In some embodiments, the user interface 5000 includes a summary (e.g., the summary 5024, the summary 5026, and/or the summary 5028). After displaying the user interface 5000 (e.g., in the first context), the computer system 100 ceases to display the user interface 5000 (e.g., because the user ceases to interact with the computer system 100 for a threshold amount of time, and/or because the user performs a manual input to cease displaying the user interface 5000). After ceasing to display the user interface 5000, the computer system 100 displays a request to display (e.g., redisplay) the user interface 5000 (e.g., at a later time). In response, the computer system 100 displays the user interface 5000, and the user interface does not include the summary (e.g., the summary 5024, the summary 5026, and/or the summary 5028) because notification-clearing criteria are met for the summary.

In FIG. 5D, for example, the computer system 100 displays additional content (e.g., beyond the initially displayed summary content shown in FIG. 5C) for the summary 5024, in response to detecting the user input 5030 directed to the summary 5024 (FIG. 5C). In some embodiments, the computer system expands the summary 5024 to display a user interface 5036 (e.g., an expanded summary user interface that includes additional content as compared to the summary 5024). In some embodiments, the user interface 5036 includes the notification 5012 (e.g., at least one notification corresponding to the summary content of the summary 5024). In some embodiments, the user interface 5036 includes a close affordance 5040 (e.g., which, when activated (e.g., by a tap input, an air pinch gesture, an air tap gesture, a click input, or another type of selection input), collapses the user interface 5036 back down into the summary 5024 shown in FIG. 5C). In some embodiments, the user interface 5036 is collapsed back down into the summary 5024 in response to detecting a user input directed to a location that is outside of the user interface 5036 (e.g., another notification or summary, or an unoccupied portion of the user interface 5000).

In some embodiments, when expanding the summary 5024 to display the additional content, the computer system shifts other displayed content (e.g., the notification 5016 and the summary 5026 are shifted downward to accommodate the expanded size of the user interface 5036, and the summary 5028 is “shifted off” the display of the computer system 100). In some embodiments, the user interface 5036 is expanded while the order of summaries and/or notifications (e.g., a temporal order) within the user interface 5000 is maintained (e.g., the other displayed content is shifted in order to maintain the user interface 5036 as the most recent item in the user interface 5000 (e.g., at the top of the user interface 5000).

In FIG. 5E, in response to detecting the user input 5038 directed to the notification 5012 in the user interface 5036 (e.g., as shown in FIG. 5D), the computer system 100 displays an expanded view 5044 of the notification 5012 inside the user interface 5036. In some embodiments, the expanded view 5044 is displayed concurrently with the summary content, within a user interface 5042 (e.g., expanded version of the user interface 5036), which optionally includes a close affordance 5050 for collapsing the user interface 5042 back into either the user interface 5036 shown in FIG. 5D, or the summary 5024 shown in FIG. 5C. In some embodiments, the expanded view 5044 of the notification 5012 includes additional notification content as compared to the notification 5012. For example, the notification 5012 corresponds to an email received in the email application M. The notification 5012 displays a first amount of email content corresponding to the received email, and the expanded view 5044 displays a second amount of email content (e.g., that includes the first amount of email content, and additional email content from the email that was not included in the first amount of email content). This feature allows the user to have varying degrees of flexibility in terms of accessing an appropriate amount of notification content (e.g., progressively more or less notification content) for an event.

In some embodiments, the user interface 5042 and/or the expanded view 5044 are displayed (e.g., concurrently) with a menu 5046. The menu 5046 includes one or more affordances or selectable options for interacting with the notification content and/or the corresponding application. For example, the menu 5046 includes affordances or selectable options corresponding to various functions for interacting with an email (e.g., and the email application M), such as “Mark as Read,” “Flag,” “Reply,” “Archive,” and “Delete.” In some embodiments, activating a respective affordance or selecting a respective selectable option in the menu 5046 causes the computer system 100 to perform a respective function (e.g., “Mark as Read,” “Flag,” “Archive,” or “Delete”) corresponding to the respective affordance or selectable option (e.g., without launching or opening the email application M, and/or without replacing display of the user interface 5000 and the user interface 5042). In some embodiments, a respective function (e.g., “Reply”), when activated, causes the computer system 100 to display an application user interface for the respective function (e.g., overlaid over the user interface 5000, and/or replacing display of the user interface 5000).

In some embodiments, the user interface 5036 (FIG. 5D) and/or the user interface 5042 (FIG. 5E) include the summary content that was shown in the summary 5024. In some embodiments, the user interface 5036 and/or the user interface 5042 do not include the summary content that was shown in the summary 5024. In some embodiments, when the user interface 5036 and/or the user interface 5042 are displayed, at least a portion of the user interface 5000 remains displayed (e.g., in a display layer below the user interface 5036 and/or the user interface 5042, or at a greater display depth than the user interface 5036 and/or the user interface 5042; and/or is optionally blurred and/or darkened).

In FIG. 5F, in response to detecting a user input 5048 directed to the expanded view 5044 of the notification 5012, the computer system 100 displays an application user interface 5052 (e.g., that corresponds to the email application M). The application user interface 5052 includes application content 5054 (e.g., an email) that corresponds to the notification 5012 and the summary 5024. In some embodiments, the content of the notification 5012, the content of the summary 5024, and the content of the expanded view 5044 are all based at least in part on the application content 5054. In some embodiments, a user input directed to notification 5012 shown in FIG. 5B causes the display of the application user interface 5052 if notification summary for the notification 5012 is not available to be displayed.

In some embodiments, the application content 5054 shown in FIG. 5F includes the full email content for the received email (e.g., for comparison against the notification 5012, the expanded view 5044 of the notification 5012, and the summary 5024, the user interface 5036, and the user interface 5042). The notification 5012 and the expanded view 5044 of the notification 5012 include portions of the application content 5054 (e.g., an initial portion of the application content 5054, allowing for size constraints on the notification 5012 and the expanded view 5044 of the notification 5012, but is drawn from and/or reproduced directly from the application content 5054).

In contrast, the summary content of the summary 5024 (e.g., and, optionally, the user interface 5036 and/or 5042) includes content that does not directly reproduce content from the application content 5054 (e.g., the summary content is not directly taken from, or does not directly reproduce, the application content 5054). For example, the summary content condenses the two paragraphs of the application content 5054 into a single line. The first paragraph of the application content 5054 mentions Mike's “new concerns,” and the second paragraph of the application content 5054 mentions the action item of sending an updated draft, which are summarized and/or condensed into the phrase “She wants an updated draft addressing Mike's concerns . . . ” in the summary content. In some embodiments, the summary content also includes some content that is not found in the application content 5054 (e.g., contextual and/or background information drawn from other sources (e.g., application content of other applications that correspond to other relevant events and/or updated content)). For example, the widget 5006 (e.g., widget of a flight tracker application or calendar application that includes updated flight information or schedule information) (as shown in FIGS. 5B-5E) indicates that there is an upcoming flight at 6:40 PM for the user. While the application content 5054 does not mention this upcoming flight, the summary content of the summary content indicates that Jane Doe would like an updated draft “before you fly out” (e.g., because the computer system 100 detects that there is an upcoming flight, as reflected in content of the widget 5006, which may make it impractical for the user of the computer system 100 to handle associated action items after the flight's departure time).

In some embodiments, the notification 5012, and the expanded view 5044 of the notification 5012, also include the greeting/salutation “Hi John.” In contrast, the summary content of the summary 5024 (e.g., and the user interface 5042) does not include a greeting or salutation from Jane Doe. Removing greetings and salutations from a summary allows relevant content to be delivered more succinctly, and using less space on the display of the computer system 100, as compared to the notification 5012 and the expanded view 5044 of the notification 5012, for example.

FIG. 5G shows a user interface 5056 that corresponds to the summary 5028 in FIG. 5C, which includes summary content concurrently displayed with the notification 5020 (e.g., in response to detecting the user input 5034 directed to the summary 5028, in FIG. 5C). In some embodiments, no expanded view is available for the notification 5020, so in response to detecting a user input 5058 directed to the notification 5020 in FIG. 5G, no expanded view is displayed (e.g., FIG. 5G is analogous to FIG. 5D, but unlike for notification 5012 in FIG. 5G, no expanded state of the notification 5020 is available). In some embodiments, when no expanded state of the notification 5020 is available, the computer system optionally launches the news application N and displays the application content 5062 in the application user interface 5060 of the news application N (e.g., as shown in FIG. 5H), in response to detecting the user input 5058 directed to the notification 5020. FIG. 5G also shows that a summary (e.g., the summary 5028 in FIG. 5C) can be expanded (e.g., in response to the user input 5034 directed to the summary 5028) while the order of summaries and notifications in the user interface 5000 is maintained (e.g., the summary 5028 expands into the user interface 5056, but remains below the summary 5026, which maintains the order shown in FIG. 5C). In some embodiments, as the summary 5028 is expanded, another notification or summary (e.g., summary 5024) is shifted upward and, optionally, slides underneath the widgets 5006, 5008, and 5010 and the time element 5004 and ceases to visible in the user interface 5000 (e.g., the summary 5024 is not cleared, and will be visible in the user interface 5000 again when the user interface 5056 is collapsed into the summary 5028 again).

FIG. 5H is analogous to FIG. 5F, and shows an application user interface 5060 that includes the application content 5062 corresponding an event generated by the news application N. The summary content of the summary 5028 (and, optionally, the summary displayed in the user interface 5056 along with the notification 5020) includes summary content corresponding to the application content 5062. The summary content of the summary 5028 and the user interface 5056 includes content that is derived from the application content 5062 (e.g., generated using artificial intelligence, machine learning, and/or large language models based on the application content 5062), but is not directly taken or repeated from the application content 5062 (e.g., the application content 5062 does not include the summary content of the summary 5028).

FIGS. 5I-5V show exemplary user interfaces for setting up and/or configuring display of summary content (e.g. automatically generated summaries corresponding to application and/or notification content for one or more events), in accordance with some embodiments. It is to be understood that, although “displaying” summary content are described in these examples, the configuration also applies to other means of presenting summary content, such as presenting summary content using audio output narrated by a digital assistant and/or graphical illustrations of key information in the summary content. In some embodiments, when display of summary content is enabled for a respective application, a user interface (e.g., such as a notification corresponding to a respective application) includes summary content (e.g., content that has been summarized via summarization functionality). For example, the summary content is displayed in place of, before, and/or concurrently with, the original application content that was prepared by the respective application for inclusion in the user interface. It is understood that in some embodiments, the summarization functionality is performed by an operating system of the computer system 100 (e.g., at a device level or operating system level) or an external service utilized by the operating system of the computer system 100, based on application content provided by one or more applications and, optionally based on contextual information available to the computer system. In some embodiments, the resulting summary content is used by the computer system to generate notification summaries to present to a user in place of the original notifications that would have been presented if the summarization function was not enabled or available for the applications. In some embodiments, the summary content can be provided to an application of the computer system 100 (e.g., even if the application cannot itself generate summary content), to be utilized by the application within a user interface of the application. In some embodiments, the summarization functionality can be performed by a specific application (e.g., the specific application can generate summary content regardless of what device/hardware the specific application is installed and/or running on). For example, in some embodiments, when the summarization functionality is enabled for a respective application, the respective application is allowed to invoke the summarization functionality provided by the operating system or an external service (e.g., using an API provided by the operating system or external service) when generating the summary content that is included in notifications for the application, and the summary content is different from the application content that would have been included in the notifications if the summarization functionality is not enabled for the respective application. In some embodiments, the interactions between the operating system and a respective application with respect to generating and/or presenting summary content may vary depending on the operating system, device, and/or applications that are involved. It is to be understood that, the summarization functionality is provided across multiple applications, and may utilize information that is retrieved from multiple applications, accumulated over an extended period of time, correlated based on semantic meaning, and/or generated in multiple user interaction sessions. In some embodiments, when the summarization functionality (e.g., described as “displaying” or “having” “summary content” or “notification summaries” in these examples) is enabled for a respective application, summary content is included in a user interface object corresponding to the respective application that is displayed outside of the application (e.g., a preview of a notification, a notification, a stack of coalesced notifications, complications, status updates, live activities, and/or other user interface objects displayed outside of the respective application to present application content of the respective application); and when the summarization functionality is not enabled or is disabled for the respective application, summary content is not included in the user interface object corresponding to the respective application that is displayed outside of the application. In some embodiments, in addition to or in lieu of displaying a user interface object corresponding to the respective application outside of the respective application, the computer system presents the summary content in another modality, such as via speed output of a digital assistant and/or using graphical illustrations in a simplified user interface, such as a vehicle dashboard, a control panel of a home appliance, a display of a media player, or a display of a smart home hub.

FIG. 5I shows the user interface 5000 after functionality for displaying (e.g., and/or enabling display of) summary content (e.g., sometimes referred to herein as “summarization functionality”) becomes available for (e.g., and/or on) the computer system 100. After the functionality for displaying summary content becomes available for the computer system 100, the computer system 100 displays a user interface 5064 (e.g., a notification, alert, or other visual indicator that new functionality for displaying summary content is now available). In some embodiments, the user interface 5064 is displayed on top of and/or above other user interface elements in the user interface 5000 (e.g., such as the notification 5012, and the indicator 5066 that other notifications are available for display, in FIG. 5I). In some embodiments, the summarization functionality becomes available to the computer system 100 as part of an update to the operating system of the computer system 100. In some embodiments, the summarization functionality becomes available to the computer system after an enrollment or authorization process has been successfully completed by a user for the computer system. In some embodiments, the summarization functionality is made available to a user profile on a different device and is automatically made available to the computer system 100 because the computer system is also associated with the user profile. In some embodiments, the summarization functionality becomes available as part of a new operating system installed on the computer system 100.

In FIG. 5J, in response to detecting a user input 5068 directed toward the notification 5064 in FIG. 5I, the computer system 100 displays a user interface 5070. In some embodiments, the user interface 5070 provides additional information about the new functionality to summarize content and/or display summary content. In some embodiments, the user interface 5070 includes one or more affordances for displaying additional information regarding different aspects of the new functionality to summarize content and/or display summary content. For example, the user could perform a user input directed to the text “New Era for Siri” to display additional information about how the summary functionality integrates with a voice assistant of the computer system 100 (e.g., as described in greater detail below with reference to FIGS. 8A-8S). For example, the user could perform a user input directed to the text “Built for Privacy” in order to display additional information about what data is used to enable the summary functionality, how and/or where that data is stored, how any stored data is protected, how long that data is stored, and/or other privacy-related information). In some embodiments, the user interface 5070 includes an affordance 5072, which when activated, continues configuration and/or setup of the new functionality to summarize content and/or display summary content. In some embodiments, the user interface 5070 is displayed as part of a setup flow for a new computer system, without requiring the computer system to display the user interface 5064 or to detect selection of the user interface 5064.

FIG. 5K shows that, in response to detecting a user input 5074 directed toward the affordance 5072 in FIG. 5J, the computer system 100 displays a user interface 5076. In some embodiments, the user interface 5076 provides additional information and/or details regarding the new functionality to summarize content and/or display summary content (e.g., the user interface 5070 in FIG. 5J provides a high level overview, while the user interface 5076 provides more specifics for how the summary content is displayed and/or appears when displayed). In some embodiments, the user interface 5076 includes a portion 5078, which displays an animation (e.g., or other visual guide) of application and/or notification content (e.g., un-summarized and/or original content), and its subsequent conversion into summary content). In FIG. 5K, the portion 5078 shows the un-summarized and/or original content (e.g., to be summarized), such as part of the original content of a news article published in a news application (News App 1) and/or content that would be included in a notification for the news article when summarization is not enabled for the news application.

FIG. 5L is analogous to FIG. 5K, but shows the user interface 5076 at a different point in the animation of the portion 5078, which shows a summary 5088 after the summarization functionality has been applied to the content shown in FIG. 5K (e.g., after summarizing the original content shown in FIG. 5K) and the notification includes summarized content that is based on, but not part of, the original content shown in FIG. 5K. In some embodiments, the animation in the portion 5078 of the user interface 5076 plays on a loop (e.g., is continuously repeated while the user interface 5076 is displayed). In some embodiments, the animation in the portion 5078 is played on a loop for a predetermined amount of time (e.g., 30 seconds, 1 minute, 2 minutes, 5 minutes, or 10 minutes). In some embodiments, the summary 5088 includes a visual indication, e.g., a symbol, an icon, or an outline, a color scheme, or other visual indications, to indicate to the user that the content of the notification includes automatically generated summary content, where the same or analogous indication is also included in other notifications and/or other user interface objects that include summary content. In some embodiments, the user interface 5076 shown in FIGS. 5K-5L is displayed in response to the user input 5068 in FIG. 5I, skipping the user interface 5070 in FIG. 5J. In some embodiments, the user interface 5076 shown in FIGS. 5K-5L are displayed in response to other requests for configuring the summarization functionality received from a configuration user interface of a respective application, a configuration user interface for notifications, and/or a settings user interface for the computer system.

In some embodiments, the user interface 5076 includes indications 5080 of one or more applications (e.g., all applications or a sampler of all applications for which notifications are frequently generated). In some embodiments, the indications 5080 correspond to the applications which generate the highest number of notifications (e.g., over a period of time, such as the past 24 hours, the past week, the past two weeks, the past month, and/or another suitable period of time to compare notification data). For example, in FIGS. 5K and 5L, the user interface 5076 includes the five applications (e.g., an application M, an application m, an application N, an application C, and an application P) which generate the highest number of notifications for a chosen period of time at the computer system.

The user interface 5076 includes an affordance 5082 (e.g., which, when activated by a user input 5091, causes the computer system 100 to display a user interface for configuring which applications should have notification summaries, on a per-application basis), an affordance 5084 (e.g., which, when activated by a user input 5087 directed toward the affordance 5084, configures the computer system 100 to enable display of summary content for all applicable applications), and an affordance 5086 (e.g., which, when activated by a user input 5089 directed toward the affordance 5086, causes the computer system 100 to forgo enabling display of summary content for any applications, configure all applications to not have notification summaries, cease to display the user interface 5076, cease to configure the computer system 100 to display summary content, redisplay the user interface 5000, and/or display another user interface such as the user interface of FIG. 4A), in accordance with some embodiments.

FIG. 5M shows that, in response to detecting the user input 5091 directed to the affordance 5082 in FIG. 5L, the computer system 100 displays a user interface 5090-a. The user interface 5090-a is a user interface for configuring specific applications to have notification summaries (e.g., but without requiring all applications be configured to have notification summaries), and includes a plurality of applications (e.g., a mail application 5092, a messaging application 5094, a first news application 5096, a doorbell application 5098, and a phone application 5100). For each respective application of the plurality of applications, the user interface 5090-a also includes a respective toggle (e.g., for configuring whether notifications of the respective application do or do not include summary content). In some embodiments, other types of controls, such as checkboxes, radial buttons, and/or other user interface objects, are used to allow a user to enable and/or disable the summarization functionality for a respective application. In some embodiments, applications that have the summarization functionality enabled are automatically grouped into one portion of the user interface 5090-a, and applications that do not have the summarization functionality enabled are automatically grouped in another portion of the user interface 5090-a. In some embodiments, the two portions of the user interface 5090-a respectively corresponding to the group of applications that have the summarization functionality enabled and the group of applications that have the summarization functionality disabled, are separated by a visual divider. In some embodiments, a user may drag a representation of a respective application from one portion to the other portion of the user interface to enable or disable the summarization functionality for the respective application.

In some embodiments, the plurality of applications are listed by number of notifications generated (e.g., the average number of notifications generated over a time period). For example, in FIG. 5M, the five applications listed at the top of the plurality of applications are the same applications that correspond to the indications 5080 in FIGS. 5K and 5L. In some embodiments, the user interface 5090-a includes all applications that are configured to generate notifications (e.g., and the user can scroll and/or navigate through the list of applications by performing a user input, such as a swipe input). In some embodiments, the plurality of applications are sorted by a different metric, such as how frequently a corresponding application is used by a user, or based off a compiled history of how likely a user is to interact with notifications for a particular application. In some embodiments, the plurality of applications are sorted alphabetically (e.g., and not based on user or notification metrics).

In some embodiments, at the start, each application of the plurality of applications is configured to have notification summaries (e.g., summarization is enabled by default, and the user can manually select individual applications for which this functionality should be disabled). In some embodiments, at the start, none of the applications of the plurality of applications is configured to have notification summaries (e.g., summarization is disabled by default, and the user can manually enable this functionality for individual applications). In some embodiments, the computer system 100 automatically enables some, but not all, applications to have notification summaries. In some embodiments, the computer system 100 determines which applications to enable and/or disable based on one or more user and/or notification metrics, such as a threshold frequency of notifications generated, a threshold amount of application screen or use time, and/or a threshold level of user interaction with notifications for an application (and optionally, the same metric or metrics are used to order the plurality of notifications).

FIG. 5N is analogous to FIG. 5M, but shows that the computer system 100 has been configured such that notifications for the messaging application 5094 do not include summary content (e.g., as a user input 5104 in FIG. 5M, directed toward the toggle 5104, toggles off the summarization functionality with respect to the messaging application 5094). Similarly, the computer system 100 has been configured such that notifications for the doorbell application 5098 do not include summary content (e.g., as a user input 5108 in FIG. 5M, directed toward the toggle 5108, toggles of the summarization functionality with respect to the doorbell application 5098). The user interface 5090-a also includes an affordance 5112 (e.g., when, when activated by a user input 5116, confirms the configuration of which applications for which this functionality is enabled or disabled via the user interface 5090-a as described above) and an affordance 5114 (e.g., which, when activated by a user input 5118, causes the computer system 100 to cease to display the user interface 5090-a and/or cease to configure the computer system 100 to display summary content).

FIG. 5O shows a user interface 5090-b, which is analogous to the user interface 5090-a shown in FIG. 5M, but shows the plurality of applications grouped by category (e.g., instead of as a single list of applications). For example, the user interface 5090-b groups the mail application 5092 and the messaging application 5094 together in a “Messaging” category, groups the first news application 5096 and a second news application 5120 in a “News” category, and groups the doorbell applications 5098 and a home application 5134 together in a “Home” category. The user interface 5090-b also includes an affordance 5112 (e.g., which, when activated by a user input 5150, accepts and/or confirms the current configuration of applications and/or categories in the user interface 5090-b), and an affordance 5114 (e.g., which, when activated by a user input 5148, ceases to display the user interface 5090-b and/or ceases to configure the computer system 100 to display summary content). In some embodiments, activating the affordance 5112 completes the configuration of the computer system 100 to display summary content (e.g., and summary content is displayed in accordance with which applications and/or categories were enabled or disabled in the user interface 5090-a or 5090-b).

In some embodiments, functionality for displaying summary content can be enabled and/or disabled individually for each application of a plurality of applications, such as all applications or a category of applications. For example, the user interface 5090-b includes a control 5124 for enabling or disabling display of summary content for the mail application 5092 (e.g., individually, without configuring other applications or categories), and as shown in FIG. 5O, the option is currently “off” (e.g., the control 5124 is in an unchecked or unselected state, and as a result, the mail application 5092 is not configured to have notification summaries). In contrast, a control 5132 for the doorbell application 5098 is currently “on” (e.g., the control 5132 is in a checked or selected state, and as a result, the doorbell application 5098 is currently configured to have notification summaries). In some embodiments, each application of the plurality of applications in the user interface 5090-b has a corresponding control (e.g., the controls previously described, along with a control 5126 corresponding to the messaging application 5094, a control 5128 corresponding to the first news application 5096, a control 5130 corresponding to a second news application 5120, and a control 5134 corresponding to the home application 5122).

In some embodiments, functionality for displaying summary content can be enabled and/or disabled for all applications within a specific category (e.g., in addition to, or in lieu of, the controls for enabling/disabling functionality individually for each application). For example, a toggle 5136 corresponds to the “Messaging” category, and when activated, enables or disables summarization functionality (e.g., configures whether or notifications include summary content) for all applications (e.g., all currently installed applications, and optionally, all future installed applications) in the “Messaging” category (e.g., the mail application 5092 and the “Messages” category 5094). In some embodiments, each category has a corresponding toggle (e.g., a toggle 5138 corresponding to the “News” category, and a toggle 5140 corresponding to the “Home” category). In some embodiments, a visual appearance of a respective toggle provides visual feedback regarding the configuration of applications within the respective category. For example, if all, or a first threshold number of applications (e.g., more than one, more than half of all applications, or some other number of fractions) within the respective category have summarization functionality enabled (e.g., are configured so that their notifications include summary content), the respective toggle is shown with an “on” appearance (e.g., and/or an “on” or “enabled” state). If one or more applications, or a second threshold number of applications (e.g., more than one, more than one third of all, or some other number or fractions) within the respective category do not have the summarization functionality enabled (e.g., are configured so that their notifications do not include summary content), the respective toggle is shown with an “off” appearance (e.g., and/or an “off” or “disabled” state).

In some embodiments, the categories in the user interface 5090-b are ordered based on an average number of notifications, across all applications within the category, generated by the applications in the category (e.g., over a period of time). In some embodiments, the average number of notifications is calculated across a subset of applications. In some embodiments, the categories in the user interface 5090-b are ordered based on notification frequency, and each category is ordered based on an application that generates the highest (e.g., or lowest) average number of notifications for that category (e.g., the top generator of notifications in each category are compared against one another, to determine the order of the categories). In some embodiments, the categories in the user interface 5090-b are ordered alphabetically. In some embodiments, the categories in the user interface 5090-b are ordered based on another metric (e.g., application screen time, and/or user interaction with notifications for applications within a category), optionally across some or all applications in each category, or optionally for a top (e.g., or bottom) performer for each category.

FIG. 5P shows the user interface 5090-b, after a user has configured applications and categories in FIG. 5O, in accordance with some embodiments. In response to detecting a user input 5136 directed toward the toggle 5136 in FIG. 5O, the computer system 100 configures each application in the “Messaging” category so that notifications for applications belonging to the “Messaging” category include summary content (e.g., in FIG. 5O, neither the mail application 5092 nor the messaging application 5094 were enabled to display summary content, but in FIG. 5P, both applications are configured to have notification summaries). Similarly, in response to detecting a user input 5146 directed toward the toggle 5140 (e.g., corresponding to the “Home” category), the computer system 100 configures all applications in the “Home” category so that notifications corresponding to applications belonging to the “Home” category do not include summary content (e.g., in FIG. 5O, both the doorbell application 5132 and the home applications 5134 are configured to have notification summaries, but in FIG. 5P, neither the doorbell application 5132 nor the home application 5134 are configured to have notification summaries). In response to detecting a user input 5144 directed to the control 5128 (e.g., corresponding to the first news application 5096), the computer system 100 enables the first news application 5096 (e.g., and not other applications in the “News” category, such as the second news application 5120) to display summary content. In some embodiments, the user can switch between enabling and disabling an application or category by performing subsequent user input directed to a respective control or toggle (e.g., a subsequent user input directed to the control 5128 in FIG. 5P would configure the first news application 5128 so that notifications corresponding to the first news application 5128 do not include summary content).

FIG. 5Q shows a notification 5152 for an application that was installed after one or more applications (e.g., and/or categories or applications) of the computer system 100 were configured to have notification summaries (e.g., at least some applications and/or categories, at least one or another threshold number of applications of all applications, or at least one or another threshold number of applications in a category to which News App 3 belongs, were previously configured to have notifications summaries before the application corresponding to the notification 5152 was installed). In some embodiments, the notification 5152, along with unsummarized notification content, includes an affordance 5154 (e.g., which, when activated by a user input 5160, configures a third news application that generated the summary content for notification 5152 and to display the summary content in notification 5152, and to include summary content in future notifications generated by the third news application) and an affordance 5156 (e.g., which, when activated by a user input 5158, configures the third news application to not include summary content in future notifications). In some embodiments, the notification 5152 includes a summary of notification content (e.g., a preview of what will be displayed if the user enables summarization functionality for the third news application), optionally, concurrently with original notification content (e.g., for comparison with the summary content). In some embodiments, the notification 5152 does not include summary content.

In some embodiments, the computer system 100 determines a category for each new application (e.g., and/or all new applications) that is installed after at least one application of the computer system 100 has been configured to have notification summaries (e.g., at least one or another threshold number of applications of all applications, or at least one or another threshold number of applications in a category to which the new application belongs, were previously configured to have notifications summaries). If at least one, all, or another threshold number of applications within a respective category are not configured to have notification summaries, the computer system 100 displays affordances for enabling or disabling display of summary content for the respective application. For example, the computer system 100 determines that a third news application, which generated the notification 5152, is an application in the “News” category. Based on the configuration shown in FIG. 5P, at least one news application (e.g., the second news application 5130) or another threshold number of applications in the “News” category, are not enabled to have notification summaries, as a result, the computer system 100 displays the notification 5120 with the affordances 5154 and 5156 to prompt the user to configure the summarization functionality for the third news application.

In some embodiments, if all applications within a respective category are configured to have summarized notifications (e.g., generated by the summarization functionality or by the application), and the new application is an application in the respective category, the computer system 100 automatically configures the new application to have summarized notifications by default. For example, if both news applications in the “News” category in FIG. 5P had been enabled to have summarized notifications, the computer system 100 would automatically configure the third news application to include summary content in notifications corresponding to both news applications (e.g., and optionally, the affordances 5154 and 5156 would not be displayed in FIG. 5Q, and the notification 5152 would be replaced by a summary of the notification content of the notification 5152, and the affordance 5154 would be replaced with an affordance to disable summarization for the new application.

FIG. 5R shows a settings user interface 5162, for configuring notification settings of the computer system 100, in accordance with some embodiments. In some embodiments, the settings user interface 5162 is a user interface for configuring system-level notification settings (e.g., across multiple and/or all notifications for multiple and/or all applications). The settings user interface 5162 includes an option 5164 for configuring (e.g., and/or reconfiguring) which applications have summarized notifications (e.g., include automatically summarized notification content in notifications, e.g., in previews of notification content visible in displayed notifications and/or narrated by a digital assistant). In FIG. 5R, the option 5164 is not currently enabled (e.g., as a result of the interaction shown in FIG. 5L, in response to detecting the user input 5089 directed to the affordance 5086, the computer system 100 does not enable display of summary content for any applications).

In FIG. 5S, in response to detecting a user input 5166 directed toward the option 5164 in FIG. 5R, the computer system 100 displays a user interface 5168 (e.g., a user interface for configuring whether notifications for one or more applications include or do not include summary content). In some embodiments, the user interface 5168 includes an option 5170. When a toggle 5172 for the option 5170 is in an “off” position (e.g., the summarization functionality is disabled), the computer system 100 does not include summary content for any notifications (e.g., summary content is disabled and/or suppressed at the system level, across all applications and notifications, so that no notifications include summary content). When the toggle 5172 is in an “on” position (e.g., the option for summarizing previews is enabled), one or more applications are enabled to have summarized notifications.

FIG. 5T shows that, in response to detecting a user input 5174 that toggles the toggle 5172 from the “off” position to the “on” position, the computer system 100 displays a plurality of applications in the user interface 5168. In some embodiments, when the toggle 5172 is toggled from the “off” position to the “on” position, each application of the plurality of applications is configured so that notifications corresponding to each application of the plurality of applications include summary content, by default. In some embodiments, each respective application in the plurality of applications has a respective toggle for configuring whether notifications corresponding to the respective application do or do not include summary content, which allows the user to customize which applications have notifications that include summary content (e.g., without needing to enable display of summary content for notifications of other applications). For example, the user performs a user input 5212 directed toward a toggle 5196 for a books application 5178, a user input 5214 directed toward a toggle 5202 for a delivery application 5184, and a user input 5216 directed toward a toggle 5210 for a home application 5192.

FIG. 5U shows the user interface 5168 that is displayed after the user inputs 5212, 5214, and 5216 in FIG. 5T, configuring some applications so that notifications corresponding to those application do not include summary content. In contrast to FIG. 5T, in FIG. 5U, the toggle 5192, the toggle 5202, and the toggle 5210 are now in an “off” position, and the notifications of corresponding applications are configured not to include summary content, without affecting the configurations for other applications (e.g., applications 5176, 5180, 5182, 5186, 5188, and 5190).

FIG. 5V shows a settings user interface 5212, in accordance with some embodiments. In some embodiments, the settings user interface 5212 is an application-specific settings user interface, for configuring notification settings for a respective application, such as a Messages application in this example, without configuring notification settings for other applications. In some embodiments, a respective instance of the settings user interface 5212 is provided by the operating system for each application that generate notifications, and includes the application-specific settings for notifications generated by the application. The settings user interface 5212 includes an option 5214, for configuring the respective application to display or not display and/or present summary content. For example, a toggle 5216 for the option 5214 is in an “on” state in FIG. 5V, indicating that the respective application (e.g., the messaging application corresponding to the settings user interface 5212) is configured to have notification summaries and/or present content summarized by the summarization functionality. In response to detecting a user input 5218 directed toward the toggle 5216, the computer system 100 sets the option 5214 to the “off” state, and configures the messaging application so that notifications corresponding to the messaging application do not include summary content.

In some embodiments, the settings user interface 5212 can be accessed (e.g., navigated to) via the settings user interface 5162 in FIG. 5R (e.g., the user can scroll down through additional notification settings in the user interface 5162, to display a list of installed applications, from which the user can access settings user interfaces for configuring notification settings of individual applications). In some embodiments, if a system-level setting for displaying summary content is initially disabled (e.g., as shown in FIGS. 5R and 5S), and the user individually enables the summarization functionality with respect to a respective application (e.g., configures the messaging application so that notifications corresponding to the messaging application include summary content, via the settings user interface 5212 shown in FIG. 5V), the computer system 100 automatically enables the system-level setting for displaying summary content (e.g., and optionally configures all or at least one application, other than the respective application, to not include summary content in notifications corresponding to those applications). For example, in the user interface 5168 shown in FIG. 5T, each application (e.g., except the specific application) would have the corresponding toggle in the “off” state (e.g., opposite to what is shown in FIG. 5T), and only the specific application would have its toggle in the “on” state. In some embodiments, when an application or other computer system software (e.g., an operating system or application framework) is configured so notifications corresponding to the application include summary content, voice narration of summary content by a digital assistant is also automatically enabled for the application.

FIGS. 6A-6X illustrate example user interfaces for displaying a group notification with summary content for application content and/or notification content for multiple related events (e.g., for content corresponding to a plurality of notifications), in accordance with some embodiments.

The user interface 5000 shown in FIG. 6A is analogous to that shown in FIG. 5B, and includes multiple individual notifications with non-summarized notification content, such as the notification 5012 for the application M (e.g., an email application), the notification 5014 for the application T (e.g., a restaurant reservation application), the notification 5016 for the application H (e.g., a health application), the notification 5018 for the application A (e.g., an airline application), and the notification 5020 for a notification N (e.g., a news application).

The user interface 5000 shown in FIG. 6B is analogous to that shown in FIG. 5C, and includes individual non-summarized notification(s), and notification summaries (e.g., also referred to “summaries”) that include summarized application content and/or summarized notification content. The user interface 5000 shown in FIG. 6B is an alternative to that shown in FIG. 6A, for embodiments that enables automatic summarization of notifications, in accordance with some embodiments. As shown in FIG. 6B, some notifications in the user interface 5000 are summaries (e.g., summary 5024, summary 5026, and summary 5028) have summarized content that is generated based at least in part on the application content corresponding to the events that triggered the notifications. Some notification(s) are non-summarized notifications (e.g., notification 5016) that have notification content that is entirely included in the application content corresponding to the event(s) that triggered the notification(s). The summary 5024 and the summary 5028 are described in greater detail above, with reference to FIGS. 5A-5H. The summary 5024 and the summary 5028 are examples of a summary that corresponds to an individual event, while the summary 5026 is an example of a summary that corresponds to multiple related events. In some embodiments, individual events are related based on various sets of criteria, e.g., corresponding to the same or related applications, same or related people, same or related sources, same or related topic(s), and/or same or related events based on the current context.

In some embodiments, the summary 5026 includes summary content corresponding to multiple events and/or multiple notifications (e.g., and optionally, across different applications, sources, and/or people). In some embodiments, the multiple events and/or multiple notifications that are represented in the same group notification (e.g., the summary 5026) are related to one another by meeting one or more sets of relatedness criteria (e.g., sufficiently related based on application, people, topic, and/or other contextual factors). In some embodiments, the relatedness criteria that are used to group events for a group notification or group summary, change over time based on changing contextual conditions (e.g., time, location, recent events, user interaction with displayed notifications and/or summaries), interaction history with application content and/or applications, scheduled events, ongoing activities (e.g., delivery task, sports games, navigation, security monitor, and/or other subscribed live events) that are monitored by the computer system, and other contextual conditions) associated with the computer system.

In some embodiments, a group summary (e.g., the summary 5026, or another group summary) includes summary content corresponding to multiple events and/or multiple notifications that meet relevance criteria (e.g., each event and/or notification of the multiple events and/or notifications meets the relevance criteria). The events that meet the relevance criteria are grouped because they are sufficiently urgent and/or important to the user as determined based the relevance criteria. In some embodiments, the relevance criteria that are used to evaluate the importance of events change over time, based on changing contextual conditions (e.g., time, location, recent events, user interaction with displayed notifications and/or summaries), interaction history with application content and/or applications, scheduled events, ongoing activities (e.g., delivery task, sports games, navigation, security monitor, and/or other subscribed live events) that are monitored by the computer system, and other contextual conditions) associated with the computer system.

In some embodiments, the summary 5026 includes summary content that is context-based. For example, in a first context (e.g., on a first day, a first date, a first time, and/or at a first location), the summary 5026 includes first summary content (e.g., corresponding to a first set of notifications (e.g., identified based on a first set of relatedness criteria) that have been summarized). In a second context (e.g., a different context, such as a second day, a second date, a second time, and/or a second location), the summary 5026 includes second summary content that is different from the first summary content (e.g., corresponding to a second set of notifications that have been summarized). In some embodiments, the second summary content differs from the first summary content, because the second summary content summarizes content corresponding to a different set of notifications (e.g., identified based on a second set of relatedness criteria, different from the first set of relatedness criteria). In some embodiments, the second summary content corresponds to the same set of notifications as the first summary content, but the content (e.g., the underlying logic that controls how the content is generated and/or summarized) is different (e.g., differ in topical emphasis, level of brevity, topical breadth, language style, and/or other aspects of content) between the first context and the second context.

In some embodiments, the summary 5026 includes a visual indicator (e.g., a badge with the number “3” on the application icon “S”, as shown in FIG. 6B, or another visual indication) which indicates that the summary 5026 includes summary content corresponding to multiple notifications (e.g., and optionally, a visual indicator of how many notifications the summary content in the summary 5026 corresponds to (e.g., the badge “3” indicates that the summary 5026 corresponds to three events and/or three notifications)). In some embodiments, a summary that includes summary content corresponding to a single event and/or notification (e.g., the summary 5024 and the summary 5028) does not include this visual indicator (e.g., there is no badge on the application icon “M” in the summary 5024, or the application icon “N” in the summary 5028). In some embodiments, the summary content in a group notification or group summary 5026 is automatically generated, optionally, using a machine learning technique (e.g., a machine learning model, a large language mode, an artificial intelligence model, or any other suitable machine learning technique techniques (e.g., using an AI process or generative AI process)) based on the application content and/or notification content for a group of related events and/or a group of related individual notifications.

In some embodiments, the summary 5026 (e.g., and/or other summaries) includes a time indicator (e.g., “last 30 minutes”) that indicates a time frame in which the notifications that correspond to the summary content of the summary 5026 were generated or in which events that correspond to the notifications were detected (e.g., the notification 5018 is the oldest notification corresponding to the summary content of the summary 5026, and was generated/delivered 25 minutes ago, so the computer system 100 rounds the time indicator to “last 30 minutes.”). In some embodiments, the time indicator of a summary is a specific time (e.g., “2 minutes ago,” as shown in the summary 5024, corresponding to a timestamp for the most recently generated notification (e.g., if the summary 5024 also corresponded to multiple related events and/or notifications) or the only notification corresponding to the summary content of the summary 5024 (e.g., a timestamp corresponding to the most recently generated notification summarized in the summary 5024).

In some embodiments, a summary corresponding to an event or a group of events (e.g., the summary 5024, the summary 5026, the summary 5028, and/or other summaries) includes a visual indication (e.g., a bolded outline, a triangular indicator, and/or an asterisk in the upper right corner) that is not included in regular notifications (e.g., non-summarized notifications, such as the notification 5016), to indicate that the summary includes summary content that is not included in the application content and/or notification content that correspond to the event or group of events.

In FIG. 6C, in response to detecting a user input 6000 (e.g., a tap input, an air tap, an air pinch, a click input, or other types of selection input or an input that meets an input threshold) directed to the summary 5026 (e.g., as shown in FIG. 6B), the computer system 100 displays an expanded view of the summary 5026 (e.g., as shown in FIG. 6C). The expanded view of the summary 5026 concurrently displays the summary content (e.g., the same summary content that was displayed in the summary 5026 in FIG. 5B) with one or more (e.g., a subset, or all) of the notifications that correspond to the summary content. In some embodiments, due to space constraint, representations of individual notifications in the expanded view of the summary 5026 are scrollable, and not all of the representations of the individual notifications are concurrently visible in the expanded view of the summary 5026. In some embodiments, the expanded view of the summary 5026 includes a close affordance 6004, which when activated, collapses the expanded view of the summary 5026 back to the view of the summary 5026 as shown in FIG. 6B (e.g., a default and/or unexpanded view of the summary 5026).

As an example, the summary content of the summary 5026 includes content for three notifications 5012, 5014 and 5018; and as shown in FIG. 6C, representations of all three notifications (e.g., the notification 5012, the notification 5014, and the notification 5018) are included in the expanded view of the summary 5026, in accordance with some embodiments.

In some embodiments, the expanded view of the summary 5026 displays a group summary for the notification 5012, the notification 5014, and/or the notification 5018 (e.g., in place of and/or in addition to the notification 5012, the notification 5014, and/or the notification 5018). In some embodiments, the expanded view of the summary 5026 includes an individual summary for each notification that is included in (e.g., and/or corresponds to) the summary 5026. In some embodiments, the individual summaries are displayed in addition to (e.g., and concurrently with) the summary content of the summary 5026). For example, an individual summary for the notification 5012 would be analogous to the summary 5024 in FIG. 5C (e.g., a summary that corresponds to a single notification 5012), and the summary 5024 in FIG. 5C (e.g., or an analogous summary) would be displayed in place of the notification 5012 in FIG. 6C (e.g., or the expanded view of the summary 5024 would be displayed in place of the notification 5012 in FIG. 6C), in accordance with some embodiments. The descriptions of interaction behaviors and other characteristics of a summary for an individual event (e.g., the summary 5024) within an expanded view of a group summary (e.g., the expanded view of the summary 5026) are similarly applicable to a summary for an individual event (e.g., the summary 5024) that is not part of a group summary, and are not repeated herein in the interest of brevity.

In some embodiments, the group of two or more notifications that correspond to the summary content of a group summary are displayed in the expanded view of the group summary in accordance with a default order (e.g., the order in which the notifications would have been displayed if the group summary (e.g., the group summary 5024) were not displayed, such as the order shown in FIG. 6A). In some embodiments, this default order is a reverse temporal order of the notifications.

FIG. 6D is an alternative to FIG. 6C, and shows that in some embodiments, the group of two or more notifications that correspond to the summary content are displayed in a different (e.g., custom or non-default) order (e.g., an order that is different than order in which the notifications would have been displayed if the summary 5024 were not displayed, such as the order shown in FIG. 6A). In some embodiments, this different order is a priority order (e.g., based on an imputed importance, relevance, or other criteria for prioritizing and/or ordering display of notifications that are not based on static properties (e.g., a chronological order or an alphabetical order). In some embodiments, the priority order is determined based at least in part on the application content included in the two or more notifications and/or application content corresponding to the events of the two or more notifications. In some embodiments, the priority order is determined based at least in part on the applications that generate or otherwise correspond to the two or more notifications. In some embodiments, the priority order is determined based at least in part on a sender and/or people associated with the two or more notifications.

FIGS. 6E-6F show another scenario alternative to that shown in FIG. 6C, where the summary 5026 correspond to a group of related events and/or a group of related notifications, but not all events and/or notifications included in the group are represented in the summary content of the summary 5026. In this example, the group of related notifications corresponding to the summary 5026 includes both summarized and un-summarized notifications (e.g., the expanded view of the summary 5026 includes both notifications that correspond to the summary content, and notifications that do not correspond to (e.g., are not included in) the summary content, of the summary 5026). In FIG. 6E, the expanded view of the summary 5026 includes the notification 5012, the notification 5014, and the notification 5018 (e.g., the same notifications that also appear in FIG. 6C, and the three notifications that correspond to the summary content of the summary 5026); and the expanded view of the summary 5026 also includes one or more additional notifications (e.g., a notification 6006) that is not represented (e.g., summarized) in the summary content of the summary 5026, but is nonetheless sufficiently related to (e.g., based on the relatedness criteria used to group the notifications for a single group summary) the notifications that are represented in the summary content of the summary 5026.

In some embodiments, the notification 6006 is not included in the summary content of the summary 5026 because the computer system 100 determines that the notification 6006 is not sufficiently high priority (e.g., based on one or more of: analysis of the content of the notification 6006; the application, source, or sender corresponding to the notification 6006; and/or the amount of time that has elapsed since the notification 6006 was generated or delivered). For example, the computer system 100 analyzes the content of the notification 6006 and determines that the availability of wine for purchase does not rise to the same priority level as a work-related email (e.g., the requires action on the part of the user of the computer system 100), or notifications with concrete timelines (e.g., in the near future and/or within a threshold amount of time from the current date), such as the notification 5012, the notification 5014, and/or the notification 5018. In some embodiments, if as the relevance criteria change over time due to change of contextual conditions, the summary content of the summary 5026 may be updated to represent the notification 6006, while the relevance of the notification 5018 (e.g., regarding flight status) diminishes and ceases to be represented in the summary content of the summary 5026.

In some embodiments, the expanded view of the summary 5026 includes more notifications than those that can be concurrently visible on the screen (e.g., within the user interface 5000, or within the notification display region of the user interface 5000) (e.g., due to physical dimensions of the display or the dimensions of the notification display region). In some embodiments, the user of the computer system 100 can scroll through the notifications within the expanded view of the summary 5026 (e.g., in a manner akin to navigating through multiple notifications on a lock screen such as the user interface 5000 itself).

FIG. 6F shows that, in response to detecting a user input 6008 (e.g., one or more upward swipe gestures directed to notification 5014 in the expanded view of the summary 5026, and/or another notification in the expanded view, as shown in FIG. 6E), the computer system 100 scrolls the notifications within the expanded view of the summary 5026. For example, the notification 5012 scrolls upward such that it is only partially displayed (e.g., with other portions that have been “scrolled off” the display) and another notification 6010 in the group of related notifications (e.g., which was not previously displayed in FIG. 6E) is moved into view (e.g., is “scrolled onto” the display) in the expanded view of the summary 5026.

In some embodiments, as shown in FIG. 6F, the summary content of the summary 5026 remains displayed in the expanded view of the summary 5026, with the representations of one or more individual notifications from the group of notifications corresponding to the summary 5026. In some embodiments, while scrolling through the notifications in the expanded view of the summary 5026, the notifications are “scrolled under” the summary content (e.g., the summary content denotes the upper boundary at which point notifications “scroll off” the display) (e.g., in a lower display layer, or at a greater display depth than the summary content). In some embodiments, the summary content scrolls with the notifications (e.g., summary content can also be “scrolled off” the display (e.g., before the notification 5012 is “scrolled off” the display) (e.g., in a lower display layer, or at a greater display depth than the widgets 5006, 5008 and 5010 and the time element 5004).

In some embodiments (e.g., as previously described with reference to FIG. 6D), the notifications within the expanded view of the summary 5026 are ordered by priority. For example, the notifications that correspond to the summary 5026 (e.g., “priority notifications,” such as the notification 5012, the notification 5014, and the notification 5018) are displayed at the top (e.g., with increased prominence and/or priority), while other notifications (e.g., “non-priority notifications,” such as the notification 6006 and the notification 6010, that do not correspond to the summary 5026) are displayed below (e.g., with lower prominence and/or priority). In some embodiments, multiple (or, optionally, all) notifications within the expanded view of the summary 5026 are displayed in a priority-based order (e.g., even non-priority notifications are ranked and/or ordered by priority). In some embodiments, the priority notifications are displayed in a priority-based order, while non-priority notifications are displayed in a non-priority-based order (e.g., reverse temporal order) (e.g., the computer system 100 does not determine a priority order for non-priority notifications).

FIGS. 6G-6H show another scenario alternative to that shown in FIG. 6C, where FIGS. 6G-6H shows a group summary 6012 that includes (e.g., summarizes) multiple notifications that are grouped based on a corresponding user, sender, and/or contact. In FIG. 6G, the group summary 6012 is analogous to the group summary 5026, but includes a different set of notifications, and includes summary content for the different set of notifications (e.g., as compared to the summary 5026). In this example, the summary 6012 in FIG. 6G includes different summary content than the summary 5026 in FIG. 6C (e.g., because the summary 6012 includes summary content corresponding to a different set of notifications from those in the summary 5026 of FIG. 5C), but the summary 6012 is otherwise analogous to the summary 5026 (e.g., both summaries have a bolded outline, a time indication, a triangular indicator, and a badge indicating the number of notifications that are summarized and/or that are included in the group).

In FIG. 6H, in response to detecting a user input 6014 (e.g., a tap gesture, an air tap gesture, an air pinch gesture, a click input, or another type of selection input, or an input that meets an input threshold) directed to the summary 6012 (e.g., as shown in FIG. 6G), the computer system 100 displays an expanded view of the summary 6012 (e.g., as shown in FIG. 6H). The expanded view of the summary 6012 includes a notification 6018 (e.g., corresponding to a missed call event generated by a phone application “P”), the notification 5012 (e.g., the same notification 5012 described above with reference to FIGS. 6A-6F, and corresponding to a new mail event generated by an email application “M”), and a notification 6020 (e.g., corresponding to a new message event generated by a messaging application “m”). In some embodiments, the notification 6018, the notification 5012, and the notification 6020 are all notifications generated for a specific other user Jane Doe (e.g., the notification 6018 indicates a missed phone call from Jane Doe, the notification 5012 includes email content sent from Jane Doe, and the notification 6020 includes messaging content sent from Jane Doe), and are thereby related in accordance with a set of relatedness criteria based on associated people or senders for the events. In some embodiments, the notifications in the summary 6012 are ordered by priority (e.g., the notification 5012 is the oldest notification of the three summarized notifications, but appears second in the list due to a higher priority based on its content relevance). In some embodiments, the expanded view of the summary 6012 includes a close affordance 6022 (e.g., which when activated, collapses the expanded view of the summary 6012 back to the default or normal view of the summary 6012, shown in FIG. 6G).

FIGS. 6I-6J show a group summary 6024 that includes (e.g., summarizes) multiple notifications that are grouped based on a corresponding topic and/or subject matter in their content. In FIG. 6I, the summary 6024 is analogous to the summary 5028 (e.g., shown in FIG. 6B), but shows that in some embodiments, a summary (e.g., the summary 6024) includes a visual indication of applications corresponding to the notifications that are summarized in the summary (e.g., the summary 6024 includes application icons that identify applications for which notifications are summarized in the summary 6024). In some embodiments, a group summary (e.g., the summary 6024 or another group summary) can summarize notification content across multiple applications (e.g., notifications from multiple applications are summarized and/or correspond to summary content for the summary 6024). For example, new applications N, Y, and Z all generate notifications relating to respective news articles that cover the same topic relating to a spacecraft carrying samples back to Earth. Even if notifications for the applications Y, N, and Z would not normally be grouped together because they are generated for events from different applications, if content-based relatedness criteria are enabled to group events and/or notifications across applications based on content topic, then content from notifications corresponding to the news applications N, Y, and Z may be combined into the same summary (e.g., the summary 6024) in some contexts (e.g., there are news articles for each of the applications that correspond to the same and/or related topic).

In FIG. 6J, in response to detecting a user input 6028 (e.g., a tap input, an air tap gesture, an air pinch gesture, a click input, or another type of selection input, or an input that meets an input threshold) directed to the summary 6024 (e.g., as shown in FIG. 6I), the computer system displays an expanded view of the summary 6024. The expanded view of the summary 6024 includes a notification 6032 (e.g., corresponding to an event generated by a news application “Y”), the notification 5020 (e.g., corresponding to an event generated by the news application “N”, and as shown in FIG. 6A), and a notification 6034 (e.g., corresponding to an event generated by a news application “Z”). The application icons of the notification 6032, the notification 5020, and the notification 6034 correspond to the visual indication of content for the summary 6024 (e.g., content from the applications “Y”, “N” and “Z”), shown in FIG. 6I.

FIGS. 6K-6P show an alternative scenario to that of FIG. 6C, and show a group summary 6038 that includes (e.g., summarizes) multiple notifications that are grouped by a corresponding application of the events that triggered the notifications. In FIG. 6K, the summary 6038 summarizes multiple notifications generated for a doorbell application “C”. In some embodiments, the user can configure the computer system 100 (e.g., via a settings user interface) to specify one or more applications for which notifications should be grouped and summarized based on application (e.g., the specified one or more applications have group summaries enabled, and the computer system 100 will display summaries corresponding to the specified one or more applications, as shown in FIGS. 6K-6P). In some embodiments, if multiple applications are enabled to group and summarize notifications, each enabled application displays a distinct summary (e.g., a summary analogous to the summary 6038 in FIGS. 6K-6P). In some embodiments, the computer system 100 displays the summary 6038 in accordance with a determination that the computer system is configured to enable summaries for a specific application (e.g., the doorbell application “C” that corresponds to the summary 6038) and that the notifications (e.g., the notification 6044, the notification 6046, the notification 6048, and/or the notification 6050) summarized in the summary 6038 meet relevance criteria (e.g., the notifications 6044, 6046, 6048, and 6050 meet the relevance criteria because they correspond to the same doorbell application “C”, and the notifications were all generated within a threshold amount of time (e.g., the last 2 hours)).

In FIG. 6L, in response to detecting a user input 6040 (e.g., a tap input, an air tap, an air pinch, a click input, or another type of selection input, or an input that meets a first input threshold) directed to the summary 6038 (e.g., as shown in FIG. 6K), the computer system 100 displays an expanded view of the summary 6038 that concurrently displays summary content of the summary 6038 with a notification 6044, a notification 6046, a notification 6048, and a notification 6050 that are included in the group of notifications corresponding to the summary 6038.

In some embodiments, the summary 6038 removes redundancies from similar and/or repeated notifications in the group of notifications corresponding to the summary 6038. For example, the notification 6044, the notification 6048, and the notification 6050 all provide the same or substantially identical notification content (e.g., that an animal was detected). Instead of repeating this content three times in the summary content of the summary 6038, the computer system 100 displays that “several animals were detected” (e.g., simplifying and/or removing the redundancy from repeated animal detections by the doorbell).

FIG. 6M shows that, after some time has passed (e.g., the current time is now 1:39 in FIG. 6M, as compared to the earlier time of 9:26 in FIG. 6L), the summary 6038 is automatically updated by the computer system (e.g., the updated summary is shown when the user interface 5000 is displayed at the current time of 1:39, optionally, after the user interface 5000 was dismissed after the previous time that the user interface 5000 had been displayed (e.g., at 9:26 in FIG. 6L). In some embodiments, a summary ceases to indicate (e.g., via a badge or other visual indication) and/or to summarize content of an event that is no longer contextually relevant (e.g., is too old and/or occurred beyond a threshold amount of time ago), even if the event, optionally, remains in the group of events corresponding to the summary. For example, in FIG. 6M, the summary 6038 summarizes only two notifications from the doorbell application C (e.g., as shown by the badge indicating “2”), and the summary content reports that a “person and an animal were detected” (e.g., instead of “a person and several animals were detected” as in FIGS. 6K and 6L).

In some embodiments, a user can configure a maximum time period for which notifications are summarized in a summary (e.g., in FIG. 6M, the user specifies a maximum duration of 2 hours, and the computer system 100 summarizes content for notifications received and/or generated within the last 2 hours).

In FIG. 6N, in response to detecting a user input 6054 (e.g., a tap input, an air tap, an air pinch, a click input, or another type of selection input, or an input that meets a first input threshold) directed to the summary 6038 (e.g., as shown in FIG. 6M), the computer system 100 displays an expanded view of the summary 6038. In some embodiments, the expanded view of the summary 6038 displays additional notifications (e.g., even notifications that are not summarized and/or do not correspond to summary content for the summary 6038). For example, a notification 6060 and a notification 6044 (e.g., old/older notifications reporting that an animal was detected) are not summarized in the summary content of the summary 6038, but are, optionally, displayed in the expanded view of the summary 6038, because they are related to (e.g., by meeting the relatedness criteria with respect to) the notifications that are summarized by the summary content of the summary 6038, and therefore are included in the group of notifications corresponding to the summary 6038. In some embodiments, all notifications corresponding to the doorbell application C are displayed in the expanded view of the summary 6038 (e.g., but only some of those notifications are summarized in the summary content). In some embodiments, some (e.g., but not all) notifications corresponding to the doorbell application “C” are displayed in the expanded view of the summary 6038 (e.g., following the same criteria used to determine whether or not a notification would be displayed on a lock screen such as the user interface 5000 (e.g., based on settings of various notification delivery modes, such as a focus mode, a DND mode, or another active notification delivery mode with notification suppression and notification breakthrough conditions), if no summary for notifications for the doorbell application C were displayed). In some embodiments, only notifications corresponding to (e.g., summarized by) the summary content of the summary 6038 are displayed (e.g., the notification 6060 and the notification 6044 are not displayed, as indicated by the dotted outlines in FIG. 6N).

In FIG. 6O, more time has passed (e.g., now the current time is 4:08), and the summary 6038 updates based on changes in context of the computer system (e.g., the passage of time, or other changes that affect the relevance of notifications). In FIG. 6O, the summary 6038 now indicates that seven notifications are summarized in the summary 6038 (e.g., in accordance with some embodiments) or that seven notifications are included in the group of related notifications corresponding to the summary 6038 (e.g., in accordance with some other embodiments). In the updated summary 6038, additional notifications are summarized, and/or a new set of notifications are summarized), and the summary content of the updated summary 6038 mentions that “two people were detected and a package was delivered.” In some embodiments, the computer system 100 automatically determines whether some notifications should no longer be summarized (e.g., removed from the group of related notifications corresponding to the summary, or remaining in the group but their notification content is no longer used to generate the summary content and/or is not reflected in the summary content). For example, in FIGS. 6M and 6N, the summary 6038 initially includes summary content corresponding to and/or summarizing notifications reporting that an animal was detected (e.g., because no higher priority notifications have been received). In FIG. 6O, a high priority notification relating to a package delivery is received, and the summary 6038 is updated to include content corresponding to and/or summarizing the high priority notification, while specifics of the content corresponding to the low priority notifications relating to detection of an animal is no longer included in the summary content of the summary 6038 (e.g., the low priority notifications are merely mentioned in the summary content as part of the “7 motion alerts”).

In FIG. 6P, in response to detecting a user input 6062 (e.g., a tap input, an air tap gesture, an air pinch gesture, a click input, or another type of selection input, or an input that meets a first input threshold) directed to the summary 6038 (e.g., as shown in FIG. 6O), the computer system 100 displays an expanded view of the summary 6308, which includes a notification 6064, a notification 6066, a notification 6068, and a notification 6070. FIG. 6P shows an embodiment where a notification (e.g., the notification 6066) is included in the expanded view of the summary 6038, even though that notification is not summarized (e.g., the summary content of the summary 6038 does not mention detection of animals) (e.g., the badge with the number “7” reflects the total number of related notifications in the group corresponding to the summary 6038, but only a subset of the more recent or relevant notifications from the group contributed to the summary content of the summary 6038), in accordance with some embodiments.

FIGS. 6Q-6X show a summary 6072 (e.g., an expanded view of the summary 6072) and a summary 6078. In some embodiments, the summary 6078 is an alternative view of the summary 6072. In FIGS. 6Q-6X, several related notifications are generated and received within a short time frame, and the device 100 organizes and displays these related notifications in a manner that provides one or more status updates over an extended period of time (e.g., provides a current status and/or the current status relative to an expected timeline of events).

In FIG. 6Q, the expanded view of the summary 6072 includes two notifications (e.g., corresponding to two related notifications for a grocery delivery application “G”), a notification 6074 and a notification 6076. The notification 6076 indicates that a grocery order was received, and the notifications 6074 indicates that a shopper is picking out items (e.g., to fulfill the order mentioned in the notifications 6076). Summary content of the expanded view of the summary 6072 indicates that two notifications (e.g., alerts) have been generated and/or are included in the summary 6072. In some embodiments, the summary content of the expanded view of the summary 6072 indicates the current status and/or most recent event out of the generated and/or summarized notifications. In some embodiments, the summary content of the expanded view of the summary 6072 does not include content corresponding to older notifications of the related notifications (e.g., because events that occurred before the current status and/or most recent event are no longer priority content that provides useful information to the user of the computer system 100).

FIG. 6R shows the summary 6078, which is an alternative appearance for the summary 6072 in FIG. 6Q. In contrast to the expanded view of the summary 6072 in FIG. 6Q, the summary 6078 does not display the notifications 6074 and the notification 6076 (e.g., the notifications that are summarized and/or correspond to summary content displayed in the summary 6078). The summary 6078 displays status information (e.g., in a timeline form), which provides the current status (e.g., “Shopping”) for the grocery order, historical timeline information (e.g., “Order Received” indicates that the previous event was that the user's order was received), and future timeline information (e.g., “On The Way” to indicate that the shopper is en route to deliver the user's grocery order). In some embodiments, the future timeline information is received from the grocery delivery application “G” (e.g., the grocery delivery application “G” provides a possible list of notifications and/or statuses that are sent over the course of a grocery delivery, and specifies the order in which the possible notifications and/or statuses appear (e.g., in a timeline or event sequence)). In some embodiments, the computer system 100 predicts the future timeline information (e.g., based on previously generated, received, and/or summarized notifications for the grocery delivery application “G” and/or similar or related applications; and/or based off a data set of notifications (e.g., including notifications from a large number of users, rather than just the individual user of the computer system 100)), optionally, without having received any specific information from the grocery delivery application “G” regarding possible future notifications and/or statuses.

In some embodiments, the user of the computer system 100 can interact with the summary 6078 via a user input (e.g., via a tap input, an air tap gesture, an air pinch gesture, a click input, or another type of selection input, or an input that meets a first input threshold). In some embodiments, in response to detecting the user input, the computer system 100 displays an expanded view similar to the one in FIG. 6Q (e.g., the summary 6078 expands to also show the notification 6074 and the notification 6076 below the summary content shown in FIG. 6R). In some embodiments, in response to detecting the user input, the computer system 100 launches, opens, and/or displays a user interface corresponding to the grocery delivery application G (e.g., as though the summary 6078 is a regular notification for an event corresponding to the grocery delivery application “G”).

In FIGS. 6S and 6T, the current time is now 9:39, and several new related notifications have been generated, received, and/or summarized. In FIG. 6S, a notification 6080 and a notifications 6082, have been generated and/or received (e.g., after the time 9:26 in FIGS. 6Q and 6R). The computer system 100 includes these two new notifications in the expanded view of the summary 6072 (e.g., and optionally updates the visual indicator to display a badge with the number “4,” indicating the total number of related notifications and/or events that have occurred for this grocery delivery order). The summary content of the summary 6072 is also updated to reflect the content of the new notifications. For example, the most recent event (e.g., based on the most recent notification 6080) is that the shopper is on the way to deliver the grocery order, so the summary content of the summary 6072 includes content that indicates the “shopper picked up your items and your order is on the way.” In some embodiments, the summary content of the summary 6072 does not include previous statuses and/or previous events (e.g., the summary content does not include content corresponding to the notification 6082, indicating and/or mentioning that the shopper has checked out). In some embodiments, the updates shown in FIG. 6S are displayed while the expanded view of the summary 6072 remains displayed from the time shown in FIG. 6Q to the time shown in FIG. 6S. Similarly, in some embodiments, the updates shown in FIG. 6T are displayed while the summary 6078 remains displayed from the time shown in FIG. 6Q to the time shown in FIG. 6S. In some embodiments, the updates shown in FIG. 6S are displayed when the user interface 5000 was dismissed and redisplayed at a later time after the new events have occurred. In some embodiments, the updates shown in FIG. 6T are displayed when the user interface 5000 was dismissed and redisplayed at a later time after the new events have occurred.

In FIG. 6T, the summary 6078 (e.g., the alternative appearance of the expanded view of the summary 6072 in FIG. 6S) updates to reflect the new notifications (e.g., the notification 6080 and the notification 6082 in FIG. 6S). For example, the summary content of the summary 6078 indicates now that there are 4 grocery alerts (e.g., 4 related notifications have been generated, received, and/or summarized for the grocery delivery application G). The summary content of the summary 6078 also indicates the current status of the order, which is that the “order is on the way.” In some embodiments, the timeline information included in the summary content of the summary 6078 omits some information (e.g., low priority and/or less important information). For example, there is no timeline information and/or step relating to the shopper checking out (e.g., directly corresponding to the notification 6082), optionally, because the computer system 100 determines that this information is not relevant and/or does not provide useful information to the user of the computer system 100 (e.g., the expectation is that the shopper will immediately begin driving to deliver the user's order, after the shopper checks out, such that reporting a status of “Checked Out” (e.g., or similar status) would be redundant with and/or less useful than, the status of “On The Way” (e.g., as shown in FIG. 6T)).

In FIGS. 6U and 6V, the current time is now 9:59, and a new notification 6084 has been generated, received, and/or summarized. In FIG. 6U, the expanded view of the summary 6072 shows the new notification 6084 that indicates that the order was delivered. The computer system 100 updates the visual indicator of the summary 6072 (e.g., the badge shows “5” notifications are included in the summary 6072), and updates the summary content to include the most recent status that the “order was delivered.”

In FIG. 6V, the summary 6078 (e.g., the alternative appearance of the expanded view of the summary 6072 in FIG. 6S) updates to reflect the new notification 6084. For example, the summary content of the summary 6078 indicates that “5 grocery alerts” have been generated, received, and/or summarized; the summary content also indicates the current status that the “order was delivered at 9:59 AM;” and the timeline information is updated to show that the end of the timeline (e.g., with a status and/or step of “Delivered”) has been reached.

FIGS. 6W-6X show that in some embodiments, a summary can be automatically “cleared” (e.g., ceases to be displayed, dismissed, and/or sent to notification history) when a particular notification (e.g., notifications of a particular type and/or containing particular content) is received.

In FIG. 6W, a notification 6086 is received, which indicates that the grocery order was delivered and that the order is complete. In response to receiving the notification 6086, the computer system 100 ceases to display the summary 6072 and/or the summary 6078 (e.g., the computer system 100 ceases to display a summary and/or summaries corresponding to the specific grocery order referenced by the notification 6086). In some embodiments, the summary 6072 and/or the summary 6078 is replaced by the notification 6086 (e.g., the notifications 6086 “clears” the summary 6078 and/or the summary 6078). In some embodiments, the notification 6086 is a notification for an event from the application for which the summary 6072 and/or the summary 6078 provided summarized notification content (e.g., the notification 6086 corresponds to the grocery delivery application “G” for which the summary 6072 and 6078 provided summarized notification content). In some embodiments, only notifications for a specific application can “clear” a summary (e.g., a summary that provided summarizes notification content for notifications of that specific application).

FIG. 6X shows an alternative to FIG. 6W, where a notification 6088 corresponding to the doorbell application “C” (e.g., an application that is different than the grocery delivery application “G” corresponding to the notifications summarized by the summary 6072 and/or the summary 6078) is received, and indicates that a package was detected (e.g., the detected package being the groceries for the grocery order). In response to receiving the notification 6088, the computer system 100 ceases to display the summary 6072 and/or the summary 6078 (e.g., and/or replaces display of the summary 6072 and/or the summary 6078 with display of the notification 6088). In some embodiments, the notification 6088 is a notification for a related application for which the summary 6072 and/or the summary 6078 provided notification summary content (e.g., the notification 6088 corresponds to the doorbell application “C”, which is capable of generating alerts regarding detection of a grocery delivery (e.g., via the grocery delivery application “G”)). In some embodiments, an application (e.g., the grocery delivery application “G” and/or the doorbell application “C”) can specify and/or identify its related applications. In some embodiments, the computer system 100 automatically determines related applications based on context (e.g., the computer system 100 determines that a package detected by the doorbell application is the grocery delivery being summarized and/or tracked by the summary 6072 and/or the summary 6078, e.g., in accordance with machine learning, and/or generative artificial intelligence processes and/or models).

FIGS. 7A-7O illustrate example user interfaces for delivering and/or suppressing notifications based on criteria based on notification type (e.g., properties of notifications other than their content, such as sender, application, and/or event time) and/or criteria based on notification content (e.g., content body as evaluated for relevance to a user in the current context, based on artificial intelligence and/or large language models), in accordance with some embodiments.

FIGS. 7A-7C show side-by-side comparisons of the user interface 5000 with different notification delivery modes (e.g., different degrees and/or settings relating to) in which whether a notification is delivered (e.g., displayed on the user interface 5000, or available to be displayed on the user interface 5000, and/or otherwise outputted to one or more output generation components) depends on an evaluation of the notification content of the notification based on a set of relevance criteria.

FIG. 7A shows an embodiment where no filtering (e.g., no suppression of notification delivery based on notification type (e.g., types based on properties of notifications other than the content of the notifications)) occurs (e.g., all notifications are delivered by the computer system 100). The user interface 5000 includes the notification 6018 (e.g., the same notification 6018 shown in FIG. 6H, corresponding to a missed call event from the phone application “P”), the notification 5012 (e.g., the same notification 5012 shown in earlier figures, such as in FIGS. 5B and 6A, corresponding to a new message event from the email application “M”), the notification 5014 (e.g., the same notification 5014 shown in earlier figures, such as in FIGS. 5B and 6A, corresponding to a confirmation event from the restaurant reservation application “T”), the notification 5018 (e.g., the same notification 5018 shown in earlier figures, such as in FIGS. 5B and 6A, corresponding to a flight status update event from the airline application “A”), the notification 5020 (e.g., the same notification 5020 shown in earlier figures, such as in FIGS. 5B and 6A, corresponding to a news event from the new application “N”), and the notification 6026 (e.g., the same notification 6026 shown in FIG. 6I, corresponding to a new message event from the messaging application “m”).

In some embodiments, notifications from the same application are grouped or coalesced together (e.g., are displayed in a stack, optionally with one notification from the group as a representative notification for the whole group), and optionally, the computer system 100 displays a visual indicator for grouped notifications. For example, a visual indicator 7000 (e.g., a tab or an indication of additional layers of notifications in a stack) displayed adjacent to the notification 5012 in FIG. 7A indicates an additional notification for the email application “M” is grouped with the notification 5012. In some embodiments, the computer system 100 provides an indication corresponding to the number of notifications that are grouped together. For example, the single visual indicator (e.g., the visual indicator 7000) displayed with the notification 5012 indicates that a single (e.g., additional) notification is grouped with the notification 5012. In contrast, two visual indicators (e.g., a visual indicator 7002 and a visual indicator 7004) are displayed with the notification 6026, indicating that at least two notifications are grouped with the notification 6026. In some embodiments, the computer system 100 displays up to a maximum number of visual indicators (e.g., a maximum of two visual indicators, as shown grouped with the notification 6026), even if there are more than two notifications grouped with the notification 6026 (e.g., to preserve space within the user interface 5000).

In some embodiments, to indicate that additional notifications are available (e.g., but not currently displayed and/or not fully displayed, due to limitations of the physical size of the display of the computer system 100 or the size of the notification display region in the user interface 5000), one or more notifications within the user interface 5000 are displayed with a different size and/or appearance (e.g., with progressively reduced sizes when displayed at and/or near the bottom of the user interface 5000). In some embodiments, one or more notifications are displayed (e.g., partially displayed) below or with less visual prominence than another notification (e.g., or other notifications). For example, the notification 6026 has a different visual appearance (e.g., is smaller in width as compared to the notification 5020 above it), and is displayed partially underneath the notification 5020. This indicates that additional notifications (e.g., such as the notification 6026) are available for display (e.g., but do not fit within the user interface 5000). In some embodiments, the additional notifications are displayed in response to detecting a user input (e.g., a scroll input (e.g., a swipe gesture, a pinch and drag gesture, a click and drag input on a scroll bar, or another type of scroll input) directed to the user interface 5000 or the notification display region in the user interface 5000).

FIG. 7B shows an embodiment with a first level of filtering. In some embodiments, the first level of filtering is based on properties of notifications other than notification content. In some embodiments, the properties that are used to filter notifications are specified in a notification delivery setting of the computer system, and is optionally associated with a mode of the computer system that can be activated or deactivated based on contextual conditions (e.g., time of day (e.g., morning, night, dinner time, business hours, or family time), date (e.g., work days, holidays, or vocation days), day of the week (e.g., weekends, weekdays, school days, days off), motion pattern (e.g., jogging, in a vehicle, in public transportation, or driving) and/or location (e.g., home, office, park, hotel, or hospital) of the computer system). Based on (e.g., in accordance with) the notification delivery settings of the computer system 100, the notification 5014, the notification 5020, and the notification 7098 are not displayed, are suppressed, and/or “filtered out” (e.g., as compared to FIG. 7A, where no filtering is in effect and/or applied). With the exception of the notification 5014 and the notification 7098, the user interface 5000 in FIG. 7B includes the same notifications as the user interface 5000 in FIG. 7A. In FIG. 7B, for example, notifications are filtered based on application (e.g., notifications for some applications are explicitly permitted when notifications for all other applications are suppressed (e.g., notification breakthrough based on application); or notifications for some applications are explicitly suppressed, while notifications for other applications are permitted (e.g., notification suppression based on application)), and notifications for the application “T,” the application “N,” and the application “H” are filtered out (e.g., are not displayed).

In some embodiments, different criteria can be used to set up an appropriate level of filtering. For example, the computer system 100 can be configured to filter notifications (e.g., either as reasons for suppressing the notifications or as reasons to break through the suppressions) by application, by user, and/or by content. In some embodiments, the first level of filtering corresponds to a first mode (e.g., focus mode, activity mode, Do Not Disturb mode, or other suitable modes) of the computer system 100. In some embodiments, the first level of filtering corresponds to a mode in which a first set of baseline notification suppression criteria is modified or superseded by a first set of breakthrough conditions, where the baseline notification suppression criteria and the breakthrough conditions are both based on properties of the notifications (e.g., static properties such as associated application, sender, source, keyword in subject line or title of message, time of receipt, size, file type, metadata, or other fixed properties that are common across multiple of notifications) other than relevance of the content of the notifications (e.g., relevance to the user, that is dynamically determined by artificial intelligence and/or changing contextual conditions based on at least in part on the main content of the notification (as opposed to fixed keywords in a subject line or based on the metadata associated with the content of the notification)). In some embodiments, the first level of filtering corresponds to a mode in which a second set of baseline notification delivery (e.g., as opposed to suppression) criteria is modified or superseded by a second set of suppression conditions, where the baseline notification delivery criteria and the suppression conditions are both based on properties of the notifications (e.g., static properties such as associated application, sender, source, keyword in subject line or title of message, time of receipt, size, file type, metadata, or other fixed properties that are common across multiple of notifications) other than relevance of the content of the notifications (e.g., relevance to the user, that is dynamically determined by artificial intelligence and/or changing contextual conditions based on at least in part on the main content of the notification (as opposed to fixed keywords in a subject line or based on the metadata associated with the content of the notification)).

In one example, as shown in FIG. 7B, the notification 5014 corresponds to a reservation confirmation from a restaurant reservation application “T,” the notification 7098 corresponds to a heart rate alert from a health application “H”, and the notification 5020 corresponds to a news event from a news app “N.” In some embodiments, the notifications 5014, 5020 and 7098 are actively suppressed because they meet the first set of baseline notification suppression criteria, and do not meet the first set of breakthrough conditions. In some embodiments, the notification 6018, the notification 5012 (and, optionally, related notification indicated by indication 7000), the notification 5018, and the notification 6026 (and related notifications indicated by indications 7002 and 7004) are delivered because they do not meet the first set of baseline notification suppression criteria, or they meet the first set of baseline notification suppression criteria but also meet the first set of breakthrough conditions. In some embodiments, the notifications 5014, 5020 and 7098 are actively suppressed because they do not meet the second set of baseline notification delivery criteria, or they meet the second set of baseline notification delivery criteria but also meet the second set of suppression conditions. In some embodiments, the notification 6018, the notification 5012 (and, optionally, related notification indicated by indication 7000), the notification 5018, and the notification 6026 (and related notifications indicated by indications 7002 and 7004) are delivered because they meet the second set of baseline notification delivery criteria and do not meet the second set of suppression conditions.

In some embodiments, the first mode is manually enabled (e.g., via a user input in a settings user interface or system configuration user interface). In some embodiments, the first mode is automatically enabled (e.g., at and/or during scheduled times, while the computer system 100 is at a particular location, and/or when any suitable contextual criteria are met). In some embodiments, the first mode is configured manually by the user specifying at least some of the first set of notification suppression criteria, and/or the first set of breakthrough conditions; or the second set of notification delivery criteria and/or the second set of suppression conditions, in a settings user interface of the computer system. In some embodiments, the first mode is preconfigured in the computer system (e.g., at least some of the first set of notification suppression criteria, and/or the first set of breakthrough conditions; or the second set of notification delivery criteria and/or the second set of suppression conditions, can be selected as a collection, as an existing primary notification mode, an existing modification option, or a combination, available in a settings user interface of the computer system. In some embodiments, the primary notification mode is a selectable mode, and the modification conditions are selectable by a user to further configure the first mode. More details of how to configure the first mode are provided with respect to FIGS. 7F-7O below.

FIG. 7C shows an embodiment with a second level of filtering (e.g., that is different than the first level of filtering). Based on (e.g., in accordance with) settings of the computer system 100, the user interface 5000 in FIG. 7C includes only the notification 5012, the grouped notification indicated by the visual indicator 7000, and the notification 6026. The embodiment in FIG. 7C corresponds to a more stringent level of filtering (e.g., filters out more notifications than that shown in FIG. 7B), and the user interface 5000 in FIG. 7C includes fewer notifications than the user interface 5000 in both FIG. 7A and FIG. 7B. In FIG. 7C, for example, all notifications are suppressed by default and only notifications that meet certain breakthrough criteria are delivered. In this example, the breakthrough criteria are based on analysis of the notification content, e.g., by one or more artificial intelligence, machine learning, and large language models and/or processes, to determine whether a notification meets a threshold level of relevance for the current context. For example, the notification 5012 is delivered because it is related to an issue in the work report that needs to be addressed very quickly. The relevance of the email from Jane Doe (corresponding to the notification 5012) is further increased by the content of the notification 6026 for the message that requests a quick call to discuss the work report. The level of relevance for the notification 5012 and the notification 6026 are above a threshold level of relevance specified by the breakthrough criteria, based on the analysis of the content of the notifications, and optionally, based on other contextual conditions.

In some embodiments, the notifications 6018, 5014, 7098, 5018, 5020 are not delivered, as shown in FIG. 7C, because they are suppressed based on a default suppression mode that suppress all notifications received, and they do not meet any breakthrough conditions (e.g., breakthrough based on specific properties of the notifications or based on the relevance of the notification content), or they are suppressed based on the low level of relevance of their notification content.

Since the breakthrough in FIG. 7C is based on content relevance, as opposed to fixed properties such as associated application or sender, notification 5012 and its related notification are delivered, notification 6026 is also delivered, but notifications from the same messaging application are not delivered because they are not related to the “work report” issue and their content does not otherwise meet the threshold hold level of relevance. In some embodiments, the computer system 100 displays a visual indicator 7008 that indicates the second level of filtering or that content-based intelligent filtering or breakthrough is currently active.

In some embodiments, the user interface 5000 includes a visual indicator 7010 that provides information relating to notification content that is suppressed. In some embodiments, the visual indicator 7010 includes one or more application icons corresponding to applications for which notifications are suppressed (e.g., not displayed). In some embodiments, the visual indicator 7010 includes one or more representations of users and/or contacts corresponding to users/contacts for which notifications are suppressed. In some embodiments, there is a maximum number of applications, users, and/or contacts that are included in the visual indicator 7010, and the visual indicator 7010 provides an indication (e.g., when appropriate) that additional content (e.g., not reflected in the included applications, user, and/or contacts) is also suppressed. For example, in FIG. 7C, the visual indicator 7010 includes application icons corresponding to the application “A”, the application “M”, the application “m,” and the application “P”. The visual indicator 7010 also includes an indication “+3 more” that indicates notifications for three more applications (e.g., beyond the application “A”, the application “M”, the application “m,” and the application “P”) are also suppressed. In some embodiments, in response to detecting a user input directed to the visual indicator 7010, the computer system 100 displays additional information corresponding to the second level of filtering (e.g., a full listing of all applications for which notifications are filtered, or other information relating to settings corresponding to the second level of filtering). It is noted that, the application “m” is included in the visual indication 7010, even though at least one notification corresponding to the application “m” has been delivered (e.g., notification 6026) for meeting content-based breakthrough conditions and/or content-based delivery criteria.

In some embodiments, the second level of filtering shown in FIG. 7C corresponds to a second mode (e.g., that is different from the first mode). In some embodiments, the first mode and the second mode are different focus modes, activity modes, or Do Not Disturb modes which modify the default notification delivery policies used in a regular mode of the computer system. In some embodiments, the second level of filtering corresponds to an optional setting of the first mode (e.g., an additional layer and/or stricter settings configuration, that can be applied to (e.g., on top of and/or in addition to) other settings of the first mode). In some embodiments, the second level of filtering corresponds to settings for selectively ignoring notification delivery settings of an active mode (e.g., the second level of filtering defines exceptions to an existing mode, such as the first mode).

In some embodiments, the first level of filtering and/or the second level of filtering corresponds to filtering (e.g., notification filtering) that is applied based on characteristics (e.g., an application corresponding to the notification; a user, sender, or source corresponding to the notification; and/or a time corresponding to an event or when the notification was generated) of notifications to which the filtering is applied. For example, when a “Do Not Disturb” mode is active for the computer system, the “Do Not Disturb” mode filters notifications based on application, user/contact, and/or a time or time frame when the “Do Not Disturb” mode is scheduled to be active. For example, the “Do Not Disturb” mode includes a “DND Breakthrough” setting that allows for some notifications based on notification characteristics, to “break through” (e.g., ignore or otherwise circumvent) other filtering that is active for the computer system 100 (e.g., active “Do Not Disturb” modes, other characteristic-based filtering modes, and/or “Intelligent Filtering” modes as described in further detail below).

In some embodiments, the second level of filtering corresponds to filtering that is applied based on content (e.g., application content corresponding to the notification content) of the notifications to which the filtering is applied). For example, the computer system 100 can be configured to apply “Intelligent Filtering,” which can filter notifications based on content (e.g., whether the content of a particular notification is determined to be relevant and/or high priority; and/or whether the content of a particular notification falls within a particular category of content). For example, the computer system 100 can be configured to apply “Intelligent Breakthrough” (e.g., as described in further detail below with reference to FIG. 7O), which allows notifications, based on notification content, to “break through” other filtering that is active for the computer system 100.

In some embodiments, the first level of filtering corresponds to filtering that applied based on characteristics of the notifications to which the filtering is applied, and the second level of filtering corresponds to filtering that is applied based on content of the notifications to which the filtering is applied. In some embodiments, characteristics-based filtering is applied first, and the result is then modified and/or overridden by the content-based intelligent filtering (e.g., suppressing one or more permitted notifications and/or allowing one or more suppressed notifications to break through). In some embodiments, content-based intelligent filtering is applied first, and the result is then modified by characteristics-based filtering (e.g., suppressing one or more permitted notifications and/or allowing one or more suppressed notifications to break through). In accordance with some embodiments, multiple combinations of characteristics-based suppression, characteristics-based permission, content-based intelligent suppression, and/or content-based intelligent suppression criteria can be applied, in accordance with multiple different priority ordering, to create different notification filtering outcomes. In some embodiments, a respective notification suppression and/or notification permission settings can be selected as a standalone mode or as a selectable modification to another mode.

FIG. 7D shows an alternative view of the user interface 5000 in FIG. 7C (e.g., while the second level of filtering, including content-based intelligent filtering (e.g., intelligent suppression and/or breakthrough), is applied). In some embodiments, as shown in FIG. 7D, the user interface 5000 includes one or more summaries (e.g., in lieu of one or more corresponding notifications). For example, while in FIG. 7C, the notification 5012 and the notification 6020 are displayed without summary content, in FIG. 7D, the computer system 100 displays the summary 5024 (e.g., the same summary 5024 shown in FIG. 5C, corresponding to and/or summarizing the notification 5012) and a summary 7012 (e.g., corresponding to and/or summarizing the notification 6020). In some embodiments, the user interface 5000 includes a summary corresponding to each notification that is delivered (e.g., notifications that would be displayed in accordance with the second level of filtering).

FIG. 7E shows an alternative view of the user interface 5000 in FIG. 7C and FIG. 7D. In some embodiments, as shown in FIG. 7E, the user interface 5000 includes one or more group summaries that correspond to and/or summarize content from respective groups of multiple related notifications (e.g., as described above with reference to FIGS. 6A-6X). For example, a summary 7014 corresponds to the notification 5012 and the notification 6020 (e.g., as shown in FIG. 7C), and includes summary content summarizing both notifications (e.g., the summary content of the summary 7014 describes that Jane Doe both emailed and messaged the user of the computer system 100 regarding the work report).

FIG. 7F shows a settings user interface 7018 for the computer system 100. In some embodiments, the settings user interface 7018 is displayed in response to detecting a user input (e.g., or a sequence of user inputs, such as an unlock user input 7015 (e.g., an upward edge swipe gesture, a hand flip air gesture, or another type of unlock input or home gesture) in FIG. 7E (which causes the computer system 100 to display the user interface shown in FIG. 4A), followed a user input (e.g., a tap input, an air tap, an air pinch gesture, a click input, or another type of selection input, or an input that meets a first input threshold) directed to icon 446 in FIG. 4A). In some embodiments, the settings user interface 7018 includes a plurality of options for configuring settings of the computer system 100. For example, the settings user interface 7018 in FIG. 7F shows selectable options for configuring network connections, such as Bluetooth connection options, cellular connection options, and/or wireless connection options. The user interface 7018 also shows some notification and alert options, such as a “Notifications” option 7020 and a “Focus” option 7022.

In some embodiments, in response to detecting a user input 7024 (e.g., a tap input, an air tap gesture, an air pinch gesture, a click input, or another type of selection input or an input that meets a first input threshold) directed to the “Notifications” option 7020, as shown in FIG. 7F, the computer system 100 displays a notifications settings user interface 7028, as shown in FIG. 7G. In some embodiments, the notifications settings user interface 7028 can be accessed through other interaction paths (e.g., through a control user interface that includes controls for various system functions, through a settings user interface for configuring a focus mode or other modes that affect notification delivery policies, and/or through options associated with a delivered notification). In some embodiments, the notifications settings user interface 7028 includes one or more options for configuring the appearance and/or layout of notifications (e.g., within the user interface 5000, or another user interface of the computer system 100 that is configured to display one or more notifications), such as options for showing delivered notifications as a count of the notifications, displaying the delivered notifications in a stack away from the central portion of the user interface 5000, or displaying the delivered notifications separately in a scrollable list. In some embodiments, the notifications settings user interface 7028 includes an “Intelligent Filtering” option 7030, for configuring one or more settings related to filtering (e.g., suppression, breakthrough, and/or permission) of notifications based on notification content (e.g., evaluated based on artificial intelligence, machine learning, and/or large language models, to determine the relevance, importance, and/or urgency of the notifications to the user). In some embodiments, in addition to the “Intelligent Filtering” option 7030, the settings user interface 7028 also includes an option for a scheduled summary, where notifications that are withheld from delivery (e.g., based on the characteristics of the notifications other than content relevance) are delivered in a scheduled summary at a preset time (e.g., “9 AM”). It is to be noted that, whether notifications will be included in the scheduled summary is not based on the content of the notifications but based on other characteristics of the notifications (e.g., timestamp, application, people, source, and/or past user interactions with notifications of similar characteristics), and optionally, contextual conditions of the computer system (e.g., active focus mode, time of day, location, and/or day of the week).

FIG. 7H shows a mode settings user interface 7034 (e.g., displayed in response to detecting a user input 7042 (e.g., a tap input, an air tap, an air pinch, a click input, or another type of selection input or an input that meets a first input threshold) directed to the “Focus” option 7022 in FIG. 7F), in accordance with some embodiments. The mode setting user interface 7034 includes one or more options for configuring a respective mode that impact notification delivery (e.g., a Do Not Disturb mode, a focus mode, a morning mode, or another mode) of the computer system 100. For example, the mode settings user interface 7034 includes options for specifying contacts (e.g., “People”) and/or applications (e.g., “Apps”) for which notifications should (e.g., or should not) be filtered (suppressed, breakthrough, and/or permitted), when the respective mode is active (e.g., automatically activated, or manually activated) for the computer system 100. The mode settings user interface 7034 also includes options for configuring an appearance of different user interfaces (e.g., a wallpaper for a lock or wake screen such as the user interface 5000), and options for automating activation (e.g., and/or deactivation) of the respective mode. In some embodiments, the mode setting user interface 7034 includes filtering options, including an “Intelligent Filtering” option 7036 and an “Intelligent Breakthrough” option 7038.

In some embodiments, the “Intelligent Filtering” option 7030 in FIG. 7G, and the “Intelligent Filtering” option 7036 in FIG. 7H, are analogous (e.g., but optionally, the “Intelligent Filtering” option 7036 configures filtering settings specifically for a particular activity or focus mode (e.g., are mode-specific settings, with settings that apply only when the particular activity or focus mode is active for the computer system 100), while the “Intelligent Filtering” option 7030 in FIG. 7G configures filtering settings that are applied more generally (e.g., are general filtering settings, which are applied at all times and/or when no activity or focus mode is active for the computer system 100). In some embodiments, mode-specific filtering settings override the general filtering settings (e.g., mode-specific filtering settings are applied when a particular mode is active, and the general filtering settings are ignored, overridden, and/or not applied). In some embodiments, mode-specific filtering settings are applied in addition to general filtering settings (e.g., mode-specific filtering settings allow for additional and/or further filtering, beyond the general filtering settings).

In response to detecting a user input 7032 selecting the “Intelligent Filtering” setting 7030 (e.g., as shown in FIG. 7G) and/or in response to detecting a user input 7040 selecting the “Intelligent filtering” option 7036 (e.g., as shown in FIG. 7H), the computer system 100 displays a settings user interface 7044 (as shown in FIG. 7I).

FIG. 7I shows the settings user interface 7044 (e.g., when no content-based intelligent filtering is currently enabled (e.g., generally (e.g., if displayed in response to selection of setting 7030 in FIG. 7G), or for a respective mode (e.g., if displayed in response to selection of option 7036 in FIG. 7F))). The settings user interface 7044 includes a “Turn on Intelligent Filtering” option 7046, and optionally provides a brief description of filtering functionality. The “Turn on Intelligent Filtering” option 7046 includes a toggle 7048 (e.g., which can toggle between an enabled and disabled states or setting for the “Turn on Intelligent Filtering” option 7046). In some embodiments, when the toggle 7048 is off and/or not enabled, no additional settings corresponding to intelligent filtering functionality are displayed.

In response to detecting a user input 7050 (e.g., a tap input, an air tap gesture, an air pinch gesture, a click input, or another type of selection input or an input that meets a first input threshold) changing the state of the toggle 7048 (e.g., toggling on the “Turn on Intelligent Filtering” option 7046) in FIG. 7I, the computer system 100 updates display of the settings user interface 7044 to display additional controls for configuring the intelligent filtering functionality of the computer system 100, and enables and/or begins filtering content in accordance with intelligent filtering settings (e.g., the configuration of settings in the settings user interface 7044). In some embodiments (e.g., the first time that “Turn on Intelligent Filtering” is toggled on), the computer system 100 begins filtering content in accordance with a default configuration for intelligent filtering settings (e.g., and optionally displays the default configuration within the settings user interface 7044).

In some embodiments, some intelligent filtering settings are configurable. For example, the settings user interface 7044 includes a plurality of options, corresponding to a plurality of categories, for which notifications and/or summaries will be delivered and/or displayed (e.g., based on a determination that notification content and/or summary content falls within the selected category or categories), including: an option 7052 (e.g., corresponding to a “Family” category), an option 7054 (e.g., corresponding to a “Health category), an option 7056 (e.g., corresponding to a “Home Security” category), an option 7058 (e.g., corresponding to a “Medical” category), an option 7060 (e.g., corresponding to a “News” category), an option 7062 (e.g., corresponding to a “Weather” category), and an option 7064 (e.g., corresponding to a “Work” category). In some embodiments, the displayed categories are (e.g., automatically) generated by the computer system 100 (e.g., based on capabilities of the computer system 100), and optionally cannot be user configured (e.g., a user cannot add or remove categories from the settings user interface 7044).

In FIG. 7J, the option 7064 corresponding to the “Work” category indicates (e.g., via a checkmark or a toggle) that notifications and/or summaries with content that is determined to fall within the “Work” category are delivered and/or displayed (e.g., while notifications and/or summaries with content that do not fall within the “Work” category or another selected category will be suppressed), while the “Turn on Intelligent Filtering” option 7046 is toggled on. For example, FIG. 7C shows exemplary work-related notifications (e.g., the notification 5012 corresponding to a work email, and the notification 6020 corresponding to a work message), and FIGS. 7D and 7E show exemplary work-related summaries (e.g., the summary 5024 summarizing the work-related notification 5012, and the summary 7012 summarizing the work-related notification 6020, and group summary 7014 summarizing the content of both work-related notifications 5012 and 6020), consistent with the configuration of the settings user interface 7044 in FIG. 7J.

In response to detecting a user input 7066 (e.g., a tap input, an air tap gesture, an air pinch gesture, a click input, or another type of selection input or an input that meets a first input threshold) directed to the option 7056 (e.g., corresponding to the “Home Security” category), and as shown in FIG. 7K, the computer system 100 (e.g., further) enables notifications and/or summaries with notification content that is determined to fall within the “Home Security” category, and indicates (e.g., via a checkmark or toggle) that the “Home Security” category is now enabled. In some embodiments, analogous user inputs can be used to enable and/or disable additional categories (e.g., additional user inputs on categories that are not already selected (e.g., without checkmarks) will enable those categories; and additional user inputs on categories that are already selected (e.g., with checkmarks) will disable those categories).

In some embodiments, the categories shown in FIG. 7J, when enabled, allow notifications (e.g., that include notification and/or application content) determined to fall within one or more enabled categories to be delivered (e.g., active delivery permission for notifications with notification and/or application content that fall within the selected categories) while “Intelligent Filtering” is applied. In some embodiments, the categories shown in FIG. 7J, when enabled, filter and/or suppress notifications that fall within the one or more enabled categories (e.g., active delivery suppression for notifications with notification and/or application content that fall within the selected categories) while “Intelligent Filtering” is active.

In some embodiments, while “Intelligent Filtering” is active, notifications that are displayed by the computer system 100 (e.g., on a wake screen; a lock screen; the user interface 5000; a notification history user interface; and/or a user interface that includes notifications which were previously displayed, delivered, and/or correspond to previously detected events) are grouped and/or arranged by content category (e.g., optionally, the same categories available for selection in FIG. 7J). In some embodiments, categories that are enabled in the settings user interface 7044 in FIG. 7J, determine which categories of notifications are delivered without active delay or complete suppression. In some embodiments, categories that are enabled in the settings user interface 7044 in FIG. 7J, determine which categories of notifications are filtered and/or suppressed (e.g., with delayed delivery or completely suppressed or deleted), and notifications with content falling within disabled categories continue to be delivered without active delay or suppression (e.g., and continue to be grouped and/or arranged by content category).

FIG. 7L shows the user interface 5000 while the “Turn on Intelligent Filtering” option 7046 is toggled on (e.g., and the settings are configured as shown in FIG. 7K). In some embodiments, the computer system 100 displays a summary corresponding to each enabled category (e.g., groups notifications by category, and summarizes the grouped notifications by category). For example, a summary 7068 includes summary content for work-related notifications and indicates that the summary 7068 corresponds to two work-related notifications, and a summary 7070 includes summary content for home security-related notifications and indicates that the summary 7070 corresponds to four home security-related notifications.

In some embodiments, in response to detecting a user input 7072 (e.g., a tap input, an air tap gesture, an air pinch gesture, a click input, or another type of selection input, or an input that meets a first input threshold) directed to the summary 7068, and as shown in FIG. 7M, the computer system 100 displays an expanded view of the summary 7068. The expanded view of the summary 7068 includes summary content concurrently displayed with the notification 5012 and the notification 6020 (e.g., the notifications corresponding to and/or summarized in the summary content of the summary 7068). The expanded view of the summary 7068 is analogous to the expanded view of the summary 6012 described above with reference to FIG. 6H (e.g., with the absence of the notification 6018 for the missed call (e.g., because the missed call does not have content to be summarized and/or does not have content that falls into the work category)).

In some embodiments, the computer system 100 displays an expanded view of the summary 7070 (e.g., that is analogous to the expanded view of the summary 6038 discussed above with reference to FIGS. 6K-6P), in response to detecting a user input (e.g., a tap input, an air tap gesture, an air pinch gesture, a click input, or another type of selection input or an input that meets a first input threshold) directed to the summary 7070 in FIG. 7L or 7M.

FIG. 7N shows a settings user interface 7074 (e.g., displayed in response to detecting a user input 7041 (e.g., a tap input, an air tap gesture, an air pinch gesture, a click input, or another type of selection input, or an input that meets a first input threshold) directed to the “Intelligent Breakthrough” option 7038 in FIG. 7H) for configuring filtering settings of the computer system 100. The settings user interface 7074 includes an “Intelligent Breakthrough” option 7076, which can be enabled or disabled (e.g., toggled) by a toggle 7078 (e.g., in response to detecting a user input 7094 changing the state of the toggle 7078). When the “Intelligent Breakthrough” option 7076 is enabled, the computer system 100 also displays a plurality of categories in the settings user interface 7074, including: an option 7080 (e.g., corresponding to a “Family” category), an option 7082 (e.g., corresponding to a “Health category), an option 7084 (e.g., corresponding to a “Home Security” category), an option 7086 (e.g., corresponding to a “Medical” category), an option 7088 (e.g., corresponding to a “News” category), an option 7090 (e.g., corresponding to a “Weather” category), and an option 7092 (e.g., corresponding to a “Work” category). Each category in the settings user interface 7074 can be enabled or disabled (e.g., as shown by a checkmark or toggle), in response to detecting a user input (e.g., a tap input, an air tap gesture, an air pinch gesture, a click input, another type of selection input, or an input that meets a first input threshold) directed to the corresponding option (e.g., a user input 7096 selecting the option 7092 would enable the “Work” category corresponding to the option 7092, if it is not already enabled).

In some embodiments, the settings user interface 7044 (e.g., described above with reference to FIGS. 7I-7M) enables a layer of filtering to be enabled on top of a normal mode in which notification delivery is fully permitted (e.g., if the settings user interface 7044 was displayed in response to the user input 7032 in FIG. 7G), allows an additional layer of filtering (e.g., on top of and/or in addition to existing settings for the “Do Not Disturb” mode (e.g., if the settings user interface 7044 was displayed in response to the user input 7040 in FIG. 7H)). In some embodiments, the settings user interface 7074 allows for conditionally ignoring or modifying existing settings for the “Do Not Disturb” mode, by allowing some notifications to be enabled for display (e.g., to “break through” other notification and/or filtering settings of the computer system 100, which would normally restrict, suppress, filter, or otherwise cause these notifications to be withheld from delivery). In some embodiments, the settings user interface 7044 allows for configuring a separate set of notification settings (e.g., for a separate “Intelligent Filtering” mode of the computer system 100, where the “Intelligent Filtering” settings in the settings user interface 7044 are applied, and wherein the “Intelligent Filtering” mode is not (e.g., and optionally, cannot be) active at the same time as the “Do Not Disturb” mode of the computer system 100). Having a standalone “Intelligent Filtering” mode allows for quick configuration of a separate (e.g., reduced-notification) mode without the need to fully configure or modify the “Do Not Disturb” mode (e.g., or other modes that are analogous to the “Do Not Disturb” mode) (e.g., the “Intelligent Filtering” settings include fewer and/or simpler options as compared to the “Do Not Disturb” mode or analogous modes).

FIG. 7O shows the user interface 5000, while the “Do Not Disturb” mode is enabled, and the “Intelligent Breakthrough” option 7076 is enabled to allow summaries and/or notifications of the “Health” category to “break through” the notification settings of the “Do Not Disturb” mode.

For example, in FIG. 7H, the “Do Not Disturb” mode allows notifications for application “A”, application “M”, application “m,” and application “P.” Since notifications for the application “H” are not allowed, while the “Do Not Disturb” mode is active, notifications for the application “H” are normally suppressed and not displayed (e.g., when the “Intelligent Breakthrough” option 7076 is not enabled for the “Do Not Disturb” mode). This is shown in FIG. 7B, where no notifications for the application “H” (e.g., and no notifications for applications other than the application “A”, the application “M”, the application “m,” and the application “P”) are displayed.

In FIG. 7O, however, a notification 7098 for the application “H” “breaks through” the notification settings for the “Do Not Disturb” mode, because the “Intelligent Breakthrough” settings 7076 is enabled, and because the content of the notification 7098 falls within the enabled “Health” category (e.g., the notification 7098 reports that a high heart rate was detected, which the computer system 100 determines (e.g., based on artificial intelligence, machine learning, and large language models that process the content of the notification 7098) to be health-related content). In some embodiments, notifications (e.g., such as the notification 7098) that “break through” the other suppression of the notifications are displayed with a visual indication (e.g., a symbol, an altered appearance, and/or other visual indications that are applied to multiple breakthrough notifications to indicate that these notifications are displayed because the “Intelligent Breakthrough” settings allow the notifications to “break through”).

FIGS. 8A-8S illustrate example embodiments for generating different notification outputs (e.g., audio outputs and/or visual outputs corresponding to notifications and/or summaries) based on content length (e.g., length of notification content and/or application content used to generate notifications), and, for choosing appropriate timing of using audio outputs for notifications based on context.

FIG. 8A shows the user interface 5000, which includes the notification 6020. The (e.g., length of) notification content of the notification 6020 (e.g., the message “did you see the news about the NASA mission”) does not exceed a content length threshold (e.g., the notification content of the notification 6020 does not exceed a threshold character limit, a threshold word limit, and/or a threshold time limit (e.g., wherein the time limit is compared to a length of time of audio output corresponding to the notification content). In some embodiments, the notification 6020 meets first criteria (e.g., length-based criteria), when the notification content of the notification 6020 is below the threshold amount of content.

As described herein, a notification is sometimes described as “short” notifications when the notification content of the notification does not exceed the content length threshold (e.g., the adjective “short” indicates that the respective notification content does not exceed the content length threshold); and the notification is sometimes described as a “long” notification when the notification content for the notification exceeds the content length threshold (e.g., the adjective “long” indicates that the notification content exceeds the content length threshold).

FIG. 8B shows an audio output device 8000 (e.g., headphones/earphones, speakers, and/or an electronic device that includes an audio output component) that is in communication with the computer system 100. In FIG. 8B, because the notification content of the notification 6020 does not exceed the content length threshold (e.g., the notification content of the notification 6020 is below the threshold amount of content), the audio output device 8000 outputs audio 8001. In some embodiments, the audio 8001 includes a brief introduction (e.g., “Jose messaged”) (e.g., to provide context for the audio content of the audio 8001). In some embodiments, because the notification 6020 meets the first criteria, the audio output 8001 includes a direct reproduction of the notification content of the notification 6020 (e.g., a word-for-word reproduction of the entire notification content of the notification 6020; and/or audio content that includes the entire notification content of the notification 6020). In some embodiments, the audio 8001 does not include a summary of the notification content for the notification 6020.

In some embodiments, the audio output device 8000 does not output audio 8001 if the user of the computer system 100 has not read or otherwise interacted with the notification 6020 (e.g., via the computer system 100). For example, the user of the computer system 100 may be wearing the audio output device 8000, but not looking at (e.g., the display of the computer system 100 is off and/or in a low-power state) and/or interacting directly with the computer system 100 (e.g., the user may be exercising, relaxing, and/or performing other actions that do not involve the computer system 100, while listening to music via the audio output device 8000). The computer system 100 detects an event (e.g., receipt of a message from Jose, corresponding to the notification 6020). Since the user is not looking at and/or interacting directly with the computer system (e.g., is not in a position to easily view and/or interact with the notification 6020 via the computer system 100), the audio output device 8000 outputs the audio 8001 (e.g., optionally, while pausing or suspending any currently playing audio when the event corresponding to the notification 6020 is detected). In this example, FIG. 8A shows what the user of the computer system 100 would see if interacting with the computer system (e.g., waking the computer system 100 from a low-power or sleep state, in order to view notifications). If, however, the user is looking at and/or interacting with the computer system 100 (e.g., while also wearing with or otherwise using the audio output device 8000), the computer system 100 displays the notification 6020 and the audio output device 8000 does not output the audio 8001 (e.g., because the user can view and interact with the notification 6020, which removes the need to interrupt the currently playing audio to output the audio 8001).

In some embodiments, the audio output device 8000 does not output audio (e.g., in analogous circumstances and for analogous reasons, as described above with reference to FIG. 8B) if the user of the computer system 100 is looking at and/or interacting directly with the computer system 100.

FIG. 8C shows a summary 5024 (e.g., the same summary 5024 described above, for example, with reference to FIG. 5E), which corresponds to a notification 5044 (e.g., previously referred to as an expanded view 5044 of the notification 5012, shown in FIG. 5E; and used herein as an example of a notification with a relatively long notification content length). In contrast to the notification 6020 (e.g., a “short” notification), notification content corresponding to the notification 5044 exceeds the content length threshold (e.g., the notification 5044 is a “long” notification). Since the notification 5044 is a “long” notification, the computer system 100 forgoes displaying the notification 5044 (e.g., because it is determined to have too much notification content to effectively display via an un-summarized notification). Instead, the computer system 100 displays the summary 5024 (e.g., summarized the notification 5044, in the summary content of the summary 5024). In some embodiments, the computer system 100 displays (e.g., generates and displays) a summary for (e.g., in lieu of) each “long” notification, and the computer system 100 displays “short” notifications (e.g., without summarizing the “short” notifications).

In FIG. 8D, since the notification 5044 is a “long” notification, the audio output device 8000 outputs audio 8003, which corresponds to (e.g., includes) the summary content of the summary 5024 (e.g., to ensure the audio 8003 remains brief and/or the duration of the audio 8003 remains below a threshold duration). In some embodiments, the audio output device 8000 outputs the audio 8005 (e.g., if the summary 5024 is the first summary the computer system 100 has generated and/or displayed (e.g., optionally, for this specific user of the computer system 100), and/or the user of the computer system 100 and/or the audio output device 8000 has not previously viewed a summary, interacted with a summary, and/or heard audio corresponding to a summary (e.g., such as the summary 5024)). In some embodiments, the audio 8005 includes additional information (e.g., as compared to the audio 8003), such as a brief description that the audio 8005 corresponds to a “long” notification (e.g., provides a reason and/or explanation for why content is being summarized), and that the user can access the “full message” (e.g., the entire notification content of the notification 5044) if necessary or desired. In some embodiments, the audio 8005 is not generated if the user of the computer system 100 has previously generated and/or displayed a summary prior to displaying the summary 5024, or if the user has already viewed a summary, interacted with a summary, and/or heard audio corresponding to a summary other than the summary 5024 (e.g., to reduce the total duration of the audio output of the audio output device 8000), and the audio output device 8000 instead outputs the audio 8003 (e.g., a shortened and/or abbreviated version of the audio output 8005).

In some embodiments, the audio 8003 and/or the audio 8005 includes a prompt (e.g., “Read it? Or “Do you want to hear the full message?”) for further user interaction (e.g., for outputting audio corresponding to related notification and/or application content, and/or for generating additional audio content). In some embodiments, in response to detecting a subsequent user input (e.g., a voice command or a voice response to the prompt, such as “yes,” “read it,” or an equivalent phrase), the audio output device 8000 generates audio corresponding the notification content of the notification 5044 (e.g., in an analogous manner to the audio 8001, for the notification 6020, described above with reference to FIG. 8B).

In some embodiments, the audio output device 8000 does not output the audio 8003 and/or the audio 8005 (e.g., in analogous circumstances and for analogous reasons, as described above with reference to FIG. 8B) if the user of the computer system 100 is looking at and/or interacting directly with the computer system 100. In some embodiments, the audio output device 8000 outputs different audio depending on a type(s) of content corresponding to the event, notification, and/or summary. For example, for a first type of content (e.g., content that includes a non-text component, such as images or video) the audio output device 8000 may output longer audio (e.g., using more words, to summarize the non-text component(s)), as compared to a second type of content (e.g., text-only content, which does not require additional description). In some embodiments, the content length threshold is different for visual notifications (e.g., for determining when to display a summary or an un-summarized notification) than for audio notifications (e.g., for determining whether to generate audio corresponding to a full notification, or for generating audio corresponding to a summarized notification).

For example, if the content length threshold for visual notifications is 16 words, and the content length threshold for audio notifications is 40 words, then if a notification is 16 words or less, the computer system 100 displays a regular notification (e.g., without a summary) and the audio output device 8000 outputs audio corresponding to the full notification content (e.g., without a summary). If the notification is 17-40 words in length, the computer system 100 displays a summary corresponding to the notification but the audio output device 8000 outputs audio corresponding to the full notification content (e.g., without a summary). If the notification is 41 words or longer, the computer system 100 displays a summary corresponding to the notification and the audio output device 8000 outputs audio that includes a summary of the notification content.

FIGS. 8E-8H show an embodiment where the audio output device 8000 outputs audio corresponding to multiple events (e.g., corresponding to multiple notifications).

FIG. 8E shows multiple notifications that have been received within a short time frame (e.g., the computer system 100 detects four events corresponding to four notifications, within a time span of two minutes), including: a notification 8002, a notification 8004, a notification 8006, and a notification 8008.

In some embodiments, the audio output device 8000 does not output audio for a threshold amount of time (e.g., 1 second, 2 seconds, 5 seconds, 10 seconds, or 30 seconds) after the computer system 100 initially detects a notification. For example, the computer system first detects the event corresponding to the notification 8008 (e.g., at 9:28), and generates/displays the notification 8008. The audio output device 8000, however, does not immediately output audio corresponding to the notification 8008 (e.g., to avoid repeatedly generating audio corresponding to recently received notifications in quick succession). In some embodiments, the threshold amount of time is calculated from the time corresponding to an initial event (e.g., the event corresponding to the notification 8008), and the initial event is the first event detected since a certain amount of time has elapsed since the last detected event (e.g., or the last time the threshold amount of time has elapsed for a detected event). In some embodiments, the threshold amount of time is calculated on a rolling basis (e.g., from the last detected event), such that if a new event is detected before the threshold amount of time has elapsed, the threshold amount of time is “reset” and is calculated from the time the latest event was detected (e.g., until no events are detected before the threshold amount of time has elapsed). In some embodiments, the rolling threshold amount of time is calculated only for events the computer system 100 determines are related (e.g., events and/or notifications that meet relevance criteria). In some embodiments, the computer system 100 determines that events are related by evaluating content (e.g., application content and/or notification content corresponding to each event) for relevance and/or similarity to other content (e.g., for previously detected events). In some embodiments, the computer system 100 determines that events are related based on an application, an application type, a user/contact, and/or a timing for the detected event(s).

FIG. 8F shows that the audio output device 8000 does not output audio. For example, in FIG. 8E, each of the received notifications corresponds to the mail application M, and each of the notifications corresponds to an email in the same thread (e.g., email chain, or conversation, relating to the subject line of “Summer Vacation”). The computer system 100 determines that each of the four events is related, and so the audio output device 8000 does not output audio corresponding to the four events (e.g., until after the threshold amount of time has passed since the latest event, the event corresponding to the notification 8002, was detected).

In FIG. 8G, the threshold amount of time has elapsed (e.g., since detecting the event corresponding to the notification 8002). The computer system 100 displays a summary 8010 which summarizes (e.g., and/or corresponds to) the notification 8002, the notification 8004, the notification 8006, and the notification 8008 (e.g., and any other related notifications received between the time of the event corresponding to the notification 8002 and the time shown in FIG. 8G). The summary 8010 includes an indicator 8012 and an indicator 8014 that indicate that the summary 8010 summarizes and/or corresponds to multiple notifications. In some embodiments, the summary 8010 has an appearance similar to that of the summary 5026 (e.g., as shown in FIGS. 5C and 6B), which includes a badge that indicates the number of notifications being summarized (e.g., and/or corresponding to the summary 8010). The summary 8010 includes summary content corresponding to the four summarized notifications (e.g., mentions that the summarized notifications are from users/contacts Dan, Rachel, and Alex, discuss plans to leave two days earlier, and that the involved users/contacts want to book flights this weekend. In some embodiments, the computer system 100 does not output individual notifications (e.g., the notifications shown in FIG. 8E are not displayed), and the computer system 100 instead delays and/or postpones delivery of the notifications shown in FIG. 8E, and optionally displays the summary 8010 in FIG. 8G, in lieu of delivering the individual notifications shown in FIG. 8E.

In FIG. 8H, the audio output device 8000 outputs audio 8007, which corresponds to the summary 8010 (e.g., at the same time, or the time, when the summary 8010 was or would have been generated and/or displayed by the computer system 100). In some embodiments, the audio output device 8000 does not output the audio 8007 (e.g., in analogous circumstances and for analogous reasons, as described above with reference to FIG. 8B) if the user of the computer system 100 is looking at and/or interacting directly with the computer system 100.

FIGS. 8I-8L show different scenarios where the audio output device 8000 delays outputting audio corresponding to multiple events (e.g., corresponding to multiple notifications) in some embodiments.

FIG. 8I shows the computer system 100 in communication with several other computer systems, including a computer system 8016 (e.g., for a user Mary Jane), a computer system 8018 (e.g., for a user Neil Barnes), and a computer system 8020 (e.g., for a user Isaac Lee). In some embodiments, users of each computer system are each participants in a group conversation (e.g., a group messaging session of a messaging application). FIG. 8I also shows that the user Neil Barnes and the user Isaac Lee are typing replies (e.g., in a group messaging session that includes John Smith, Mary Jane, Neil Barnes, and Isaac Lee). In some embodiments, the computer system 8018 and the computer system 8020 transmit data to the computer system 100 (e.g., data that Neil and/or Isaac are typing and/or composing a reply via their respective computer systems). While the computer system 100 in FIG. 8I is shown as displaying a notification 8015, in some embodiments, the computer system 100 delays delivery of and/or suppresses the notification 8015 (e.g., while the computer system 100 detects that the user Neil Barnes and the user Isaac Lee are typing replies).

In FIG. 8J, the audio output device 8000 does not output audio (e.g., even though the computer system 100 has already detected a first event corresponding to a notification 8015, as shown on the computer system 100 for John Smith), since the computer system 100 determines that multiple participants (e.g., Neil and Isaac) in the relevant group conversation are typing replies. In some embodiments, the audio output device 8000 does not output audio (e.g., and if the computer system 100 is delaying delivery of the notification 8015, the computer system 100 delays delivery) if the computer system 100 detects that another user (e.g., Neil and/or Isaac) is typing within a threshold amount of time (e.g., 1 second, 2 seconds, 5 seconds, 10 seconds, 15 seconds, or 30 seconds) since an initial event (e.g., the event corresponding to the notification 8015) was detected. In some embodiments, if no other user is detected as typing within the threshold amount of time, the audio output device 8000 outputs audio corresponding to the notification 8015 (e.g., if the notification is a “short” notification) and/or a summary corresponding to the notification 8015 (e.g., if the notification is a “long” notification).

FIG. 8K is analogous to FIG. 8I, but at a later time (e.g., 9:42) where no participants are typing (e.g., Neil and Isaac have finished and sent the replies they were typing in FIG. 8I).

In FIG. 8L, the audio output device 8000 outputs the audio 8009, since the computer system 100 does not detect any participants of the relevant group conversation are typing replies. The audio 8009 includes a summary that mentions messages from Mary (e.g., the initial message shown in FIG. 8I), Neil (e.g., that Neil was typing in FIG. 8I), and Isaac (e.g., that Isaac was typing in FIG. 8I), and that the participants in the group conversation discussed hiking at Point Reyes on Saturday (e.g., Mary initially proposes hiking on Saturday, and Neil and/or Isaac suggest Point Reyes as a hiking spot). In some embodiments, the audio output device 8000 does not output the audio 8009 (e.g., and if the computer system 100 is delaying delivery of the notification 8015 and/or the summary 8011, the computer system 100 delays delivery) until a threshold amount of time (e.g., 1 second, 2 seconds, 5 seconds, 10 seconds, 15 seconds, or 30 seconds) has passed since another user was last detected as typing (e.g., composing a reply).

In some embodiments, the audio output device 8000 does not output audio (e.g., even though the computer system 100 has already detected the first event corresponding to a notification) when the computer system 100 determines that (e.g., application and/or notification) content corresponding to the notification includes an indication that subsequent related events are expected. In some embodiments, the computer system 100 also optionally delays delivery of and/or suppresses notifications when the computer system 100 determines that the content corresponding to the notification includes an indication that subsequent related events are expected. For example, the notification may include content that indicates another contact/user is expected to send additional related information (e.g., the notification is from a user Jane Doe, indicating that another user Mike Davis will send notes (e.g., in a separate message)), and/or the notification 8015 includes content that indicates the same contact/user is expected to send additional information at a later time (e.g., the notification is from the user Jane Doe and indicates that Jane will send her meeting notes as soon as possible (e.g., in a second, later message)). In some embodiments, the computer system 100 and the audio output device 8000 behave in an analogous manner as described above with reference to FIGS. 8I-8L, but leveraging these indications of subsequent related events in place of (e.g., or in addition to) whether or not another participant of a group conversation is typing a reply.

FIGS. 8M-8P show embodiments where the computer system 100 outputs summaries in response to a user input (e.g., a speech input).

FIG. 8M shows a user interface 8022 (e.g., for a messaging application). The user interface 8022 includes multiple messages, including: a message 8024, a message 8026, a message 8028, a message 8030, a message 8032, a message 8034, and a message 8036. Some messages (e.g., the message 8024, the message 8034, and the messages 8036) are group conversations. Other messages (e.g., the message 8026, the message 8028, the message 8030, and the message 8032) are individual (e.g., one-on-one) conversations. Some messages (e.g., the message 8026, the message 8030, and the message 8032) are unread messages (e.g., messages that have not been viewed and/or interacted with by the user of the computer system 100, either via the user interface 8022 or via a notification corresponding to the message 8026, the message 8030, or the message 8032), as shown by indicators (e.g., dots) for the unread messages.

In FIG. 8N, in response to detecting a user input 8038 (e.g., a speech input and/or a voice command reciting “catch me up on messages”), the computer system 100 displays (e.g., in the user interface 5000) a summary 8040 (e.g., summarizing and/or corresponding to the unread message 8030), a summary 8042 (e.g., summarizing and/or corresponding to the unread message 8026), and a summary 8044 (e.g., summarizing and/or corresponding to the unread message 8032).

In some embodiments, the computer system 100 outputs a summary for each unread message (e.g., optionally, including unread messages across multiple messaging applications). In some embodiments, the computer system 100 groups summaries by relevance (e.g., subject matter, corresponding user/contact/sender, and/or by application), optionally, in an analogous manner as described above with reference to FIGS. 6A-6X. In some embodiments, the computer system 100 arranges or orders the displayed summaries by relevance and/or priority. For example, the message 8026 was received more recently than the message 8030, but the summary 8040 (e.g., corresponding to the message 8030) is determined to be more relevant and/or important, and is displayed first (e.g., above) the summary 8042 (e.g., corresponding to the message 8026). In some embodiments, an audio output device in communication with the computer system 100 (e.g., the audio output device 8000 shown in FIG. 8B) outputs audio corresponding to one or more summaries (e.g., shown in FIG. 8N), in response to detecting the user input 8038.

FIG. 8O is analogous to FIG. 8M, but for a user interface 8046 (e.g., corresponding to an email application). The user interface 8046 includes a plurality of email messages, including an email 8048, an email 8050, an email 8052, an email 8054, and an email 8056. Some emails are (e.g., and/or represent) email chains (e.g., threads, or other grouping that includes multiple replies or emails that are grouped by relevance, subject line, and/or subject matter), such as the email 8052 and the email 8054. Some emails (e.g., the email 8050, the email 8052, and the email 8056) are unread, as shown by indicators (e.g., dots, bolded sender(s), and bolded subject line).

FIG. 8P is analogous to FIG. 8N. In FIG. 8P, in response to detecting a user input 8058 (e.g., a speech input and/or a voice command reciting “show me mail highlights”), the computer system 100 displays a summary 8060 (e.g., corresponding to the unread email 8048 and the unread email 8050), a summary 8062 (e.g., corresponding to the unread email 8052), and a summary 8064 (e.g., corresponding to the unread email 8056). In some embodiments, a summary (e.g., the summary 8060) summarizes multiple related emails (e.g., emails that include content for and/or relating to the same subject and/or topic). For example, the email 8048 and the email 8050 both discuss the same work report. While the email application does not group these emails (e.g., unlike the emails represented by the email 8052, the email 8048 and the email 8050 have different subject lines), the computer system 100 determines that the two emails are related (e.g., by subject matter and/or topic) and generates a single summary summarizing (e.g., and/or corresponding to) the email 8048 and the email 8050. The summary 8062 is another example of a summary that summarizes multiple related emails (e.g., multiple emails replying to and/or sent with the same subject line “Summer Vacation). In some embodiments, one or more users/contacts/senders are indicated with a different name or descriptor. For example, the summary 8064 summarizes an email from Alice Smith, but indicates that the email is from “your[/the user's] mother.” In some embodiments, an audio output device in communication with the computer system 100 (e.g., the audio output device 8000 shown in FIG. 8B) outputs audio corresponding to one or more summaries (e.g., shown in FIG. 8P), in response to detecting the user input 8058.

FIGS. 8Q-8S show an embodiment where the computer system 100 displays an alert, which when selected, generates an audio output.

FIG. 8Q shows a user interface 8066 (e.g., a navigation user interface for a car or other vehicle). While displaying the user interface 8066 (e.g., while the user is navigating), the computer system 100 displays an alert 8068 (e.g., a notification or an indication of a notification).

In FIG. 8R, in response to detecting a user input 8070 directed to the alert 8068 (e.g., as shown in FIG. 8Q), the computer system 100 displays a user interface 8072 (e.g., optionally, replacing display of the alert 8068 with display of the user interface 8072), and the computer system 100 generates (e.g., and/or transmits instructions to an audio output device to generate) audio 8082. In some embodiments, the audio 8082 includes a summary of content corresponding to the alert 8068. For example, the audio 8082 includes an indication that the alert 8068 relates to a user or contact Jane, and that Jane wants an updated draft addressing Mike's concerns. The user interface 8072 includes a “Reply” affordance 8074 (e.g., for composing a reply to a message or communication corresponding to the alert 8068), a “Read” affordance 8076 (e.g., for generating extended audio or additional audio, such as audio corresponding to the entire content for the alert 8068, rather than a summary of the content for the alert 8068), and a “Done” affordance 8078 (e.g., for dismissing and/or ceasing to display the user interface 8072 and/or the alert 8068).

In FIG. 8S, in response to detecting a user input 8080 directed to the “Read” affordance 8076, the computer system 100 generates (e.g., and/or transmits instructions to an audio output device to generate) audio 8084. In some embodiments, the audio 8084 is an extended or expanded version of the audio 8082. For example, the audio 8082 includes a summary (e.g., summary content of the summary 5024 shown in FIG. 5C), while the audio 8084 includes full (e.g., un-summarized) content (e.g., the full application content 5054 shown in FIG. 5F).

FIGS. 9A-9Z illustrate example user interfaces for prioritizing and/or highlighting notification content (e.g., notifications and/or summaries of notifications) in accordance with some embodiments.

FIG. 9A shows the user interface 5000 of the computer system 100, which includes a plurality of notifications that include a set of notification content (e.g., FIG. 9A shows a “normal” view of notifications, when the computer system is not configured to prioritize and/or highlight notification content). In contrast, in FIG. 9B, the computer system 100 is configured to prioritize and/or highlight notification content. FIG. 9B shows the same notifications (e.g., the same set of notification content) as FIG. 9A, but arranged and presented in a different visual format.

In FIG. 9B, the user interface 5000 includes a region 9000, which includes a portion 9002 (e.g., corresponding to a summary of the notification 5012 in FIG. 9A), and a portion 9004 (e.g., corresponding to the notification 5018 in FIG. 9A). In some embodiments, the region 9000 is displayed with a different visual appearance (e.g., a different border thickness, a different background color, a different font size, a different font or font style, and/or a different font color) as compared to other (e.g., non-prioritized and/or non-highlighted) notifications in the user interface 5000. In some embodiments, the region 9000 includes an icon or indicator (e.g., an icon and text reading “Most Important,” in FIG. 9B) that the region 9000 includes prioritized and/or highlighted content.

In some embodiments, the region 9000 is persistently displayed at a fixed position in the user interface 5000 (e.g., directly below other fixed portions of the user interface 5000, such as the date 5002, the time 5004, and the user interface objects/widgets 5006, 5008, and 5010). As described in further detail below, in some embodiments, the region 9000 remains in (or consistently returns to) the fixed position in the user interface 5000 (e.g., even if new notifications, corresponding to newly detected events, are generated and/or displayed in the user interface 5000). This provides a consistent location in which the region 9000 can always be located, which assists the user in quickly identifying key (e.g., prioritized) notification content.

In some embodiments, some notification content (e.g., lengthy or “long” notification content) is summarized in the region 9000 (e.g., in a portion of the region 9000). For example, the portion 9002 includes a summary of the notification content of the notification 5012 (e.g., shown in FIG. 9A). In some embodiments, some notification content (e.g., brief or “short” notification content) is not summarized in (e.g., a portion of) the region 9000. For example, the portion 9004 does not include a summary of the notification content of the notification 5018 (e.g., the notification 5018 in FIG. 9A includes the same notification content that appears in the portion 9004 in FIG. 9B). In some embodiments, the region 9000 includes a mix of summarized and un-summarized content/portions (e.g., the portion 9002 includes a summary, while the portion 9004 does not include a summary).

In some embodiments, what notification content is prioritized and/or highlighted in the region 9000 can be customized and/or configured by the user of the computer system 100 (e.g., the user of the computer system 100 can configure what notification content should or should not be displayed in the region 9000). In some embodiments, the computer system 100 is configured to prioritize and/or highlight notification content based at least in part on the content of the notification content (e.g., an evaluation of the content of the notification content) (e.g., as opposed to non-content notification characteristics, such as an application, a corresponding user/contact/sender, or a time of receipt/detection). In some embodiments, the computer system 100 can be configured not to display the region 9000 (e.g., at all).

In some embodiments, content (e.g., notification content and/or application content) appears in the region 9000 if (e.g., and optionally, only if) the content meets relevance criteria (e.g., such that related content is displayed together in the region 9000). In some embodiments, relevance criteria include a time-sensitive component such that as time passes, content can meet the relevance criteria, or content may no longer meet the relevance criteria. In some embodiments, content that no longer meets the relevance criteria ceases to be displayed in the region 9000 (e.g., a portion of the region 9000 that corresponds to the content that no longer meets the relevance criteria ceases to be displayed in the region 9000).

In some embodiments, the computer system 100 determines “relevance” based on one or more factors, including (e.g., but not limited to): the text of a notification or summary, a current location (e.g., at which an event corresponding to a notification or summary is detected), a time of day (e.g., at which the event corresponding to the notification or summary is detected), an active mode ((e.g., that controls delivery of and/or suppression of notifications) of the computer system 100 is active when the event corresponding to the notification or summary is detected), past user interaction with similar or related notifications (e.g., notifications with the same source, corresponding to the same application, and/or containing similar content), or other contextual information. For example, the region 9000 may include content from notifications and/or summaries from a certain period of time (e.g., some or all notifications from the certain period of time). For example (e.g., and as discussed in further detail below with reference to FIG. 9R), the region 9000 may include content from notifications and/or summaries generated while a particular mode of the computer system 100 is active (e.g., some or all notifications generated while the particular mode of the computer system was active). For example, the region 9000 may include notifications that include content relating to the same subject (e.g., a work report) (e.g., some or all notifications relating to the same subject).

In some embodiments, the portions of the region 9000 are ordered temporally (e.g., with the portion corresponding to the most recently detected event listed first, and with portions corresponding to older events listed later). In some embodiments, the portions of the region 9000 are ordered in a priority order (e.g., based on a determined importance or current relevance). In some embodiments, the portions of the region 9000 are ordered based on relevance criteria (e.g., the same and/or analogous criteria as the relevance criteria used to determine whether or not content should appear in the region 9000). In some embodiments, the order of the portion of the region 9000 changes (e.g., and/or is updated), when a new event is detected and/or as time passes (e.g., at set time intervals and/or preset times).

In some embodiments, content-based prioritization and/or highlighting can result in un-grouping of notification content that is normally grouped (e.g., in the “normal” view of notifications, as shown in FIG. 9A). For example, in FIG. 9A, notifications are configured to be grouped by application, so the notification 5012 is grouped with another notification from the email application M (e.g., as shown by the indicator 7000). In contrast, in FIG. 9B, the computer system 100 is configured to prioritize and/or highlight certain notification content (e.g., work-related content, content that mentions the user of the computer system 100 directly, and/or notification content that includes action items and/or require a response from the user). Based on this content-based prioritization and/or highlighting, the notification content of the notification 5012 (e.g., a work email) appears in the portion 9002 of the region 9000, but the notification content of a notification 9006 (e.g., previously represented by the indicator 7000 in FIG. 9A) does not appear in a portion of the region 9000 (e.g., because the notification 9006 is not work-related, does not mention the user of the computer system 100 directly, and does not include immediate action items or require a timely response from the user of the computer system 100).

In some embodiments, one or more portions of the region 9000 include content corresponding to a particular contact or user, and one or more notifications and/or summaries that are displayed outside of the region 9000 corresponds to the same contact or user. For example, in FIG. 9D, the region 9000 could include a portion corresponding to content from a contact “Rachel M.,” and the computer system 100 could concurrently display the notification 9006 (e.g., also corresponding to the user “Rachel M.”) with the region 9000.

In FIG. 9C, the computer system 100 detects an event (e.g., corresponding to new application content and/or notification content), and displays a summary 9008 (e.g., that summarized the new application content and/or notification content). In some embodiments, as shown in FIG. 9C, the summary 9008 is initially displayed above the region 9000 (e.g., to indicate that the summary 9008 corresponds to new content).

In some embodiments, the summary 9008 (e.g., a new summary that was not previously displayed) is (e.g., initially) displayed with a different level of prominence than the region 9000. For example, when the summary 9008 is first displayed, it is displayed with an increased level of prominence (e.g., with a brighter appearance, with larger font, with bolded font, with a flashing or animated background, and/or with a different color) as compared to the region 9000 (e.g., to assist the user in quickly identifying the most recently generated summary). In some embodiments, after a threshold amount of time (e.g., 1 second, 2 seconds, 5 seconds, 10 seconds, or 15 seconds), the summary 9008 ceases to be displayed with the increased level of prominence (e.g., the summary 9008 and the region 9000 are displayed with the same level of prominence).

In some embodiments, when the summary 9008 (e.g., a new summary) is displayed, the region 9000 is displayed with a lower level of prominence (e.g., with a dimmer appearance, with smaller font, with a blur effect, and/or with a different color) as compared to a default (e.g., normal or regular) appearance of the region 9000, and optionally, the summary 9008. After a threshold amount of time (e.g., 1 second, 2 seconds, 5 seconds, 10 seconds, or 15 seconds), the region 9000 is displayed with the default appearance (e.g., ceases to be displayed with the lower level of prominence). In some embodiments (e.g., after the threshold amount of time, and optionally, before displaying/redisplaying the region 9000 with the default appearance), the computer system 100 displays an animated transition of the summary 9008 merging into and/or with the region 9000 (e.g., as described in further detail below with reference to FIG. 9D) (e.g., and after merging the summary 9008 and the region 9000, the region 9000 is displayed with the default appearance).

In some embodiments, prior to displaying the summary 9008 (e.g., or concurrently with displaying the summary 9008), the computer system 100 displays an animated visual effect in the region 9000 (e.g., movement of, a change in shape of, or another change in visual appearance of, the region 9000). In some embodiments, prior to displaying the summary 9008 (e.g., or concurrently with displaying the summary 9008), the computer system 100 displays the animated visual effect in the region 9000 if the computer system 100 determines that the content of the summary 9008 should be prioritized and/or highlighted (e.g., the content of the summary 9008 should also appear in the region 9000, since the content of the summary 9008 relates to the same work report mention in the content appearing in the portion 9002 of the region 9000, and thus meets relevance criteria).

In FIG. 9D, the computer system 100 determines that the content of the summary 9008 should be prioritized and/or highlighted (e.g., the content of the summary 9008 should also appear in the region 9000, since the content of the summary 9008 relates to the same work report mention in the content appearing in the portion 9002 of the region 9000, and thus meets relevance criteria), and the computer system 100 displays (e.g., updates) the region 9000 to include a portion 9010 of the region 9000. In some embodiments, the computer system 100 displays an animated transition of the summary 9008 merging with and/or into the summary region 9000.

In some embodiments, the computer system 100 determines whether or not the content of the summary 9008 should be prioritized and/or highlighted at the time that the computer system detects the event corresponding to the content and/or the summary 9008. The computer system 100 initially displays the summary 9008 above the region 9000 (e.g., as in FIG. 9C) regardless of the outcome of the determination whether the content of the summary 9008 should be prioritized and/or highlighted. If the computer system 100 determines that the content and/or the summary 9008 should be prioritized and/or highlighted, the computer system 100 proceeds to display the region 9000 with the portion 9010. If the computer system 100 determines that the content and/or the summary 9008 should not be prioritized and/or highlighted, the summary 9008 is shifted to a position in the user interface 5000 that is below the region 9000. Such behavior is discussed in greater detail below with reference to FIGS. 9E and 9F.

In FIG. 9E, the computer system 100 detects an event (e.g., corresponding to new application content and/or notification content), and displays a notification 9012 (e.g., without a summary of the new application content and/or notification content). The notification 9012 is initially displayed above the region 9000 (e.g., to indicate that the notification 9012 corresponds to new content).

In FIG. 9F, the computer system 100 determines that the content of the notification 9012 should not be prioritized and/or highlighted, and the computer system 100 moves the notification 9012 from an initial position (e.g., above the region 9000, as shown in FIG. 9E) to a different position that is below the region 9000 (e.g., the region 9000 returns to its fixed position in the user interface 5000). In some embodiments, notifications and/or summaries that are not prioritized and/or highlighted (e.g., are not displayed in a portion of the region 9000) are arranged in a default and/or temporal order (e.g., a reverse temporal order, with the most recent notifications and/or summaries appearing at the top, and with the oldest notifications and/or summaries appearing at the bottom).

In FIG. 9G, the computer system 100 detects an event (e.g., corresponding to new application content and/or notification content), and displays a summary 9014 (e.g., that includes a summary of the new application content and/or notification content). The summary 9014 is initially displayed above the region 9000 (e.g., to indicate that the summary 9014 corresponds to new content).

In FIG. 9H, the computer system 100 determines that the content of the summary 9014 should be prioritized and/or highlighted, and the computer system 100 displays (e.g., updates) the region 9000 with a portion 9016 (e.g., an updated version of the portion 9002).

In some embodiments, as shown in FIG. 9H, some notifications and/or summaries can be combined in a portion of the region 9000. For example, the summary 9014 corresponds to the email application M, and the portion 9002 of the region 9000 includes content corresponding to the same email application M (e.g., the portion 9002 of the region 9000 corresponds to the notification 5012 in FIG. 9A, which corresponds to the email application M). The computer system 100 combines the content corresponding to the email application M (e.g., the content corresponding to (e.g., a summary of) the notification 5012 in FIG. 9A, and the content corresponding to the summary 9014 in FIG. 9G) into the portion 9016 of the region 9000 in FIG. 9H. In some embodiments, a portion of the region 9000 includes a visual indicator (e.g., a badge with a number) that the portion corresponds to a combination of notifications and/or summaries. For example, the portion 9016 includes a badge with the number “2” that indicates the portion 9016 includes content from two combined notifications and/or summaries.

In FIG. 9I, the computer system 100 detects an event (e.g., corresponding to new application content and/or notification content), and displays the notification 6026 (e.g., that does not include a summary of the new application content and/or notification content). The notification 6026 is initially displayed above the region 9000 (e.g., to indicate that the summary 9014 corresponds to new content).

In FIG. 9J, the computer system 100 determines that the content of the notification 6026 should be prioritized and/or highlighted, and the computer system 100 displays (e.g., updates) the region 9000 with a portion 9018. In some embodiments, the region 9000 includes display of only up to a maximum number of portions. If the computer system 100 determines that the amount of content to include (e.g., to prioritize and/or highlight) in the region 9000 would exceed the maximum number of portions, the computer system 100 displays only the maximum number of portions. In some embodiments, if one or more portions of the region 9000 are not displayed because they would exceed the maximum number of portions, the region 9000 includes a visual indicator of the additional (e.g., non-displayed) portion(s). In some embodiments, the visual indicator of the additional portion(s) includes information corresponding to the additional portion(s) (e.g., a number of additional portions; and/or applications, senders, and/or sources corresponding to the additional portions).

For example, the maximum number of portions in FIG. 9J is three. Since displaying the region 9000, including the portion 9018, would result in four total portions (e.g., the portion 9018, the portion 9010, the portion 9016, and the portion 9004), the computer system 100 displays only the maximum number of portions (e.g., the region 9000 can include only a maximum of three portions, so the portion 9004 is not displayed). The region 9000 includes an indicator 9020 of one additional portion (e.g., the previously displayed portion 9004) that is not currently displayed.

In some embodiments, if a new portion to be added to the region 9000 would cause the region 9000 to include more than the maximum number of portions, the new portion to be added replaces one or more previously displayed portions of the region 9000 (e.g., in FIG. 9J, the portion 9018 replaces the previously displayed portion 9004). In some embodiments, the new portion to be added replaces the oldest portion of the region 9000 (e.g., the portion 9004 corresponds to the oldest content and/or event previously detected by the computer system, so the computer system 100 replaces the portion 9004 with the new portion 9018 to be added).

In some embodiments, the computer system 100 determines a priority for each portion that is available for display, and displays (e.g., up to the maximum number of portions) the highest priority portions (e.g., in FIG. 9J, the computer system 100 does not display the portion 9004, because the content of the portion 9004 is not currently time-critical (e.g., the flight for which tickets are confirmed is in six days), as compared to the content corresponding to the displayed portions (e.g., each of the portions 9018, 9010, and 9016, correspond to content and/or action items to be addressed on the current day).

In FIG. 9K, in response to detecting a user input 9022 on the visual indicator 9020 (e.g., as shown in FIG. 9J), the computer system 100 displays an expanded version of the region 9000. In some embodiments, the expanded version of the region 9000 is not subject to the maximum number of portions. For example, while the portion 9004 was not displayed in FIG. 9J (e.g., because the maximum number of displayed portions is 3), but the portion 9004 is displayed in expanded version of the region 9000 in FIG. 9K (e.g., even though that brings the total number of displayed portions to four, which is above the maximum of three).

In some embodiments, if a portion (e.g., the portion 9016) of the region 9000 includes a combination of notifications and/or summaries, the expanded version of the region 9000 includes a separate portion of each notification and/or summary that was combined (e.g., in the non-expanded version of the region 9000).

In FIG. 9L, in response to detecting a user input 9024 (e.g., a leftward swipe input, as shown in FIG. 9K) directed to a portion (e.g., the portion 9010) of the region 9000, the computer system 100 displays an animation of a border of the region 9000 deforming in accordance with the user input 9024. For example, in FIG. 9L, as the user input 9024 moves towards the left side of the display of the computer system 100, a portion of the border (e.g., corresponding to the portion 9010) of the region 9000 begins to stretch and deform towards the left of the display (e.g., optionally, by an amount that is proportional to the amount of movement of the user input 9024). In some embodiments, the computer system 100 displays the animation of the border deforming in accordance with an analogous user input that is detected while displaying a non-expanded version of the region 9000 (e.g., as shown in FIG. 9J).

FIG. 9M shows that, if (e.g., and/or when) the user input 9024 meets and/or exceeds a threshold amount of movement, the computer system 100 displays separate representations of each portion of the region 9000. In some embodiments, displaying the separate representation of each portion of the region 9000 includes displaying an animation of the (e.g., expanded version of the) region 9000 splitting apart into the individual representation of each portion of the region.

The separate representation of the portion 9010 is offset to the left (e.g., as compared to the other representations of the other portions in FIG. 9M), to display an affordance 9028 and an affordance 9030. In some embodiments, in response to detecting a user input 9034 directed to the affordance 9028, the computer system 100 displays additional options for interacting with representation of the portion 9010 (e.g., an option to configure settings relating to delivery of notifications and/or notification content relating to the email application M, which corresponds to the portion 9010; an option to configure settings relating to whether content for the email application M can and/or should appear in the region 9000; an option to indicate that content of the portion 9010 and/or content that is related to the content of the portion 9010 should or should not appear in the region 9000; and/or an option to configure settings relating to what content is or is not included in the region 9000). In some embodiments, in response to detecting a user input 9036 directed to the affordance 9030, the computer system 100 removes the portion 9010 from the region 9000 (e.g., and also ceases to display the representation of the portion 9010 in FIG. 9M). In some embodiments, in response to detecting a user input 9032 (e.g., a rightward swipe, or an input involving movement in an opposite direction as compared to the user input 9024), the computer system 100 ceases to display the portion 9010 with the offset (e.g., the representation of the portion 9010 is displayed with the same horizontal alignment as the other representation of the portions of the region 9000). In some embodiments, in response to detecting a user input analogous to the user input 9032 (e.g., a rightward swipe) on the portion 9010 (e.g., prior to displaying the separate representations of the region 9000, as in FIG. 9L), the computer system displays at least one affordance for accessing at least one function (e.g., an “open” functions that opens the email application M, which corresponds to the portion 9010, to display the full application content corresponding to the portion 9010) different than those described with reference to the affordance 9028 and the affordance 9030.

In some embodiments, a portion (e.g., the portion 9016) of the region 9000 that includes a combination of notifications and/or summaries, splits (e.g., further splits) into separate representations for each notification and/or summary that was combined. For example, the portion 9016 (e.g., in the expanded version of the region 9000 in FIG. 9L) splits into a portion 9016-a (e.g., corresponding to the summary 9014 in FIG. 9G) and a portion 9016-b (e.g., corresponding to summary 9008 in FIG. 9C).

FIG. 9N shows an alternative (e.g., to FIG. 9M), where the user input 9024 terminates before meeting and/or exceeding the threshold amount of movement. In response to detecting the termination of the user input 9024, the computer system 100 ceases to display the animation that includes the border of the region 9000 deforming in accordance with the user input 9024 (e.g., and deformation of the border of the region 9000 is at least partially undone and/or reverted, such that the region 9000 has the same appearance as in FIG. 9K, prior to detecting the user input 9024).

In FIG. 9O, in response to detecting a user input 9038 (e.g., as shown in FIG. 9N) directed to the portion 9016 of the region 9000, the computer system 100 displays separate representations of the portions of the region 9000. FIG. 9O is analogous to FIG. 9M, but without any offset for the representation of the portion 9010. In some embodiments, if the user input 9038 is directed to a portion of the region 9000 that does not combine multiple notifications and/or summaries (e.g., the portion 9018, the portion 9010, and/or the portion 9004, in FIG. 9N), the computer system 100 displays additional content (e.g., and optionally, an application user interface that includes application content) that corresponds to the event that corresponds to the selected portion of the region 9000 (e.g., in response to detecting the user input 9038). In some embodiments, the region 9000 behaves in an analogous manner as described above with reference to FIG. 9L (e.g., the border of the region 9000 deforms in accordance with movement of the user input 9038, until the user input 9038 meets and/or exceeds a movement threshold, at which point the computer system 100 displays the separate representations of the region 9000; and if the user input 9038 terminates before meeting and/or exceeding the movement threshold, the computer system 100 reverses (e.g., at least partially reverses) the deformation of the border of the region 9000).

In some embodiments, the user input 9038 is a tap input. In some embodiments, the user input 9038 is a long press input. In some embodiments, the computer system 100 performs different functions depending on the type of input (e.g., a tap input open the application user interface that include application content, and a long press input displays additional content (e.g., without opening the application user interface) corresponding to the event that corresponds to the selected portion of the region 9000).

In some embodiments, the user input 9038 is not directed to a specific portion of the region 9000, and instead the user input 9038 includes movement in a specific (e.g., predefined) direction. For example, the user input 9038 is an upward or downward swipe along or within the region 9000 (e.g., that may cross into and/or through multiple portions of the region 9000).

In some embodiments, in response to detecting a user input directed to a location outside of the representations of the portions of the region 9000, the computer system 100 ceases to display separate representations of the portions of the region 9000, and displays (e.g., redisplays) the region 9000 (e.g., as a single user interface element).

FIGS. 9P and 9Q shows the relative position (e.g., and/or level of prominence) of the region 9000, relative to other user interface elements. In FIG. 9P, the region 9000 is displayed above (e.g., with a higher level of prominence) as compared to the notification 9012 and the notification 5014 (e.g., notifications including content that is not prioritized and/or highlighted). The region 9000, however, is displayed below a notification 9040. The notification 9040 is a “critical,” time-sensitive, and/or high importance notification (e.g., notifications relating to immediate health complications; or notifications relating to immediate weather and/or environmental hazards). In some embodiments, “critical” alerts are displayed above (e.g., with a higher level of prominence than) the region 9000, and remain displayed above the region 9000 for as long as the “critical” alert remains relevant (e.g., until after detected biometrics no longer indicate an immediate health complication; or after weather and/or environmental conditions are no longer hazardous).

FIG. 9Q is analogous to FIG. 9P, but with respect to a summary 9042 instead of a “critical” notification (e.g., the notification 9040). The summary 9042 includes content that is updated periodically over time. For example, the summary 9042 corresponds to a food delivery application F, and updates over time to reflect the current status of a food delivery (e.g., placed on and/or via the computer system 100). Since the summary 9042 updates periodically over time (e.g., in order to provide real-time feedback to the user regarding the food order), the summary 9042 is displayed above (e.g., with a higher level of prominence than) the region 9000.

FIG. 9R shows a region 9044, which is different from the region 9000 discussed above. In some embodiments, a region includes different content based on context. For example, in FIGS. 9A-9Q, the region 9000 includes content that the computer system 100 determines should be prioritized and/or highlighted (e.g., based on relevance and/or importance).

In contrast (e.g., to FIG. 9J or 9Q), in FIG. 9R, the region 9044 includes content corresponding to events that were detected while a particular mode (e.g., a “driving” mode, in which notifications are suppressed while the user of the computer system 100 is operating a vehicle in communication with the computer system 100) is active for the computer system 100. The region 9044 includes a portion 9043 (e.g., analogous to the portion 9018 of the region 9000, and corresponding to the notification 6026 (e.g., in FIG. 9I) which would have been delivered and/or displayed at 9:49, but was suppressed due to the “driving” mode being active for the computer system 100), a portion 9045 (e.g., analogous to the portion 9016-b of the region 9000, and corresponding to the summary 9014 (e.g., in FIG. 9G) which was also suppressed due to the “driving” mode being active), and a portion 9047 (e.g., corresponding to the notification 9012 in FIG. 9E) which does not have an analogous portion of the region 9000 (e.g., because the notification 9012 did not meet relevance criteria, and/or the computer system 100 determined that the notification 9012 should not be prioritized and/or highlighted).

The summary 9008 in FIG. 9R is displayed separately from (e.g., distinct from) the region 9044 (e.g., in contrast to the portion 9010 of the region 9000 in previous figures), because the “driving” mode of the computer system 100 was not active at 9:25 (e.g., the time when the event corresponding to the summary 9008 was detected by the computer system 100). Similarly, the notification 5012 is displayed separately from the region 9044 (e.g., in contrast to the portion 9002 of the region 9000 in, e.g., FIGS. 9B and 9E), because the “driving” mode of the computer system 100 was not active at 9:25.

FIGS. 9S-9V show embodiments where content is prioritized and/or highlighted on multiple and/or different computer systems.

FIG. 9S shows the user interface 5000 of the computer system 100, including the region 9000, the notification 9012, the notification 5014, and the notification 9006 (e.g., displayed as a reduced scale representation to indicate that additional notifications are available for display, e.g., in response to detecting a user input).

The upper half of FIG. 9T shows a user interface 9046 of a computer system 200 (e.g., a second computer system in communication with the computer system 100; or a peripheral device in communication with the first computer system 100). The user interface 9046 includes a watch face (e.g., that indicates the current time), and an indicator 9048 (e.g., that indicates that at least one (e.g., unread) notifications is available for display. The computer system 200 includes an input device 9052 (e.g., a mechanical input device such as a button, a crown, or a touch-sensitive surface). In the lower half of FIG. 9T, in response to detecting a user input 9050 (e.g., a downward swipe, in the upper half of FIG. 9T), the computer system 200 displays a region 9056 and a notification 9064. The region 9056 includes a portion 9058 (e.g., analogous to the portion 9018 of the region 9000, for the computer system 100), a portion 9060 (e.g., analogous to the portion 9010 of the region 9000, for the computer system 100), and a portion 9062 (e.g., analogous to the portion 9016 of the region 9000, for the computer system 100). In some embodiments, in response to detecting a user input directed to a portion of the region 9056 (e.g., a user input 9066 directed to the portion 9058; a user input 9068 directed to the portion 9060; or a user input 9070 directed to the portion 9062), the computer system 200 displays additional content (e.g., additional notification content, or an application user interface that includes application content) corresponding to the particular portion of the region 9056.

FIG. 9U is analogous to FIG. 9S, and is used to show communication with the computer system 200, in accordance with some embodiments.

The upper half of FIG. 9V is analogous to the upper half of FIG. 9T, but with different content in the region 9056. In some embodiments, the region 9056 displays one or more portions that correspond to content received from an external source (e.g., from the computer system 100). In some embodiments, portions of the region 9056 corresponding to and/or including content received from an external source display a visual indication (e.g., a visual indicator of the external source). For example, the computer system 100 transmits content (e.g., as shown by the solid arrow originating from the portion 9018) corresponding to the portion 9018 of the region 9000, to the computer system 200, and the computer system 200 displays the received content in the portion 9058 of the region 9056. Similarly, the computer system 100 transmits content (e.g., as shown by the solid arrow originating from the portion 9016) corresponding to the portion 9016 of the region 9000, to the computer system 200, and the computer system 200 displays the received content in the portion 9062 of the region 9056. Both the portion 9058 and the portion 9062 include a visual indication (e.g., a phone icon) in the lower left (e.g., near an indication of an application corresponding to the respective portion), which indicates that content was received from an external device (e.g., the computer system 100).

In some embodiments, the region 9056 includes display of at least one portion that corresponds to content that was not received from an external source. For example, a portion 9072 corresponds to content not received from the computer system 100 (e.g., and instead corresponds to a notification that was generated by (e.g., and optionally, summarized by) the computer system 200 independent of the computer system 100). The portion 9072 does not include a visual indication like the portions 9058 and the portion 9062, because the content corresponding to the portion 9072 was not received from an external source.

In some embodiments, the region 9056 includes a portion that includes content that was generated by the computer system 200, but was transmitted to an external source (e.g., as shown by the dotted, two-way arrow between the computer system 200 and the computer system 100). For example, the computer system 200 detects an event corresponding to a news story for an incoming stormfront. The computer system 200 transmits content corresponding to this event to the computer system 100, and the computer system 100 determines whether the received content should be prioritized and/or highlighted (and also, optionally, summarizes the received content). The computer system 100 then transmits the determination (e.g., and optionally, the summary) to the computer system 200. If the computer system 100 determined that the content should be prioritized and/or highlighted, the computer system 200 displays the content in the region 9056 (e.g., in the portion 9072, as shown in FIG. 9V). If the computer system 100 determines that the content should not be prioritized and/or highlighted, the computer system 200 does not display the portion 9072 in the region 9056 (e.g., and optionally, instead displays a separate notification that is distinct from the region 9056).

In the lower half of FIG. 9V, in response to detecting a user input 9052 (e.g., as shown in the upper half of FIG. 9T) directed to the input device 9052 (e.g., a rotation input that rotates a crown, or a physical activation of a button, or a swipe input along a touch-sensitive surface), the computer system 200 scrolls display of user interface elements. For example, in response to detecting the user input 9052, the region 9056 is scrolled down (e.g., and mostly off the display), which the notification 9064 (e.g., which is only partially displayed in the upper half of FIG. 9V) scrolls on to the display (e.g., and is displayed in full). In some embodiments, in response to repeated user inputs (e.g., and/or a continuation of the user input 9074, in the same direction of motion), the computer system 200 continues to scroll display of user interface elements (e.g., further rotation of the input device 9052 by the user input 9074 would cause the notification 9064 to scroll down and mostly off the display, while a notification 9076 (e.g., which is only partially displayed in FIG. 9V) would scroll on to the display and be displayed in full). In some embodiments, in response to detecting an opposite user input (e.g., including motion in an opposite direction from the user input 9074), the computer system 100 scrolls display of user interface elements in a reverse manner (e.g., scrolls upward, rather than downward). This allows the user to scroll through displayable content in either direction, based on a direction of movement of a user input directed to the input device 9052.

FIG. 9W shows an expanded view of the user interface 5000 (e.g., optionally, displayed in response to detecting a user input directed to the user interface 5000, that is a request to display additional content). The expanded view shows the relative positioning of different user interface elements (e.g., which are ordered by priority and/or importance). For example, “critical” notifications such as the notification 9040 (e.g., described above with reference to FIG. 9P) are displayed at the top (e.g., with the highest priority, importance, and/or level of prominence). Notifications and/or summaries, such as the summary 9042 (e.g., described above with reference to FIG. 9Q), which are updated periodically over time, are displayed below “critical” notifications but above other user interface elements. The region 9000 is displayed below notifications that are periodically updated over time, but above other user interface elements. Finally, other notifications (e.g., the notification 5014 and the notification 5012) which are not determined (e.g., by the computer system 100) to require prioritization and/or highlighting (e.g., should not be displayed within the region 9000) are displayed with the lowest priority, importance, and/or level of prominence. In some embodiments, the other notifications are ordered in reverse temporal order (e.g., a default order in which notifications are ordered when not considering prioritization, importance, and/or highlighting).

FIGS. 9X-9Z show an example layout of the region 9000 and other user interface elements. In FIGS. 9A-9W, the user interface 5000 is shown with a layout that avoids overlapping of displayed user interface elements (e.g., except when necessary, such as at the bottom of the display, to indicate that additional content is available for display). In contrast, in FIGS. 9X-9Z, the layout shown intentionally overlaps user interface elements (e.g., even when there is sufficient space in the user interface 5000 to display all user interface elements without overlapping). This alternate layout enables more of a background (e.g., image and/or wallpaper) of the user interface 5000 to be visible, and also reduces the amount of user interface elements displayed (e.g., concurrently displayed) (e.g., to facilitate improved user focus and/or to enable the user to easily locate important or high priority content).

In FIG. 9X, the region 9000 is displayed as partially overlapping the notification 9012. At least a portion of the notification 9012 is visible (e.g., to indicate that additional content, including the notification 9012, is available for display). FIG. 9X also shows a side view 9078. In the side view 9078, the region 9000 is further forward than the notification 9012.

In FIG. 9Y, the computer system 100 detects a new event and display a new notification 9080. The new notification 9080 is displayed below the region 9000, but at the same depth (e.g., in the side view 9078, the region 9000 and the notification 9080 are displayed at the same distance from the front of the computer system 100, and both are displayed further forward than the notification 9012).

In FIG. 9Z, the computer system 100 displays an animation of the region 9000 as “lifting up” (e.g., moving closer to the perspective of the user, and or rising relative to the display of the computer system 100), and moving to (e.g., partially) overlap the notification 9012. The notification 9080 is “pushed back” (e.g., to take the original location of the notification 9012), and overlaps (e.g., at least partially overlaps) the notification 9012. At least a portion of the notification 9080 and the notification 9012 are visible (e.g., to indicate that additional content, including the notification 9080 and the notification 9012, is available for display.

In some embodiments, the computer system 100 can display a maximum number of user interface elements (e.g., three user interface elements). If a new event is detected, and a new notification is displayed, the new notification follows an analogous process as the one described above with reference to FIGS. 9Y-9Z. The new notification takes the position that the notification 9080 occupies in FIG. 9Z, the notification 9080 moves to take the position that the notification 9012 occupies in FIG. 9Z, and the notification 9012 ceases to be displayed (e.g., because the maximum number of user interface elements is three).

FIGS. 10A-10I are flow diagrams illustrating method 10000 of providing summary content for a single event, in accordance with some embodiments. Method 10000 is performed at an electronic device or computer system (e.g., device 300, FIG. 3A, or portable multifunction device 100, FIG. 1A) that is in communication with a display generation component, and one or more input devices. In some embodiments, the display generation component is a touch-screen display and the touch-sensitive surface is on or integrated with the display. In some embodiments, the display is separate from the touch-sensitive surface. Some operations in method 10000 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Displaying a first notification for a first event that corresponds to first content of a first application that includes a first automatically generated summary that is based at least on the first content of the first application and includes automatically generated content (e.g., automatically-generated text content and/or automatically-generated audio content and/or generative text and/or audio content) that is not part of the first content, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

At a computer system that is in communication with a display generation component and one or more input devices (e.g., one or more sensors and/or devices for detecting user inputs): the computer system detects (10002) a first event that corresponds to first content of a first application (e.g., application content designated for inclusion in a notification (e.g., application content for inclusion in the notification 5012, the notification 5014, the notification 5016, the notification 5018, and/or the notification 5020 in FIG. 5B), such as content from a received text message, content of a news alert, content of a weather alert, content of a location-based alert, and/or other application content (e.g., generated by an application for inclusion in a notification)). In some embodiments, content of an application is distinguished from metadata associated with the content or other objects of the application, and includes text and/or graphics that is displayed in a user interface or user interface object of the application to convey information to the user visually.

After (e.g., in response to or at a later time after) detecting the first event, the computer system displays (10004) a first notification for the first event (e.g., the summary 5024, the summary 5026, and/or the summary 5028 in FIG. 5C), including a first automatically generated summary (e.g., summary content of the summary 5024, the summary 5026, and/or the summary 5028 in FIG. 5C) that is based on at least the first content of the first application (e.g., a summary generated using and/or with the assistance of artificial intelligence (e.g., using an AI process or generative AI process), machine learning, and/or a language learning model), wherein the first automatically generated summary includes automatically generated content (e.g., automatically-generated text content and/or generative text content) that is not part of the first content of the first application (e.g., the summary includes automatically generated content that is not included in the first content of the first application, the first automatically generated summary includes automatically generated content that is not included in application content, or the automatically generated summary is generated by the operating system and is not provided by the first application)) (e.g., the first content shown in FIG. 5F does not use the exact phrase “updated draft addressing Mike's concerns” that appears in the summary 5024 (e.g., in FIG. 5C) or the expanded version 5042 of the summary 5024 (e.g., in FIG. 5E); and the summary 5024 in FIG. 5C (and the expanded version 5042 of the summary 5024 in FIG. 5E) mentions that Jane wants the draft before the user flies out, which is not mentioned in the first content shown in FIG. 5F).

In some embodiments, while displaying the first notification for the first event, including the first automatically generated summary (e.g., automatically-generated text content and/or generative text content) of the first content of the first application, the computer system displays (10006) a second notification for a second event, concurrently with the first notification for the first event that includes the first automatically generated summary of the first content of the first application. In some embodiments, the second notification is displayed in response to detecting a second event that corresponds to second content (e.g., application content to be included in a notification, such as content from a received text message, content of a news alert, content of a weather alert, content of a location-based alert, and/or other application content (e.g., generated by an application for inclusion in a notification)). For example, in FIG. 5C, the summary 5028 is concurrently displayed with the summary 5024, the notification 5016, and the summary 5026. In some embodiments, at an earlier time (e.g., 2 hours ago, at 6:07 AM), the summary 5028 is initially displayed alone (e.g., prior to detecting events corresponding to the summary 5024, the notification 5016, the summary 5026, and the summary 5028). At a later time (e.g., at 7:42 AM), the computer system 100 detects an event corresponding to a notification (e.g., the notification 5018 in FIG. 6C) of the summary 5026, and in response (e.g., and while displaying (e.g., while maintaining display of) the summary 5028), the computer system 100 displays the summary 5026 (e.g., including summary content corresponding to the notification 5018). At an even later time (e.g., 7:56 AM), the computer system 100 detects an event corresponding to the notification 5016, and in response (e.g., and while displaying the summary 5028 and the summary 5026), the computer system 100 displays the notification 5016. Displaying a second notification concurrently with the first notification that includes the first automatically generated summary of the first content of the first application, reduces the numbers of inputs required by the user to review notifications saving the user time, improves the efficiency of the device, and provides improved visual feedback to the user (e.g., improved visual feedback regarding the organization and content of the notifications on the display).

In some embodiments, the second notification for the second event includes (10008) a second automatically generated summary (e.g., automatically-generated text content and/or generative text content) that is based at least in part on second content of a second application (e.g., a summary generated using and/or with the assistance of artificial intelligence, machine learning, and/or a language learning model), wherein the second automatically generated summary includes automatically generated content that is not part of the second content of the second application (e.g., the automatically generated content is not included in the second content of the second application, the second automatically generated summary is not included in application content, or the second automatically generated summary is generated by the operating system and is not provided by the second application)). For example, in FIG. 5C, the summary 5028 (e.g., including summary content corresponding to a news application) is concurrently displayed with the summary 5026 (e.g., including summary content corresponding to an email application, a restaurant reservation application, and an airline application). Displaying a second notification for a first event that corresponds to first content of a second application that includes a second automatically generated summary that is based at least on the first content of the first application and includes automatically generated content that is not part of the first content, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, displaying the first notification (and/or displaying the second notification) includes (10010) displaying the first notification (and/or the second notification) in a first system user interface, wherein the first system user interface includes one or more user interface objects associated with the first application and one or more user interface objects associated with a third application (e.g., the second application or one or more other applications) that is different from the first application (e.g., a system user interface that is configured to display a plurality of notifications, optionally, from a plurality of different sources (e.g., notifications corresponding to different applications and/or system alerts) and/or a plurality of different times (e.g., a notification history), such as a notification center user interface or a lock screen user interface). For example, in FIG. 5C, the user interface 5000 is a lock screen of the computer system 100, and includes the summary 5024, the notification 5016, the summary 5026, and the summary 5028. Displaying the first notification in a first system user interface that includes one or more user interface objects associated with the first application and one or more user interface objects associated with the third application that is different from the first application, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the first automatically generated summary is generated (10012) by a machine learning algorithm (e.g., using an AI process or a generative AI process) based on at least the first content of the first application (and optionally, other sources of information and/or content such as the states and/or interaction history of the computer system and the application content of other applications different from the first application). In some embodiments, the machine learning algorithm takes the first content, such as textual content of messages and emails, images, notification content, associated metadata, related to the first event as input, to generate the first automatically generated summary (e.g., using one or more generative AI models such as large language models trained on words or word tokens). In some embodiments, the machine learning algorithm outputs content that is not included in the first content of the first application as part of the first automatically generated summary. For example, as described with reference to FIG. 5C, in some embodiments, the summary content (e.g., of the summary 5024, the summary 5026, and/or the summary 5028) is automatically generated using a machine learning (ML) algorithm. Displaying a first notification for a first event that corresponds to first content of a first application that includes a first automatically generated summary that is automatically generated by a machine learning algorithm based at least on the first content of the first application and includes automatically generated content that is not part of the first content, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the first automatically generated summary is generated (10014) by a large language model (e.g., using an AI process or a generative AI process) based on at least the first content of the first application (and optionally, other sources of information and/or content such as the states and/or interaction history of the computer system and the application content of other applications different from the first application). In some embodiments, the large language model takes the first content, such as textual content of messages and emails, images, notification content, associated metadata, related to the first event as input, to generate the first automatically generated summary. In some embodiments, the large language model outputs content that is not included in the first content of the first application as part of the first automatically generated summary. For example, as described with reference to FIG. 5C, in some embodiments, the summary content (e.g., of the summary 5024, the summary 5026, and/or the summary 5028) is automatically generated using a large language model (LLM). Displaying a first notification for a first event that corresponds to first content of a first application that includes a first automatically generated summary that is automatically generated by a large language model based at least on the first content of the first application and includes automatically generated content that is not part of the first content, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the computer system displays (10016) (e.g., in response to detecting that criteria for displaying the second system user interface are met) a second system user interface (e.g., a system user interface that includes a notification display region), including two or more notifications that include automatically generated summaries (e.g., the first notification that includes the first automatically generated summary, the second notification that includes the second automatically generated summary, and/or other notifications that includes respective automatically generated summaries based on respective application content that triggered the display of the notifications). In some embodiments, the second system user interface includes the first system user interface that is redisplayed in response to an event (e.g., arrival of a new notification, updates to an existing notification displayed in the second system user interface, a user input that wakes up the computer system from a low power state, a user input that brings down a coversheet user interface, a user input that locks the computer system, or another event that triggers the display of the second system user interface), after the first system user interface including the first notification that includes the first automatically generated summary and the second notification that includes the second automatically generated summary, is dismissed and/or displayed in a low power state. For example, in FIG. 5C, the computer system 100 displays the user interface 5000, which includes the summary 5024, the summary 5026, and the summary 5028 (e.g., and each summary includes automatically generated summaries corresponding to different notifications and applications). Displaying two or more notifications that include generated summaries on a second user interface provides improved visual feedback to the user in regarding the two or more notifications, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the computer system displays (10018) a third notification concurrently with the first notification for the first event, wherein the third notification does not include an automatically generated summary that is based on third content of a third application (e.g., the third notification includes the third content of the third application in the body of the third notification). In some embodiments, the computer system displays the third notification in response to detecting a third event that corresponds to third content of a third application (e.g., the first application, the second application, or a third application that is different from the first application and the second application). In some embodiments, the computer system only generates summaries for some events, for example, for events of a subset of applications that have triggered notifications, for events related to a subset of topics in the application content of the applications that have triggered notifications, for application content that mentioned some names and people, for application content that is long and difficult to comprehend at a glance, for events that occurred during a subset of contexts (e.g., user is driving, or otherwise occupied to make reading long notifications or many notifications difficult) in which application content have triggered notifications, and/or based on other criteria that selects suitable for automatic summarization. For example, in FIG. 5C, the summary 5028 is concurrently displayed with the summary 5024, the notification 5016, and the summary 5026. In some embodiments, at an earlier time (e.g., 7:50 AM), the summary 5028 and the summary 5026 are initially displayed without displaying the notification 5016 (e.g., or the summary 5024). At a later time (e.g., 7:56 AM), the computer system 100 detects an event corresponding to the notification 5016, and in response (e.g., and while displaying the summary 5028 and the summary 5026), the computer system 100 displays the notification 5016. Displaying a third notification concurrently with the first notification for the first event, wherein the third notification does not include an automatically generated summary that is based on the third content of the third application, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the computer system displays (10020) a first plurality of notifications, including the first notification, that include automatically generated summaries, concurrently with a second plurality of notifications, including the third notification, that do not include automatically generated summaries, wherein concurrently displaying the first plurality of notifications and the second plurality of notifications includes:
displaying notifications in the first plurality of notifications with a first set of visual characteristics (e.g., an outline, a highlighting, a badge, an indicator, a changed font, a color, and/or other characteristics) that distinguishes the notifications in the first plurality of notifications, from the notifications in the second plurality of notifications (e.g., the respective notifications of the second plurality of notifications do not have the first set of characteristics). For example, in FIG. 5C, the summary 5024, the summary 5026, and the summary 5028 are displayed with a different visual appearance (e.g., a bolded border, and including an asterisk symbol in the upper right corner), as compared to the notification 5016. Displaying the first and second plurality of notifications include distinguishing the first plurality of notifications that include automatically generated summaries from the notifications in the second plurality of notifications by a first set of visual characteristics, provides improved visual feedback to the user by differentiating the first and second plurality of notifications to identify relevant information more efficiently.

In some embodiments, the first set of visual characteristics includes (10022) a first appearance property of notification text (e.g., font, text color, text style, or other properties that change the appearance of text in the notifications) of a notification that has the first set of visual characteristics. For example, as described above with reference to FIG. 5C, in some embodiments, summaries (e.g., summary content displayed in and/or corresponding to a summary) are displayed with a different text color, a different text size, and/or a different text font. Displaying the first and second plurality of notifications include distinguishing the first plurality of notifications that include automatically generated summaries from the notifications in the second plurality of notifications by a first set of visual characteristics includes a first appearance property of notification text provides improved visual feedback to the user by differentiating the first and second plurality of notifications to identify relevant information more efficiently.

In some embodiments, the first set of visual characteristics includes (10024) a first type of outline (e.g., a thickened outline, an outline of a different color, highlighted outline, an outline with a first line style, or other types of outlines that are distinguished from the outline of a notification that does not include automatically generated summary) around a notification that has the first set of visual characteristics. For example, in FIG. 5C, the summary 5024, the summary 5026, and the summary 5028 are displayed with a different visual appearance (e.g., a bolded border), as compared to the notification 5016. Displaying the first and second plurality of notifications include distinguishing the first plurality of notifications that include automatically generated summaries from the notifications in the second plurality of notifications by a first set of visual characteristics includes a first type of outline around a notification text provides improved visual feedback to the user by differentiating the first and second plurality of notifications to identify relevant information more efficiently.

In some embodiments, the first set of visual characteristics includes (10026) a first graphical indication (e.g., a star, a dot, an icon, a glyph, a set of glyphs, or other graphical indications) displayed in association with a notification that has the first set of visual characteristics. For example, in FIG. 5C, the summary 5024, the summary 5026, and the summary 5028 are displayed with a graphical indication (e.g., an asterisk in the upper right corner), while the notification 5016 is not displayed with the graphical indication. Displaying the first and second plurality of notifications include distinguishing the first plurality of notifications that include automatically generated summaries from the notifications in the second plurality of notifications by a first set of visual characteristics includes a graphical indication provides improved visual feedback to the user by differentiating the first and second plurality of notifications to identify relevant information more efficiently.

In some embodiments, respective notifications of the first plurality of notifications are displayed (10028) with respective indications of time corresponding to when the automatically generated summaries of the first plurality of notifications were generated. In some embodiments, the time that corresponds to when the automatically generated summary for a respective notification was generated is different from the time that the application content that triggers the respective notification was generated or received. For example, the automatically generated summaries for multiple notifications may be generated in a batch at the same time, even though the original notifications were generated at different times prior to the time that the summaries were generated. For example, in FIG. 5C, the summary 5028 includes a time indicator “2 h ago,” which indicates that the summary 5028 (e.g., and/or the notification 5020 that corresponds to and/or is summarized by the summary 5028) was generated 2 hours ago, and the summary 5026 includes a time duration “last 30 m,” which indicates that the summary 5026 summarizes content received and/or generated over the last 30 minutes. Displaying the respective notifications of the first plurality of notifications with respective indications of time corresponding to when the automatically generated summaries of the first plurality of notifications were generated provides improved visual feedback to the user indicating time generated and lapse of time from the summary was generated and when the user is viewing the notification.

In some embodiments, the first content of the first application includes (10030) a first portion of content, a second portion of content, and one or more additional portions of content from the first application that separates the first portion of content and the second portion of content, and the first automatically generated summary is based on the first portion of content and the second portion of content, and does not include a summary of the one or more additional portions of content from the first application. In some embodiments, the different portions of content include different portions of a message from a messaging application, different portions of an email from an email application, different portions of a webpage from a browser application, different messages in a discussion thread from a social networking application, or other muti-portion application content from a respective application that triggers display of a notification. For example, in FIG. 5E, the summary content of the summary 5042 is based on a first portion of content (e.g., a sentence “Mike called me yesterday that we need to address.”) and a second portion of content (e.g., a sentence “Please work these into the report and send me an updated draft”) of the full email message shown in FIG. 5F, but does not summarize other portions of the email message (e.g., a sentence “I've attached my notes from my call with Mike”). Displaying a first notification for a first event that corresponds to first content of a first application that includes a first and a second portion of content separated by one or more additional portions of content from the first application, and the first automatically generated summary that is based on the first and the second portion, reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the first content of the first application includes (10032) content of a message (e.g., the message body and/or attachment of a message, and optionally, the sender, receiver, subject line, and/or other metadata of the message) from a messaging application (e.g., an email application, an instant messaging application, a text message, an SMS message, or an application message). For example, in FIG. 5E, the summary content of the summary 5024 includes content from a messaging application (e.g., an email application M), which is shown in the application user interface 5052 in FIG. 5F. Displaying a first notification for a first event that corresponds to first content of a first application wherein the first content of the first application includes content of a message from a messaging application reduces the numbers of inputs required by the user to review notifications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the first automatically generated summary is further based (10034) on first contextual information (e.g., the current date, time, day of the week, location, and/or other contextual information associated with the first content of the first application) that is not part of the first content of the first application. For example, when generating a summary of a message from “Lisa” that includes the message content “Thank you for the invitation for the flower show. If you are not busy, shall we have dinner afterwards?” the computer system generates the summary based on the message content, as well as date, time, and schedule information related to the “flower show” from a calendar application, and content of another email that makes reference to the same date (e.g., an email to “Bob” that says “Bob, I will review the report on Wed night.”). Based on these pieces of information, the computer system generates a summary that states “Lisa is wondering if you want to have dinner with her after the flower show on Wednesday. But you promised to review a report for Bob on Wed evening.” In another example, the summary for the notification for the messaging application can state “Lisa is wondering if you want to have dinner with her after the flower show on Wednesday. But it is going to rain on Wed” based on calendar information and weather information from the weather application. For example, in FIG. 5E, the summary content of the summary 5042 includes contextual information that the user should send the updated draft to Jane Doe “before you [the user] fly out.” The contextual information regarding the upcoming flight corresponds to content of the widget 5006 indicating an upcoming flight, which is contextual information that is not included in the email message in the application user interface 5052 in FIG. 5F. Displaying a first notification for a first event that corresponds to first content of a first application that includes a first automatically generated summary further based on contextual information that is not part of the first application, reduces the numbers of inputs required by the user to review notifications from various applications saving the user time (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

In some embodiments, the first content of the first application includes (10036) first information repeated (e.g., information that is reiterated, in exactly the same form, substantially the same form, and/or in alternative forms; and/or information that is redundant) in multiple portions of the first content (e.g., in a message thread of a group of users, a topic of discussion is repeated in multiple messages, and views of the different users can be grouped based on their similarity), and the first automatically generated summary does not repeat the first information in multiple portions of the first automatically generated summary. For example, the summary of a group discussion may remove redundant information such that messages from Bob “No, I do not agree.” “I have said it again and again that I do not agree.” “If you refer to my earlier message, I have already replied that I do not agree.” are summarized as “Bob is adamant that he does not agree with you on . . . ” For example, as described above with reference to FIG. 5C, in some embodiments, the summary content removes or reduces (e.g., does not include) redundant content (e.g., that would have appeared in a normal or un-summarized notification, and/or that is present in application content that would have been included and/or reproduced in a notification). Displaying a first notification for a first event that corresponds to first content of a first application, wherein the first content of the first application includes first information repeated in multiple portions of the first content, and includes a first automatically generated summary that does not repeat the first information in multiple portions, reduces the numbers of inputs required by the user to review notifications from various applications saving the user time (e.g., the automatically generated summary reduces scenarios where redundant content may require a user to perform additional user inputs to either expand a notification and/or open a corresponding application to view the full application content, when the redundant content causes relevant notification content not to be displayed), improves the efficiency of the device, and provides improved visual feedback to the user (e.g., improved visual feedback regarding the elimination of the display of repetitive information).

In some embodiments, the first content of the first application includes (10038) first metadata, and the first automatically generated summary does not include the first metadata. In some embodiments, the first content of the first application further includes second metadata, and the first automatically generated summary includes the second metadata or a summary of the second metadata. For example, as described above with reference to FIG. 5C, in some embodiments, the summary content removes (e.g., unnecessary) metadata (e.g., that would have appeared in a normal notification and/or that is present in application content that would have been included and/or reproduced in a notification). Displaying a first notification for a first event that corresponds to first content of a first application, wherein the first content of the first application includes first metadata, and includes a first automatically generated summary that does not include the first metadata, reduces the numbers of inputs required by the user to review notifications from various applications saving the user time, improves the efficiency of the device, and provides improved visual feedback to the user (e.g., improved visual feedback regarding the elimination of the display of unnecessary metadata).

In some embodiments, the first content of the first application includes (10040) one or more opening phrases followed by an information body, and the first automatically generated summary does not include the one or more opening phrases. For example, for a message from Lisa that reads “Bob, it was great hearing from you. Thank you for your inquiry. Unfortunately, I do not have the information you need. Please direct your inquiries to Mike,” the automatically generated summary removes the opening phrases such as “it was great hearing from you” and “thank you for your inquiry” and instead provides a summary “Lisa wants you to redirect your inquiry to Mike.” For example, in FIG. 5F, the email message in the application user interface 5052 includes an opener phrase “Hi John,” followed by an information body (e.g., the content of the email between “Hi John,” and “Thanks, Jane”). The summary content of the summary 5042 in FIG. 5E does not include the opener phrase “Hi John,” (e.g., but the opener phrase appears in the notification 5044, which reproduces portions of the email without removing opener phrases). Displaying a first notification for a first event that corresponds to first content of a first application, wherein the first content of the first application includes one or more opening phrases followed by an information body, and includes a first automatically generated summary that does not include one or more opening phrases, reduces the numbers of inputs required by the user to review notifications from various applications saving the user time (e.g., the automatically generated summary reduces scenarios where including opening phrases in notification content may require a user to perform additional user inputs to either expand a notification and/or open a corresponding application to view the full application content, when the opening phrases cause relevant notification content not to be displayed), improves the efficiency of the device, and provides improved visual feedback to the user (e.g., improved visual feedback regarding the elimination of the display of human generated communication opener phrases).

In some embodiments, the computer system displays (10042) a first group notification for a plurality of events, including a fourth event corresponding to fourth content from a fourth application and a fifth event corresponding to fifth content from a fifth application, wherein the plurality of events are related to one another in accordance with first criteria (e.g., criteria based on similarity and/or relatedness of content, subject matter, sender, receiver, time, location, and/or other content or context-based criteria), and wherein the first group notification includes a respective automatically generated summary that is based on at least the fourth content from the fourth application and the fifth content from the fifth application. In some embodiments, the computer system displays the first group notification for the plurality of events in response to detecting the plurality of events (e.g., multiple events generated by one or more applications, for respective application content of the one or more applications, at the same time or at different points in time) (e.g., in response to detecting a subset, all, the first, the last, and/or representative events of the first plurality of events). For example, the summary 5026 in FIG. 5C and FIG. 6B, is a group notification (e.g., group summary) for a plurality of events (e.g., events corresponding to the notification 5012, the notification 5014, and the notification 5018, as shown in FIG. 6C). Displaying a first group notification for a plurality of events, including a fourth event corresponding to a fourth content from a fourth application and a fifth event corresponding to a fifth application, wherein the plurality of events are related to one another in accordance with the first criteria and wherein the first group notification includes a respective automatically generated summary at least based from the fourth and fifth content reduces the numbers of inputs required by the user to review notifications from various applications (e.g., the user does not need to separately navigate to and/or separately view the fourth content and the fifth content), improves the efficiency of the device, and provides improved visual feedback to the user (e.g., improved visual feedback regarding the organization and content of the notifications on the display).

In some embodiments, while displaying the first notification in a respective user interface (e.g., the wake screen, a notification region of a system user interface, or another user interface that persistently displays notifications for an extended period of time), the computer system detects (10044) a request to dismiss the respective user interface (e.g., a user input that turns off the display or puts the display into a low-power always-on state, a user input that dismisses the wake screen and transitions the computer system out of the restricted state, or elapse of time and prolonged inactivity that causes the computer system to go into a low-power always-on state). In response to detecting the request to dismiss the respective user interface, the computer system ceases to display the respective user interface and the first notification. After ceasing to display the respective user interface and the first notification, the computer system detects a request to display the respective user interface (e.g., a user input that turns on the display or wakes the display from the low-power always-on state to a normal state, a user input that locks the computer system and transitions the computer system into a restricted state, or other events that wakes the display and causes display of the respective user interface). In response to detecting the request to display the respective user interface: in accordance with a determination that notification-clearing criteria are met for the first notification, wherein the notification-clearing criteria includes a first set of contextual conditions (e.g., the contextual conditions are evaluated against the current location, current time, and/or elapsed time since last display of the first notification), the computer system displays the respective user interface without displaying the first notification in the respective user interface (e.g., the first notification is cleared from the respective user interface, saved to notification history, or deleted from the computer system); and in accordance with a determination that notification-clearing criteria are not met for the first notification, the computer system displays the respective user interface with the first notification in the respective user interface. In some embodiments, a second notification may be displayed in the respective user interface with the first notification, and remains displayed in the respective user interface after the first notification is cleared from the respective user interface, because the notification-clearing criteria are not met for the second notification. In some embodiments, while the respective user interface is displayed, the computer system determines whether the notification-clearing criteria are met, and removes first notification from the respective user interface in accordance with a determination that the notification-clearing criteria are met for the first notification. For example, as described above with reference to FIG. 5C, in some embodiments, a summary is automatically cleared (e.g., removed from and/or no longer displayed in the user interface 5000) when the summary is no longer relevant (e.g., certain contextual criteria are met, a current location meets contextual criteria, a current time meets contextual criteria, a threshold amount of time has passed (e.g., since the summary was generated and/or viewed), and/or the user has viewed and/or interacted with the summary). Detecting a request to dismiss the user interface and ceasing to display the respective user interface and the first notification, in response to detecting a request to display the respective user interface, display the respective user interface without displaying the first notification in the respective user interface when the determination that notification-clearing criteria, including a first set of contextual conditions, are met, and display the respective user interface with the first notification in the respective user interface when the determination that the notification-clearing criteria, including a first set of contextual conditions, are not met, reduces the numbers of inputs required by the user to review notifications from various applications (e.g., the user does not need to perform additional user inputs to manually remove or clear notifications that are no longer relevant), improves the efficiency of the device, and provides improved visual feedback to the user (e.g., improved visual feedback regarding automatically clearing the notifications based on criteria).

In some embodiments, the computer system detects (10046) a respective event that corresponds to content of a respective application (e.g., a respective event that meets summarization criteria such as having content that meets a threshold content length, concluding a series of earlier events, corresponding to a last message of a plurality of messages transmitted in a short period of time of one another, and/or other criteria for generating a summary for an event). After (e.g., in response to or at a later time after) detecting the respective event: in accordance with a determination that summary generation is enabled for the respective application, the computer system generates a summary of the content of the respective application; and in accordance with a determination that summary generation is disabled for the respective application, the computer system forgoes generating a summary of the content of the respective application (e.g., generating a respective notification that does not include a summary the content of the respective application, but includes the content of the respective application directly). In some embodiments, whether a summary is generated for the content of a respective application can be configured by a user in a configuration user interface of notification generation or a configuration user interface of the respective application. In some embodiments, the computer system receives one or more configuration input from a user that disables automatic summary for notifications of one application, and/or enables automatic summary of another application, and, optionally, leaving the automatic summary generation setting for a third application unchanged. When an event that corresponds to respective content of a respective application is subsequently detected, the computer system determines whether to generate the summary based on the content of the respective event in accordance with whether the automatic summary setting is enabled or disabled for the respective application. For example, as described with reference to FIG. 5C, in some embodiments, the summary 5024 (e.g., or the summary 5026, or the summary 5028) is displayed in accordance with a determination that settings for the computer system 100 enable summaries for the mail application M corresponding to the summary 5024. In some embodiments, the user can configure some (e.g., but not all) applications to enable summaries to be generated for those applications, and can configure some applications to disable summaries for those applications (e.g., notifications will be delivered without summaries for those applications). Detecting a respective event that corresponds to content of a respective application, and after detecting the respective event, generating and forgoing generating a summary of the content of the respective application in accordance to the determination that the summary generation is enabled or disabled, respectively, reduces the numbers of inputs required by the user to review notifications from various applications (e.g., by enabling and/or disabling automatically generated summaries, when relevant), improves the efficiency of the device, and provides improved visual feedback to the user (e.g., improved visual feedback regarding the organization and content of the notifications on the display).

In some embodiments, the computer system is in communication with a second computer system that had detected occurrence of the first event before the computer system detected the first event, and the computer system detected the first event through communication with the second computer system (e.g., the computer system (e.g., a peripheral device, such as a smartwatch, an earphone, a smartphone device, a door bell, a thermostat, a smart home appliance, and/or another computer system) and the second computer system, such as a main device, such as a smartphone, a desktop computer, a tablet device, and/or another type of computer system, are paired devices, and can pass notifications detected locally to each other) (e.g., the content of a summary of the first event that is output at the computer system is optionally generated by the computer system locally, or generated by the second computer system and transmitted to the computer system before being output by the computer system), The computer system detects (10048) a respective event that corresponds to content of a respective application (e.g., a respective event that meets summarization criteria such as having content that meets a threshold content length, concluding a series of earlier events, corresponding to a last message of a plurality of messages transmitted in a short period of time of one another, and/or other criteria for generating a summary for an event). After (e.g., in response to, or at a later time after) detecting the respective event: in accordance with the respective event being detected via communication with the second computer system (e.g., in accordance with a determination that the respective event is detected via communication with the second computer system or a determination that the respective event is associated with an automatically generated summary generated by the second computer system) (e.g., the occurrence of the respective event is detected by the second computer system locally and passed onto the computer system by the second computer system), the computer system displays a respective notification for the respective event, including a respective automatically generated summary that is based on at least the content of the respective application (e.g., the automatically generated summary is optionally generated by the second computer system and transmitted to the computer system (e.g., along with or as part of communication regarding the occurrence of the respective event) to be output by the computer system), wherein the respective automatically generated summary includes generated content that is not part of the content of the respective application; and in accordance with the respective event being detected by the computer system locally (e.g., in accordance with a determination that the respective event is detected locally or a determination that the respective event is not associated with an automatically generated summary generated by the first computer system or generated by second computer system) (e.g., without requiring communication with the second computer system), the computer system displays the respective notification for the respective event without including a respective automatically generated summary that is based on at least the content of the respective application (e.g., the content of the respective notification does not include content that is not part of the content of the respective application) (e.g., the computer system is not capable of generating a summary locally for a locally detected event, and relies on the second computer system to generate summaries for events detected locally and/or events detected through communication with the second computer system). In some embodiments, when two computer systems are paired, they pass notifications detected locally to each other, such that notifications regarding a respective event detected at either computer system can be displayed at both computer systems. In some embodiments, a computer system (e.g., the computer system, such as a smart watch, an earphone, a vehicle dashboard, a smart home control device, or a door bell) that has a limited display detects an event through communication with another computer system that has a bigger display (e.g., a smartphone, a mobile device, a tablet device, or a desktop computer), and display a notification for the event that includes an automatically summary of the content corresponding to the event, rather than a notification that includes the non-summarized content corresponding to the event. The computer system does not automatically summarize content for a respective event that is detected locally, and displays a notification for the locally detected event without an automatically generated summary for the content corresponding to the locally detected event. For example, as described with reference to FIG. 5C, in some embodiments, the computer system 100 displays at least one locally generated notification (e.g., that is not summarized) and at least one summary (e.g., received from an external source such as the other computer system). Detecting a respective event that corresponds to content of a respective application, and after detecting the respective event, displaying a respective notification for the respective event, including and without including, a respective automatically generated summary that is based at least the content of the respective application in accordance to the determination that the respective event being detected via communication with a second computer system and by the computer system locally, respectively, enables more efficient design of (e.g., a reduces the cost to manufacture) the computer system (e.g., the computer system 100 does not need to include required software and/or processing power in order to generate summaries, and can instead receive summary content (e.g., when applicable) from an external source). This also reduces the numbers of inputs required by the user to review notifications from various applications (e.g., the automatically generated summary reduces scenarios where redundant content may require a user to perform additional user inputs to either expand a notification and/or open a corresponding application to view the full application content, when the redundant content causes relevant notification content not to be displayed), improves the efficiency of the device, and provides improved visual feedback to the user (e.g., improved visual feedback regarding the organization and content of the notifications on the display).

In some embodiments, after (e.g., in response to, or at a later time after) detecting the respective event: in accordance with the respective event being detected via communication with the second computer system (e.g., in accordance with a determination that the respective event is detected via communication with the second computer system or a determination that the respective event is associated with an automatically generated summary generated by the second computer system) (e.g., the occurrence of the respective event is detected by the second computer system locally and passed onto the computer system by the second computer system), the computer system displays (10050), concurrently with the respective notification for the respective event, including the respective automatically generated summary that is based on at least the content of the respective application (e.g., the content of the summary is optionally generated by the second computer system and transmitted to the computer system to be output at the computer system), a respective indication (e.g., an icon or identifier that identifies the second computer system that detected the respective event locally, or a generic icon to indicate a remote device that detected the respective event locally) that indicates that the respective event was detected remotely from the computer system; and in accordance with the respective event being detected by the computer system locally (e.g., without requiring communication with the second computer system), the computer system displays the respective notification for the respective event, without the respective indication and without including the respective automatically generated summary that is based on at least the content of the respective application. For example, as described with reference to FIG. 5C, in some embodiments, summaries that are received from the other computer system include a visual indicator (e.g., a badge, an icon, a distinct border, a distinct color, a distinct shape, a distinct text color, and/or a distinct background) that the summary was received from an external source (e.g., the other computer system), and locally generated notifications are not displayed with the visual indicator (e.g., the visual indicator denotes notifications and/or summaries received from an external source, and so is not applied to locally generated notifications). Displaying concurrently and without, a respective indication that indicates that the respective event was detected remotely from the computer system, in accordance to the determination that the respective event being detected via communication with a second computer system and by the computer system locally, respectively, reduces the numbers of inputs required by the user to review notifications from various applications saving the user time, improves the efficiency of the device, and provides improved visual feedback to the user (e.g., improved visual feedback regarding the source of the displayed summary or notification).

In some embodiments, the computer system is in communication with a third computer system, and the computer system detected the first event locally at the computer system (e.g., the third computer system (e.g., a peripheral device, such as a smartwatch, an earphone, a smartphone device, a door bell, a thermostat, a smart home appliance, and/or another computer system) and the computer system, such as a main device, such as a smartphone, a desktop computer, a tablet device, and/or another type of computer system, are paired devices, and can pass notifications detected locally to each other). In response to detecting the first event, the computer system sends (10052) the first automatically generated summary to the third computer system, wherein sending the first automatically generated summary to the third computer system causes the third computer system to display a respective notification for the first event, including the first automatically generated summary. In some embodiments, when two computer systems are paired, they pass notifications detected locally to each other, such that notifications regarding a respective event detected at either computer system can be displayed at both computer systems. In some embodiments, the computer system, such as a smart watch, an earphone, a vehicle dashboard, a smart home control device, or a door bell, that has limited processing power, receives the automatically generated summary of the content of a respective event from another computer system that has greater processing power (e.g., a smartphone, a mobile device, a tablet device, or a desktop computer), and displays a notification for the event that includes the automatically summary of the content corresponding to the respective event. In some embodiments, the computer system detects an event locally and generates the automatically generated summary for the event locally, and sends the event and the automatically generated summary to a remote computer system for display at the remote computer system. In some embodiments, the computer system detects an event through communication with a remote computer system, and receives an automatically generated summary from the remote computer system and displays a notification for the event including the automatically generated summary. In some embodiments, the computer system detects an event locally, send the event to a remote computer system and receives an automatically generated summary from the remote computer system and displays a notification for the event with the automatically generated summary, where the remote computer system also displays a notification for the event including the automatically generated summary. In some embodiments, the computer system detects an event through communication with a remote computer system that had detected the event locally, and the computer system generates an automatically generated summary for the event and sends it to the remote computer system, where the remote system displays a notification including the automatically generated summary received from the computer system. For example, as described with reference to FIG. 5C, in some embodiments, the computer system 100 (e.g., a smartphone) generates a summary (e.g., and/or summary content) and transmits the generated summary/summary content to the other computer system (e.g., a peripheral device such as a smartwatch). In response to receiving the generated summary/summary content from the computer system 100, the other computer system 100 displays the summary (e.g., or a summary that includes the summary content generated and transmitted by the computer system 100). In some embodiments, the computer system 100 also displays the generated summary/summary content (e.g., in response to a user input and/or request to display summaries and/or notifications). Sending the first automatically generated summary to the third computer system, wherein sending the first automatically generated to the third computer system causes the third computer system to display a respective notification for the first event, including the first automatically generated summary, in response to detecting the first event, reduces the numbers of inputs required by the user to review notifications from various applications (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding display of the notification on the remote device).

In some embodiments, the computer system detects (10054) a respective event that corresponds to content of a respective application, wherein the respective event was detected by the third computer system locally, and the computer system detects the respective event through communication with the third computer system. In response to detecting the respective event: the computer system generates a respective automatically generated summary that is based on at least the content of the respective application, wherein the respective automatically generated summary includes generated content that is not part of the content of the respective application; and the computer system sends the respective automatically generated summary to the third computer system, wherein sending the first automatically generated summary to the third computer system causes the third computer system to display a respective notification for the respective event, including the respective automatically generated summary received from the computer system. In some embodiments, the computer system displays the respective notification including the respective automatically generated summary locally at the computer system, optionally with an indication that the respective notification is for an event detected by a remote computer system (e.g., the third computer system), and not a locally detected event. For example, as described with reference to FIG. 5C, in some embodiments, the computer system 100 (e.g., a smartphone) generates a summary (e.g., and/or summary content) and transmits the generated summary/summary content to the other computer system (e.g., a peripheral device such as a smartwatch). In response to receiving the generated summary/summary content from the computer system 100, the other computer system 100 displays the summary (e.g., or a summary that includes the summary content generated and transmitted by the computer system 100). In some embodiments, the computer system 100 also displays the generated summary/summary content (e.g., in response to a user input and/or request to display summaries and/or notifications). Sending the first automatically generated summary that is based on at least the content of a respective application, wherein the respective automatically generated summary includes generated content that is not part of the content of the respective application, to the third computer system, wherein sending the first automatically generated to the third computer system causes the third computer system to display a respective notification for the first event, including the first automatically generated summary, in response to detecting the respective event that corresponds to the content of a respective application, wherein the respective event was detected by the third computer system locally, and the computer system detects the respective event through communication with the third computer system, reduces the numbers of inputs required by the user to review notifications from various applications (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding display of the notification on the remote device).

In some embodiments, in accordance with a determination that a first summarization functionality (e.g., automatic summarization of notification content, automatic summarization of application content across multiple applications and/or across multiple notifications of a respective application, displaying notifications and/or previews of notifications with automatically generated summaries of the content of the notifications, and/or other summarization features described in this disclosure) that was previously unavailable at the computer system has become available at the computer system (e.g., activated during system setup of a new device, installed as part of a newly installed operating system for a device, added as part of an update to an existing operating system of a device, and/or activated as a result of completing an authorization and/or enrollment process for a summarization service), the computer system displays (10056), via the display generation component, a user interface for configuring the first summarization functionality for a plurality of different applications. In some embodiments, the user interface for configuring the first summarization functionality for a plurality of different applications includes a set of one or more selectable options that are configured to enable and/or disable the first summarization functionality for one or more applications. In some embodiments, the user interface includes an example of how the first summarization functionality changes the content and appearances of the notifications to which it operates on. In some embodiments, the one or more selectable options are radial buttons, toggle controls, checkboxes, and/or other selectable options corresponding to different ways of configuring the first summarization functionality for different applications and/or groups of applications. In some embodiments, the set of one or more selectable options are configured to enable notification summarization for all applications, including current and future installed applications, on the computer system; all applications currently installed on the computer system; one or more categories of applications; some or all native applications provided with the operating system, and/or some or all third party applications that are compliant with certain rules established by the operating system. In some embodiments, the set of one or more selectable options are displayed in response to option-display criteria being met, such as in response to receipt of a new notification for an application that does not currently have automatic notification summarization enabled, in response to activation or installation of the new summarization functionality at the computer system, in response to installation of a new application from a category of applications that do not have automatic notification summarization enabled or fully enabled for all applications in the category; and/or in response to detecting a request from an application to configure notification preferences for the application. For example, in FIG. 5M, the computer system 100 displays the user interface 5090-a, for enabling or disabling display of summary content for a plurality of applications. For example, in FIGS. 5K and 5L, the computer system 100 displays the user interface 5076 that includes the affordance 5084 for enabling display of summary content for all applications (e.g., without needing to configure individual application settings, as in FIG. 5M). In some embodiments, both the user interface 5090-a in FIG. 5M, and the user interface 5076 in FIGS. 5K and 5L, are displayed in response to detecting the user input 5068, directed toward the user interface 5064 in FIG. 5I (e.g., and as described with reference to FIG. 5I, the user interface 5064 is displayed when new functionality for displaying summary content, which was not previously available, is now available for the computer system 100). Displaying a user interface for configuring first summarization functionality for a plurality of different applications, in accordance with a determination that the first summarization functionality was previously unavailable at the computer system and has become available at the computer system, reduces the number of inputs needed to enable the first summarization functionality without requiring further user inputs (e.g., the user does not need to perform additional user inputs to display the set of one or more selectable options, and/or to navigate through different user interfaces in order to access the set of one or more selectable user interface options).

In some embodiments, displaying the user interface for configuring the first summarization functionality for the plurality of different applications includes (10058) displaying a set of one or more selectable options configured to enable the first summarization functionality for one or more applications, and displaying the set of one or more selectable options includes, concurrently displaying, via the display generation component: a first selectable option that, when selected (e.g., based on user input directed to the first selectable option), initiates a process to enable the first summarization functionality for a respective set of applications (e.g., for all applications or all applications with notifications that can be summarized by the first summarization functionality); and a second selectable option that, when selected (e.g., based on user input directed to the second selectable option), initiates a process to enable the first summarization functionality for a first subset of the respective set of applications (e.g., a first application, a first category of applications, applications with notification enabled in a first focus mode) without enabling the first summarization functionality for a second subset of the respective set of applications (e.g., a second application, a second category of applications, applications with notification enabled in a second focus mode) that is different from (e.g., that do not overlap with) the first subset of the respective set of applications. In some embodiments, the respective set of applications includes all notifications that are generated, received, and/or available to be displayed at the computer system, including notifications generated across all applications, all categories, and/or all time periods, that are available to be displayed at the computer system as individual notifications without utilizing the first summarization functionality. In some embodiments, the first subset of the respective set of applications includes one or more individual applications, one or more individual categories of applications, or a set of applications that have notification enabled during a first notification mode, such as a focus mode, a driving mode, or a DND mode, that are displayable at the computer system without utilizing the first summarization functionality. In some embodiments, the first selectable option is a toggle control that enables (or disables, if already enabled) the first summarization functionality to be used for and/or applied to all future notifications (e.g., irrespective of application identity, application category, or associated notification modes) that are available to be displayed individually without the first summarization functionality (e.g., displayed as in standalone or coalesced forms, without automatic summarization of notification content). In some embodiments, the second selectable option is a toggle control that enables (or disables, if already enabled) the first summarization functionality to be used for and/or applied to all future notifications that are associated with a respective application, a respective category of applications, or a respective notification mode (e.g., a focus mode, a DND mode, a driving mode, or another notification delivery mode in which notification delivery is modified from a default manner), and that are available to be displayed individually without the first summarization functionality (e.g., displayed as in standalone or coalesced forms, without automatic summarization of notification content). In some embodiments, the second selectable option is displayed among a plurality of other selectable options that respectively correspond to one or more other subsets of notifications (e.g., corresponding to another application, another category of applications, or another notification mode) different from the first subset of notifications, e.g., concurrently with the first selectable option and/or in a same settings user interface as the first and/or second selectable options. In some embodiments, the state of the first selectable option overrides and automatically modifies the state of the second selectable option, e.g., in the case of conflicting configurations for a respective application that falls within the respective set of applications and the first subset of the respective set of applications. In some embodiments, the state of the second selectable option overrides and automatically modifies the state of the first selectable option, e.g., in the case of conflicting configurations for a respective application that falls within the respective set of applications and the first subset of the respective set of applications. In some embodiments, the state of the first selectable option overrides and automatically modifies the state of the second selectable option when the first selectable option is reset by user input; and the state of the second selectable option overrides and automatically modifies the state of the first selectable option when the second selectable option is reset by user input. In some embodiments, enabling the first summarization functionality for a notification allows the notification to be displayed with automatically summarized content that is not part of the original notification content of the notification; and disabling the first summarization functionality for a notification does not allow the notification to be displayed with automatically summarized content and the notification is displayed with its original notification content. For example, in FIGS. 5K and 5L, the computer system 100 concurrently displays the affordance 5084 (e.g., which, when activated, initiates a process to enable summarization functionality for all applications and/or configures all applications to have summarized notifications), and the affordance 5082 (e.g., which, when activated, initiates a process to enable summarization functionality for a subset of applications and/or configures a subset of applications to have summarized notifications, as shown in FIGS. 5M-5P). Concurrently displaying a first selectable option that initiates a process to enable the first summarization functionality for a set of applications when activated, and a second selectable option that initiates a process to enable the first summarization functionality for a subset of the set of applications (e.g., without enabling the first summarization functionality for a different subset of the set of applications) when activated, reduces the numbers of inputs required by the user to display summarized content for the appropriate applications (e.g., if summarization functionality should be enabled for all applications, the user does not need to perform individual user inputs to enable functionality for each application individually; and if summarization functionality should be enabled for a subset of applications, the user does not need to first enable functionality for all applications, then perform additional user inputs to disable the functionality for certain applications).

In some embodiments, displaying the set of one or more selectable options configured to enable the first summarization functionality for one or more applications, includes (10060), concurrently displaying, via the display generation component the first selectable option, and a third selectable option that, when selected (e.g., based on user input directed to the third selectable option), initiates a process to disable (or forgo enabling, or continue using the computer system without enabling) the first summarization functionality for the respective set of applications (e.g., all notifications that are generated, received, and/or available to be displayed at the computer system, including notifications generated across all applications, all categories, and/or all time periods, that are available to be displayed at the computer system as individual notifications). In some embodiments, the first selectable option and the third selectable option correspond to two different states of a toggle control corresponding to all notifications that are displayable at the computer system without utilizing the first summarization functionality. In some embodiments, selection of the third selectable option causes the computer system to forgo automatic summarization of notification content for all notifications, and, as a result, automatic content summarization is not enabled for any notification at the computer system. In some embodiments, enabling the first summarization functionality for a notification allows the notification to be displayed with automatically summarized content that is not part of the original notification content of the notification; and disabling the first summarization functionality for a notification does not allow the notification to be displayed with automatically summarized content and the notification is displayed with its original notification content. For example, in FIG. 5K, the computer system 100 concurrently displays the affordance 5084 (e.g., which, when activated, initiates a process to enable summarization functionality for all applications and/or configures all applications to have summarized notifications), and the affordance 5082 (e.g., which, when activated, disables summarization functionality for all applications and/or configures all applications not to have summarized notifications). Concurrently displaying a first selectable option that initiates a process to enable the first summarization functionality for a set of applications when activated, and a third selectable option that initiates a process to disable the summarization functionality for the set of applications when selected, reduces the numbers of inputs required by the user to correctly configure the first summarization functionality for all notifications (e.g., the user does not need to perform individual user inputs to enable and/or disable the summarization functionality for each application individually).

In some embodiments, displaying the user interface for configuring the first summarization functionality for the plurality of different applications (e.g., initiating the process to enable the first summarization functionality for a first subset of the respective set of applications without enabling the first summarization functionality for a second subset of the respective set of applications), includes (10062) concurrently displaying, via the display generation component, a plurality of controls that correspond to different sets of one or more applications. including: a first control for changing (e.g., enabling or disabling) a respective configuration of the first summarization functionality for a first set of one or more applications (e.g., a first application or a first category of applications that includes a plurality of applications of a first type of application such as news applications or games); and a second control for changing (e.g., enabling or disabling) a respective configuration of the first summarization functionality for a second set of one or more applications (e.g., a second application or a second category of applications that includes a plurality of applications of a first type of application such as messaging applications or workout applications) that is different from the first set of one or more applications. In some embodiments, the first control and the second control are displayed in response to detecting selection of the second selectable option (e.g., described in greater detail above). In some embodiments, the first set of one or more applications and the second set of one or more applications differ in terms of constituent applications, corresponding application categories, associated notification modes that modify notification delivery for different applications at different times, and/or other characteristics of notifications. In some embodiments, the first control and the second control are displayed in a listing that includes corresponding controls for multiple sets of one or more applications, such as different individual applications, individual application categories, and/or notification modes. For example, in FIG. 5M, the user interface 5090-a includes toggles 5102, 5104, 5106, 5108, and 5110, for configuring whether notifications corresponding to the respective applications do or do not include summary content (e.g., for enabling or disabling summarization functionality with respect to the respective applications). Similarly, in FIG. 5O, the user interface 5090-b includes controls 5124, 5126, 5127, 5139, 5132, and 5134 for configuring individual applications, and also toggles 5136, 5138, and 5140 for configuring whether notifications corresponding to applications belonging to respective categories (e.g., that can include multiple applications) do or do not include summary content (e.g., to enable or disable summarization functionality with respect to respective categories). Concurrently displaying a first control for changing summarization functionality for a first set of one or more applications, and a second control for changing the summarization functionality for a different set of one or more applications, reduces the number of inputs needed to configure summarization functionality for multiple applications and/or categories of applications (e.g., a single user input can configure summarization functionality for multiple applications at once, without requiring individual user inputs for each applications).

In some embodiments, concurrently displaying the plurality of controls that correspond to different sets of one or more applications includes (10064) displaying the plurality of controls in an order that is determined based on a frequency of notifications, including: in accordance with a determination that the first set of one or more applications gets more notifications than the second set of one or more applications (e.g., based on numbers of notifications delivered in the past, or estimated and/or projected for the future, per unit of time), the first control is emphasized over the second control (e.g., the first control is displayed before the second control in the plurality of controls); and in accordance with a determination that the second set of one or more applications gets more notifications than the first set of one or more applications (e.g., based on numbers of notifications delivered in the past, or estimated and/or projected for the future, per unit of time), the second control is emphasized over the first control (e.g., the second control is displayed before the first control in the plurality of controls). For example, in some embodiments, the estimated and/or average numbers of notifications that are delivered in the past or are anticipated in the future per unit of time (e.g., a measure of historic or projected notification frequencies) are used to determine the relative display priorities (e.g., relative visual prominence, display order, and/or other indications of priority) of for the selectable controls for enabling/disabling the first summarization functionality for different applications, application categories, and/or notification modes in the setting user interface. For example, in FIG. 5M, the user interface 5090-a includes a plurality of applications that are ordered based on frequency of notifications (e.g., an average number of notifications generated over a period of time). Similarly, in FIG. 5O, the categories in the user interface 5090-b are optionally ordered by average number of notifications generated over a period of time (e.g., across all applications in each category, or for a top/bottom performer in each category). Emphasizing a first control over a second control in accordance with a determination that the first set of one or more applications gets more notifications than the second set of one or more applications, and emphasizing the second control over the first control in accordance with a determination that the second set of one or more applications gets more notifications than the first set of one or more applications, reduces the number of inputs needed to configure applications to enable summarization functionality (e.g., and/or have summarized notifications) (e.g., applications which get more notifications than other applications are likely to benefit from summarization functionality, and emphasizing these applications makes it easier to locate and configure these applications, without needing to navigate through other applications which get fewer notifications).

In some embodiments, in accordance with the determination that the first summarization functionality (e.g., automatic summarization of notification content, and/or automatic summarization of application content across multiple applications and/or across multiple notifications of a respective application) that was previously unavailable at the computer system has become available at the computer system (e.g., activated during system setup of a new device, installed as part of a newly installed operating system for a device, added as part of an update to an existing operating system of a device, and/or activated as a result of completing an authorization and/or enrollment process for a summarization service), the computer system displays (10066), via the display generation component, an example of the first summarization functionality (e.g., an example showing, via an animation, a visual illustration, and/or textual descriptions, a notification or group of notifications with their original notification content replaced with or augmented with the automatically summarized content that is generated based on the original notification content). In some embodiments, the example of the first summarization functionality is displayed in the user interface for configuring the first summarization functionality of the plurality of different applications. In some embodiments, the example of the first summarization functionality is displayed in conjunction with (e.g., concurrently with, immediately before, immediately after, in the same setup process, and/or in the same user interaction session) displaying the set of one or more selectable options configured to enable the first summarization functionality for one or more applications. For example, in FIGS. 5K and 5L, the user interface 5076 includes a portion 5078 that displays an animation of application or notification content (e.g., in FIG. 5K) being summarized (e.g., as shown in the summary 5088, after summarizing the content in FIG. 5K). Displaying an example of first summarization functionality in accordance with the determination that the first summarization functionality was previously unavailable at the computer system and has become available at the computer system provides support to the user by illustrating the first summarization functionality while displaying the options configured to enable the functionality, thereby reducing the risk that the user enables undesired functionality or forgoes enabling desired functionality, due to insufficient understanding of how the summarization functionality works.

In some embodiments, in accordance with a determination that a first application that was previously unavailable at the computer system has become available at the computer system (e.g., newly installed on the operating system of a device, installed as part of a newly installed operating system for a device, added as part of an update to an existing operating system of a device, and/or activated as a result of completing an authorization and/or enrollment process for the first application), the computer system automatically establishes (10068) a default setting regarding the first summarization functionality for the first application (e.g., as an initial setting for the first application upon installation of the first application), including: in accordance with a determination that the first summarization functionality has been enabled for a first threshold amount of applications in a first application category (e.g., all of the applications in the first application category, a majority of applications in the first application category, or at least one application in the first application category) and that the first application belongs to the first application category, automatically enabling (e.g., without requiring a user input specifically directed to a control corresponding to the first application or a completing a specific configuration process associated with the first application) the first summarization functionality for the first application (e.g., as an initial setting for the first application upon installation of the first application); and in accordance with a determination that the first summarization functionality has been disabled for a second threshold amount of applications in a second application category (e.g., all of the applications in the second application category, a majority of applications in the second application category, or at least one application in the second application category) and that the first application belongs to the second application category, automatically disabling (e.g., without requiring a user input specifically directed to a control corresponding to the first application or a completing a specific configuration process associated with the first application) the first summarization functionality for the first application (e.g., as an initial setting for the first application upon installation of the first application). In some embodiments, the first threshold amount is the same as the second threshold amount. In some embodiments, the first threshold amount is different from the second threshold amount. In some embodiments, the computer system encourages enabling the first summarization functionality by enabling the first summarization functionality for an application if any other applications in the same category have the first summarization functionality enabled. In some embodiments, the computer system avoids unnecessarily enabling the first summarization functionality by not automatically enabling the first summarization functionality if the first summarization functionality is disabled for one or more other applications in the same category. In some embodiments, the first application category corresponds to a first automatically generated category that includes multiple applications that provide a first set of similar or related content and/or functions, and the second application category corresponds to a second automatically generated category that includes multiple applications that provide a second set of similar or related content and/or functions. For example, the computer system optionally has multiple application categories, such as a news category, a gaming category, a communications category, a social networking category, a productivity category, a shopping category, a health category, an entertainment category, a travel category, a creativity category, a reading category, a multimedia category, an education category, an online dating category, a tools category, a smart home category, and other categories depending on the applications installed on the computer system. In some embodiments, the first application category and the second application category include categories created based on other categorization criteria, such as age-restriction, associated notification modes, recency of usage, frequency of usage, paid vs unpaid, usage time, usage location, and/or other categorization criteria. In some embodiments, the applications associated with different application categories may change over time as applications are installed and/or deleted, and/or as usage behavior and notification configurations of the applications change. In some embodiments, the available application categories and/or the categories associated with installed applications may change over time as applications are installed and/or deleted, and/or as usage behavior and notification configurations of the applications change. For example, in FIG. 5Q, the computer system 100 determines that a third news application, which generated the notification 5152, is an application in the “News” category. Based on the configuration shown in FIG. 5P, at least one news application (e.g., the second news application 5130) in the “News” category is configured not to include summary content in notifications corresponding to that news application, so the computer system 100 displays the notification 5120 with the affordances 5154 and 5156. For example, as described with reference to FIG. 5Q, if both news applications in the “News” category in FIG. 5P are configured to include summary content in notifications corresponding to both news applications, the computer system 100 would automatically configure the third news application to include summary content in notifications corresponding to the third news application (e.g., and optionally, the affordances 5154 and 5156 would not be displayed in FIG. 5Q, and the notification 5152 would be replaced by a summary of the notification content of the notification 5152. Automatically enabling first summarization functionality for a new application in accordance with a determination that the first summarization functionality has been enabled for a first threshold amount of applications in a first application category and that the new application belongs to the first application category, and automatically disabling the first summarization functionality for the new application in accordance with a determination that the first summarization functionality has been disabled for a second threshold amount of applications in a second application category and that the new application belongs to the second application category, automatically enables and disables the first summarization functionality for a new application without requiring additional user inputs (e.g., the user does not need to manually enable or disable the first summarization functionality).

In some embodiments, the computer system detects (10070) occurrence of a first event. In response to detecting the first event, in accordance with a determination that the first event is associated with a first newly available application (e.g., newly installed on the operating system of a device, installed as part of a newly installed operating system for a device, added as part of an update to an existing operating system of a device, and/or activated as a result of completing an authorization and/or enrollment process for the first application): the computer system presents (e.g., via visual and/or audio output) a respective notification that corresponds to the first event at the computer system (e.g., presenting an individual notification that includes original, unsummarized notification content if the first summarization functionality is disabled for the first newly available application by default; or presenting a summarized notification that includes automatically summarized notification content if the first summarization functionality is enabled for the first newly available application by default); and the computer system displays, via the display generation component, a respective selectable option that, when selected (e.g., based on a user input directed to the respective selectable option), initiates a process that enables the first summarization functionality for the first newly available application (e.g., in the case where the first summarization functionality was disabled for the first newly available application by default, and an unsummarized notification is displayed) and/or a respective selectable option that, when selected (e.g., based on a user input directed to the respective selectable option), initiates a process that disables the first summarization functionality for the first newly available application (e.g., in the case where the first summarization functionality was enabled for the first newly available application by default, and a summarized notification is displayed). For example, in FIG. 5Q, the notification 5152 is presented (e.g., displayed), along with the affordance 5154 (e.g., which, when activated by the user input 5160, initiates a process for configuring the computer system 100 to include summary content for notifications corresponding to the third news application and/or enabling summarization functionality with respect to the third news application), and the affordance 5156 (e.g., which, when activated by the user input 5156, initiates a process for configuring the computer system 100 to not include summary content for notifications corresponding to the third news application and/or disabling summarization functionality with respect to the third news application). Presenting a respective notification that corresponds to a first event at the computer system, and displaying a respective selectable option for initiating a process that enables first summarization functionality for the first newly available application and/or a respective selectable option for initiating a process that disables the first summarization functionality for the first newly available application, in response to detecting the first event and in accordance with a determination that the first event is associated with a first newly available application, reduces the number of user inputs needed to correctly configure a newly available application (e.g., displaying options for initiating a process for enabling or disabling summarization functionality along with a respective notification removes the need for the user to perform additional user inputs dismissing the notification and/or navigating to appropriate settings for enabling or disabling the summarization functionality for the newly available application).

It should be understood that the particular order in which the operations in FIGS. 10A-10I have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 11000, 12000, 13000, and 14000) are also applicable in an analogous manner to method 10000 described above with respect to FIGS. 10A-10I. For example, the application (content), notification (content), summary (content, applications, notifications, summaries, and user inputs, described above with reference to method 10000 optionally have one or more of the characteristics of the application (content), notification (content), summary (content, applications, notifications, summaries, and user inputs, described herein with reference to other methods described herein (e.g., 11000, 12000, 13000, and 14000). For brevity, these details are not repeated here.

FIGS. 11A-11I are flow diagrams illustrating method 11000 of providing summary content for multiple events, in accordance with some embodiments. Method 11000 is performed at an electronic device or computer system (e.g., device 300, FIG. 3A, or portable multifunction device 100, FIG. 1A) that is in communication with a display generation component, and one or more sensors for detecting user inputs. In some embodiments, the display generation component is a touch-screen display and the touch-sensitive surface is on or integrated with the display. In some embodiments, the display is separate from the touch-sensitive surface. Some operations in method 11000 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Displaying a first group notification that includes a first automatically generated summary based on a first content and a second content in accordance with the determination that a first event and a second event are detected have met a first and second criteria, reduces the numbers of inputs required by the user to review notifications from various applications (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding the organization and content of the notifications on the display).

At a computer system that is in communication with a display generation component and one or more sensors for detecting user inputs: the computer system detects (11002) occurrence of a first plurality of events (e.g., detecting respective occurrences of multiple events at different times over a period of time), including a first event and a second event (e.g., events corresponding to the notification 5012, the notification 5014, and the notification 5018 in FIG. 6C), wherein the first event corresponds to first content (e.g., first application content that was designated for inclusion in a notification for the first event, independent of the second event) (e.g., notification content for the notification 5012 in FIG. 6C) and the second event corresponds to second content (e.g., second application content that was designated for inclusion in a notification for the second event, independent of the first event) (e.g., notification content for the notification 5014 in FIG. 6C) that is different from the first content; In some embodiments, the first event is detected before the second event (e.g., the first event and the second event occur at different times, and are detected sequentially). In some embodiments, if the first event is detected before the second event, the computer system displays a first notification corresponding to the first content in response to detecting the first event. In some embodiments, the first event and the second event are concurrently detected (e.g., the computer system periodically checks for the occurrence of events, and the first event and the second event occur between the periodic checks). After detecting the occurrence of the first plurality of events, the computer system detects (11004) that first criteria are met (e.g., criteria for displaying one or more notifications, criteria for displaying a notification user interface, criteria for displaying a wake screen of a device, criteria for displaying a summary of events that have occurred, and/or criteria that are met in response to detection of a respective event (e.g., a most recent event, or an event of a selected type or significance) of the first plurality of events) (e.g., criteria are met to display the user interface 6000 in FIG. 6B). In response to detecting (11006) that the first criteria are met: in accordance with a determination that the first event and the second event meet second criteria (e.g., the first content and the second content are evaluated by an artificial intelligence and/or machine learning algorithm to determine a level of similarity or relatedness, and the first content and the second content meet the second criteria if the level of similarity or relatedness is at least a threshold level of similarity or relatedness (e.g., the artificial intelligence and/or machine learning algorithm determine that the first content and the second content are sufficiently similar and/or related); additionally or alternatively, in some embodiments, the first event and the second event meet the second criteria when they are generated by the same application and/or are generate within a threshold amount of time from each other), the computer system displays (11008) (e.g., on a wake screen user interface, a lock screen user interface, a coversheet user interface, and/or another system user interface that is displayed when the computer system transitions out of a low power always on state, or transition into a restricted state of the computer system), via the display generation component, a first group notification (e.g., the summary 5026 in FIGS. 6B and 6C) that includes a first automatically generated summary (e.g., summary content of the summary 5026 in FIGS. 6B and 6C) that is based on both the first content and the second content (e.g., an integrated summary of the first content and the second content, taking into account of the relatedness of the first content and the second content, e.g., the second content overrides the first content, the second content augments the first content, the first content and the second content are taken as context for each other to generate the summary), wherein the first automatically generated summary includes automatically generated content (e.g., automatically-generated text content and/or generative text content) that is not part of the first content or the second content (e.g., the first automatically generated summary is not included in application content, or the automatically generated summary is generated (e.g., using an AI process or a generative AI process) by the operating system and is not provided by the first application or the second application) (e.g., the summary content of the summary 5026 does not repeat or directly reproduce content of the notification 5012 or the notification 5014, in FIG. 6C). In some embodiments, the first automatically generated summary includes a summary of both the content and the metadata of the first content and the second content. In some embodiments, the first group notification has different appearance and/or content from the first notification for the first event and the second notification for the second event, if the first notification and the second notification are respectively displayed, independently of each other. In some embodiments, in response to detecting that the first criteria are met: in accordance with a determination that the first content and the second content do not meet the second criteria (e.g., the artificial intelligence and/or machine learning algorithm determine that the first content and the second content are too dissimilar or not sufficiently related to each other, and/or that the first event and the second event are generated from different applications or outside of a threshold amount of time from each other), the computer system forgoes displaying the first group notification that includes the first automatically generated summary that is based on both the first content and the second content (e.g., and optionally, displaying a first notification corresponding to the first content and a second notification, different from the first notification, corresponding to the second content). In some embodiments, the first content is detected before the second event, and the computer system displays a first notification for the first event in response to detecting the first content (e.g., prior to detecting the second event and prior to displaying the group notification). In response to detecting additional events (e.g., in response to detecting the second event) related to the first event, the computer system replaces display of the first notification including the first content with display of the first group notification that includes the automatically generated summary that is based on both the first content and the second content). In some embodiments, the computer system concurrently displays the first group notification with a third notification corresponding to a third event and/or a fourth notification corresponding to a fourth event, if the computer system determines that the first event and the second event are not sufficiently related to the third event and the fourth event based on the second criteria.

In some embodiments, the first automatically generated summary is generated (11010) from the first content of the first event and the second content of the second event (e.g., content bodies of two related text messages, an email and a message from the same sender, a message and a calendar alert related to the same scheduled event, or content of other related events) using a machine learning technique (e.g., using an AI process or a generative AI process) (e.g., an artificial intelligence model, a large language model, and/or other machine learning techniques such as using one or more generative AI models such as large language models trained on words or word tokens) (e.g., as opposed to according to programmed rules and conditions based on keywords, format, and/or other properties of the events (e.g., associated application, people, and/or keywords), and/or manual generation by a human). For example, as described with reference to FIG. 6B, in some embodiments, the summary content is automatically generated, optionally, using a machine learning technique (e.g., a machine learning model, a large language mode, an artificial intelligence model, or any other suitable machine learning technique). Displaying a first group notification that includes a first automatically generated summary generated from a first content and a second content using a machine learning technique in accordance with the determination that a first event and a second event are detected have met a first and second criteria, reduces the numbers of inputs required by the user to review notifications from various applications (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding the organization and content of the notifications on the display).

In some embodiments, displaying the first group notification includes (11012) displaying a first indication that content of the first group notification includes an automatically generated summary (e.g., automatically-generated text content and/or generative text content) of event content (e.g., a visual distinction (e.g., an outline, a highlighting, an icon, and/or other types of indications) in the appearance of the first group notification, that distinguishes the first group notification from notifications that include event content, and/or notifications that include automatically generated summaries for individual notifications, rather than automatically generated summaries of multiple related events). For example, in FIG. 6B, the summary 5026 (e.g., and the summary 5024 and the summary 5028) includes a visual indicator (e.g., the asterisk in the upper right of each summary in FIG. 6B), as well as a bolded border (e.g., a bolder, thicker, and/or more prominent border relative to the border of the notification 5016). Displaying the first group notification includes displaying a first indication that content of the first group notification includes an automatically generated summary of event content reduces the numbers of inputs required by the user to review notifications from various applications (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding the organization and content of the notifications on the display).

In some embodiments, the first automatically generated summary includes (11014) a context-based description of the first event and the second event. In accordance with a determination that a first set of contextual conditions (e.g., conditions based on current time, data, time of day, location, and/or other contextually relevant information) are met, the first automatically generated summary includes a first description of the first event and the second event. In accordance with a determination that a second set of contextual conditions (e.g., conditions based on current time, data, time of day, location, and/or other contextually relevant information) are met, the first automatically generated summary includes a second description of the first event and the second event, that is different from the first description of the first event and the second event. For example, if the first event corresponds to receipt of a delivery update that says, “Your driver is ten stops away,” and the second event corresponds to another delivery update that says, “Your driver is one stop away.” If the first group notification is displayed at a time that is soon after the receipt of the second delivery update, the first automatically generated summary may include a first description that reads, “We got updates that your delivery is almost here.” If the first group notification is displayed at a time that is half an hour after the receipt of the second delivery update and the computer system also detects a door bell ring and/or a delivery truck on a security camera at the front door some time ago, the first automatically generated summary may include a second description that reads, “According to the delivery updates, your delivery has probably arrived by now.” For example, as described with reference to FIG. 5C, in some embodiments, in a first context (e.g., on a first day, a first date, a first time, and/or at a first location), the summary 5026 includes first summary content (e.g., corresponding to a first set of notifications that have been summarized). In a second (e.g., and different) context (e.g., a second day, a second date, a second time, and/or a second location), the summary 5026 includes second summary content that is different from the first summary content (e.g., corresponding to a second set of notifications that have been summarized). The second summary content may differ from the first summary content, because the second summary content summarizes content corresponding to a different set of notifications. The second summary content may correspond to the same set of notifications as the first summary content, but the content (e.g., the underlying logic that controls how the content is generated and/or summarized) is different between the first context and the second context. Displaying a first group notification that includes a first automatically generated summary that includes a context-based description of the first and the second event, that includes a first and a second description of the first and second event, wherein the second description is different from the first in accordance with the determination that a first set of contextual conditions and a second set of contextual conditions are met, respectively, reduces the numbers of inputs required by the user to review notifications from various applications (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding the organization and content of the notifications on the display).

In some embodiments, the computer system detects (11016) a change in context of the computer system. After (e.g., in response to, and/or at a later time when the system user interface including notifications is displayed) detecting the change in context of the computer system, the computer system displays an updated version of the first group notification including an updated version of the first automatically generated summary that is generated based on both the first content and the second content and the change in the context of the computer system. In some embodiments, the updated version of the first group notification is displayed when a wake screen or notification user interface is displayed (e.g., after or in response to detecting a request to wake the device from a low power state or a request to display a notification user interface). In some embodiments, the first automatically generated summary in the first group notification can be updated as the first group notification is displayed. In some embodiments, the first automatically generated summary in the first group notification is updated at a time that the first group notification is not displayed, and is shown in the first group notification the next time that the first group notification is displayed (e.g., whether the first group notification had been displayed and/or read by the user previously with the previous version of the first automatically generated summary, or when the first group notification had not been displayed or read by the user before). For example, in FIG. 6M, the summary content of the summary 6038 is updated (e.g., as compared to the summary content of the summary 6038 in FIG. 6K, the number of motion alerts reported in the summary is different) as time passes (e.g., and one or more notifications no longer meet relevance criteria and/or one or more (new) notifications meet relevance criteria and are included in the summary 6038). This is also shown in FIG. 6O, where the summary content of the summary 6038 is again updated (e.g., in FIG. 6O, the summary content includes mention of a received package, which is not present in FIG. 6K or FIG. 6M) as more time passes (e.g., the notification 6064 comes in at a later time (than in FIG. 6K and FIG. 6M). and the summary content of the summary 6038 is updated to reflect (e.g., summarize) the content of the notification 6064). Displaying an updated version of the first group notification including an updated version of the first automatically generated summary that is generated based on both the first content and the second content and the change in the context of the computer system after detecting a change in context of the computer system reduces the numbers of inputs needed to display contextually relevant content (e.g., the user does not need to perform user inputs to update the displayed group notification each time there is a change in context), improves the efficiency of the device, and provides improved visual feedback to the user (e.g., improved visual feedback regarding the organization and content of the notifications on the display).

In some embodiments, after detecting the occurrence of the first plurality of events and after displaying the first group notification that includes the first automatically generated summary that is based on both the first content and the second content (e.g., in response to detecting that the first criteria were met and in accordance with the determination that the first event and the second event met the second criteria), the computer system detects (11018) occurrence of a third event different from the first plurality events, wherein the third event corresponds to third content (e.g., third application content that was designated for inclusion in a notification for the third event, independent of the first event and the second event). After (e.g., in response to, and/or at a later time when the system user interface including notifications is displayed) detecting the occurrence of the third event: in accordance with a determination that the third event and at least one of the first event and the second event meets the second criteria (e.g., the third content is evaluated by an artificial intelligence and/or machine learning algorithm to determine a level of similarity or relatedness to the first content and/or the second content, and the third content and the first and/or second content meet the second criteria if the level of similarity or relatedness is at least a threshold level of similarity or relatedness (e.g., the artificial intelligence and/or machine learning algorithm determine that the third content and the first and/or second content are sufficiently similar and/or related); additionally or alternatively, in some embodiments, the third event and at least one of the first and second event meet the second criteria when they are generated by the same application and/or are generated within a threshold amount of time from each other), the computer system displays an updated first group notification, wherein displaying the updated first group notification includes displaying the first automatically generated summary (e.g., automatically-generated text content and/or generative text content) in accordance with the third content (e.g., an integrated summary of the first content, the second content, and the third content, taking into account of the relatedness of the first content, the second content, and the third content, e.g., the third content overrides the first and/or second content, the third content augments the first and/or second content, the third content is taken as context for the first and/or second content, or vice versa, to generate the updated summary), wherein the first automatically generated summary is updated in accordance with the third content includes automatically generated content that is not part of the third content (e.g., the first automatically generated summary as updated is not included in application content of the applications that generated the first, second, and/or third events; and the updated version of the first automatically generated summary is generated by the operating system and is not provided by the applications that generated the first, second, and/or third events). In some embodiments, the updated version of the first group notification is displayed when a wake screen or notification user interface is displayed (e.g., after or in response to detecting a request to wake the device from a low power state or a request to display a notification user interface). In some embodiments, after a group notification that includes the automatically generated summary of content corresponding to multiple related events has been generated and/or displayed on the computer system, if additional events that are related to the multiple events are detected, the computer system updates the automatically generated summary based on the content in the additional events, so that the summary remains valid in light of the most recent changes in context and/or information. In some embodiments, the computer system displays the updated version of the first automatically generated summary in the first group notification, as new related events are detected (e.g., the wake screen is woken up from a lower power dimmed state temporally to show the updated group notification, and returns to the low power dimmed state again. In some embodiments, the computer system displays the updated version of the first automatically generated summary in the first group notification, after new related events were detected some time ago (e.g., the wake screen is woken up from a lower power dimmed state by a user and the updated group notification is displayed in its most recently updated state). For example, in FIG. 6K, the summary 6038 includes summary content that corresponds to a first set of notifications (e.g., the notifications 6044, 6046, 6048, and 6050 shown in FIG. 6L) at a first time of 9:26 AM. In FIG. 6O, the current time is now 4:08 PM, and the summary 6038 includes summary content that corresponds to the notification 6064 (e.g. and the notifications 6066, 6068, and 6070) which were not in the first set of notifications. The summary content includes a description of the number of motion alerts being summarized by the summary 6038 (e.g., the text “7 motion alerts”), which is content that is not found in any individual notification corresponding to the summary 6038 (e.g., in either FIG. 6K or in FIG. 6O). Displaying an updated first group notification, wherein displaying the updated first group notification includes displaying the first automatically generated summary in accordance with a third content, wherein the first automatically generated summary as updated in accordance with the third content includes automatically generated content that is not part of the third content, in accordance with the determination that the third event and at least one of the first event and the second event meet the second criteria, reduces the numbers of inputs needed to display contextually relevant content (e.g., the user does not need to perform user inputs to update the displayed group notification each time a new event is detected), improves the efficiency of the device, and provides improved visual feedback to the user (e.g., improved visual feedback regarding the organization and content of the notifications on the display).

In some embodiments, detecting the occurrence of the third event includes (11020) detecting the occurrence of the third event while displaying, in a first system user interface (e.g., on a wake screen user interface, a lock screen user interface, a coversheet user interface, and/or another system user interface that is displayed when the computer system transitions out of a low power always on state, or transition into a restricted state of the computer system), the first group notification including the first automatically generated summary that is based on both the first content and the second content (and optionally, content corresponds to one or more additional events that are determined to be related to the first event and/or the second event based on the second criteria), and updating the first group notification (including updating the first automatically generated summary in accordance with the third content) in response to detecting the occurrence of the third event and in accordance with the determination that the third event and at least one of the first event and the second event meets the second criteria, includes updating the first group notification while the first group notification is persistently displayed on the first system user interface (e.g., the computer system displays an animated transition to show the content and/or appearance of the first group notification is updated to reflect the content and/or occurrence of the third event). In some embodiments, the first group representation remains displayed on the first system user interface, as the computer system transitions between a low power always-on state (e.g., dimmed, darkened state to conserve power after a period of inactivity and/or after the user locks the computer system) and a restricted state of the computer system that is not the low power always-on state (e.g., the wake screen, lock screen, coversheet user interface is displayed with normal brightness and clarity) over an extended period of time. In some embodiments, the first group notification is displayed in a region of the first system user interface that is updated from time to time, as new events related to the first event and/or the second event are detected, to reflect the latest status of a series of related activities and/or events. In some embodiments, the first group notification is represented by a graphical object that illustrate the current status of the activities and/or events relative to a timeline or a series of stages for a multi-state activity and/or task, optionally, relative to one or more earlier and future stages of the multi-stage activity or task (e.g., current, prior, future stages for a grocery order or package delivery). For example, in FIG. 6R, FIG. 6T, and FIG. 6V, the summary 6078 is persistently displayed in the user interface 5000 (e.g., the summary 6078 always appears at the top of the displayed notifications and/or summaries, as time progresses from 9:26 AM in FIG. 6R to 9:59 AM in FIG. 6V), and is updated over time (e.g., the summary 6078 includes different content, and shows a different current status, as shown in each of FIG. 6R, FIG. 6T, and FIG. 6V), as the status of the grocery order corresponding to the summary 6078 changes. Updating the first group notification in response to detecting the occurrence of the third event and in accordance with the determination that the third event and at least one of the first event and the second event meets the second criteria, includes updating the first group notification while the first group notification is persistently displayed on the first system user interface, reduces the numbers of inputs needed to display contextually relevant content (e.g., the user does not need to perform user inputs to update the displayed group notification each time a new event is detected), improves the efficiency of the device, and provides improved visual feedback to the user (e.g., improved visual feedback regarding the organization and content of the notifications on the display).

In some embodiments, the first event corresponds to a first application and the first content includes (11022) content from a first application; and the second event corresponds to a second application different from the first application, and the second content includes content from the second application. For example, in some embodiments, the first application is a smart home application, and the second application is a food delivery application; and the first event corresponds to an alert generated by a security camera managed by the smart home application, and the second event corresponds to an alert generated by the food delivery application indicating that a food delivery driver is about to arrive. The first event and the second event are determined to be related based on the content of the alerts from the two different applications (e.g., video showing arrival of a delivery van from the smart home application, and an alert stating that the delivery van is close by) and/or their proximity in time and location, and a group notification provides a summary that indicates that the food delivery has arrived (e.g., before the final alert from the food delivery application has been generated). For example, in FIG. 6K, the summary 6038 includes summary content corresponding to multiple notifications (e.g., the notifications 6044, 6046, 6048, and 6050 shown in FIG. 6L) that all correspond to the doorbell application C. Displaying a first group notification that includes a first automatically generated summary based on a first content, wherein the first content includes content from a first application, and a second content, wherein the second content includes content from a second application, in accordance with the determination that a first event, wherein the first event corresponds to a first application, and a second event, wherein the second event corresponds to a second application different from the first application, are detected have met a first and second criteria, reduces the numbers of inputs required by the user to review notifications from various applications saving the user time (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding the organization and content of the notifications on the display).

In some embodiments, displaying the first group notification includes (11024) displaying a first indication (e.g., a first application icon, and/or a first application name) that corresponds to the first application and a second indication (e.g., a second application icon, and/or a second application name) that corresponds to the second application in the first group notification. In some embodiments, the first indication and the second indication are integrated into a single icon or graphical element that includes miniature application icons of the first application and second application, to indicate that the group notification includes a summary of content from both the first application and the second application. In some embodiments, the computer system updates the first group notification to include additional indications for applications of newly detected events that are determined to be related to the first event and/or the second event based on the second criteria. For example, in FIG. 6I and FIG. 6J, the summary 6024 includes a visual indication of the applications (e.g., representations of the application icons for the news application Y, the news application N, and the news application Z) corresponding to notifications that correspond to the summary 6024. Displaying the first group notification includes displaying a first indication that corresponds to the first application and a second indication that corresponds to the second application in the first group notification, reduces the numbers of inputs required by the user to review notifications from various applications saving the user time, improves the efficiency of the device, and provides improved visual feedback to the user (e.g., improved visual feedback regarding the applications corresponding to the first group notification).

In some embodiments, displaying the first group notification includes (11026) displaying a third indication of a respective quantity of events corresponding to the first application that were used to generate the first automatically generated summary, and a fourth indication of a respective quantity of events corresponding to the second application that were used to generate the first automatically generated summary. For example, in some embodiments, if a first number of events from the first application and a second number of events from the second application were determined to be related events in accordance with the second criteria, the computer system displays the first group notification including the first automatically generated summary that summarizes the content of the first number of events from the first application and the content of the second number of events from the second application, where the first group notification includes the first application icon of the first application with a badge indicating a count of the first number of events, and the second application of the second application with a badge indicating a count of the second number of events. In some embodiments, the computer system updates the fourth indication and/or the fifth indication as additional events from the first application and/or the second application are detected and determined to be related to the first event and/or the second event based on the second criteria, and summarized in an updated version of the first automatically generated summary. In some embodiments, when displaying a respective group notification, the computer system displays a first number with the respective group notification if a first quantity of events were used to generate the automatically generated summary included in the respective group notification, and displays a second number, different from the first number, with the respective group notification if a second quantity of events, different from the first quantity of events, were used to generate the automatically generated summary included in the respective group notification. In some embodiments, when displaying multiple group notifications concurrently, the computer system displays a third number with a third group notification if a third quantity of events were used to generate the automatically generated summary included one third group notification, and displays a fourth number, different from the third number, with a fourth group notification displayed concurrently with the fourth group notification, if a fourth quantity of events, different from the third quantity of events, were used to generate the automatically generated summary included in the fourth group notification. For example, in FIG. 6C, the summary 5026 includes a badge that indicates that 3 notifications are summarized in the summary 5026. In FIG. 6K, the summary 6038 includes a badge that indicates that 4 notification are summarized in the summary 6038. In FIG. 6O, the summary 6038 includes a badge that indicates (e.g., and is updated, from FIG. 6K) that 7 notifications are summarized in the summary 6038. Displaying the first group notification includes displaying a third indication of a respective quantity of events corresponding to the first application that were used to generate the first automatically generated summary, and a fourth indication of a respective quantity of events corresponding to the second application that were used to generate the first automatically generated summary reduces the numbers of inputs required by the user to review notifications from various applications saving the user time, improves the efficiency of the device, and provides improved visual feedback to the user (e.g., improved visual feedback regarding quantity of events corresponding to the first automatically generated notification).

In some embodiments, the second criteria are met (11028) by the first event and the second event in accordance with a determination that the first event and the second event correspond to a first topic (e.g., the first event and the second event are both related to the same breaking news story, the same calendar event, or other particular subject matter of communication or information) based on the first content of the first event and the second content of the second event (e.g., irrespective of whether the first event and the second event are generated by different applications, or the same application). For example, in FIG. 6I and FIG. 6J, the summary 6024 includes summary content that corresponds to the notification 6032, the notification 5020, and the notification 6034. The three notifications all include content corresponding to a first topic (e.g., news stories relating to a spacecraft carrying samples back to Earth). Displaying a first group notification that includes a first automatically generated summary based on a first content and a second content in accordance with the determination that a first event and a second event are detected have met a first criteria and second criteria, wherein the second criteria are met by the first event and the second event in accordance with a determination that the first event and the second event correspond to a first topic based on the first and second content, reduces the numbers of inputs required by the user to review notifications from various applications saving the user time (e.g., automatically generated summaries provide relevant notification content for the first topic, without a need for interaction with and/or opening multiple different notifications to view the full notification content and/or application content corresponding to summarized notifications), improves the efficiency of the device, and provides improved visual feedback to the user (e.g., improved visual feedback regarding notifications of a similar topic).

In some embodiments, the second criteria are met (11030) by the first event and the second event in accordance with a determination that the first event and the second event correspond to a first identity (e.g., the same person, a first user account other than the user account of the computer system, a first sender of communication, a first poster of a news story or post, or other people and/or identities of users) based on first metadata of the first event and second metadata of the second event (e.g., sender information for an incoming message, caller information of an incoming call or missed call, sender information of an incoming email message, and/or other metadata included in the visible content of the event or hidden from the visible content of the event). In some embodiments, the second criteria are met by the first event and the second event based on a determination that the first event and the second event corresponding to the same user identity based on metadata as well as the first content of the first event and/or the second of the second event. In some embodiments, the metadata of the first event and the second event are included as part of the first content and the second content. In some embodiments, the metadata of the first event and the second event are excluded from the first content and the second content. In an example, in some embodiments, when the computer system has detected an event for a missed call from a first user identity (e.g., mom), and another event for a text message that says “call me as soon as you can” from a second user identity (e.g., “Catherine Brown”), and the computer system determines that “mom” and “Catherine Brown” are the same person (e.g., based on the contact information stored for the user identities “mom” and “Catherine Brown”), the computer system generates a group notification that includes an automatically generated summary that states “Your mom called and wants you to call back as soon as possible.” If the computer system determines that “mom” and “Catherine Brown” are two different people, the computer system does not generate a single group notification that summarizes both the missed call and the text message in the same summary (e.g., the two notifications can still be deemed related based on other criteria for relatedness (e.g., based on proximity in time, based on topic, or other relatedness criteria)). For example, in FIG. 6G and FIG. 6H, the summary 6012 includes summary content corresponding to the notification 6018, the notification 5012, and the notification 6020, and all three notifications correspond to a first identity for Jane Doe (e.g., based on stored contact information such as a phone number, a username, and/or an email address, the computer system determines that the notification 6018, the notification 5012, and the notification 6020 all correspond to the same contact “Jane Doe”). Displaying a first group notification that includes a first automatically generated summary based on a first content and a second content in accordance with the determination that a first event and a second event are detected have met a first criteria and second criteria, wherein the second criteria are met by the first event and the second event in accordance with a determination that the first event and the second event correspond to a first identity based on the based on first metadata of the first event and second metadata of the second event, reduces the numbers of inputs required by the user to review notifications from various applications saving the user time (e.g., automatically generated summaries provide relevant notification content corresponding to the first identity, without a need for interaction with and/or opening multiple different notifications to view the full notification content and/or application content corresponding to summarized notifications), improves the efficiency of the device, and provides improved visual feedback to the user (e.g., improved visual feedback regarding notifications from the same person or entity).

In some embodiments, the second criteria are met (11032) by the first event and the second event in accordance with a determination that the first event and the second event correspond to a same application (e.g., the same application). In some embodiments, the second criteria include multiple sets of conditions that are used to determine how events may be related to one another, and allow a set of events to meet the second criteria if the second of events meet any of the multiple sets of conditions. In some embodiments, the first event and the second event meet the second criteria because they are generated from the same application; and the first event and the second event may also meet the second criteria if they are generated by different applications but correspond to the same people, or related to the same topic. For example, in FIG. 6C, the summary 5026 includes summary content corresponding to the notification 5012 (e.g., for the email application M), the notification 5014 (e.g., for the restaurant reservation application T), and the notification 5018 (e.g., for the airline application A). Displaying a first group notification that includes a first automatically generated summary based on a first content and a second content in accordance with the determination that a first event and a second event are detected have met a first criteria and second criteria, wherein the second criteria are met by the first event and the second event in accordance with a determination that the first event and the second event correspond to a same application, reduces the numbers of inputs required by the user to review notifications from various applications saving the user time (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding notifications from the same application).

In some embodiments, displaying the first group notification includes (11034) displaying a fifth indication of a total count of events that meet the second criteria (e.g., determined to be related to one another based on the second criteria) and are represented by the first group notification. In some embodiments, the computer system updates the sixth indication as additional events are detected and determined to be related to the first event and/or the second event based on the second criteria, and, optionally, summarized in an updated version of the first automatically generated summary. In some embodiments, when displaying a respective group notification, the computer system displays a first number with the respective group notification if a first quantity of events were used to generate the automatically generated summary included in the respective group notification, and displays a second number, different from the first number, with the respective group notification if a second quantity of events, different from the first quantity of events, were used to generate the automatically generated summary included in the respective group notification. In some embodiments, when displaying multiple group notifications concurrently, the computer system displays a third number with a third group notification if a third quantity of events were used to generate the automatically generated summary included one third group notification, and displays a fourth number, different from the third number, with a fourth group notification displayed concurrently with the fourth group notification, if a fourth quantity of events, different from the third quantity of events, were used to generate the automatically generated summary included in the fourth group notification. For example, in FIG. 6C, the summary 5026 includes a badge that indicates the summary 5026 corresponds to three notifications (e.g., the notification 5012, the notification 5014, and the notification 5018). For example, in FIG. 6K, the summary 6038 includes a badge that indicates that the summary 6038 corresponds to four notifications (e.g., the notification 6044, the notification 6046, the notification 6048, and the notification 6050 in FIG. 6L). Displaying the first group notification includes displaying a fifth indication of a total count of events that meet the second criteria and are represented by the first group notification, reduces the numbers of inputs required by the user to review notifications from various applications saving the user time, improves the efficiency of the device, and provides improved visual feedback to the user (e.g., improved visual feedback regarding the total count of events corresponding to the first group notification).

In some embodiments, the events that meet the second criteria and are represented (11036) by the first group notification, include at least the first event, the second event, and a first set of additional events including events that are different from the first event and the second event (e.g., the first set of additional events includes one or more additional events detected before the first event and/or the second event, and/or one or more additional events detected after the first event and the second event and generation of the initial version of the first automatically generated summary), and wherein the first automatically generated summary is not based on content corresponding to one or more events of the first set of additional events. In some embodiments, even though some events are determined to be related to the first event and/or the second event and are represented in the first group notification (e.g., counting toward the total number of events included in the first group notification), the content of these events are not used to generate the first automatically generated summary, for various reasons, such as the additional events include redundant content already summarized based on the content of other events, the additional events include trivial content (such as greetings, or other opening, closing, and/or non-essential information). For example, in FIG. 6E, the summary 5026 includes summary content corresponding to the notification 5012, the notification 5014, and the notification 5018, and includes a badge that indicates that three notifications are summarized in the summary 5026. The expanded version of the summary 5026, however, also includes the notification 6006 and the notification 6010 (e.g., shown in FIG. 6F), which are notifications corresponding to a first set of additional events, and which are not summarized by the summary 5026. Displaying the first group notification includes displaying a fifth indication of a total count of events that meet the second criteria and are represented by the first group notification, include at least the first event, the second event, and a first set of additional events including events that are different from the first event and the second event, and wherein the first automatically generated summary is not based on content corresponding to one or more events of the first set of events, reduces the numbers of inputs required by the user to review notifications from various applications saving the user time (e.g., automatically generated summaries provide relevant notification content without a need for manual manage displayed notifications and/or summaries), improves the efficiency of the device, and provides improved visual feedback to the user (e.g., improved visual feedback regarding the organization and content of the notifications).

In some embodiments, the computer system prioritizes (11038) the first event, the second event, and events of the first set of additional events different from the first event and the second event, in accordance with a first set of prioritization parameters (e.g., importance based on urgency of language, the subject matter, the user's preference, or other aspects of the first content, the second content, and the content of the first set of additional events, and/or the current context (e.g., current location, current time, other related events, and/or current and past restrictions on notification delivery)) other than a recency parameter for events (e.g., newer timestamp corresponds to higher priority, or vice versa), wherein the first automatically generated summary is generated based on the first content of the first event and the second content of the second event, and not based on the content corresponding to events of the first set of additional events, in accordance with a determination that the events of the first set of additional events received a lower priority than the first event and the second event in accordance with the first set of prioritization parameters. In some embodiments, recency of the events is taken into account in the prioritization of the events, but is not the sole parameter taken into account. For example, as described with reference to FIG. 6E, in some embodiments, the notification 6006 is not included in the summary content because the computer system 100 determines that the notification 6006 is not sufficiently high priority (e.g., based on one or more of: analysis of the content of the notification 6006; the application, source, or sender corresponding to the notification 6006; and/or the amount of time that has elapsed since the notification 6006 was generated or delivered). For example, the computer system 100 analyzes the content of the notification 6006 and determines that the availability of wine for purchase does not rise to the same priority level as a work-related email (e.g., the requires action on the part of the user of the computer system 100), or notifications with concrete timelines (e.g., in the near future and/or within a threshold amount of time from the current date), such as the notification 5012, the notification 5014, and/or the notification 5018. Generating the first automatically generated summary based on the first content of the first content of the first event and the second content of the second event, and events of the first set of additional events different from the first event and the second event, in accordance with a first set of prioritization parameters either than a recency parameter for events, wherein the first automatically generated summary is generated based on the first content of the first event and the second content of the second event, and not based on the content corresponding to events of the first set of additional events, in accordance with a determination that the events of the first set of additional events received a lower priority than the first event and the second event in accordance with the first set of prioritization parameters, reduces the numbers of inputs required by the user to review notifications from various applications (e.g., prioritizing more relevant content reduces the need for users to scroll through low priority content to view higher priority content), improves the efficiency of the device, and provides improved visual feedback to the user (e.g., improved visual feedback regarding the organization and content of the notifications on the display based on prioritization).

In some embodiments, the first set of prioritization parameters that is used to prioritize a respective event includes (11040) a parameter based on whether a user associated with the computer system is identified by name in the respective event (e.g., a message that includes the name or nickname of the user (e.g., Mike, Timmy, and so on, that indicates that this is not a group message with general applicability, but a message specifically calling the attention of the user)), For example, in some embodiments, a TRUE value (e.g., +1, or another positive integer value) for the parameter indicates that the user associated with the computer system is identified by name in the respective event, and results in an increase in the priority of the respective event; and a FALSE (e.g., 0, or a negative integer value) for the parameter indicates that the user associated with the computer system is not identified by name in the respective event (e.g., the user is part of a group of people identified by the respective event), and results in a decrease in the priority of the respective event or makes no difference in the priority of the respective event. In some embodiments, the first set of prioritization parameters that is used to prioritize a respective event includes a parameter based on whether a task is being assigned in the respective event (e.g., an email message that assigns a task to the user (e.g., “homework due tomorrow”), an alert that requires the user's attention and/or action (e.g., “critical update to be installed tonight, click to download”), or another event that requires the user to perform some action or complete a task), For example, in some embodiments, a TRUE value (e.g., +1, or another positive integer value) for the parameter indicates that one or more tasks are being assigned in the respective event, and results in an increase in the priority of the respective event (e.g., optionally, by an amount that is based on the total number of tasks and/or the importance and/or urgency of the tasks); and a FALSE (e.g., 0, or a negative integer value) for the parameter indicates that no task or no significant task is being assigned in the respective event, and results in a decrease in the priority of the respective event or makes no difference in the priority of the respective event. In some embodiments, the first set of prioritization parameters that is used to prioritize a respective event includes a parameter based on a frequency of communication between the user associated with the computer system and a person associated with the respective event (e.g., if the user frequently communicates with and responds quickly to messages of a first person and rarely respond to communications from another person, the events corresponding to communications from the first person has a higher priority), For example, in some embodiments, a higher frequency value for the parameter indicates that the user communicates with the person associated with the respective event frequently, which results in an increase in the priority of the respective event (e.g., optionally, by an amount that is based on the frequency value); and a lower frequency value for the parameter indicates that the user communicates with the person associated with the respective event infrequently, and results in a decrease in the priority of the respective event or makes no difference in the priority of the respective event. In some embodiments, the first set of prioritization parameters that is used to prioritize a respective event includes a parameter based on whether the respective event corresponds to a live person (e.g., events corresponding to live people are prioritized over events corresponding to automatically generated communications from businesses and organizations); For example, in some embodiments, a TRUE value (e.g., +1, or another positive integer value) for the parameter indicates that the respective event corresponds to a live person and results in an increase in the priority of the respective event; and a FALSE (e.g., 0, or a negative integer value) for the parameter indicates that the respective event does not correspond to a live person and results in a decrease in the priority of the respective event or makes no difference in the priority of the respective event. In some embodiments, the first set of prioritization parameters that is used to prioritize a respective event includes a parameter based on whether the respective event corresponds to a question requesting an answer from the user associated with the computer system (e.g., events that includes a question and a request for response to the question have higher priority than events that provide information and make no request for a response), For example, in some embodiments, a TRUE value (e.g., +1, or another positive integer value) for the parameter indicates that the respective event corresponds to a question requesting an answer from the user, and results in an increase in the priority of the respective event; and a FALSE (e.g., 0, or a negative integer value) for the parameter indicates that the respective event does not correspond to a question that requests an answer from the user, and results in a decrease in the priority of the respective event or makes no difference in the priority of the respective event. In some embodiments, the first set of prioritization parameters that is used to prioritize a respective event includes a parameter based on whether the respective event corresponds to a stored contact of the user associated with the computer system (e.g., events for messages from the known contacts of the user have higher priority than events for messages from senders that are not stored contacts of the user), and For example, in some embodiments, a TRUE value (e.g., +1, or another positive integer value) for the parameter indicates that the respective event corresponds to a stored contact of the user and results in an increase in the priority of the respective event; and a FALSE (e.g., 0, or a negative integer value) for the parameter indicates that the respective event does not correspond to a stored contact of the user and results in a decrease in the priority of the respective event or makes no difference in the priority of the respective event. In some embodiments, the first set of prioritization parameters that is used to prioritize a respective event includes a parameter based on whether respective content of the respective event includes an indication of urgency (e.g., subject lines with “urgent,” content with keywords such as “ASAP” or “deadline”, and/or other indications of urgency that can be determined based on artificial intelligence analysis of the content of the respective event). For example, in some embodiments, a TRUE value (e.g., +1, or another positive integer value) for the parameter indicates that the respective event includes an indication of urgency, and a greater value of indicates a greater level of urgency indicated by the content of the respective event, and results in an increase in the priority of the respective event (optionally by an amount that corresponds to the level of urgency); and a FALSE (e.g., 0, or a negative integer value) for the parameter indicates that the respective event does not include an indication of urgency and results in a decrease in the priority of the respective event or makes no difference in the priority of the respective event. In some embodiments, the first set of prioritization parameters that is used to prioritize a respective event includes a combination of two or more of the parameters described above. For example, in FIG. 6E, the notification 5012 mentions the user John by name, assigns the user a task (e.g., to send an updated draft report to Jane Doe, as shown in the full content of FIG. 5F) that is urgent (e.g., needs to be completed before the user's flight at 6:40 PM, later the same day), corresponds to a live person (Jane Doe) with which the user frequently communicates (e.g., Jane Doe is replying to a previous communication sent by John). Thus, the notification 5012 is given a high priority (e.g., included in the summary content of the summary 5026). In contrast, the notification 6006 does not mention the user by name, does not assign the user a task, does not correspond to a live person, and does not indicate urgency. Thus, the notification 6006 is given a low priority (e.g., is not included in the summary content of the summary 5026). Generating the first automatically generated summary based on the first content of the first content of the first event and the second content of the second event, and events of the first set of additional events different from the first event and the second event, in accordance with a first set of prioritization parameters, wherein the first set if prioritization parameters includes one or more of a parameter based on whether a user is identified by name, a task is being assigned in the respective event, the frequency of communication, the respective event corresponds to a live person, a question requesting an answer, and a stored contact of the user, reduces the numbers of inputs required by the user to review notifications from various applications (e.g., prioritizing more relevant content reduces the need for users to scroll through low priority content to view higher priority content), improves the efficiency of the device, and provides improved visual feedback to the user (e.g., improved visual feedback regarding the organization and content of the notifications on the display based on prioritization).

In some embodiments, while displaying the first group notification including the first automatically generated summary, the computer system detects (11042) a first user input directed to the first group notification. In response to detecting the first user input directed to the first group notification: in accordance with a determination that the first user input meets expansion criteria (e.g., the expansion criteria are met by a swipe input in a first direction (e.g., swipe up or swipe down), a tap input on an expansion button in the first group notification, a tap and hold input on the first group notification, or other criteria for expanding the first group notification), the computer system displays a first plurality of notifications that correspond to the first plurality of events, including the first event and the second event, that meet the second criteria with respect to one another and that are represented by the first group notification, wherein the first plurality of notifications include a first notification corresponding to the first event and a second notification corresponding to the second event (and optionally, one or more other notifications corresponding to other events in the first plurality of events that are determined to be related to the first event and the second event based on the second criteria). In some embodiments, in response to detecting the first user input, in accordance with a determination that the first user input does not meet the expansion criteria, the computer system forgoes displaying the first plurality of notifications that correspond to the first plurality of events. For example, in FIG. 6C, the expanded view of the summary 5026 includes a plurality of notifications (e.g., the notification 5012, the notification 5014, and the notification 5018), and each respective notification of the plurality of notifications corresponds to a respective event (e.g., a respective event that triggers and/or corresponds to the respective notification). Displaying a first plurality of notifications, in accordance with the determination that the first user input meets expansion criteria and in response to detecting the first user input directed to the first group notifications, that correspond to the first plurality of events, including the first event and the second event, that meet the second criteria with respect to one another and that are represented by the first group notification, wherein the first plurality of notifications include a first notification corresponding to the first event and a second notification corresponding to the second event, in accordance with the determination that the first user input meets expansion criteria, reduces the numbers of inputs required by the user to review notifications from various applications (e.g., a single user input allows for display of additional relevant notifications, and the user does not need to perform additional user inputs to navigate to different applications to view the content corresponding to the additional relevant notifications), improves the efficiency of the device, and provides improved visual feedback to the user (e.g., improved visual feedback regarding expansion to view content of the notification).

In some embodiments, the second notification includes (11044) a second automatically generated summary based on at least the second content corresponding to the second event (and, optionally, not based on the first content corresponding to the first event), and the second automatically generated summary includes automatically generated content (e.g., automatically-generated text content and/or generative text content) that is not part of the second content corresponding to the second event. In some embodiments, the first notification also includes an automatically generated summary that is generated (e.g., using an AI process or generative AI process) based on the first content corresponding to the first event (and optionally, not based on the second content corresponding to the second event), and the automatically generated summary of the first content of the first event includes automatically generated content that is not part of the first content of the first event. In some embodiments, one or more individual notifications are concurrently displayed with one or more group notifications, and some of the individual notifications include respective automatically generated summaries (e.g., the automatically generated summary of a respective individual notification includes automatically generated content that is based on respective application content corresponding to a respective event but is not part of the respective application content corresponding to the respective event), while some other individual notifications do not include automatically generated summaries (e.g., the notification content is based on respective application content corresponding to a respective event, but does not include automatically generated content that is not part of the respective application content corresponding to the respective event). For example, as described with reference to FIG. 6C, in some embodiments, the expanded view of the summary 5026 displays an individual summary for the notification 5012, the notification 5014, and/or the notification 5018. For example, an individual summary for the notification 5012 would be analogous to the summary 5024 in FIG. 5C (e.g., a summary that corresponds to a single notification 5012), and the summary 5024 in FIG. 5C (e.g., or an analogous summary) would be displayed in place of the notification 5012 in FIG. 6C (e.g., or the expanded view of the summary 5024 or 5036 would be displayed in place of the notification 5012 in FIG. 6C). Displaying a first plurality of notifications, in accordance with the determination that the first user input meets expansion criteria and in response to detecting the first user input directed to the first group notifications, that correspond to the first plurality of events, including the first event and the second event, that meet the second criteria with respect to one another and that are represented by the first group notification, wherein the first plurality of notifications include a first notification corresponding to the first event and a second notification corresponding to the second event, in accordance with the determination that the first user input meets expansion criteria, reduces the numbers of inputs required by the user to review notifications from various applications (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding expansion to view content of the notification).

In some embodiments, prior to detecting the first user input directed to the first group notification, the computer system displays (11046) a second plurality of notifications, including the first group notification, in a second system user interface (e.g., a wake screen user interface, a lock screen user interface, a notification user interface, a coversheet user interface, a notification history user interface, or another system user interface that display notifications corresponding to different applications), wherein the second plurality of notifications, including the first group notification, are displayed in accordance with a first sequential order of the second plurality of notifications. In some embodiments, the second plurality of notifications are not all visible in a notification display region of the second system user interface at a given time if more than a threshold number of notifications are included in the second plurality of notifications; additional notifications in the second plurality of notifications that are not currently visible become visible in the second system user interface, and/or some previously visible notifications become invisible in the second system user interface, in response to scrolling of the second plurality of notifications in accordance with the first sequential order of the second plurality of notifications. In response to detecting the first user input and in accordance with a determination that the first user input meets the expansion criteria (e.g., the expansion criteria are met by a swipe input in a first direction (e.g., swipe up or swipe down), a tap input on an expansion button in the first group notification, a tap and hold input on the first group notification, or other criteria for expanding the first group notification), the computer system maintains relative positions of the second plurality of notifications in accordance with the first sequential order of the second plurality of notifications, while replacing display of the first group notification with display of the first plurality of notifications that correspond to the first plurality of events, within the second plurality of notifications. For example, in some embodiments, if the first group notification is displayed among other notifications in a stack or list, when the first group notification is expanded into a set of individual notifications, the set of individual notifications, as a group, retains the ordinal position of the first group notification in the stack or list. For example, in FIG. 6B, the summary 5026 is displayed below the summary 5024 and above the notification 5016. In FIG. 6C, the expanded view of the summary 5026 is displayed below the summary 5024 to maintains the same position in the sequential order as the summary 5026 in FIG. 6B (e.g., the summary 5026 is expanded without changing the sequential order of notifications and summaries displayed within the user interface 5000). In FIG. 6C, the notification 5016 is no longer displayed (e.g., due to the larger size of the expanded view of the summary 5026), but would be displayed below the expanded view of the summary 5026 (e.g., if the user performs a user input such as a scrolling user input to navigate through notifications and/or summaries in the user interface 5000), Maintaining relative positions of the second plurality of notifications in accordance with the first sequential order of the second plurality of notifications, while replacing display of the first group notification with display of the first plurality of notifications that correspond to the first plurality of events, in response to detecting the first user input and in accordance with the determination that the first user input meets the expansion criteria, reduces the numbers of inputs required by the user to display notifications in the appropriate order (e.g., the user does not need to perform additional user inputs to re-order each time expansion criteria are met), improves the efficiency of the device, and provides improved visual feedback to the user (e.g., improved visual feedback regarding the organization and content of the notifications on the display for multiple applications).

In some embodiments, in response to detecting (11048) the first user input directed to the first group notification: in accordance with a determination that the first user input meets expansion criteria (e.g., the expansion criteria are met by a swipe input in a first direction (e.g., swipe up or swipe down), a tap input on an expansion button in the first group notification, a tap and hold input on the first group notification, or other criteria for expanding the first group notification), the computer system displays a visual indication (e.g., a boundary, a color scheme, a visual effect, a background platter, and/or other visual properties and/or structures) that groups the first plurality of notifications that correspond to the first plurality of events, including the first event and the second event, that meet the second criteria with respect to one another and that are represented by the first group notification, in a first spatial region (e.g., in a group platter, in exclusion of other notifications not belonging to the first plurality of notifications). In some embodiments, in response to detecting the first user input directed to the first group notification, in accordance with a determination that the first user input does not meet the expansion criteria, the computer system forgoes displaying the visual indication that groups the first plurality of notifications (e.g., maintains display of the first group notification in the second plurality of notifications in accordance with the first sequential order of the second plurality of notifications, scrolls the second plurality of notifications while maintaining the first sequential order of the second plurality of notifications (e.g., if the first user input is a swipe or drag gesture that directed to the first group notification and in a first direction (e.g., up and down directions, and/or a direction corresponding to the direction along with the second plurality of notifications are arranged in the first sequential order), and the expansion criteria require some other types of input different from a swipe or drag gesture), clears the first group notification from the second plurality of notifications without replacing it with the first plurality of notifications in its place (e.g., if the first user input is a swipe or drag gesture directed to the first group notification and in a second direction (e.g., sideways directions, and/or a direction corresponding to a horizontal direction of the first group notification) different from the first direction)), or navigates to an application corresponding to the first plurality of notifications (e.g., if the first user input is a tap input, or another selection input). For example, in FIG. 6C, the expanded view of the summary 5026 includes a border than encompasses the notification 5012, the notification 5014, and the notification 5018, such that all three notifications are visually grouped (e.g., to provide a visual indication that these three notifications correspond to the summary content of the summary 5026). Displaying a visual indication, in accordance with the determination that the expansion criteria has been met, that groups the first plurality of notifications that correspond to the first plurality of events, including the first event and the second event, that meet the second criteria with respect to one another and that are represented by the first group notification, in a first spatial region, reduces the numbers of inputs required by the user to review notifications from various applications and helps the user easily locate the relevant notifications (e.g., within a single spatial region), improves the efficiency of the device, and provides improved visual feedback to the user (e.g., improved visual feedback regarding expansion to view content of the notification within a spatial region).

In some embodiments, in response to detecting (11050) the first user input directed to the first group notification: in accordance with a determination that the first user input meets expansion criteria (e.g., the expansion criteria are met by a swipe input in a first direction (e.g., swipe up or swipe down), a tap input on an expansion button in the first group notification, a tap and hold input on the first group notification, or other criteria for expanding the first group notification), the computer system displays the first automatically generated summary concurrently with the first plurality of notifications that correspond to the first plurality of events. For example, in some embodiments, when the first group notification is expanded into the first plurality of notifications, the first automatically generated summary is moved to the top of the group platter, while individual notifications of the first plurality of notifications are displayed below the first automatically generated summary in the same group platter. In some embodiments, in response to detecting the first user input directed to the first group notification, in accordance with a determination that the first user input does not meet the expansion criteria, the computer system forgoes displaying the first automatically generated summary concurrent with the first plurality of notifications (e.g., maintains display of the first group notification, including the first automatically generated summary, in the second plurality of notifications in accordance with the first sequential order of the second plurality of notifications). For example, in FIG. 6C, the summary content of the (e.g., expanded view of the) summary 5026 includes the same summary content as in the (e.g., non-expanded) summary 5026 in FIG. 6B. The summary content is concurrently displayed with the notification 5012, the notification 5014, and the notification 5018. Displaying the first automatically generated summary concurrently with the first plurality of notifications that correspond to the first plurality of events, in accordance with the determination that the first user meets the expansion criteria, reduces the numbers of inputs required by the user to review notifications from various applications (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding displaying the automatically generated summary when the notification is expanded).

In some embodiments, while displaying the first group notification, including the first automatically generated summary, the computer system detects (11052) a first related event of the first event and the second event, wherein the first related event meets the second criteria with respect to the first event and the second event. After (e.g., in response to, or at a later time when the first criteria (e.g., criteria for displaying one or more notifications, criteria for displaying a notification user interface, criteria for displaying a wake screen of a device, and/or criteria for displaying a summary of events that have occurred) are met again after detecting the first related event) detecting the first related event of the first event and the second event, in accordance with a determination that completion criteria are met as a result of the first related event (e.g., the first related event indicates that a task or action related to the first event and the second event is completed, and a period of time has elapsed after the occurrence of the first related event, and/or content of the first related event overrides the content of the first event and the second event), the computer system displays a notification user interface that previously included the first group notification, without including the first group notification (e.g., without requiring a user input to explicitly clear the first group notification from the notification user interface). In some embodiments, the first related event is detected while the notification user interface is displayed with the first group notification; and in response to detecting the first related event, the computer system displays an animated transition that updates the first group notification in accordance with the content of the first related event, and subsequently removes the first group notification from the notification user interface without requiring user input (e.g., the notification user interface remains displayed without the first group notification). In some embodiments, if the first event is detected while the notification user interface is not displayed, the next time that the notification user interface is displayed, the computer system displays the notification user interface without the first group notification (e.g., the computer system has cleared the first group notification automatically without requiring user input). In some embodiments, after (e.g., in response to, or at a later time when the first criteria are met again (e.g., the first criteria are criteria for triggering display of the notification user interface)) detecting the first related event of the first event and the second event, in accordance with a determination that the completion criteria are not met, the computer system, optionally, displays the notification user interface with an updated version of the first group notification in accordance with the content of the first related event (e.g., increase the indication of the total count of events represented by the first group notification, moving the graphical indication of the current stage of a multi-stage task according to the content of the first related event, and/or updating the first automatically generated summary in accordance with the content of the first related event). For example, in FIGS. 6Q-6T, the summary 6072 (e.g., in FIG. 6Q and FIG. 6S) or the summary 6078 (e.g., in FIG. 6R and FIG. 6T) correspond to related notifications (e.g., are all notifications corresponding to the same grocery order). In FIG. 6W, in response to detecting an event corresponding to the notification 6086, the computer system 100 displays the notification 6086 and ceases to display the summary 6072 and the summary 6078 (e.g., the notification 6086 replaces and/or “clears” the summary 6072 and the summary 6078). The notification 6086 also corresponds to the same grocery order, and indicates that the grocery order is complete (e.g., and so the information that was included in the summary 6072 and the summary 6078 in FIGS. 6Q-6T is no longer contextually relevant). Displaying a notification user interface, that previously included the first group notification, without including the first group notification, after detecting the first related event of the first event and the second event in accordance with a determination that completion criteria are met as a result of the first related content, reduces the numbers of inputs required by the user to display relevant notifications (e.g., the user does not need to perform additional user inputs to manually cease displaying the first group notification when no longer relevant), improves the efficiency of the device, and provides improved visual feedback to the user (e.g., improved visual feedback regarding the organization and content of the notifications on the display).

In some embodiments, the first related event is associated (11054) with a same application as the first plurality of events. For example, the first related event is a final alert generated by an application (e.g., a food delivery application, a timesheet application, or another application) for a completion of a multi-stage task (e.g., a food delivery task, a multi-shift work day, or another multi-stage task), and the computer system automatically replaces the first group notification of the earlier steps of the task with a single notification for the completion of the task when the final alert is received. For example, in FIGS. 6Q-6T, the summary 6072 (e.g., in FIG. 6Q and FIG. 6S) or the summary 6078 (e.g., in FIG. 6R and FIG. 6T) correspond to related notifications (e.g., are all notifications corresponding to the same grocery order). In FIG. 6W, in response to detecting an event corresponding to the notification 6086, the computer system 100 displays the notification 6086 and ceases to display the summary 6072 and the summary 6078 (e.g., the notification 6086 replaces and/or “clears” the summary 6072 and the summary 6078). The notification 6086 indicates that the grocery order is complete (e.g., and so the information that was included in the summary 6072 and the summary 6078 in FIGS. 6Q-6T is no longer contextually relevant). Displaying a notification user interface, that previously included the first group notification, without including the first group notification, after detecting the first related event, wherein the first related event is associated with the same application as the first plurality of events, of the first event and the second event in accordance with a determination that completion criteria are met as a result of the first related content, reduces the numbers of inputs required by the user to display relevant notifications (e.g., the user does not need to perform additional user inputs to manually cease displaying the first group notification when no longer relevant), improves the efficiency of the device, and provides improved visual feedback to the user (e.g., improved visual feedback regarding the organization and content of the notifications on the display).

In some embodiments, the first related event is associated (11056) with a first application and the first plurality of events are associated with one or more applications different from the first application. For example, the first related event is an alert generated by a smart home application indicating that a food delivery truck is on the driveway, after the food delivery application has generated two or more alerts indicating that the food delivery truck is close by. The first related alert generated by the smart home application indicates a completion of a multi-stage task (e.g., a food delivery task), and the computer system automatically replaces the first group notification of the earlier steps of the task with a single notification for the completion of the task when the first related event is detected. In some embodiments, the computer system determines whether the first related event is related to the earlier events included in the first group notification in accordance with one or more artificial intelligence or machine learning processes and/or one or more generative artificial intelligent models. For example, in FIGS. 6Q-6T, the summary 6072 (e.g., in FIG. 6Q and FIG. 6S) or the summary 6078 (e.g., in FIG. 6R and FIG. 6T) correspond to related notifications (e.g., are all notifications corresponding to the same grocery order). In FIG. 6W, in response to detecting an event corresponding to the notification 6088, the computer system 100 displays the notification 6088 and ceases to display the summary 6072 and the summary 6078 (e.g., the notification 6086 replaces and/or “clears” the summary 6072 and the summary 6078). The notification 6088 corresponds to the doorbell application C (e.g., a different application than the grocery order application G), and indicates that a package was detected (e.g., which, based on context, the computer system 100 determines to be the grocery order for which information was provided via the summary 6072 and the summary 6078 in FIGS. 6Q-6T). Displaying a notification user interface, that previously included the first group notification, without including the first group notification, after detecting the first related event, wherein the first related event is associated with a first application and the first plurality of events are associated with one or more applications different from the first application, of the first event and the second event in accordance with a determination that completion criteria are met as a result of the first related content, reduces the numbers of inputs required by the user to display relevant notifications (e.g., the user does not need to perform additional user inputs to manually cease displaying the first group notification when no longer relevant), improves the efficiency of the device, and provides improved visual feedback to the user (e.g., improved visual feedback regarding the organization and content of the notifications on the display).

In some embodiments, in accordance with a first user setting, the second criteria require (11058) that the first event and the second event are associated with a same application in order for the second criteria to be met by the first event and the second event; and in accordance with a second user setting different from the first user setting, the second criteria do not require that the first event and the second event are associated with the same application in order for the second criteria to be met by the first event and the second event. For example, as described with reference to FIGS. 6K-6P, in some embodiments, the user can configure the computer system 100 (e.g., via a settings user interface) to specify one or more applications for which notifications should be grouped and summarized (e.g., as shown in FIGS. 6K-6P). In some embodiments, if multiple applications are enabled to group and summarize notifications, each enabled application displays a distinct summary (e.g., a summary analogous to the summary 6038 in FIGS. 6K-6P). Displaying a first group notification, that includes a first automatically generated summary based on a first content and a second content in accordance with the determination that a first event and a second event are detected have met a first and second criteria, wherein in accordance with a first user setting and a second user setting, the second criteria require and does not require, respectively, the first and second event are to be associated with the same application, reduces the numbers of inputs required by the user to review notifications from various applications (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding the organization and content of the notifications on the display).

In some embodiments, the computer system detects (11050) occurrence of a second plurality of events that are associated with a respective application (e.g., detecting respective occurrences of multiple events associated with the same application at different times over a period of time), including a fifth event and a sixth event, wherein the fifth event corresponds to fifth content (e.g., fifth application content that was designated for inclusion in a notification for the fifth event, independent of the sixth event) and the sixth event corresponds to sixth content (e.g., sixth application content that was designated for inclusion in a notification for the sixth event, independent of the fifth event) that is different from the fifth content. After detecting the occurrence of the second plurality of events that are associated with the respective application, the computer system detects that the first criteria are met (e.g., the criteria for displaying a notification user interface, such as a wake screen user interface, coversheet user interface, lock screen user interface, or another system user interface that displays notifications, are met). In response to detecting that the first criteria are met after detecting the occurrence of the second plurality of events: in accordance with a determination that a third user setting associated with the respective application (e.g., as configured by a user (e.g., turned on or off, selected to enable/unselected to disable) using a configuration user interface for notification delivery and/or for the respective application) permits grouping and summarization of events of the respective application, and that the fifth event and the sixth event meet the second criteria, the computer system displays a respective group notification that includes a respective automatically generated summary that is based on both the fifth content and the sixth content; in accordance with a determination that the third user setting associated with the respective application (e.g., as configured by a user using a configuration user interface for notification delivery and/or for the respective application) permits grouping and summarization of events of the respective application, and that the fifth event and the sixth event do not meet the second criteria, the computer system forgoes displaying a respective group notification that includes a respective automatically generated summary that is based on both the fifth content and the sixth content; and in accordance with a determination that the third user setting associated with the respective application does not permit grouping and summarization of events of the respective application, the computer system forgoes displaying a respective group notification that includes a respective automatically generated summary that is based on both the fifth content and the sixth content, irrespective of whether the fifth event and the sixth event meet the second criteria. In some embodiments, the first group notification was generated in accordance with a determination that the first event and the second event meet the second criteria because they are both associated with a first application, and a respective user setting permits grouping and automatic summarization for the first application. For example, as described with reference to FIGS. 6K-6P, in some embodiments, the computer system 100 displays the summary 6038 (e.g., only) if the computer system is configured to enable summaries for a specific application (e.g., the doorbell application C that corresponds to the summary 6038), and if the notifications (e.g., the notification 6044, the notification 6046, the notification 6048, and/or the notification 6050) summarized in the summary 6038 meet relevance criteria (e.g., the notifications 6044, 6046, 6048, and 6050 (e.g., each) meet the relevance criteria because they correspond to the same doorbell application C, and the notifications were all generated within a threshold amount of time (e.g., the last 2 hours)). Displaying a respective group notification that includes a respective automatically generated summary that is based on both the fifth content and the sixth content in accordance with a determination that a third user setting associated with the respective application permits grouping and summarization of events of the respective application, and that the fifth event and the sixth event meet the second criteria, reduces the numbers of inputs required by the user to review notifications from the application (e.g., automatically generated summaries provide relevant notification content without a need for interaction with and/or opening multiple different notifications to view the full notification content and/or application content corresponding to summarized notifications), improves the efficiency of the device, and provides improved visual feedback to the user (e.g., improved visual feedback regarding the organization and content of the notifications on the display).

In some embodiments, the computer system is in communication with a second computer system (e.g., the second computer system had detected occurrence of the first event before the computer system detected the first event, the second computer system detected the second event before the computer system detected the second event, and the computer system detected the first event and the second event through communication with the second computer system) (e.g., the computer system (e.g., a peripheral device, such as a smartwatch, an earphone, a smartphone device, a door bell, a thermostat, a smart home appliance, and/or another computer system) and the second computer system, such as a main device, such as a smartphone, a desktop computer, a tablet device, and/or another type of computer system, are paired devices, and can pass notifications detected locally to each other). The computer system detects (11062) a respective event that corresponds to content of a respective application (e.g., a respective event that meets summarization criteria such as having content that meets a threshold content length, concluding a series of earlier events, corresponding to a last message of a plurality of messages transmitted in a short period of time of one another, and/or other criteria for generating a summary for an event). In response to detecting the respective event: in accordance with the respective event being detected via communication with the second computer system (e.g., in accordance with a determination that the respective event is detected via communication with the second computer system or a determination that the respective event is associated with an automatically generated summary generated by the second computer system) (e.g., the occurrence of the respective event is detected by the second computer system locally and passed onto the computer system by the second computer system), the computer system displays a respective notification for the respective event, including a respective automatically generated summary that is based on at least the content of the respective application, wherein the respective automatically generated summary includes generated content that is not part of the content of the respective application (e.g., the content of a summary of the respective event that is output at the computer system is optionally generated by the second computer system and transmitted to the computer system before being output by the computer system); and in accordance with the respective event being detected by the computer system locally (e.g., without requiring communication with the second computer system), the computer system displays the respective notification for the respective event, without including a respective automatically generated summary that is based on at least the content of the respective application (e.g., the content of the respective notification does not include content that is not part of the content of the respective application) (e.g., the computer system is not capable of generating a summary locally for a locally detected event, and relies on the second computer system to generate summaries for events detected locally and/or events detected through communication with the second computer system). In some embodiments, when two computer systems are paired, they pass notifications detected locally to each other, such that notifications regarding a respective event detected at either computer system can be displayed at both computer systems. In some embodiments, a computer system (e.g., the computer system, such as a smart watch, an earphone, a vehicle dashboard, a smart home control device, or a door bell) that has a limited display detects an event through communication with another computer system that has a bigger display (e.g., a smartphone, a mobile device, a tablet device, or a desktop computer), and display a notification for the event that includes an automatically summary of the content corresponding to the event, rather than a notification that includes the non-summarized content corresponding to the event. The computer system does not automatically summarize content for a respective event that is detected locally, and displays a notification for the locally detected event without an automatically generated summary for the content corresponding to the locally detected event. For example, as described with reference to FIG. 5C, in some embodiments, the computer system 100 displays at least one locally generated notification (e.g., that is not summarized) and at least one summary (e.g., received from an external source such as the other computer system). Displaying a respective notification for the respective event, including or without including a respective automatically generated summary that is based on at least the content of the respective application, in accordance that the respective event is being detected via communication with the second computer system and detected by the computer system locally, enables more efficient design of (e.g., a reduces the cost to manufacture) the computer system (e.g., the computer system 100 does not need to include required software and/or processing power in order to generate summaries, and can instead receive summary content (e.g., when applicable) from an external source). This also reduces the numbers of inputs required by the user to review notifications from various applications (e.g., the automatically generated summary reduces scenarios where redundant content may require a user to perform additional user inputs to either expand a notification and/or open a corresponding application to view the full application content, when the redundant content causes relevant notification content not to be displayed), improves the efficiency of the device, and provides improved visual feedback to the user (e.g., improved visual feedback regarding display of the notification on the remote device).

In some embodiments, in response to detecting (11054) the respective event: in accordance with the respective event being detected via communication with the second computer system (e.g., in accordance with a determination that the respective event is detected via communication with the second computer system or a determination that the respective event is associated with an automatically generated summary generated by the second computer system) (e.g., the occurrence of the respective event is detected by the second computer system locally and passed onto the computer system by the second computer system), the computer system displays, concurrently with the respective notification for the respective event, including the respective automatically generated summary that is based on at least the content of the respective application (e.g., the content of the summary is optionally generated by the second computer system and transmitted to the computer system to be output at the computer system), a respective indication (e.g., an icon or identifier that identifies the second computer system that detected the respective event locally, or a generic icon to indicate a remote device that detected the respective event locally) that indicates that the respective event was detected remotely from the computer system; and in accordance with the respective event being detected by the computer system locally (e.g., without requiring communication with the second computer system), the computer system displays the respective notification for the respective event, without the respective indication and without including the respective automatically generated summary that is based on at least the content of the respective application. For example, as described with reference to FIG. 5C, in some embodiments, summaries that are received from the other computer system include a visual indicator (e.g., a badge, an icon, a distinct border, a distinct color, a distinct shape, a distinct text color, and/or a distinct background) that the summary was received from an external source (e.g., the other computer system), and locally generated notifications are not displayed with the visual indicator (e.g., the visual indicator denotes notifications and/or summaries received from an external source, and so is not applied to locally generated notifications). Displaying concurrently and without, a respective indication that indicates that the respective event was detected remotely from the computer system, in accordance to the determination that the respective event being detected via communication with a second computer system and by the computer system locally, respectively, reduces the numbers of inputs required by the user to review notifications from various applications saving the user time, improves the efficiency of the device, and provides improved visual feedback to the user (e.g., improved visual feedback regarding the source of the displayed summary or notification).

In some embodiments, the computer system is in communication with a third computer system, and the computer system detected the first event locally at the computer system (e.g., the third computer system (e.g., a peripheral device, such as a smartwatch, an earphone, a smartphone device, a door bell, a thermostat, a smart home appliance, and/or another computer system) and the computer system, such as a main device, such as a smartphone, a desktop computer, a tablet device, and/or another type of computer system, are paired devices, and can pass notifications detected locally to each other). In response to detecting (11066) the first event: the computer system sends the first automatically generated summary to the third computer system, wherein sending the first automatically generated summary to the third computer system causes the third computer system to display a respective notification for the first event, including the first automatically generated summary. In some embodiments, when two computer systems are paired, they pass notifications detected locally to each other, such that notifications regarding a respective event detected at either computer system can be displayed at both computer systems. In some embodiments, the computer system, such as a smart watch, an earphone, a vehicle dashboard, a smart home control device, or a door bell, that has limited processing power, receives the automatically generated summary of the content of a respective event from another computer system that has greater processing power (e.g., a smartphone, a mobile device, a tablet device, or a desktop computer), and displays a notification for the event that includes the automatically summary of the content corresponding to the respective event. In some embodiments, the computer system detects an event locally and generates the automatically generated summary for the event locally, and sends the event and the automatically generated summary to a remote computer system for display at the remote computer system. In some embodiments, the computer system detects an event through communication with a remote computer system, and receives an automatically generated summary from the remote computer system and displays a notification for the event including the automatically generated summary. In some embodiments, the computer system detects an event locally, send the event to a remote computer system and receives an automatically generated summary from the remote computer system and displays a notification for the event with the automatically generated summary, where the remote computer system also displays a notification for the event including the automatically generated summary. In some embodiments, the computer system detects an event through communication with a remote computer system that had detected the event locally, and the computer system generates an automatically generated summary for the event and sends it to the remote computer system, where the remote system displays a notification including the automatically generated summary received from the computer system. For example, as described with reference to FIG. 5C, in some embodiments, the computer system 100 (e.g., a smartphone) generates a summary (e.g., and/or summary content) and transmits the generated summary/summary content to the other computer system (e.g., a peripheral device such as a smartwatch). In response to receiving the generated summary/summary content from the computer system 100, the other computer system 100 displays the summary (e.g., or a summary that includes the summary content generated and transmitted by the computer system 100). In some embodiments, the computer system 100 also displays the generated summary/summary content (e.g., in response to a user input and/or request to display summaries and/or notifications). Sending the first automatically generated summary to the third computer system, wherein sending the first automatically generated to the third computer system causes the third computer system to display a respective notification for the first event, including the first automatically generated summary, in response to detecting the first event, reduces the numbers of inputs required by the user to review notifications from various applications (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding display of the notification on the remote device).

In some embodiments, the computer system detects (11068) a respective event that corresponds to content of a respective application, wherein the respective event was detected by the third computer system locally, and the computer system detects the respective event through communication with the third computer system. In response to detecting the respective event: the computer system generates a respective automatically generated summary that is based on at least the content of the respective application, wherein the respective automatically generated summary includes generated content that is not part of the content of the respective application; and the computer system sends the respective automatically generated summary to the third computer system, wherein sending the respective automatically generated summary to the third computer system causes the third computer system to display a respective notification for the respective event, including the respective automatically generated summary received from the computer system. In some embodiments, the computer system displays the respective notification including the respective automatically generated summary locally at the computer system, optionally with an indication that the respective notification is for an event detected by a remote computer system (e.g., the third computer system), and not a locally detected event. For example, as described with reference to FIG. 5C, in some embodiments, the computer system 100 (e.g., a smartphone) generates a summary (e.g., and/or summary content) and transmits the generated summary/summary content to the other computer system (e.g., a peripheral device such as a smartwatch). In response to receiving the generated summary/summary content from the computer system 100, the other computer system 100 displays the summary (e.g., or a summary that includes the summary content generated and transmitted by the computer system 100). In some embodiments, the computer system 100 also displays the generated summary/summary content (e.g., in response to a user input and/or request to display summaries and/or notifications). Generating a respective automatically generated summary that is based on at least the content of the respective application, wherein the respective automatically generated summary includes generated content that is not part of the content of the respective application, and sending the respective automatically generated summary to the third computer system for display, reduces the numbers of inputs required by the user to review notifications from various applications (e.g., automatically generated summaries provide relevant notification content without a need for interaction with and/or opening notifications to view the full notification content and/or application content corresponding to summarized notifications), improves the efficiency of the device, and provides improved visual feedback to the user (e.g., improved visual feedback regarding the organization and content of the notifications on the display).

It should be understood that the particular order in which the operations in FIGS. 11A-11I have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 12000, 13000, and 14000) are also applicable in an analogous manner to method 11000 described above with respect to FIGS. 11A-11I. For example, the application (content), notification (content), summary (content, applications, notifications, summaries, and user inputs, described above with reference to method 11000 optionally have one or more of the characteristics of the application (content), notification (content), summary (content, applications, notifications, summaries, and user inputs, described herein with reference to other methods described herein (e.g., 10000, 12000, 13000, and 14000). For brevity, these details are not repeated here.

FIGS. 12A-12E are flow diagrams illustrating method 12000 of filtering notification and/or summary content, in accordance with some embodiments. Method 12000 is performed at an electronic device or computer system (e.g., device 300, FIG. 3A, or portable multifunction device 100, FIG. 1A) that is in communication with a display generation component, and one or more sensors for detecting user inputs. In some embodiments, the display generation component is a touch-screen display and the touch-sensitive surface is on or integrated with the display. In some embodiments, the display is separate from the touch-sensitive surface. Some operations in method 12000 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Generating the first notification corresponding to the first event in accordance with the determination that the computer system is operating in a first mode in which notifications corresponding to events of the first event type are permitted, and in accordance with a determination that the first event includes first content that meets relevance criteria and forgoing generating the first notification corresponding to the first event in accordance with the determination that the computer system is operating in a second mode, in which notifications corresponding to events of the first event type are suppressed and the first event does not include content that meets the relevance criteria, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user (e.g., improved visual feedback regarding the organization and content of the notifications on the display).

At a computer system that is in communication with a display generation component and one or more sensors for detecting user inputs: the computer system detects (12002) occurrence of a first event of a first event type (e.g., an event corresponding to an application H, or an event corresponding to an application N). In response to detecting (12004) the occurrence of the first event of the first event type: in accordance with a determination that the computer system is operating in a first mode in which notifications corresponding to events of the first event type are permitted (e.g., a mode in which all notifications are permitted to be displayed as they are generated, a mode in which some notifications types (e.g., notifications of selected applications and/or communications from selected people) are permitted and other notification types (e.g., notifications of applications that are not specifically selected as being permitted for the first mode, and/or communications that are from people who are not specifically selected as being permitted for the first mode) are not permitted to be displayed, as they are generated), the computer system generates (12006) a first notification corresponding to the first event (e.g., including displaying the first notification corresponding to the first event on a wake screen user interface, lock screen user interface, home screen, application user interface of another application different from the application that generated the first event of the first type, as a pop-up, banner, and/or persistently displayed notification; and/or outputting a non-visual notification that includes a tactile output and/or an audio alert that corresponds to the first event) (e.g. in FIG. 7A, the notification 7098, corresponding to the application H, is displayed when no filtering is active; and the notification 5020, corresponding to the application N, is displayed when no filtering is active); in accordance with a determination that the computer system is operating in a second mode in which notifications corresponding to events of the first event type are suppressed (e.g., a mode in which all notifications are prevented from being displayed as they are generated, a mode in which some notifications types (e.g., notifications of selected applications and/or communications from selected people) are permitted and other notification types (e.g., notifications of applications that are not specifically selected as being permitted for the first mode, and/or communications that are from people who are not specifically selected as being permitted for the first mode) are not permitted to be displayed, as they are generated) and the first event includes first content that meets relevance criteria (e.g., despite that the first event meets the condition to be suppressed because of the application or sender it is associated with, the content of the first event meets relevance criteria (e.g., criteria measuring urgency of the content, and importance of the content to the user)), the computer system generates (12008) the first notification corresponding to the first event (e.g., including displaying the first notification corresponding to the first event on a wake screen user interface, lock screen user interface, home screen, application user interface of another application different from the application that generated the first event of the first event type, as a pop-up, banner, and/or persistently displayed notification; and/or outputting a non-visual notification that includes a tactile output and/or an audio alert that corresponds to the first event) (e.g., in FIG. 7O, the notification 7098 meets relevance criteria because the notification 7098 falls within the “Health” category 7082 (e.g., that is enabled for “Intelligent Filtering,” as shown in FIG. 7N), and the computer system 100 displays the notification 7098 (e.g., even though the “Do Not Disturb” mode would normally suppress the notification 7098); and in accordance with a determination that the computer system is operating in the second mode in which notifications corresponding to events of the first event type are suppressed and the first event does not include content that meets the relevance criteria (the first event meets the condition to be suppressed because of the application or sender it is associated with, and the content of the first event does not meet the relevance criteria (e.g., the content is not urgent or important enough to overcome the suppression based on application and/or sender))), the computer system forgoes (12010) generating the first notification corresponding to the first event (e.g., including forgoing displaying the first notification corresponding to the first event on a wake screen user interface, lock screen user interface, home screen, application user interface of another application different from the application that generated the first event of the first event type, as a pop-up, banner, and/or persistently displayed notification, sending the first notification directly to notification history or archive, forgoing outputting a non-visual notification that includes a tactile output and/or an audio alert that corresponds to the first event; and/or otherwise taking the first notification out of the normal, unsuppressed delivery process) (e.g., in FIG. 7J, the “News” category is not enabled for “Intelligent Breakthrough,” and in FIG. 7O, the computer system 100 does not display the notification 5020 while the “Do Not Disturb” mode is active, because the notification 5020 (e.g., that corresponds to the application N, which would fall under the “News” category) does not meet relevance criteria (e.g., does not fall within an enabled “Intelligent Breakthrough” category). In some embodiments, the first mode is a mode in which DND filtering is turned off, such that notifications from all applications are permitted without restriction. In some embodiments, the first mode is a mode in which DND filtering is turned on, but DND breakthrough for some notifications are enabled. For example, DND breakthrough allows notifications from some applications and people to be displayed when DND filtering is turned on. In some embodiments, the events of the first event type include all events when DND filtering is turned off. In some embodiments, events of the first event type include events that meet the DND breakthrough criteria, when DND filtering is turned on. In some embodiments, the events of the first event type can include respective events generated by multiple different applications and/or associated with multiple different people. In some embodiments, the second mode is a mode in which DND filtering is turned on, and intelligent breakthrough is also turned on. In some embodiments, DND breakthrough is not turned on in the second mode, or the first event type of event does not meet DND breakthrough criteria. In some embodiments, intelligent breakthrough differs from DND breakthrough in that intelligent breakthrough is based on content of the notification, and rather than based on static properties such as the application name, application type, and/or people associated the notification. In some embodiments, when DND filtering is turned on, DND breakthrough can be a setting that can be enabled to modify the result of DND filtering (e.g., in the first mode, where all notifications are permitted, or notifications that meets the requirement for DND breakthrough are permitted). In some embodiments, when DND filtering is turned on, with or without DND breakthrough (e.g., in the second mode, where all notifications are suppressed, or notifications that do not meet the requirements of DND breakthrough are suppressed), intelligent breakthrough can be a setting that can be enabled to modify the result of the DND filtering with or without DND breakthrough (e.g., out of the notifications that were suppressed based on DND filtering with or without DND breakthrough, suppressed notifications that meet the relevance criteria are also permitted). In some embodiments, if intelligent breakthrough were not enabled, the first notification would be suppressed in accordance with the DND filtering with or without DND breakthrough.

In some embodiments, notifications corresponding to a second event type, different from the first event type, are permitted in the second mode (e.g., DND filtering is on to suppress notifications of the first event type, but permits notifications of the second event type) (e.g., first event type corresponds to a first application and second event type corresponds to a second application different from the first application; the first event type corresponds to a first sender of communications, and the second event type corresponds to a second sender of communications different from the first sender of communications). The computer system detects (12012) occurrence of a second event of the second event type. In response to detecting the occurrence of the second event of the second event type: in accordance with a determination that the computer system is operating in the second mode in which notifications corresponding to events of the first event type are suppressed and that notifications corresponding to events of the second event type are permitted in the second mode (e.g., events of the second event type meets the DND breakthrough criteria for the active DND mode), the computer system generates a second notification for the second event (e.g., including displaying the second notification corresponding to the second event on a wake screen user interface, lock screen user interface, home screen, application user interface of another application different from the application that generated the second event of the second event type, as a pop-up, banner, and/or persistently displayed notification, and/or outputting a non-visual notification that includes a tactile output and/or an audio alert that corresponds to the second event;). In some embodiments, the second mode is a mode in which DND filtering is turned on and DND breakthrough is also turned on, but the first type of events does not meet the DND breakthrough criteria while the second type of events meet the DND breakthrough criteria. In some embodiments, the intelligent breakthrough is turned on as well in the second mode, but it does not affect the display of the second notification, because the second notification is permitted by the DND breakthrough already. In some embodiments, the computer system operates in a mode in which DND filtering is on, and intelligent breakthrough is off, so that the notifications are permitted or suppressed based on DND filtering alone. In some embodiments, the computer system operates in a mode in which DND filtering is off, and intelligent filtering is on, so that the notifications are permitted or suppressed based on whether their content meets the relevance criteria (e.g., intelligent filtering is turned on as a standalone mode, with or without DND filtering or DND breakthrough to modify the result of the intelligent filtering). In some embodiments, intelligence filtering is turned on, and DND breakthrough is also turned on, such that if the content of a notification does not meet the relevance criteria, the notification may still be displayed if it meets the requirement of DND breakthrough (e.g., if its application, type, or associated people are among the permitted applications, types, or associated peoples). For example, as described with reference to FIG. 7C, in some embodiments, the first level of filtering and/or the second level of filtering corresponds to (e.g., notification) filtering that is applied based on characteristics (e.g., an application corresponding to the notification; a user, sender, or source corresponding to the notification; and/or a time corresponding to an event or when the notification was generated) of notifications to which the filtering is applied. For example, when a “Do Not Disturb” mode is active for the computer system, the “Do Not Disturb” mode filters applications based on application, user/contact, and/or a time or time frame when the “Do Not Disturb” mode is scheduled to be active. For example, the “Do Not Disturb” mode includes a “DND Breakthrough” setting that allows for some notifications based on notification characteristics, to “break through” (e.g., ignore or otherwise circumvent) other filtering that is active for the computer system 100 (e.g., active “Do Not Disturb” modes, other characteristic-based filtering modes, and/or “Intelligent Filtering” modes as described in further detail below). Generating the second notification corresponding to the second event in accordance with the determination that the computer system is operating in the second mode, in which notifications in which notifications corresponding to events of the first event type are suppressed and that notifications corresponding to events of the second event type are permitted in the second mode reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user (e.g., improved visual feedback regarding the organization and content of the notifications on the display).

In some embodiments, the computer system detects (12014) occurrence of a third event of a third event type, different from the first event type. In response to detecting the occurrence of the third event of the third event type and in accordance with a determination that the computer system is operating in a third mode in which the relevance criteria are not used to determine whether to display notifications (e.g., intelligent breakthrough and intelligent filtering of notifications based on content of the notifications are not turned on for the third mode), and that notifications corresponding to events of the third event type are permitted in the third mode (e.g., events of the third event type meet the DND breakthrough criteria for the active DND mode, or DND filtering is turned off), the computer system generates a third notification for the third event (e.g., including displaying the third notification corresponding to the third event on a wake screen user interface, lock screen user interface, home screen, application user interface of another application different from the application that generated the third event of the third event type, as a pop-up, banner, and/or persistently displayed notification; and/or outputting a non-visual notification that includes a tactile output and/or an audio alert that corresponds to the third event;). In response to detecting the occurrence of the third event of the third event type, and in accordance with a determination that the computer system is operating in a fourth mode in which the relevance criteria are not used to determine whether to display notifications, and that notifications corresponding to events of the third event type are suppressed in the fourth mode (e.g., events of the third event type does not meet the DND breakthrough criteria, if turned on, for the active DND mode), the computer system forgoes generating the third notification for the third event. For example, in FIG. 7A, an event corresponding to the notification 5020 (e.g., the third event type is events corresponding to the application N) is detected (e.g., was detected 2 hours ago), and in response, the computer system 100 displays the notification 5020 (e.g., because no filtering is applicable, as the “Do Not Disturb” mode and no “Intelligent Filtering” is active for the computer system 100). In FIG. 7B, the “Do Not Disturb” mode is active for the computer system (e.g., “Normal” filtering is applied), In some embodiments, the “Do Not Disturb” mode does not permit notifications corresponding to events corresponding to the application N (e.g., notifications for the application N are suppressed when the “Do Not Disturb” mode is active, for example, because the user has configured the “Do Not Disturb” mode to suppress notifications for the application N while the “Do Not Disturb” mode is active). Generating the third notification corresponding to the third in accordance with a determination that the computer system is operating in a third mode in which the relevance criteria are not used to determine whether to display notifications, and that notifications corresponding to events of the third event type are permitted in the third mode, and forgoing generating third notification corresponding to the third in accordance with a determination that the computer system is operating in a fourth mode in which the relevance criteria are not used to determine whether to display notifications, and that notifications corresponding to events of the third event type are suppressed in the fourth mode, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user (e.g., improved visual feedback regarding the organization and content of the notifications on the display).

In some embodiments, the computer system detects (12016) occurrence of a first plurality of events, corresponding to a first plurality of event types. In response to detecting the occurrence of the first plurality of events: in accordance with a determination that the computer system is operating in a fifth mode in which the relevance criteria are used to determine whether to display notifications (e.g., intelligent filtering based on content is turned on, as a standalone mode), the computer system evaluates respective events of the first plurality of events in accordance with the relevance criteria, irrespective of respective event types that correspond to the respective events of the first plurality of events (e.g., in the fifth mode, intelligent filtering is turned on, without DND filtering, or DND breakthrough); in accordance with a determination that a first subset of the first plurality of events meet the relevance criteria, the computer system displays a first set of notifications corresponding to the first subset of the first plurality of events; and in accordance with a determination that a second subset of the first plurality of events do not meet the relevance criteria, the computer system forgoes displaying a second set of notifications corresponding to the second subset of the first plurality of events. For example, as described with reference to FIG. 7N, in some embodiments, the settings user interface 7044 allows for configuring a separate set of notification settings (e.g., for a separate “Intelligent Filtering” mode of the computer system 100, where the “Intelligent Filtering” settings in the settings user interface 7044 are applied, and wherein the “Intelligent Filtering” mode is not (e.g., and optionally, cannot be) active at the same time as the “Do Not Disturb” mode of the computer system 100), which allows for quick configuration of a separate (e.g., reduced-notification) mode without the need to fully configure the “Do Not Disturb” mode (e.g., or other modes that are analogous to the “Do Not Disturb” mode). Displaying a first set of notifications corresponding to the first subset of the first plurality of events in accordance with a determination that a first subset of the first plurality of events meet the relevance criteria, and forgoing displaying a second set of notifications corresponding to the second subset of the first plurality of events in accordance with a determination that a second subset of the first plurality of events do not meet the relevance criteria, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user (e.g., improved visual feedback regarding the organization and content of the notifications on the display).

In some embodiments, in accordance with a determination that the first subset of the first plurality of events meet the relevance criteria, the computer system displays (12018) the first set of one or more notifications corresponding to the first subset of the first plurality of events, along with one or more indications (e.g., a text color, platter color, glyph, icon, or animated visual effect) that the first set of one or more notifications are displayed in accordance with the relevance criteria that are in use (e.g., intelligent filtering criteria, and/or intelligent breakthrough criteria, either as a standalone mode, or as a modifier for an event-type based filtering mode). For example, as described with reference to FIG. 7O, in some embodiments, notifications (e.g., such as the notification 7098) that “break through” are displayed with a visual indication (e.g., that the notification is displayed because the “Intelligent Breakthrough” settings allow the notification to “break through”). Displaying the first set of one or more notifications corresponding to the first subset of the first plurality of events, along with one or more indications provides improved visual feedback to the user (e.g., improved visual feedback regarding which notifications meet the relevance criteria and/or which notifications are determined to be particularly relevant in a particular context).

In some embodiments, the fifth mode is enabled (12020) without requiring activation of a mode in which modification of notification delivery is based on event types of notifications (e.g., content-based intelligent filtering is enabled as a standalone mode, without requiring activation of DND filtering, and/or DND breakthrough based on event types). For example, as described with reference to FIG. 7N, in some embodiments, the settings user interface 7044 allows for configuring a separate set of notification settings (e.g., for a separate “Intelligent Filtering” mode of the computer system 100, where the “Intelligent Filtering” settings in the settings user interface 7044 are applied, and wherein the “Intelligent Filtering” mode is not (e.g., and optionally, cannot be) active at the same time as the “Do Not Disturb” mode of the computer system 100), which allows for quick configuration of a separate (e.g., reduced-notification) mode without the need to fully configure the “Do Not Disturb” mode (e.g., or other modes that are analogous to the “Do Not Disturb” mode). Displaying a first set of notifications, in accordance to the determination that the computer system is operating in a fifth mode, and wherein the fifth mode is enabled without requiring activation of a mode in which modification of notification delivery is based on event types of notifications, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user (e.g., improved visual feedback regarding the organization and content of the notifications on the display).

In some embodiments, the computer system has (12022) a sixth mode in which modification of notification delivery is based on event types of detected events, and wherein the fifth mode has fewer configuration options than the sixth mode. In some embodiments, the sixth mode includes configuration options to specify the special handling (e.g., breakthrough and/or filtering) based on a first event type, a second event type, a third event type, and/or other event types that correspond to different applications, different people, different time and date, different locations, and/or other properties associated with the notifications, and the fifth mode does not include these event type based configuration options, and performs evaluation of content of all events of all event types based on the same set of relevance criteria to determine whether to and/or how to deliver the notifications (e.g., irrespective of the applications, people, and/or other properties associated with the events). For example, as described with reference to FIG. 7N, in some embodiments, the settings user interface 7044 allows for configuring a separate set of notification settings, for quick configuration of a separate (e.g., reduced-notification) mode without the need to fully configure the “Do Not Disturb” mode (e.g., the “Intelligent Filtering” settings include fewer and/or simpler options as compared to the “Do Not Disturb” mode or analogous modes). Displaying a first set of notifications, in accordance to the determination that the computer system is operating in a fifth mode, wherein the computer system has a sixth mode in which modification of notification delivery is based on event types of detected events, and wherein the fifth mode has fewer configuration options than the sixth mode, reduces the numbers of inputs required by the user to review notifications (e.g., provides a streamlined configuration for modifying delivery of notifications, without needing to display every available setting for modifying delivery of notifications and without requiring a user to configure every available setting for modifying delivery of notifications)), improves the efficiency of the device, and provides improved visual feedback to the user (e.g., improved visual feedback regarding the organization and content of the notifications on the display).

In some embodiments, generating the first notification for the first event includes (12024): displaying the first notification for the first event on a first system user interface (e.g., a lock screen, a wake screen, and/or a coversheet user interface) that is displayed in response to a request (e.g., swipe to bring down a cover sheet user interface, or a press on a power button to lock the computer system) to transition the computer system into a restricted state of the computer system (e.g., from a home screen or a user interface of an application) or in response to a request (e.g., a press on the power button to wake up the device, a tap on the touch-screen to wake up the display) to transition out of a low power state into the restricted state of the computer system (e.g., waking up from a low power always on state, or a sleep state). In some embodiments, when displaying a plurality of notifications in a user interface (e.g., a notification user interface, a wake screen user interface, a lock screen user interface, or another user interface that displays notifications), sometimes, the plurality of notifications are concurrently visible in the user interface when the notification display area in the user interface is sufficiently large to display the plurality of notifications concurrently (e.g., when there are only a few notifications). Sometimes, only some of the plurality of notifications are visible in the user interface at a given time, and additional notifications from the plurality of notifications become visible in the user interface when the user scrolls the plurality of notifications relative to the user interface. In the examples and descriptions provided herein, displaying a plurality of notifications in a respective user interface means that the plurality of notifications form part of the respective user interface, but some of the plurality of notifications may become visible in the respective user interface through scrolling the plurality of notifications relative to the respective user interface. For example, in FIGS. 7A-7C, the notifications that are displayed (e.g., in accordance with notification settings and/or active modes of the computer system 100) are displayed on a lock screen of the computer system 100. Displaying the first notification for the first event on a first system user interface that is displayed in response to a request to transition the computer system into a restricted state of the computer system or in response to a request to transition out of a low power state into the restricted state of the computer system, reduces the numbers of inputs required by the user to review notifications (e.g., configures the computer system to provide relevant notifications, when transitioning out of the restricted state of the computer system, and in the relevant contexts, without requiring the user to perform additional inputs to display suppressed notifications and/or cease displaying notifications that are not relevant in a particular context), improves the efficiency of the device, and provides improved visual feedback to the user (e.g., improved visual feedback regarding the organization and content of the notifications on the display).

In some embodiments, the computer system displays (12026), in the first system user interface (e.g., concurrently with notifications of one or more detected events that are not suppressed and/or that met breakthrough conditions based on their event types and/or content), an indication of one or more events for which notification delivery is suppressed in accordance with an active mode of the computer system (e.g., indiscriminate suppression, event-type based suppression (e.g., DND filtering), content-based suppression (e.g., intelligent filtering), with or without event-based breakthrough (e.g., DND breakthrough) and/or content-based breakthrough (e.g., intelligent breakthrough), a combination of two or more of above (e.g., filtering modified by breakthrough, or breakthrough modified by filtering)). In some embodiments, the indication includes an indication of event types of the events (e.g., associated applications, associated people, and/or other associated properties) that are a basis for suppressing the notification delivery of the one or more events in the active mode of the computer system. For example, in some embodiments, in a respective active mode of the computer system, notifications are suppressed unless their corresponding events meet some event-type-based breakthrough conditions (e.g., events are from a subset of allowed applications, or associated with a subset of allowed people), and the indication of the one or more events for which notification delivery is suppressed includes the application icons for the events for which notifications were not generated and delivered because the applications of those events are not included in the subset of allowed applications, and/or the indication of the one or more events for which notification delivery is suppressed includes the username or avatars of people that are associated with the events that were suppressed because the people associated with those events are not included in the subset of allowed people for the respective active mode. In some embodiments, suppression of notification is based on intelligent filtering, and notifications for events that have content that meets relevance criteria are generated and displayed in the first system user interface, while notifications for events with content that does not meet the relevance criteria are suppressed. The indication of the events with content that does not meet the relevance criteria is displayed in the first system user interface (e.g., the application icons of the applications that generated the content of the events). For example, in FIG. 7C, the visual indicator 7010 includes an indication of applications for which some notifications have been suppressed while “Intelligent Filtering” is active for the computer system 100. Displaying, in the first system user interface, an indication of one or more events for which notification delivery is suppressed in accordance with an active mode of the computer system provides improved visual feedback (e.g., improved visual feedback regarding events and/or characteristics of notifications corresponding to events for which notification delivery was suppressed in accordance with the active mode of the computer system).

In some embodiments, the relevance criteria include (12028) a first set of criteria that correspond to a first set of user-specified categories for event content (e.g., user can specify categories such as health, safety, invitations, project X, and/or other categories of event content, in the configurations of a mode in which content-based filtering and/or breakthrough are enabled), and wherein a determination of whether content of a respective event meets the relevance criteria is based on whether the content of the respective event belongs to (e.g., in accordance with machine analysis of the content of the respective event, using artificial intelligence and/or machine learning techniques such as one or more generative AI models such as large language models trained on words or word tokens) the first set of user-specified categories of event content (e.g., if the first set of user-specified categories are suppressed categories, notifications for events with content that falls into those categories are suppressed; and if the first set of user-specified categories are breakthrough categories, notifications for events with content that falls into those categories are not suppressed). For example, in some embodiments, the first set of user-specified categories of content are user-specified breakthrough categories of content, when the computer system is operating in the second mode and the first event type is suppressed (e.g., based on the event-type-based filtering), if the first event includes content that belongs in the first set of user-specified categories of content, the computer system generates and displays a notification for the first event; and if the first event does not include content that belongs in the first set of user-specified categories of content, the computer system forgoes generating the notification for the first event. In another example, in some embodiments, the first set of user-specified categories of content are user-specified filtering categories of content, when the computer system is operating in the second mode and the first event type is suppressed (e.g., based on the event-type-based filtering) and the second event type is permitted (e.g., based on event-type-based breakthrough), if the second event includes content that belongs in the first set of user-specified categories of content, the computer system forgoes generating a notification for the second event; and if the second event does not include content that belongs in the first set of user-specified categories of content, the computer system generates the notification for the second event. For example, in FIG. 7J, different categories are configurable for “Intelligent Filtering” settings of the computer system 100. In FIG. 7K, the computer system 100 is configured to select (e.g., enable) the category “Home Security” (e.g., in response to detecting the user input 7066 in FIG. 7J). In FIG. 7L, since the “Home Security” category is now enabled, the computer system 100 also displays the summary 7070 (e.g., corresponding to “Home Security” notifications, such as notifications from a doorbell camera and/or home security system), that was not previously displayed (e.g., prior to selecting the “Home Security” category). Generating the first notification corresponding to the first event in accordance with the determination that the computer system is operating in a first mode in which notifications corresponding to events of the first event type are permitted, and in accordance with a determination that the first event belongs to a first set of user-specified categories of event content, and forgoing generating the first notification corresponding to the first event in accordance with the determination that the computer system is operating in a second mode, in which notifications corresponding to events of the first event type are suppressed and the first event does not include content that meets the relevance criteria, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user (e.g., improved visual feedback regarding the organization and content of the notifications on the display).

In some embodiments, the computer system displays (12030) a first configuration user interface for a respective mode (e.g., a mode in which intelligent filtering or intelligent breakthrough are enabled) in which notification delivery is modified (filtering and/or breakthrough based on content and/or properties of events are enabled), wherein the first set of user-specified categories for event content includes a first category of event content and a second category of event content, different from the first category of event content, at a time when the first configuration user interface is displayed (e.g., the first set of user-specified categories of event content are used in the relevance criteria for the respective mode). While displaying the first configuration user interface, the computer system displays a first user input that adds a third category of event content to the first set of user-specified categories for event content, and detecting a second user input that deletes the first category of event content from the first set of user-specified categories for event content, without deleting the second category of event content from the first set of user-specified categories of event content. In response to detecting the first user input and the second user input, the computer system updates the first set of user-specified categories of event content to include the second category of event content and the third category of event content, without including the first category of event content. For example, in FIG. 7J, the computer system 100 displays a plurality of categories (e.g., the categories 7052, 7054, 7056, 7058, 7060, 7062, and 7064). In response to detecting the user input 7066 that selects the “Home Security” category 7056, the computer system adds the “Home Security” category to the set of categories (e.g., categories for which notifications are grouped and summarized, as shown in the summary 7070 in FIG. 7L). As described with reference to FIG. 7K, in some embodiments, analogous user inputs can be used to enable and/or disable additional categories (e.g., additional user inputs on categories that are not already selected (e.g., without checkmarks) will enable those categories; and additional user inputs on categories that are already selected (e.g., with checkmarks) will disable those categories). Updating a first set of user-specified categories of event content to include a second category of event content and a third category of event content, without including a first category of event content, wherein the second category of event content is different from the first category of event content, in response to detecting a first user input that adds the third category of event content to the first set of user-specified categories for event content and a second user input that deletes the first category of event content from the first set of user-specified categories for event content, reduces the number of user inputs needed to access relevant notification and/or summary content (e.g., the user can specify categories of event content in order to control what notification/summary content is displayed, which reduces the need for the user to perform additional inputs to open different applications (e.g., to view content for notifications/summaries that were not displayed or delivered) and/or to navigate through or clear notifications/summaries with low priority content (e.g., content that is not contextually relevant).

In some embodiments, displaying the first configuration user interface includes (12032) displaying a plurality of selectable options that correspond to a plurality of available categories of event content, wherein selection of a respective selectable option of the plurality of selectable options causes a respective available category of event content to be added or removed from the first set of categories of event content (e.g., enabled or disabled, as a filtering or breakthrough category). For example, in FIG. 7J, the computer system 100 displays a plurality of categories (e.g., the categories 7052, 7054, 7056, 7058, 7060, 7062, and 7064). In response to detecting the user input 7066 that selects the “Home Security” category 7056, the computer system adds the “Home Security” category to the set of categories (e.g., categories for which notifications are grouped and summarized, as shown in the summary 7070 in FIG. 7L). Displaying the first configuration user interface includes displaying a plurality of selectable options that correspond to a plurality of available categories of event content, wherein selection of a respective selectable option of the plurality of selectable options causes a respective available category of event content to be added or removed from the first set of categories of event content reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user to select an option to filter specific categories of event types.

In some embodiments, the computer system detects (12034) occurrence of a second plurality of events, corresponding to a second plurality of event types. After (e.g., in response to or at a later time after) detecting the occurrence of the second plurality of events: in accordance with a determination that the computer system is operating in a sixth mode in which the first set of user-specified categories of event content are used to determine whether to display notifications (e.g., intelligent filtering based on content is turned on, as a standalone mode, as a modification for DND filtering and/or DND breakthrough, or is modified by DND filtering and/or DND breakthrough), the computer system evaluates respective events of the second plurality of events to determine if the second plurality of events include content that belong to the first set of user-specified categories of event content. In some embodiments, if the first set of categories are enabled as permitted categories of event content (e.g., intelligent breakthrough based on the first set of categories of event content), in accordance with a determination that a first subset of the second plurality of events include content that belongs to the first set of categories of event content, the computer system displaying notifications corresponding to the first subset of the second plurality of events; and in accordance with a determination that a second subset of the second plurality of events do not include content that belongs to the first set of categories of event content, the computer system forgoes displaying notifications corresponding to the second subset of the second plurality of events. In some embodiments, if the first set of categories are enabled as suppressed categories of event content (e.g., intelligent filtering based on the first set of categories of event content), in accordance with a determination that a third subset of the second plurality of events include content that belongs to the first set of categories of event content, the computer system forgoes displaying notifications corresponding to the third subset of the second plurality of events; and in accordance with a determination that a fourth subset of the second plurality of events do not include content that belongs to the first set of categories of event content, the computer system displays notifications corresponding to the fourth subset of the second plurality of events. For example, in FIG. 7J and FIG. 7K, the settings user interface 7044 includes multiple categories. As described with reference to FIG. 7J, the categories shown in FIG. 7J, when enabled, allow notifications (e.g., that include notification and/or application content) determined to fall within one or more enabled categories to be displayed while “Intelligent Filtering” is applied. In some embodiments, the categories shown in FIG. 7J, when enabled, filter and/or suppress notifications that fall within the one or more enabled categories (e.g., notifications falling within the enabled categories are not displayed) while “Intelligent Filtering” is active. Evaluating respective events of the second plurality of events to determine if the second plurality of events include content that belong to the first set of user-specified categories of event content in accordance with a determination that the computer system is operating in a sixth mode in which the first set of user-specified categories of event content are used to determine whether to display notifications, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, and provides improved visual feedback to the user to select an option to filter specific categories of event types.

In some embodiments, the computer system displays (12036) a second system user interface (e.g., a notification history user interface, and/or a wake screen user interface that includes a notification history display region) that includes representations of a plurality of notifications, including a plurality of previously displayed notifications (e.g., notifications that were not suppressed and that were displayed on the wake screen user interface at some point in time after the events corresponding to the notifications were detected) and stored notifications for a plurality of previously detected events for which notifications were suppressed (e.g., notifications that were not displayed on the wake screen user interface because they were received or generated during a mode in which the notifications were suppressed based on their corresponding event type and/or relevance of their content, and some of them are directly stored in notification history), wherein the representations of the plurality of notifications are grouped in accordance with a plurality categories of event content (e.g., grouped based on the categories associated with the content of the events corresponding to the previously displayed notifications and stored notifications, e.g., including the first set of user-specified categories of event content and additional sets of categories of event content). For example, in FIG. 7L, the user interface 5000 includes the summary 7068 and the summary 7070, based on enabled categories (e.g., shown in FIG. 7K). As described with reference to FIG. 7J, in some embodiments, while “Intelligent Filtering” is active, notifications that are displayed by the computer system 100 (e.g., on a wake screen; a lock screen; the user interface 5000; a notification history user interface; and/or a user interface that includes notifications which were previously displayed, delivered, and/or correspond to previously detected events) are grouped and/or arranged by content category (e.g., optionally, the same categories available for selection in FIG. 7J). In some embodiments, categories that are enabled in the settings user interface 7044 in FIG. 7J, determine which categories of notifications are displayed. In some embodiments, categories that are enabled in the settings user interface 7044 in FIG. 7J, determine which categories of notifications are filtered and/or suppressed, and notifications with content falling within disabled categories continue to be displayed (e.g., and continue to be grouped and/or arranged by content category). Displaying a second system user interface that includes representations of a plurality of notifications, reduces the numbers of inputs required by the user to review notifications saving the user time, improves the efficiency of the device, and provides improved visual feedback to the user (e.g., improved visual feedback regarding determined categories of content and/or logical groupings of notifications).

In some embodiments, notifications for events of the first event type are suppressed (12038) in the second mode based on a first set of event properties (e.g., corresponding applications, and people), wherein the relevance criteria includes a set of permitted content categories, wherein the first event of the first event type meets the relevance criteria when the content of the first event belongs to the set of permitted content categories, and wherein the first event of the first event type does not meet the relevance criteria when the content of the first event does not belong to the set of permitted content categories. For example, in some embodiments, when the intelligent breakthrough is enabled for a set of content categories (e.g., safety, emergency, party invites, and/or other content categories for event content), even if notification for a respective event is supposed to be suppressed based on the DND filtering criteria (e.g., notification for a detected event is suppressed based on the application and/or people associated with the detected event), the computer system still generates and displays the notification for the respective event because of the content-based breakthrough. For example, in FIG. 7O, the notification 7098 (e.g., which was previously suppressed due to the “Do Not Disturb” mode of the computer system 100) “breaks through” and is displayed in the user interface 5000 (e.g., because notifications for the “Health” category 7082 are enabled to “break through,” as shown in the “Intelligent Breakthrough” settings in FIG. 7N). Displaying of notifications for events of the first type in the second mode wherein the relevance criteria includes a set of permitted content categories, wherein the first event of the first event type meets the relevance criteria when the content of the first event belongs to the set of permitted content categories, and wherein the first event of the first event type does not meet the relevance criteria when the content of the first event does not belong to the set of permitted content categories, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context), improves the efficiency of the device, provides improved visual feedback to the user by displaying highly relevant criteria even when a suppression mode is enabled.

In some embodiments, the computer system generates (12040) the first notification corresponding to the first event (and/or generating and displaying the notification (and optionally, outputting a non-visual alerts) for other events mentioned above) includes generating a summary of the content of the first event, and displaying the first notification of the first event, including displaying the summary of the content of the first event in the first notification of the first event. In some embodiments, the summary of the content of the first event is included as part of a group notification that includes a summary of the content of multiple related events. In some embodiments, the summary of the content includes content generated by machine analysis of the content of the respective event, using artificial intelligence and/or machine learning techniques such as one or more generative AI models such as large language models trained on words or word tokens. For example, in FIG. 7D, while “Intelligent Filtering” is enabled, the computer system 100 displays the summary 5024 (e.g., the same summary 5024 that is shown in FIG. 5C) and the summary 7012. Generating the first notification corresponding to the first event includes generating a summary of the content of the first event, and displaying the first notification of the first event, including displaying the summary of the content of the first event in the first notification of the first event, reduces the numbers of inputs required by the user to review notifications (e.g., configures the computer system to provide relevant notifications in the relevant contexts, without requiring the user to perform additional inputs to display suppressed notifications and/or cease displaying notifications that are not relevant in a particular context; and providing summaries that include relevant information, reducing the need for users to perform additional inputs to read the entire notification, or open an application to view the full application content corresponding to a particular notification, in order to access the relevant information), improves the efficiency of the device, and provides improved visual feedback to the user to select an option to filter specific categories of event types.

In some embodiments, the computer system display (12042) a respective system user interface (e.g., a home screen user interface, a wake screen user interface, a lock screen user interface, a notification user interface, a control user interface, a watch face, a user interface that corresponds to a restricted state of the computer system, or another system user interface that is different from user interfaces of applications), including: in accordance with a determination that a currently active notification delivery mode is subject to a respective set of relevance criteria, displaying a first indication (e.g., an icon, a dot, a badge, or another type of indication) in the respective system user interface indicating that relevance-based notification delivery is active; and in accordance with a determination that the currently active notification delivery mode is not subject to a respective set of relevance criteria, forgoing displaying the first indication in the respective system user interface. In some embodiments, the indication is displayed in a status region of the respective system user interface (e.g., at the top of the respective system user interface, among in the status indicators; or in another system indicator region). For example, in FIG. 7C, the computer system 100 displays the visual indicator 7008 that the second level of filtering (e.g., “Intelligent Filtering”) is active for the computer system 100. Displaying a first indication in the respective system user interface indicating that relevance-based notification delivery is active and forgoing displaying the first indication in a respective set of relevance criteria in accordance with a determination that the currently active notification delivery mode is subject and is not subject, respectively, to a respective set of relevance criteria, provides improved visual feedback to the user (e.g., improved visual feedback regarding whether the currently active notification delivery mode is or is not subject to the respective set of relevance criteria)

It should be understood that the particular order in which the operations in FIGS. 12A-12E have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 13000, and 14000) are also applicable in an analogous manner to method 12000 described above with respect to FIGS. 12A-12E. For example, the application (content), notification (content), summary (content, applications, notifications, summaries, and user inputs, described above with reference to method 12000 optionally have one or more of the characteristics of the application (content), notification (content), summary (content, applications, notifications, summaries, and user inputs, described herein with reference to other methods described herein (e.g., 10000, 11000, 13000, and 14000). For brevity, these details are not repeated here.

FIGS. 13A-13F are flow diagrams illustrating method 13000 of outputting content via contextually relevant output devices, in accordance with some embodiments. Method 13000 is performed at an electronic device or computer system (e.g., device 300, FIG. 3A, or portable multifunction device 100, FIG. 1A) that is in communication with a display generation component, and one or more input devices. In some embodiments, the display generation component is a touch-screen display and the touch-sensitive surface is on or integrated with the display. In some embodiments, the display is separate from the touch-sensitive surface. Some operations in method 13000 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Outputting a first notification that corresponds to a first event, in accordance with the determination that first application content exceeds a first content length threshold, wherein the first notification includes a first automatically generated summary based on at least a first application content, in accordance to the determination that the first application content exceeds a first constant length threshold, and outputting a second notification that corresponds to the first event, in accordance with a determination that the first application content does not exceed the first content length threshold, wherein the second notification does not include the first automatically generated summary, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user by audibly alerting the user to relevant notification content.

The method 13000 is performed a computer system (e.g., a mobile device, a smartphone, a smartwatch, a desktop computer, a gaming device, and/or other computer systems) (e.g., the computer system 100 in FIG. 8A) that is in communication with one or more output generation components (e.g., a display, a speaker, tactile surfaces, a vehicle dashboard, vehicle head unit, and/or headphones; and/or other visual output generation components, audio output generation components, and/or tactile output generation components) (e.g., the audio device 8000 in FIG. 8B) and one or more input devices (e.g., devices and/or sensors for detecting user inputs, such as touch-sensitive surfaces, cameras, joysticks, buttons, touch-screen display, microphone, vibration sensors, motion sensors, mouses, pointers, and/or other input devices): In some embodiments, the computer system includes a pair of headphones or a speaker, a companion device to a pair of headphones or a speaker (e.g., the device that is controlling the pair of headphones or speaker), or a computer system that includes a pair of headphones or a speaker and a companion device that controls the headphones or speaker. In some embodiments, the computer system detects (13002) (e.g., detecting locally, or detecting via communication with another device that had detected the first event earlier than the computer system) a first event that corresponds to first application content (e.g., first application content of a first application (e.g., application content designated for inclusion in one or more notifications, such as content from one or more received text messages, content of one or more news alerts, content of one or more weather alerts, content of one or more location-based alerts, and/or other application content (e.g., generated by an application for inclusion in one or more notifications), or related application content from a plurality of applications (e.g., related communications from multiple communication applications, or related application content from multiple different applications, such as a doorbell application, a smart home application, a weather application, and/or a health application)) (e.g., an event corresponding to the notification 6020 in FIG. 8A, or an event corresponding to the summary 5024 in FIG. 8C); and In some embodiments, content of an application is distinguished from metadata associated with the content or other objects of the application, and includes text and/or graphics that is displayed in a user interface or user interface object of the application to convey information to the user visually, and playable content of an audio or video media item. In response to detecting the first event, the computer system outputs (13004), via the one or more output generation components (e.g., one or more speakers or headphones), a respective notification for the first event, wherein outputting the respective notification for the first event includes: in accordance with a determination that the first application content exceeds a first content length threshold (e.g., the first length threshold includes a threshold hold number of characters, words, paragraphs, sections, pages, a duration, and/or bytes, a threshold file size, and/or other measures of content length for one or more types of content and/or their equivalents (e.g., equivalent number of words for audio messages, or equivalent audio duration for textual messages)), outputting (13006), via the one or more output generation components, a first notification that corresponds to the first event (e.g., as a banner or pop-up over a currently displayed user interface (e.g., an application user interface of an application other than the application(s) associated with the first application content, a home screen user interface, a wake screen user interface, a dimmed always-on lock screen, a system user interface that corresponds to a restricted state of the computer system); and/or as audible speech output corresponding to the first event that is outputted by a speaker and/or headphones), the first notification including a first automatically generated summary (e.g., automatically-generated text content and/or generative text content and/or automatically generated audio content and/or generative audio content) (e.g., textual summary, audio summary, graphical summary, highlight summary, and/or descriptive summary) that is based on at least the first application content, (e.g., a summary generated using and/or with the assistance of artificial intelligence, machine learning, and/or a language learning model), wherein the first automatically generated summary is not included in the first application content (e.g., the first automatically generated summary is not included in the first application content, the automatically generated summary is generated (e.g., using an AI process or generative AI process) by the operating system and is not provided by the application(s) associated with the first application content, and/or the automatically generated summary is not simply a transcription of audio, translation between languages, and/or speech to text conversion of the first application content) (e.g., the first automatically generated summary is generated using and/or with the assistance of artificial intelligence, machine learning, and/or a language learning model (e.g., generated locally at the computer system or transmitted to the computer system from another device), and is outputted in a visual and/or audible form at the computer system) (e.g., in FIG. 8B, the content of the notification 6020 does not meet the content length threshold, and the audio device 8000 outputs the audio 8001 that does not include a summary of the content of the notification 6020); and in accordance with a determination that the first application content does not exceed the first content length threshold, outputting (13008), via the one or more output generation components, a second notification that corresponds to the first event (e.g., as a banner or pop-up over a currently displayed user interface (e.g., an application user interface of an application other than the application(s) associated with the first application content, a home screen user interface, a wake screen user interface, a dimmed always-on lock screen, or a system user interface that corresponds to a restricted state of the computer system; and/or as audible speech output corresponding to the first event that is outputted by a speaker and/or headphones), wherein the second notification does not include the first automatically generated summary (e.g., the second notification includes the first application content, or a subset of the first application content; and/or the second notification includes transcription, translation, and/or speech-to-text conversion of the first application content, without any semantic summary of the first application content) (e.g., in FIG. 8D, the content corresponding to a notification 5044 meets the content length threshold, and the computer system 100 displays the summary 5024, and the audio device 8000 outputs the audio 8003 that includes a summary of the notification 5044 (e.g., summary content of the summary 5024)).

In some embodiments, the computer system outputs (13010), via the one or more output generation components, the first notification that corresponds to the first event, includes outputting, via a first output generation component (e.g., a first set of speakers, a first pair of headphones, a first pair of earphones, and/or other audio output components) of the one or more output generation components, a first audio output (e.g., a first audio announcement, and/or a first speech output) that includes the first automatically generated summary (e.g., an audio output that reads out the content of the first notification, including the content of the first automatically generated summary). In some embodiments, the first automatically generated summary is generated using and/or with the assistance of one or more artificial intelligence models, machine learning models, one or more large language models and/or other generative artificial intelligence and machine learning models and/or processes (e.g., using an AI process or a generative AI process) (e.g., generated locally at the computer system or transmitted to the computer system from another device) based at least in part on the first application content. In some embodiments, the computer system outputs, via the one or more output generation components, the second notification that corresponds to the first event, includes outputting, via the first output generation component (e.g., the first set of speakers, the first pair of headphones, the first pair of earphones, and/or other audio output components) of the one or more output generation components, a second audio output (e.g., a second audio announcement, and/or a second speech output) that does not include the first automatically generated summary (e.g., an audio output that reads out the content of the second notification which does not includes the content of the first automatically generated summary). In some embodiments, the computer system includes a display and an output device for audio outputs (e.g., integrated output device or paired via one or more connections), such as a pair of earphones, a headphone, a speaker, or another audio output device. In some embodiments, in response to detecting the first event, the computer system outputs an audio version of the respective notification for the first event using the output device for audio outputs (e.g., when the display is powered off, is in a low power state, is in a pocket or away from the user), optionally without concurrent display of a companion notification for the respective notification (e.g., a visual version of the respective notification for the first event, or a visual notification that has content that is different from the content of the respective notification (e.g., more substantial, detailed, and/or illustrated, than the audio version of the respective notification)). For example, in FIG. 8D, the audio device 8000 outputs audio 8003 (e.g., which includes content corresponding to the summary 5024 in FIG. 8C, which summarizes a “long” notification), and in FIG. 8B, the audio device 8000 outputs audio 8001 (e.g., which includes content corresponding to the notification 6020 in FIG. 8A, and does not include a summary of the notification 6020 (e.g., because the notification 6020 is a “short” notification). Outputting a first notification that corresponds to a first event and outputting a first audio output that includes a first automatically generated summary based on at least first application content, in accordance to the determination that the first application content exceeds a first constant length threshold, and outputting a second notification and a second audio output that does not include the first automatically generated summary, in accordance to the determination that the first application does not exceed the first content length threshold, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications).

In some embodiments, the first audio output includes (13012) a first indication indicating that the first audio output includes an automatically generated summary (e.g., automatically-generated text content and/or generative text content and/or automatically generated audio content and/or generative audio content), and wherein the second audio output does not include the first indication. For example, the first audio output includes content that is written in a third person voice, rather than a direct readout of the content from the first application that corresponds to the first event. In a more specific example, for one or more newly received messages from Alice that says “It's raining so hard. There are so many cars on the road. I am completely stuck in traffic. I don't think I can make it to the dinner tonight,” the first audio output that includes the automatically generated summary conveys the information in a third person voice, such as “Alice messaged that she will be late due to the rain and heavy traffic.” Alternatively, the first audio output includes a keyword or key phrase to indicate that the audio content that follows includes an automatically generated summary. In a more specific example, the first audio output starts with “Alice, summarized,” followed by “Not able to make to dinner due to rain and traffic.” In contrast, in some embodiments, the second audio output does not include an automatically generated summary, and does not include the indication that would be used to indicate presence of any automatically summarized content in an audio version of a notification. For example, if Alice's message(s) were “I can't make to dinner tonight. There is too much rain and traffic” and the message content did not meet the first content length threshold, the computer system generates a normal notification without an automatically generated summary, and the second audio output reads out the content of the regular un-summarized notification “Message from Alice: I can't make to dinner tonight. There is too much rain and traffic.” The audio output is not spoken in the third person's voice, and does not include the keyword or key phrase indicating that the content of the audio output includes an automatically generated summary. For example, in FIG. 8D, the audio 8003 includes audio corresponding to the summary 5024 (e.g., shown in FIG. 8C), and also indicates that the audio includes a summary (e.g., by stating “From Jane, summarized . . . ”). Outputting a first notification and a first audio output that includes a first indication that the first automatically generated summary based on at least first application content, in accordance to the determination that the first application content exceeds a first constant length threshold, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user (e.g., improved audio feedback that the first application content has been summarized).

In some embodiments, after outputting the first audio output including the first automatically generated summary (e.g., at or within a threshold time window of the end of the first audio output) in accordance with the determination that the first application content exceeds the first content length threshold, the computer system outputs (13014), via the one or more output generation components (e.g., the first output generation component, a second output generation component, and/or another output generation component of the one or more output generation components), a first prompt (e.g., a first audio prompt outputted by an audio output device (e.g., earphones, or a speaker), and/or a first visual prompt shown on a display) that requests a user's instruction for outputting the first application content (e.g., the un-summarized version of the first application content, optionally, in its entirety (e.g., message content of one or more related messages, or notification content of one or more notifications for past events that have not been read or seen)). For example, in FIG. 8D, the audio 8003 (e.g., and the audio 8005) ends with a prompt for outputting additional content (e.g., “Read it?” for the audio 8003, or “Do you want to hear the full message?” for the audio 8005). Outputting a first prompt that requests a user's instruction for outputting first application content after outputting a first notification that corresponds to a first event, wherein the first notification includes a first automatically generated summary based on at least a first application content, in accordance to the determination that the first application content exceeds a first constant length threshold, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), provides additional control options without cluttering a display with additional displayed controls (e.g., individually displayed controls for displaying and/or outputting audio for the first automatically generated summary and/or the first application content).

In some embodiments, after outputting the first audio output including the first automatically generated summary (e.g., at or within a threshold time window of the end of the first audio output, or after outputting at least a threshold portion of the first audio output) in accordance with the determination that the first application content exceeded the first content length threshold, the computer system detects (13016), via the one or more input devices (e.g., a microphone), a first speech input that corresponds to a request to output the first application content (e.g., a speech input “Read the whole message” or “Read it.”) via the first output generation component (e.g., the first speaker, or the first pair of earphones); and in response to detecting the first speech input that corresponds to a request to output the first application content using the first output generation component, the computer system outputs, via the first output generation component, a respective audio output that includes the first application content (e.g., optionally including the entirety of the first application content, and without including the first automatically generated summary). In some embodiments, if a speech input that corresponds to a request to output the first application content is not detected after outputting the first audio output including the first automatically generated summary (e.g., is not detected within a threshold time window after the completion of the first audio output, or is not detected before another request is made by the user for another task unrelated to the first event (e.g., causing a context change)), the computer system does not output the respective audio output that includes the first application content. For example, as described with reference to FIG. 8D, in some embodiments (e.g., after outputting audio that includes a prompt for further user interaction and/or to output additional content), in response to detecting a subsequent user input (e.g., a voice command or a voice response to the prompt, such as “yes,” “read it,” or an equivalent phrase), the audio device 8000 generates audio corresponding the notification content of the notification 5044 (e.g., in an analogous manner to the audio 8001, for the notification 6020, described above with reference to FIG. 8B). Outputting a respective audio output that includes the first application content in response to detecting a first speech input that corresponds to a request to output the first application content using the first generation component, provides additional control options without cluttering the display with additional displayed controls (e.g., individual controls for displaying the first automatically generated summary and/or the first application content).

In some embodiments, the computer system outputs (13018), via the one or more output generation components, the first notification that corresponds to the first event, includes displaying, via a second output generation component (e.g., via a display, a touch-sensitive display, a head-mounted display, a vehicle head unit, a watch display, or another type of display) of the one or more output generation components (e.g., a display of a companion device such as a phone, a vehicle dashboard, a vehicle head unit, a watch, or another companion device, that is in communication with one or more audio output devices, such as headphones or speakers, that are outputting the audio output), a first visual output (e.g., a first pop-up, a first banner, and/or a first textual notification) that includes the first automatically generated summary (e.g., automatically-generated text content and/or generative text content) (e.g., a displayed notification that includes the content of the first automatically generated summary in visual and/or textual form); and the computer system outputs, via the one or more output generation components, the second notification that corresponds to the first event, includes displaying, via the second output generation component (e.g., via a display, a touch-sensitive display, a head-mounted display, a vehicle head unit, a water display, or another type of display) (e.g., a display of a companion device such as a phone, a vehicle dashboard, a vehicle head unit, a watch, or another companion device, that is in communication with one or more audio output devices, such as headphones or speakers, that are outputting the audio output), a second visual output (e.g., a second pop-up, a second banner, and/or a second textual notification) that does not include the first automatically generated summary (e.g., a displayed notification that includes notification content for the first event in visual and/or textual form, which does not include the content of the first automatically generated summary). In some embodiments, the computer system includes a display (e.g., a touch-screen display, a head-mounted display, or another type of display) and an output device for audio outputs (e.g., integrated output device or paired via one or more connections), such as a pair of earphones, a headphone, a speaker, or another audio output device. In some embodiments, in response to detecting the first event, the computer system outputs a visual version of the respective notification for the first event using the output device for visual outputs, optionally without concurrently outputting a companion notification for the respective notification (e.g., an audio version of the respective notification for the first event, or an audio notification that has content that is different from the content of the respective notification (e.g., less substantial, less detailed, and/or less illustrated, than the visual version of the respective notification)). In some embodiments, the first visual output and/or the second visual output are displayed on a system user interface that corresponds to a restricted state of the computer system, such as a wake screen user interface, a lock screen user interface, a notification user interface, a low-power always-on wake screen user interface, when the event is first detected, and/or subsequently when the system user interface is displayed one or more times. For example, in FIG. 8A, the computer system 100 displays the notification 6020 (e.g., which optionally accompanies the audio 8001 in FIG. 8B). For example, in FIG. 8C, the computer system 100 displays the summary 5024 (e.g., which optionally accompanies the audio 8003 or the audio 8005 in FIG. 8D). Outputting, a first notification that includes a first visual output that includes the first automatically generated summary, in accordance with a determination that first application content exceeds a first content length threshold, and outputting a second notification that includes a second visual output that does not include the first automatically generated summary, in accordance with a determination that the first application content does not exceed the first content length threshold, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications.

In some embodiments, the one or more output generation components include (13020) a first output generation component and a second output generation component; and outputting, via the one or more output generation components, the first notification that corresponds to the first event, includes: in accordance with a determination that a first set of contextual conditions are met (e.g., the user is driving a vehicle, and/or the user's attention is otherwise engaged by a task requiring focused attention), outputting, via the first output generation component (e.g., via a display, a touch-sensitive display, a head-mounted display, a vehicle dashboard, vehicle head unit, or another type of display) of the one or more output generation components, a first visual alert (e.g., a pop-up, a banner, and/or a textual alert) that indicates availability of the first automatically generated summary for the first event (e.g., a displayed alert that requests the user's confirmation to output the content of the first automatically generated summary in audio form); and in accordance with a determination that a first user input that corresponds to a request to output the first automatically generated summary for the first event is detected (e.g., during a period of time that the first visual alert is displayed and not yet dismissed by a user or automatically due to time-out), outputting, via the second output generation component (e.g., that is different from the first output generation component) (e.g., a speaker, a pair of headphones, a pair of earphones, and/or other audio output components) of the one or more output generation components, a first audio output (e.g., a first audio announcement, and/or a first speech output) that includes the first automatically generated summary (e.g., an audio output that reads out the content of the first notification, including the content of the first automatically generated summary). In some embodiments, in accordance with a determination that a first user input that corresponds to a request to output the first automatically generated summary for the first event is not detected (e.g., during a period of time that the first visual alert is displayed and not yet dismissed by a user or automatically due to time-out), forgoing outputting, via the second output generation component (e.g., a speaker, a pair of headphones, a pair of earphones, and/or other audio output components) of the one or more output generation components, the first audio output (e.g., a first audio announcement, and/or a first speech output) that includes the first automatically generated summary (e.g., an audio output that reads out the content of the first notification, including the content of the first automatically generated summary). In some embodiments, the first audio output includes an indication that the content of the first audio output is an automatically generated summary, such as by phrasing the summary in a third person voice, and/or using keywords or key phrase that indicates that the content is a summary of application content (e.g., “Robert, summarized”). In some embodiments, after the first audio output is completed, the computer system provides a prompt to a user's instruction to play the full content corresponding to the first event; and if the user provides a speech input that corresponds to a request to hear the entirety of the first application content (e.g., “Read it,” or “More details.”), the computer system proceeds to output the first application content via the audio output component(s) of the computer system. In some embodiments, for events that do not meet the content length threshold, outputting, via the one or more output generation components, the second notification that corresponds to the first event, includes, in accordance with a determination that the first set of contextual conditions are met (e.g., the user is driving a vehicle, and/or the user's attention is otherwise engaged by a task requiring focused attention), outputting, via the first output generation component (e.g., via a display, a touch-sensitive display, a head-mounted display, a vehicle dashboard, or another type of display) of the one or more output generation components, a second visual alert (e.g., a pop-up, a banner, and/or a textual alert) that indicates availability of the first application content for the first event (e.g., a displayed alert that requests the user's confirmation to output the first application content in audio form); and in accordance with a determination that a second user input that corresponds to a request to output the first application content for the first event is detected (e.g., during a period of time that the second visual alert is displayed and not yet dismissed by a user or automatically due to time-out), outputting, via the second output generation component (e.g., a speaker, a pair of headphones, a pair of earphones, and/or other audio output components) of the one or more output generation components, a second audio output (e.g., a second audio announcement, and/or a second speech output) that includes first application content without including the first automatically generated summary (e.g., an audio output that reads out the content of the second notification, including the first application content). For example, in FIG. 8Q, the computer system 100 displays the alert 8068 (e.g., a visual alert), and in response to detecting the user input 8070 (e.g., a request to output a summary) directed to the alert 8068, the computer system 100 outputs the audio 8082 (e.g., in FIG. 8R). Outputting a visual alert that indicates availability of the first automatically generated summary for the first event, in accordance with the determination that a first set of contextual conditions are met, and outputting a first audio output that includes the first automatically generated summary, in accordance with the determination that the first automatically generated summary for the first event is detected, reduces the numbers of inputs required by the user to review notifications (e.g., content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user by audibly and visually alerting the user to relevant notification content.

In some embodiments, after outputting the first audio output including the first automatically generated summary (e.g., at or within a threshold time window of the end of the first audio output) in accordance with the determination that the first user input is detected, the computer system detects (13022), via the one or more input devices (e.g., a microphone, a touch screen, or another type of input device), a user request for the first application content (e.g., a speech input “Read the whole message” or “Read it.” or a touch input, gesture input, or another type of selection input directed to an affordance for outputting the first application content). In response to detecting the user request for the first application content, the computer system outputs, via the second output generation component, a respective audio output that includes the first application content (e.g., optionally including the entirety of the first application content, and without including the first automatically generated summary). In some embodiments, if a user request for the first application content is not detected after outputting the first audio output including the first automatically generated summary (e.g., is not detected within a threshold time window after the completion of the first audio output, or is not detected before another request is made by the user for another task unrelated to the first event (e.g., causing a context change)), the computer system does not output the respective audio output that includes the first application content. In some embodiments, after outputting the first audio output via the second output generation component, the computer system outputs a first prompt (e.g., a first audio prompt outputted by an audio output device (e.g., earphones, or a speaker), and/or a first visual prompt shown on a display) that requests a user's instruction for outputting the first application content (e.g., the un-summarized version of the first application content, optionally, in its entirety (e.g., message content of one or more related messages, or notification content of one or more notifications for past events that have not been read or seen)). In some embodiments, the first prompt (“Read the whole message?”) includes a visual affordance (e.g., a button, or another type of selectable affordance) that when selected by a selection input (e.g., a voice input calling out the affordance (“Read”, “OK”), a touch input on the affordance, a pinch gesture detected when the gaze is on the affordance, or another type of selection input), cause the computer system to output the respective audio output that includes the first application content. For example, in FIG. 8R, after outputting the audio 8082, the computer system detects the user input 8080 directed to the affordance 8076 (e.g., a user request for the first application content). In FIG. 8S, in response to detecting the user input 8080 directed to the affordance 8076, the computer system 100 outputs the audio 8084 (e.g., which includes audio content corresponding to email content, such as the email shown in FIG. 5F). Outputting a respective audio output that includes first application content in response to detecting a first user request for the first application content, reduces the numbers of inputs required by the user to review notifications (e.g., providing the first audio output that includes the first automatically generated summary may eliminated the need for the user to perform additional user inputs to access the full application content; and outputting the respective audio output that includes the first application content in response to the user request for the first application content preserves the option for the user to quickly access the full application content when needed (e.g., if the first automatically generated summary is unclear and/or does not provide enough detail to the user)), improves the efficiency of the device, and provides improved feedback to the user by audibly and visually alerting the user to relevant notification content.

In some embodiments, the first application content includes (13024) message content of a plurality of communication messages (e.g., communications between people and/or machines) (e.g., the first application content includes message content of a first message, and message content of one or more earlier messages and/or one or more later messages from the same messages application; or the first application content includes message content for a first message from a first application and message content for a second message from a second application different from the first application), and the first automatically generated summary is a summary of the message content of the plurality of communication messages (e.g., the first automatically generated summary is a new summary, or an update to an existing summary of the two or more related communication messages). In some embodiments, the computer system withholds generating the summary of one or more received communication messages if there are indications that additional communication messages related to the one or more received communication messages may be received shortly (e.g., when the message content of a received message indicates that it is not finished, and more messages are coming, when the sender is composing additional messages at the moment). In some embodiments, the computer system delays generating a summary for one or more earlier messages until summary generation criteria are met (e.g., when the sender has stopped composing a new message after sending a previous message, when an idea communicated in the earlier messages appears to be complete, and/or when a threshold amount of time has elapsed without receiving a new message from the same sender or group of senders for a group conversation). In some embodiments, the computer system has generated (e.g., using an AI process or a generative AI process) a summary for one or more earlier messages, and when a new message related to the one or more earlier messages is detected, the computer system updates the summary with the content of the new message. In some embodiments, the computer system determines that events associated with multiple different applications are related events (e.g., messages from different applications, or application content corresponding to different events generated by different applications), and the first automatically generated summary is a summary of application content from different applications that correspond to the different related events. In some embodiments, the different related events are events that occurred during the same period of time (e.g., when the user asks for a summary of the missed events during the day, or missed events for a respective application). For example, in FIG. 8G, the computer system displays the summary 8010 (e.g., which summarizes multiple notifications, including the four notifications shown in FIG. 8E), and in FIG. 8H, the audio device 8000 outputs the audio 8007 (e.g., which includes content corresponding to multiple communication messages (e.g., emails, as shown in FIG. 8E) from multiple contacts). Outputting a first notification that corresponds to a first event, wherein the first application content includes message content of a plurality of communication messages, and wherein the first notification includes a first automatically generated summary that is a summary of the message content of the plurality of communication messages, in accordance to the determination that the first application content exceeds a first constant length threshold, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user by audibly alerting the user to relevant notification content.

In some embodiments, the plurality of communication messages include (13026) a first communication message associated with a first source and a second communication message associated with a second source (e.g., the first source and the second source are different sources, e.g., when the plurality of communication messages include messages from different senders, and/or the plurality of communication messages include messages corresponding to different events associated with different applications), and wherein the first automatically generated summary includes a first attribution corresponding to (or, optionally, describing, identifying, and/or representing) the first source and a second attribution corresponding to (or, optionally, describing, identifying, and/or representing) the second source (e.g., the first automatically generated summary mentions a first sender that sent a first message, and a second sender that sent a second message that are part of the plurality of communication messages, and/or, the name of a first application associated with a first message, and the name of a second application associated with a second message that are part of the plurality of communication messages). For example, in FIG. 8B, the audio 8001 includes a first attribution (e.g., “Jose messaged . . . ”) corresponding to a first source (e.g., a contact Jose), and in FIG. 8D, the audio 8003 (e.g., or the audio 8005) includes a second attribution (e.g., “From Jane . . . ”) corresponding to a second source (e.g., a different contact Jane). Outputting a first notification that corresponds to a first event, wherein the first application content includes message content of a plurality of communication messages that include a first communication message associated with a second source, and includes a first automatically generated summary that is a summary of the message content of the plurality of communication messages, and wherein the first notification includes a first automatically generated summary that includes a first attribution corresponding to the first source and a second attribution corresponding to the second source, in accordance to the determination that the first application content exceeds a first constant length threshold, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user (e.g., improved feedback regarding the first and second source of the first and second communication messages).

In some embodiments, detecting the first event that corresponds to the first application content includes (13028) detecting receipt of a first incoming communication (e.g., a text message, an audio message, a video message, an email, a reply of an earlier outgoing communication, an instant message, an SMS message, that were addressed to a user associated with the computer system and that received by the first application for an identity associated with the user). For example, in FIG. 8A, the computer system 100 detects an event corresponding to a new notification 6020 (e.g., a communication message received from a contact Jose), and the computer system displays the notification 6020 (e.g., and the audio device 8000 outputs the audio 8001, as shown in FIG. 8B). Outputting a first notification that corresponds to a first incoming communication, in accordance with the determination that first application content exceeds a first content length threshold, wherein the first notification includes a first automatically generated summary based on at least a first application content, in accordance to the determination that the first application content exceeds a first constant length threshold, and outputting a second notification that corresponds to the first incoming communication, in accordance with a determination that the first application content does not exceed the first content length threshold, wherein the second notification does not include the first automatically generated summary, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications).

In some embodiments, outputting the respective notification includes (13030): in accordance with a determination that delay criteria are met, wherein the delay criteria are met when one or more indications that one or more additional events related to the first event are likely to be detected (e.g., the sender of the message is composing a new message after sending the message corresponding to the first event; and/or the content of the message indicates that it is not complete and has additional parts coming shortly), have been detected (e.g., by the computer system, or by another computer system facilitating the transmission of the events), delaying outputting the respective notification (e.g., withholding delivery of a notification for the first event; and/or withhold generating the first automatically generated summary for the first event); and in accordance with a determination that the delay criteria are not met (e.g., the sender of the message is not composing a new message after sending the message corresponding to the first event; and/or the content of the message indicates that it is complete), outputting the respective notification (e.g., withholding delivery of a notification for the first event; and/or withhold generating the first automatically generated summary for the first event) without further delay. In some embodiments, the respective notification includes a first automatically generated summary that is based on the content corresponding to the first event, and the content for one or more second events that are additional events received after the first event and/or content for one or more third events that were received prior to the first event. In some embodiments, the computer system determines whether to generate the first automatically generated summary based on the content lengths of a plurality of related events including the first event, the one or more second events, and/or the one or more third events. For example, as described with reference to FIGS. 8E and 8G, in some embodiments, the computer system 100 does not output individual notifications (e.g., the notifications shown in FIG. 8E are not displayed), and the computer system 100 instead delays and/or postpones delivery of the notifications shown in FIG. 8E, and optionally displays the summary 8010 in FIG. 8G, in lieu of delivering the individual notifications shown in FIG. 8E. Outputting a respective notification that corresponds to a first event without further delay in accordance with a determination that the delay criteria are not met, and delaying outputting the respective notification in accordance with a determination that delay criteria are met, wherein the delay criteria are met when one or more indications that one or more additional events related to the first event are likely to be detected, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications).

In some embodiments, delaying outputting the respective notification (e.g., withholding delivery of a notification for the first event; and/or withhold generating the first automatically generated summary for the first event) includes (13032) delaying outputting the respective notification for a first threshold amount of time, and outputting the respective notification (e.g., without further delay) after the first threshold amount of time has elapsed (or, optionally, in response to detecting that the first threshold amount of time has elapsed) since detecting the first event. For example, as described with reference to FIGS. 8E and 8G, in some embodiments, after the threshold amount of time (e.g., 1 second, 2 seconds, 5 seconds, 10 seconds, or 30 seconds) has elapsed, the computer system 100 displays a summary 8010 which summarizes (e.g., and/or corresponds to) the notification 8002, the notification 8004, the notification 8006, and the notification 8008 (e.g., and any other related notifications received between the time of the event corresponding to the notification 8002 and the time shown in FIG. 8G). Outputting a respective notification that corresponds to a first event without further delay in accordance with a determination that the delay criteria are not met, and delaying outputting the respective notification for a first threshold amount of time, in accordance with a determination that delay criteria are met, wherein the delay criteria are met when one or more indications that one or more additional events related to the first event are likely to be detected, and outputting the respective notification after the first threshold amount of time has elapsed since, detecting the first event reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications).

In some embodiments, the one or more indications that one or more additional events related to the first event are likely to be detected includes (13034) a first indication in the first application content (e.g., punctuation and/or language in the message body of the message that corresponds to the first event) that one or more additional events related to the first event are likely to be detected (e.g., the message ended with a comma, the message ended with a sentence that is not complete, the message is a greeting, the message is an opening of a narrative or discussion). For example, as described with reference to FIG. 8L, in some embodiments, the audio device 8000 does not output audio (e.g., even though the computer system 100 has already detected the first event corresponding to a notification) when the computer system 100 determines that (e.g., application and/or notification) content corresponding to the notification includes an indication that subsequent related events are expected. The computer system 100 also optionally delays delivery of and/or suppresses notifications when the computer system 100 determines that the content corresponding to the notification includes an indication that subsequent related events are expected. Outputting a respective notification that corresponds to a first event without further delay, in accordance with a determination that the delay criteria are not met, and delaying outputting the respective notification for a first threshold amount of time, in accordance with a determination that delay criteria are met, wherein the delay criteria are met when one or more indications that one or more additional events related to the first event are likely to be detected includes a first indication in the first application content that one or more additional events related to the first event are likely to be detected, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications).

In some embodiments, the one or more indications that one or more additional events related to the first event are likely to be detected includes (13036) a second indication that a communication related to the first event is being composed within a first threshold amount of time after occurrence of the first event. For example, if the first event is receipt of a first message, and the sender of the first message is composing another message within a threshold amount of time of sending the first message, the computer system delays outputting the respective notification for the first message. For example, as described with reference to FIG. 8J, in some embodiments, the audio device 8000 does not output audio (e.g., and if the computer system 100 is delaying delivery of the notification 8015, the computer system 100 delays delivery) if the computer system 100 detects that another user (e.g., Neil and/or Isaac) is typing within a threshold amount of time (e.g., 1 second, 2 seconds, 5 seconds, 10 seconds, 15 seconds, or 30 seconds) since an initial event (e.g., the event corresponding to the notification 8015) was detected. In some embodiments, if no other user is detected as typing within the threshold amount of time, the audio device 8000 outputs audio corresponding to the notification 8015 (e.g., if the notification is a “short” notification) and/or a summary corresponding to the notification 8015 (e.g., if the notification is a “long” notification). Outputting a respective notification that corresponds to a first event without further delay, in accordance with a determination that the delay criteria are not met, and delaying outputting the respective notification for a first threshold amount of time, in accordance with a determination that delay criteria are met, wherein the delay criteria are met when one or more indications that one or more additional events related to the first event are likely to be detected includes a second indication that a communication related to the first event is being composed within a first threshold amount of time after occurrence of the first event, and outputting the respective notification after the first threshold amount of time has elapsed since, detecting the first event reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user by audibly alerting the user to relevant notification content.

In some embodiments, detecting (13038) the first event that corresponds to the first application content includes detecting, via the one or more input devices, a second user input (e.g., a voice input (e.g., “catch up on messages,” “what did I miss today?” or “read notifications”), selection of a “catch up” affordance displayed on a system user interface (e.g., a vehicle dashboard, a wake screen, a home screen, a notification user interface, or another system user interface), or another type of user input) that corresponds to a request to catch up on events that have been detected within a first period of time (e.g., catch up on recent events, recent messages, and/or missed notifications, that were detected and/or received since the last time that the events, messages, and/or notifications, were reviewed by the user and/or up to the present time of the current day). For example, in FIG. 8N, the computer system 100 displays the summary 8040, the summary 8042, and the summary 8044 in response to detecting the user input 8038 (e.g., a speech input that requests to catch up). As described with reference to FIG. 8N, in some embodiments, an audio device in communication with the computer system 100 (e.g., the audio device 8000 shown in FIG. 8B) outputs audio corresponding to one or more summaries (e.g., shown in FIG. 8N), in response to detecting the user input 8038. Outputting a first notification that corresponds to a request to catch up on events that have been detected within a first period of time, in accordance with the determination that first application content exceeds a first content length threshold, wherein the first notification includes a first automatically generated summary based on at least a first application content, in accordance to the determination that the first application content exceeds a first constant length threshold, and outputting a second notification that corresponds to the request to catch up on events that have been detected within the first period of time, in accordance with a determination that the first application content does not exceed the first content length threshold, wherein the second notification does not include the first automatically generated summary, reduces the numbers of inputs required by the user to review notifications (e.g., automatically generated summaries provided by the output generation components including relevant notification content inform the user of the content and they can understand the content of the relevant notification without a need for interaction with and/or opening notifications to view the full notification content and/or application content corresponding to summarized notifications).

In some embodiments, detecting the second user input that corresponds to a request to catch up on events that have been detected within the first time period includes (13040) detecting a first speech input, via the one or more input devices, that corresponds to a request to hear notifications that were received within the first period of time; and outputting the respective notification for the first event includes: outputting, via a first output generation component of the one or more output generation components, an audio version of a first plurality of notifications that were received within the first period of time (e.g., audio version of individual notifications of the first plurality of notifications, or audio version of an automatically generated summary of the first plurality of notifications); and displaying, via a second output generation component of the one or more output generation components (e.g., a display of a companion device such as a phone, a vehicle dashboard, a vehicle head unit, a watch display, or another type of companion device, that is in communication with one or more audio output devices, such as headphones or speakers, that are outputting the audio output), a visual version of the first plurality of notifications that were received within the first period of time (e.g., visual version of individual notifications of the first plurality of notifications, or visual version of an automatically generated summary of the first plurality of notifications, displayed on a system user interface, such as a wake screen user interface, a notification user interface, a vehicle dashboard, or another system user interface for displaying notifications or notification summaries). For example, in FIG. 8N, the computer system 100 displays the summary 8040, the summary 8042, and the summary 8044 (e.g., each corresponding to unread notifications (e.g., since a certain time and/or within a certain time period) in response to detecting the user input 8038 (e.g., a speech input that requests to catch up). Outputting an audio version of a first plurality of notifications that were received within the first period of time, and displaying a visual version of the first plurality of notifications that were received within the first period of time, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user by audibly and visually alerting the user to relevant notification content.

In some embodiments, detecting the second user input that corresponds to a request to catch up on events that have been detected within the first time period includes (13042) detecting a second speech input, via the one or more input devices, that corresponds to a request to hear communications associated with a first application that were received within the first period of time; and outputting the respective notification for the first event includes: outputting, via a first output generation component of the one or more output generation components, an audio version of a first plurality of communications that were received within the first period of time (e.g., audio version of individual messages of the first plurality of messages, or audio version of an automatically generated summary of the first plurality of message). In some embodiments, the computer system also outputs, via a second output generation component of the one or more output generation components, a visual version of the first plurality of messages that were received within the first period of time (e.g., visual version of individual messages of the first plurality of messages, or visual version of an automatically generated summary of the first plurality of messages, displayed on a system user interface, such as a wake screen user interface, a notification user interface, a vehicle dashboard, or another system user interface for displaying notifications or notification summaries). For example, in FIG. 8P, the computer system displays the summary 8060, the summary 8062, and the summary 8064 (e.g., all summaries corresponding to an email application M) in response to detecting the user input 8058 (e.g., a request to catch up on a specific (mail/email) application). As described with reference FIG. 8P, in some embodiments, an audio device in communication with the computer system 100 (e.g., the audio device 8000 shown in FIG. 8B) outputs audio corresponding to one or more summaries (e.g., shown in FIG. 8P), in response to detecting the user input 8058. Outputting an audio version of a first plurality of communications that were received within a first period of time, in response to detecting a second user input that corresponds to a request to catch up on events that have been detected within the first time period, reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), improves the efficiency of the device, and provides improved feedback to the user by audibly alerting the user to relevant notification content.

In some embodiments, the computer system detects (13044) a second event that corresponds to second application content (e.g., the second event is the first event, or another event different from the first event). In response to detecting the second event, the computer system outputs, via the one or more output generation components, a respective notification for the second event, wherein outputting the respective notification for the second event includes: in accordance with a determination that the respective notification for the second event is to be output as an audio notification (e.g., via the first output generation component, or another audio output component, such as a pair of headphones, speakers, earphones, and/or other types of audio output components) and that the second application content exceeds a first content length threshold (e.g., a content length threshold used for audio output components, including the first output generation component, the third output generation component, and/or one or more other audio output components), outputting, via a third output generation component of the one or more output generation components, a first audio notification that corresponds to the second event, the first audio notification including a third automatically generated summary that is based on at least the second application content, wherein the third automatically generated summary is not included in the second application content; in accordance with a determination that the respective notification for the second event is to be output as an audio notification and that the second application content does not exceed the first content length threshold, outputting, via the third output generation component, a second audio notification that corresponds to the second event, the second audio notification includes content corresponding to the second event without including the third automatically generated summary (and optionally, without including any automatically generated summary); in accordance with a determination that the respective notification for the second event is to be output as a visual notification (e.g., via the second output generation component, or another display generation component, such as touch screen display, a vehicle dashboard, a vehicle head unit, a watch display, and/or other types of display generation components) and that the second application content exceeds a second content length threshold (e.g., a content length threshold used for display generation components, including the second output generation component, the fourth output generation component, and/or one or more other display generation components), wherein the second content length threshold is different from (e.g., greater than, or less than) the first content length threshold (e.g., because they correspond to different output modalities and/or types of output components), and outputting, via a fourth output generation component of the one or more output generation components, a first visual notification that corresponds to the second event, the first visual notification including a fourth automatically generated summary that is based on at least the second application content, wherein the fourth automatically generated summary is not included in the second application content; and in accordance with a determination that the respective notification for the second event is to be output as a visual notification and that the second application content does not exceed the second content length threshold, outputting, via the third output generation component, a second visual notification that corresponds to the second event, the second visual notification includes content corresponding to the second event without including the fourth automatically generated summary (and optionally, without including any automatically generated summary).

In some embodiments, the computer system, in response to detecting a respective event (e.g., the first event, the second event, and/or another event), determines a respective output modality for the respective notification for the respective event (e.g., determines which output generation component is to be used to output the respective notification for the respective event, and depending on the output modality and/or output type of the output generation component, the computer system uses different content length thresholds to determine whether to output an automatically generated summary in the respective notification. In some embodiments, for events with application content length that is in between the first content length threshold and the second content length threshold, the notification of a respective event would include different content (e.g., including automatically generated summary or including original application content without the automatically generated summary) depending on whether the notification is to be output as an audio notification or a visual notification (e.g., whether the notification is to be output as an audio notification or visual notification depends on user preference, availability of output devices and their output modalities, and/or other contextual conditions, such as user's location, whether the user is in a moving vehicle, driving, exercising, resting, or doing other activities that prioritizes visual or audio outputs) In some embodiments, for an audio output modality, a shorter content length threshold (e.g., 15 words, 30 words, or another shorter content length) is used to determine whether to generate a summary for the notification content before outputting the respective notification using the audio output modality; while for a visual output modality, a longer content length threshold (e.g., 40 words, 50 words, or another longer content length) is used to determine whether to generate a summary for the notification content before outputting the respective notification using the visual output modality. In some embodiments, descriptions of the first event and the operations performed by the computer system with respect to the first event also applies to the second event, and the operations performed by the computer system with respect to the second event, and these descriptions are not repeated for the second event in the interest of brevity. For example, as described with reference to FIG. 8D, in some embodiments, the content-length threshold is different for visual notifications (e.g., for determining when to display a summary or an un-summarized notification) than for audio notifications (e.g., for determining whether to generate audio corresponding to a full notification, or for generating audio corresponding to a summarized notification). For example, if the content-length threshold for visual notifications is 16 words, and the content-length threshold for audio notifications is 40 words, then if a notification is 16 words or less, the computer system 100 displays a regular notification (e.g., without a summary) and the audio device 8000 outputs audio corresponding to the full notification content (e.g., without a summary). If the notification is 17-40 words in length, the computer system 100 displays a summary corresponding to the notification but the audio device 8000 outputs audio corresponding to the full notification content (e.g., without a summary). If the notification is 41 words or longer, the computer system 100 displays a summary corresponding to the notification and the audio device 8000 outputs audio that includes a summary of the notification content. Outputting a first audio notification that corresponds to a second event, including a third automatically generated summary based on at least second application content, in accordance with a determination that the respective notification for the second event is to be output as an audio notification and that the second application content exceeds a first content length threshold, wherein the third automatically generated summary is not included in the second application content; and outputting a second audio notification that includes the third automatically generated summary, in accordance with a determination that the respective notification for the second event is to be output as an audio notification and that the second application content does not exceed the first content length threshold; and outputting a first visual notification that corresponds to the second event and that includes a fourth automatically generated summary that is based on at least the second application content, in accordance with a determination that the respective notification for the second event is to be output as a visual notification and that the second application content exceeds a second content length threshold, wherein the fourth automatically generated summary is not included in the second application content; and outputting a second visual notification that corresponds to the second event and that does not include the fourth automatically generated summary, in accordance with a determination that the respective notification for the second event is to be output as a visual notification and that the second application content does not exceed the second content length threshold, reduces the numbers of inputs required by the user to review notifications (e.g., automatically generated summaries provided by the output generation components and visual output inform the user of the content and they can understand the content of the relevant notification without a need for interaction with and/or opening notifications to view the full notification content and/or application content corresponding to summarized notifications), improves the efficiency of the device, and provides improved feedback to the user by audibly and visually alerting the user to relevant notification content.

In some embodiments, in response to detecting the first event, the computer system outputs (13046), via a second output generation component of the one or more output generation components, a companion notification of the respective notification for the first event, wherein the companion notification of the respective notification corresponds to the first event (e.g., includes either the content of the first notification, the content of the second notification, or content that is different from the content of the first notification and the second notification and that is generated based on the first content of the first application) and is of a first output type, and wherein the respective notification is of a second output type different from the first output type (e.g., the first output type is textual or graphical output that is optionally output via a display of a companion device such as a phone that is in communication with one or more audio output devices, such as headphones, that are outputting the audio output, and the second output type is audio or speech output that is output via one or more speakers or headphones; or vice versa). In some embodiments, the respective notification is outputted without the companion notification being outputted at the same time. In some embodiments, the respective notification is outputted at a time when the companion output has not yet been outputted via the second output generation component. In some embodiments, the respective notification is outputted at a time after the companion output has been outputted via the second output generation component at an earlier time. In some embodiments, outputting the respective notification prevents the companion notification from being outputted. In some embodiments, detecting that the respective notification has been perceived by a user (e.g., viewed, read and/or heard by the user) prevents the companion notification from being outputted. In some embodiments, the respective notification is outputted as an audio output via a pair of speakers or earphones, and the companion notification is outputted as a visual output on a display. In some embodiments, the respective notification is outputted as a visual output on a display, and the companion notification is outputted as an audio output via a pair of speakers or earphones. For example, in FIG. 8C, the computer system 100 displays the summary 5024 (e.g., outputs a visual notification), and in FIG. 8D, the audio device 8000 outputs the audio 8003 (e.g., outputs an audio notification). Outputting a companion notification of the respective notification for the first event, wherein the companion notification of the respective notification corresponds to the first event, and is of a first output type, and wherein the respective notification is of a second output type different from the first output type, in response to detecting the first event reduces the numbers of inputs required by the user to review notifications (e.g., automatically generated summaries provided by the output generation components include relevant notification content assisting the user in quickly viewing and understanding the content of the relevant notification(s) without a need for interaction with and/or opening individual notifications to view the full notification content and/or application content corresponding to summarized notifications), and enables prompt and effective delivery of notifications and/or content (e.g., notifications and/or content can still be effectively delivered even if the user is not capable of perceiving notifications and/or content via the first output type (e.g., or the second output type)).

It should be understood that the particular order in which the operations in FIGS. 13A-13F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, and 14000) are also applicable in an analogous manner to method 13000 described above with respect to FIGS. 13A-13F. For example, the application (content), notification (content), summary (content, applications, notifications, summaries, and user inputs, described above with reference to method 13000 optionally have one or more of the characteristics of the application (content), notification (content), summary (content, applications, notifications, summaries, and user inputs, described herein with reference to other methods described herein (e.g., 10000, 11000, 12000, and 14000). For brevity, these details are not repeated here.

FIGS. 14A-14J are flow diagrams illustrating method 14000 of prioritizing and/or highlighting content in accordance with some embodiments. Method 14000 is performed at an electronic device or computer system (e.g., device 300, FIG. 3A, or portable multifunction device 100, FIG. 1A) that is in communication with a display generation component, and one or more inputs devices. In some embodiments, the display generation component is a touch-screen display and the touch-sensitive surface is on or integrated with the display. In some embodiments, the display is separate from the touch-sensitive surface. Some operations in method 14000 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

Displaying a representation of the first notification and a representation of the second notification within a first user interface object, in accordance with a determination that a plurality of notifications available to be displayed in the first user interface includes a first notification with first notification content that meets the relevance criteria, in response to detecting that the first set of conditions are met and the first user interface that corresponds to the restricted state of the computer system, performing a first operation with respect to a first notification and forgoing performing the first operation with respect to the second notification, in response to detecting a first user input directed to the first user interface object and in accordance with a determination that the first user input is directed to a location that corresponds to the representation of the first notification in the first user interface object, and performing the second operation with respect to the second notification and forgoing performing the second operation with respect to the first notification, in response to detecting a first user input directed to the first user interface object and in accordance with a determination that the first user input is directed to a location that corresponds to the second notification in the first user interface object, reduces the numbers of inputs required by the user to review notifications (e.g., displaying notifications on the user interface in a highlighted manner only if the notifications meet the relevance criteria informs the user of important and relevant content, and the user can understand the content of the relevant notification without a need for interaction with and/or opening the device and sorting through notifications), improves the efficiency of the device, and provides improved visual feedback to the user by alerting the user only to relevant notification content.

A computer system (e.g., a mobile device, a smartphone, a smartwatch, a desktop computer, a gaming device, and/or other computer systems) (e.g., the computer system 100 in FIG. 9K) is in communication with one or more display generation components and one or more input devices (e.g., devices and/or sensors for detecting user inputs) (e.g., a display of the computer system 100, and/or a computer system 200 in FIG. 9T). The computer system detects (14002) that a first set of conditions for displaying a first user interface (e.g., a wake screen user interface, a coversheet user interface, a dimmed always-on lock screen, a notification user interface, a vehicle dashboard, and/or another system user interface that corresponds to a restricted state of the computer system, and that includes a notification display region that is configured to display a plurality of notifications corresponding to a plurality of previously detected events, including notification highlights (if any) and regular notifications (if any)) that corresponds to a restricted state of the computer system (e.g., access to the home screen user interface and the applications are restricted by the presence of the first user interface) are met (e.g., a request to display the user interface 5000 in FIG. 9K is detected). In some embodiments, detecting that the first set of conditions are met includes detecting an application event that corresponds to first application content from a first application (e.g., receipt of a message, an email, a missed call, completion of a task, generation of an alert, and/or other events from a respective application) that triggers display of a notification on a wake screen user interface. In some embodiments, detecting that the first set of conditions are met includes detecting a user input, or other events, such as movement of the computer system, that wakes the computer system and/or the display generation component from a low power state (e.g., a display-off state, or a dimmed always-on state). In some embodiments, detecting that the first set of conditions are met includes detecting a user input (e.g., a press on the power button to lock the display, or a swipe gesture on a touch-screen user interface in the downward direction) that dismisses a currently displayed user interface (e.g., a home screen user interface, or an application user interface of an application) and displays a coversheet user interface that corresponds to a restricted state of the computer system. In some embodiments, detecting that the first set of conditions are met includes detecting a user input (e.g., a speech input or a selection of an affordance for requesting catching up on missed events and/or notifications for a respective application or multiple applications). In some embodiments, detecting that the first set of conditions are met includes detecting a user input that requests the computer system to switch to a different mode or detecting that conditions for switching to a different mode of the computer system are met, where the different modes of the computer system correspond to different notification delivery preferences, and optionally, different sets of relevance criteria for selecting notifications for including in the notification highlight platter and/or breakthrough notification delivery. In response to detecting that the first set of conditions are met, the computer system displays (14004), via the one or more display generation components, the first user interface (e.g., the user interface 5000 in FIG. 9A) that corresponds to the restricted state of the computer system, including: in accordance with a determination that a plurality of notifications available to be displayed in the first user interface (e.g., notifications for a plurality of previously detected events that have not been read or cleared from the first user interface) includes a first notification with first notification content (e.g., including original first application content and/or an automatically generated summary (e.g., automatically-generated text content and/or generative text content) of the original first application content (e.g., summaries generated based on one or more artificial intelligence models, machine learning models, large language models, and/or other generative artificial intelligence or machine learning models and processes (e.g., using an AI process or generative AI process))) that meets relevance criteria and a second notification with second notification content (e.g., including original second application content and/or an automatically generated summary of the original second application content (e.g., summaries generated based on one or more artificial intelligence models, machine learning models, large language models, and/or other generative artificial intelligence or machine learning models and processes)) that meets the relevance criteria (e.g., the content of the first notification and the content of the second notification meet criteria measuring urgency of the content, and importance of the content to the user (e.g., measures of relevance based on one or more artificial intelligence models, machine learning models, large language models, and/or other generative artificial intelligence or machine learning models and processes)), concurrently displaying (14006) a representation of the first notification and a representation of the second notification within a first user interface object (e.g., displaying a notification highlight platter in the first notification display region of the first user interface, with a representation of the first notification (e.g., including at least a portion of the first notification content, and optionally, a first application identifier, a first sender identity, and/or other content of the first notification) and a representation the second notification (e.g., including at least a portion of the second notification content, and optionally, a second application identifier, a second sender identity, and/or other content of the first notification) arranged within the notification highlight platter) (e.g., the region 9000 in FIG. 9K includes: the portion 9018 (e.g., that includes content corresponding to the notification 6026 in FIG. 9I), the portion 9010 (e.g., that includes content corresponding to the summary 9008 in FIG. 9C), the portion 9016 (e.g., that includes content corresponding to the notification 5012 in FIG. 9A, and the summary 9014 in FIG. 9G), the portion 9004 (e.g., that includes content corresponding to the notification 5014 in FIG. 9A)); and In some embodiments, the first user interface object includes a visible border, a background, a visual theme, a color, a style, and/or other visual characteristics that visually separate the objects included within the first user interface object and objects that are not included the first user interface object. While displaying the first user interface, including concurrently displaying (e.g., in accordance with the determination that the first notification and the second notification met the relevance criteria) the representation of the first notification and the representation of the second notification within the first user interface object (optionally, along with a third notification having third notification content that does not meet the relevance criteria, displayed outside of the first user interface object), the computer system detects (14008) a first user input directed to the first user interface object (e.g., a tap, a swipe in a first direction, a swipe in a second direction, a swipe in a third direction, an air tap gesture, an air pinch gesture, a pinch and drag gesture, a tap and hold gesture, or another type of input, that is directed to the first user interface object (e.g., based on the location of the input and/or the location of a focus selector or gaze)) (e.g., the user input 9024 in FIG. 9K). In response to detecting (14010) the first user input directed to the first user interface object: in accordance with a determination that the first user input is directed to a location that corresponds to the representation of the first notification in the first user interface object, the computer system performs (14012) a first operation with respect to the first notification (e.g., clearing the first notification, sending the first notification to notification history, expanding the first notification, opening an application corresponding to the first notification, and/or other operations that are triggered by interacting with the first notification) (e.g., in FIG. 9M, in response to detecting the user input 9024, the computer system 100 displays the affordance 9028 and the affordance 9036 (e.g., for performing operations with respect to the representation of the portion 9010 of the region 9000)), and the computer system forgoes performing the first operation with respect to the second notification (e.g., without clearing the second notification, without sending the second notification to notification history, without expanding the second notification, without opening an application corresponding to the second notification, and/or without performing any operation that can be triggered by interacting with the second notification) (e.g., in FIG. 9M, no operations are performed with respect to other portions of the region 9000); and in accordance with a determination that the first user input is directed to a location that corresponds to the representation of the second notification in the first user interface object, the computer system performs (14014) a second operation with respect to the second notification (e.g., clearing the second notification, sending the second notification to notification history, expanding the second notification, opening an application corresponding to the second notification, and/or other operations that are triggered by interacting with the second notification) (e.g., as described with reference to FIG. 9O, if the user input 9038 is directed to a portion of the region 9000 that does not combine multiple notifications and/or summaries (e.g., the portion 9018, the portion 9010, and/or the portion 9004, in FIG. 9N), the computer system 100 displays additional content (e.g., and optionally, an application user interface that includes application content) that corresponds to the event that corresponds to the selected portion of the region 9000 (e.g., in response to detecting the user input 9038)), and the computer system forgoes performing the second operation with respect to the first notification (e.g., without clearing the first notification, without sending the first notification to notification history, without expanding the first notification, without opening an application corresponding to the first notification, and/or without performing any operation that can be triggered by interacting with the first notification).

In some embodiments, displaying the first user interface that corresponds to the restricted state of the computer system (e.g., in response to detecting that the first set of conditions are met) includes: displaying (14016), via the one or more display generation components, a third notification of the plurality of notifications with third notification content (e.g., original application content from a third application associated with the third notification, or automatically summarized content that is based on the original application content), outside of the first user interface object (e.g., in accordance with a determination that the third notification with third notification content does not meet the relevance criteria (e.g., the third notification content does not meet the criteria measuring urgency of the content, and importance of the content to the user), forgoing displaying a representation of the third notification within the first user interface object (e.g., displaying the third notification outside of and concurrently with the notification highlight platter in the first notification display region)). For example, in FIG. 9B, the notification 5014, the notification 9006, and the notification 5020, are displayed outside of the region 9000 (e.g., the first user interface object). Displaying the first user interface that includes the representation of the first notification and the representation of the second notification of the computer system, and displaying a third notification of the plurality of notifications with third notification content, outside of the user interface content, reduces the numbers of inputs required by the user to review notifications (e.g., displaying notifications in highlighted manner in the user interface only if the notifications meet the relevance criteria inform the user of important and relevant content, and the user can understand the content of the relevant notification without a need for interaction with and/or opening the device and sorting through the notifications), improves the efficiency of the device, and provides improved visual feedback to the user by alerting the user only to relevant notification content.

In some embodiments, the third notification with the third notification content corresponds (14018) to (e.g., was received and/or generated during) a time span covered by notifications represented in the first user interface object (e.g., a respective timestamp of the third notification is earlier than a respective time stamp of one of the first and second notifications and later than a respective time stamp of another of the first and second notifications), and the third notification is displayed outside of the first user interface object in accordance with a determination that the third notification content of the third notification does not meet the relevance criteria. For example, in some embodiments, recency of a notification does not guarantee that the notification is included in the highlight platter, and the notification may be excluded from the highlight platter because the notification does not meet the relevance criteria, while another notification that is less recent is included in the highlight platter because it meets the relevance criteria. This feature distinguishes the first user interface object from a user interface object that includes or excludes notifications based on whether their timestamps fall within a respective time period, irrespective of whether the notification content of the notifications are important or urgent to the user (e.g., as determined based on the relevance criteria). For example, in FIG. 9B, the notification 5014 is displayed outside of the region 9000 (e.g., the first user interface object). The region 9000 includes content from a time span (e.g., from 9:01 to 9:24) that spans at least the last 23 minutes (e.g., because the portion 9004 of the region 9000 corresponds to the notification 5018, which was generated at 9:01), and the notification 5014 was generated within that time span (e.g., the notification 5014 was generated at 9:23, which is between 9:01 and 9:24). Displaying the first user interface that includes the representation of the first notification and the representation of the second notification of the computer system, and displaying a third notification of the plurality of notifications with third notification content, outside of the user interface content, wherein the third notification with the third notification corresponds to a time span covered by notifications represented in the first user interface object and the third notification is displayed outside of the first user interface object in accordance with a determination that the third notification content of the third notification does not meet the relevance criteria, reduces the numbers of inputs required by the user to review notifications (e.g., displaying notifications in highlighted manner on the user interface only if the notifications meet the relevance inform the user of important and relevant content, and the user can understand the content of the relevant notification without a need for interaction with and/or opening the device and sorting through the notifications), improves the efficiency of the device, and provides improved visual feedback to the user by alerting the user only to relevant notification content.

In some embodiments, displaying the first user interface that corresponds to the restricted state of the computer system (e.g., in response to detecting that the first set of conditions are met) includes (14020): in accordance with a determination that the plurality of notifications includes a fourth notification (e.g., the third notification, or another notification different from the third notification) with fourth notification content that does not meet the relevance criteria (e.g., the content of the fourth notification does not meet the criteria measuring urgency of the content, and importance of the content to the user) (e.g., the fourth notification is the third notification or another notification that is not included in the highlight platter), forgoing displaying a representation of the fourth notification within the first user interface object (e.g., displaying the fourth notification outside of the notification highlight platter in the first notification display region), wherein the fourth notification is associated with a same application as least one of the first notification and the second notification. For example, in some embodiments, the application of a notification does not guarantee that the notification is included in the highlight platter, and the notification may be excluded from the highlight platter because the notification does not meet the relevance criteria, while another notification from the same application is included in the highlight platter because it meets the relevance criteria. This feature distinguishes the first user interface object from a user interface object that includes or excludes notifications based on whether the applications associated with the notifications are included in a group of selected applications, irrespective of whether the notification content of the notifications are important or urgent to the user (e.g., as determined based on the relevance criteria). For example, in FIG. 9B, the notification 9006 corresponds to the email application M, and the portion 9002 of the region 9000 also corresponds to the content from the email application M (e.g., corresponds to the notification 5012, which corresponds to the email application M). Displaying the first user interface that includes the representation of the first notification and the representation of the second notification of the computer system, including forgoing displaying a representation of the fourth notification within the first user interface object, wherein the fourth notification is associated with a same application as least one of the first notification and the second notification, in accordance with a determination that the plurality of notifications includes a fourth notification with fourth notification content that does not meet the relevant criteria, reduces the numbers of inputs required by the user to review notifications (e.g., displaying notifications in highlighted manner on the user interface only if the notifications meet the relevance criteria inform the user of important and relevant content, and the user can understand the content of the relevant notification without a need for interaction with and/or opening the device and sorting through the notifications), improves the efficiency of the device, and provides improved visual feedback to the user by alerting the user only to relevant notification content.

In some embodiments, displaying the first user interface that corresponds to the restricted state of the computer system (e.g., in response to detecting that the first set of conditions are met) includes (14022): in accordance with a determination that the plurality of notifications includes a fifth notification (e.g., the third notification, the fourth notification, or another notification different from the third notification and the fourth notification) with fifth notification content that does not meet the relevance criteria (e.g., the content of the fifth notification does not meet the criteria measuring urgency of the content, and importance of the content to the user) (e.g., the fifth notification is the third notification, the fourth notification, or another notification that is not included in the highlight platter), forgoing displaying a representation of the fifth notification within the first user interface object (e.g., displaying the fifth notification outside of the notification highlight platter in the first notification display region), wherein the fifth notification is associated with a source (e.g., sender, owner, or other associated people or username) of at least one of the first notification and the second notification. For example, in some embodiments, the application of a notification does not guarantee that the notification is included in the highlight platter, and the notification may be excluded from the highlight platter because the notification does not meet the relevance criteria, while another notification from the same application is included in the highlight platter because it meets the relevance criteria. This feature distinguishes the first user interface object from a user interface object that includes or excludes notifications based on whether the people or user identities associated with the notifications are included in a group of selected people or user identities, irrespective of whether the notification content of the notifications are important or urgent to the user (e.g., as determined based on the relevance criteria). For example, as described with reference to FIG. 9B, in some embodiments, one or more portions of the region 9000 include content corresponding to a particular contact or user, and one or more notifications and/or summaries that are displayed outside of the region 9000 corresponds to the same contact or user. For example, in FIG. 9D, the region 9000 could include a portion corresponding to content from a contact “Rachel M.,” and the computer system 100 could concurrently display the notification 9006 (e.g., also corresponding to the user “Rachel M.”) with the region 9000. Displaying the first user interface that includes the representation of the first notification and the representation of the second notification of the computer system, including forgoing displaying a representation of the fifth notification within the first user interface object, wherein the fifth notification is associated with a source of at least one of the first notification and the second notification, in accordance with a determination that the plurality of notifications includes a fifth notification with fifth notification content that does not meet the relevance criteria, reduces the numbers of inputs required by the user to review notifications (e.g., displaying notifications in highlighted manner on the user interface only if the notifications meet the relevance criteria inform the user of important and relevant content, and the user can understand the content of the relevant notification without needing for interaction with and/or opening the device and sorting through the notifications), improves the efficiency of the device, and provides improved visual feedback to the user by alerting the user only to relevant notification content.

In some embodiments, at a first time after the representation of the first notification and the representation of the second notification were concurrently displayed in the first user interface object in the first user interface (e.g., in response to detecting the first set of conditions were met and in accordance with the determination that the first notification and the second notification both met the relevance criteria at the time that the first set of conditions were met), the computer system displays (14024) the first user interface (e.g., in response to detecting that the first set of conditions are met again after ceasing to display the first user interface that included the representations of the first notification and the second notification, in response to detecting that other set of conditions for displaying the first user interface are met, and/or while continuing to display the first user interface including the representations of the first notification and the second notification), including: in accordance with a determination that the first notification with the first notification content does not meet the relevance criteria at the first time, and that the second notification with the second notification content continues to meet the relevance criteria at the first time (e.g., the relevance criteria at the first time are the same relevance criteria that take into account of the changing time and changing contextual conditions, or are updated relevance criteria that are based on the changing time and changing contextual conditions), displaying the representation of the second notification in the first user interface object without displaying the representation of the first notification in the first user interface object, in the first user interface (e.g., the first notification is displayed outside of the first user interface object in the first user interface, among other notifications that do not meet the relevance criteria at the second time). For example, in some embodiments, a notification that was included in the highlight platter is automatically removed from the highlight platter, and optionally displayed outside of the highlight platter in the first user interface, when the notification no longer meets the relevance criteria (e.g., the relevance of a notification changes based on elapse of time, availability of additional information, and/or changing contextual conditions). In some embodiments, the removal of the representation of a notification from the highlight platter occurs while the highlight platter is displayed in the first user interface. In some embodiments, the removal of the representation of a notification from the highlight platter occurs when the first user interface is redisplayed with the highlight platter at a later time, and the representation of the notification is simply not included in the highlight platter any more. In some embodiments, if the first notification meets the relevance criteria while the second notification no longer meets the relevance criteria, the computer system displays the first user interface object in the first user interface, including the representation of the second notification without including the representation of the first notification. In some embodiments, neither of the first notification and the second notification meet the relevance criteria are the later time, the computer system forgoes displaying the representations of both the first notification and the second notification in the first user interface object. If there are no other notifications meeting the relevance criteria at the time, the computer system forgoes displaying the first user interface object all together in the first user interface. For example, as described with reference to FIG. 9B, in some embodiments, relevance criteria include a time-sensitive component such that as time passes, content can meet the relevance criteria, or content may no longer meet the relevance criteria. In some embodiments, content that no longer meets the relevance criteria ceases to be displayed in the region 9000 (e.g., a portion of the region 9000 that corresponds to the content that no longer meets the relevance criteria ceases to be displayed in the region 9000). Displaying the first user interface at a first time after the representation of the first notification and the representation of the second notification were concurrently displayed in the first user interface object in the first user interface, including displaying the representation of the second notification in the first user interface object without displaying the representation of the first notification in the first user interface object, in accordance with a determination that the first notification with the first notification content does not meet the relevance criteria at the first time, and that the second notification with the second notification content continues to meet the relevance criteria at the first time, reduces the numbers of inputs required by the user to display contextually relevant content (e.g., the user does not need to manually remove or delete notifications from the first user interface, when those notifications are no longer relevant and/or important), improves the efficiency of the device, and provides improved visual feedback to the user by alerting the user only to relevant notification content.

In some embodiments, at a second time after the representation of the first notification and the representation of the second notification were concurrently displayed in the first user interface object in the first user interface (e.g., in response to detecting the first set of conditions were met and in accordance with the determination that the first notification and the second notification both met the relevance criteria at the time that the first set of conditions were met), the computer system displays (14026) the first user interface (e.g., in response to detecting that the first set of conditions are met again after ceasing to display the first user interface that included the representations of the first notification and the second notification, in response to detecting that other set of conditions for displaying the first user interface are met, and/or while continuing to display the first user interface including the representations of the first notification and the second notification), including: in accordance with a determination that a sixth notification with the sixth notification content is available to be displayed in the first user interface and that the sixth notification meets the relevance criteria at the second time (e.g., the relevance criteria at the second time are the same relevance criteria that take into account of the changing time and changing contextual conditions, or are updated relevance criteria that are based on the changing time and changing contextual conditions), displaying, via the one or more display generation components, a representation of the sixth notification in the first user interface object (e.g., concurrently with the representations of the first and/or second notifications and/or any other notifications that meet the relevance criteria at the second time), in the first user interface. For example, in some embodiments, new notifications are automatically added to the highlight platter if they meet the relevance criteria and old notifications that did not meet the relevance criteria before but meet the relevance criteria at the second time are also automatically added to the highlight platter (e.g., the relevance of a notification changes based on elapse of time, availability of additional information, and/or changing contextual conditions). In some embodiments, the addition of the representation of a notification into the highlight platter occurs while the highlight platter is displayed in the first user interface. In some embodiments, the addition of the representation of a notification into the highlight platter occurs when the first user interface is redisplayed with the highlight platter at a later time, the representation of the notification is simply included in the highlight platter. In some embodiments, the sixth notification may have been displayed outside of the first user interface object as a regular notification at an earlier time because the sixth notification did not meet the relevance criteria back then; and the sixth notification is removed from the first user interface if its representation is added to the first user interface object as a result of the sixth notification meeting the relevance criteria at the later time. For example, in FIG. 9B, at a first time (e.g., 9:24), the region 9000 includes a portion 9002 and a portion 9004. In FIG. 9D, at a second time (e.g., 9:25), the computer system 100 determines that content corresponding to the summary 9008 (e.g., shown in FIG. 9C) meets relevance criteria (e.g., should be prioritized and/or highlighted), and displaying the portion 9010 of the region 9000. Displaying the first user interface at a second time after the representation of the first notification and the representation of the second notification were concurrently displayed in the first user interface object in the first user interface, including displaying a representation of a sixth notification in the first user interface object, in accordance with a determination that the sixth notification with sixth notification content is available to be displayed in the first user interface and that the sixth notification meets the relevance criteria at the second time, reduces the numbers of inputs required by the user to display contextually relevant content (e.g., the user does not need to manually remove or delete notifications from the first user interface, when those notifications are no longer relevant and/or important), improves the efficiency of the device, and provides improved visual feedback to the user by alerting the user only to relevant notification content.

In some embodiments, performing the first operation with respect to the first notification includes (14028): in accordance with a determination that the first user input includes a selection input (e.g., a tap input, an air pinch gesture, a double click input, or another type of selection input), displaying a first application corresponding to the first notification (e.g., replacing display of the first user interface with display of a user interface of the first application). For example, as described with reference to FIG. 9O, in some embodiments, if the user input 9038 is directed to a portion of the region 9000 that does not combine multiple notifications and/or summaries (e.g., the portion 9018, the portion 9010, and/or the portion 9004, in FIG. 9N), and the user input 9038 is a tap input (e.g., a selection input), the computer system 100 displays additional content (e.g., and optionally, an application user interface that includes application content) that corresponds to the event that corresponds to the selected portion of the region 9000 (e.g., in response to detecting the user input 9038). Displaying a representation of the first notification and a representation of the second notification within a first user interface object, in accordance with a determination that a plurality of notifications available to be displayed in the first user interface includes a first notification with first notification content that meets the relevance criteria, in response to detecting that the first set of conditions are met and the first user interface that corresponds to the restricted state of the computer system, performing a first operation with respect to a first notification, including displaying a first application corresponding to the first notification, and forgoing performing the first operation with respect to the second notification, in response to detecting a first user input directed to the first user interface object, and in accordance with a determination that the first user input that includes a selection input directed to a location that corresponds to the representation of the first notification in the first user interface object, and performing the second operation with respect to the second notification and forgoing performing the second operation with respect to the first notification, in response to detecting a first user input directed to the first user interface object and in accordance with a determination that the first user input is directed to a location that corresponds to the second notification in the first user interface object, reduces the numbers of inputs required by the user to review notifications (e.g., displaying notifications on the user interface in a highlighted manner only if the notifications meet the relevance criteria inform the user of important and relevant content, and opening the corresponding application after an input from the user on the highlighted notifications reduces the steps the user takes to open the application and read the content without opening the device and/or self-navigating to the application), improves the efficiency of the device, and provides improved visual feedback to the user by opening the application from user interaction with the notification.

In some embodiments, performing the first operation with respect to the first notification includes (14030): in accordance with a determination that the first user input includes a respective type of input (e.g., a tap and hold input, an air pinch and hold gesture, a click and hold input, a light press input, or another type of input) that is different from the selection input (e.g., the respective type of input meets a first input threshold, requires more time, higher intensity, or slower speed than that of the selection input), displaying first additional notification content in an expanded version of the representation of the first notification, wherein the first additional notification content was not included in the representation of the first notification prior to detecting the first user input (e.g., expanding the representation of the first notification to display the entirety of the first notification content of the first notification). For example, as described with reference to FIG. 9O, in some embodiments, if the user input 9038 is directed to a portion of the region 9000 that does not combine multiple notifications and/or summaries (e.g., the portion 9018, the portion 9010, and/or the portion 9004, in FIG. 9N), and the user input 9038 is a long press input (e.g., a respective type of input different from a tap input), the computer system 100 displays additional content (e.g., and optionally, an application user interface that includes application content) that corresponds to the event that corresponds to the selected portion of the region 9000 (e.g., in response to detecting the user input 9038). Displaying a representation of the first notification and a representation of the second notification within a first user interface object, in accordance with a determination that a plurality of notifications available to be displayed in the first user interface includes a first notification with first notification content that meets the relevance criteria, in response to detecting that the first set of conditions are met and the first user interface that corresponds to the restricted state of the computer system, performing a first operation with respect to a first notification, including includes displaying first additional notification content in an expanded version of the representation of the first notification that was not included prior to detecting the first user input, and forgoing performing the first operation with respect to the second notification, in response to detecting a first user input directed to the first user interface object, and in accordance with a determination that the first user input includes a respective type of input (e.g., that is different from a selection input) directed to a location that corresponds to the representation of the first notification in the first user interface object, and performing the second operation with respect to the second notification and forgoing performing the second operation with respect to the first notification, in response to detecting a first user input directed to the first user interface object and in accordance with a determination that the first user input is directed to a location that corresponds to the second notification in the first user interface object, reduces the numbers of inputs required by the user to review notifications (e.g., displaying notifications on the user interface in a highlighted manner only if the notifications meet the relevance criteria inform the user of important and relevant content, and opening the corresponding application after an input from the user on the highlighted notifications reduces the steps the user takes to open get more notification information), improves the efficiency of the device, and provides improved visual feedback to the user by giving more notification information.

In some embodiments, performing the first operation with respect to the first notification includes (14032): in accordance with a determination that the first user input includes a first movement input (e.g., a swipe input, an air swipe, a pinch and drag gesture, a click, hold, and drag input, or another type of movement input), performing a respective operation of a plurality of operations associated with the first notification, wherein the respective operation is selected in accordance with one or more characteristics of the movement input. For example, in FIG. 9L, the computer system 100 detects a user input 9024 that includes movement (e.g., a leftward swipe). In FIG. 9M, in response to detecting the user input 9024, the computer system 100 displays the affordance 9028 and the affordance 9030 (e.g., affordances for performing operations associated with the portion 9010 that corresponds to summary 9008 shown in FIG. 9C). Displaying a representation of the first notification and a representation of the second notification within a first user interface object, in accordance with a determination that a plurality of notifications available to be displayed in the first user interface includes a first notification with first notification content that meets the relevance criteria, in response to detecting that the first set of conditions are met and the first user interface that corresponds to the restricted state of the computer system, performing a first operation with respect to a first notification, including performing a respective operation of a plurality of operations associated with the first notification, and forgoing performing the first operation with respect to the second notification, in response to detecting a first user input directed to the first user interface object, and in accordance with a determination that the first user input includes a first movement input directed to a location that corresponds to the representation of the first notification in the first user interface object, and performing the second operation with respect to the second notification and forgoing performing the second operation with respect to the first notification, in response to detecting a first user input directed to the first user interface object and in accordance with a determination that the first user input is directed to a location that corresponds to the second notification in the first user interface object, reduces the numbers of inputs required by the user to review notifications (e.g., displaying notifications on the user interface in a highlighted manner only if the notifications meet the relevance criteria inform the user of important and relevant content, and performing operations after a movement input from the user on the highlighted notifications reduces the steps the user takes perform operations), improves the efficiency of the device, and provides improved visual feedback to the user by performing operations after a movement input from the user.

In some embodiments, performing the respective operation of the plurality of operations associated with the first notification includes (14034): in accordance with a determination that the first movement input meets first criteria (e.g., movement is in a first direction relative to the representation of the first notification with a magnitude that meets a first distance threshold and/or with a speed that meets a first threshold speed), ceasing to display the representation of the first notification in the first user interface (e.g., ceasing to display the representation of the first notification in the first user interface object, after the first user interface object is restored (e.g., displaying the representation of the second notification) after the termination of the movement input). In some embodiments, after the representation of the first notification is removed from the first user interface object and the first user interface, the first notification is optionally deleted from the computer system or stored in a notification history of the computer system. In some embodiments, in accordance with the determination that the first movement input meets the first criteria, the computer system ceases to display the representation of the first notification in the first user interface, while continuing to display the representations of other notifications that were included in the first user interface object in the first user interface. In some embodiments, after ceasing to display the representation of the first notification in the first user interface, the computer system continues to display the first user interface including the first user interface object, except that the representation of the first notification is no longer included in the first user interface object. It is to be noted that, ceasing to display the representation of the first notification means removing the first notification from the collection of notifications that are available to be represented in the first user interface object, and merely scrolling the first user interface to move the first user interface object out of the currently displayed portion of the first user interface or scrolling the content of the first user interface object to move the representation of the first notification out of the currently displayed portion of the first user interface object does not qualify as ceasing to display the representation of the first notification in the first user interface while continuing to display of the first user interface. In some embodiments, in accordance with a determination that the first movement input does not meet the first criteria, the computer system continues to display the representation of the first notification in the first user interface object, while the first user interface object is displayed in the control user interface. For example, in FIG. 9M, in response to detecting a user input 9036 directed to the affordance 9030 (e.g., after detecting the user input 9024 in FIG. 9L), the computer system 100 ceases to display the representation of the portion 9010 (e.g., and ceases to and/or will no longer display the portion 9010 of the region 9000). Displaying a representation of the first notification and a representation of the second notification within a first user interface object, in accordance with a determination that a plurality of notifications available to be displayed in the first user interface includes a first notification with first notification content that meets the relevance criteria, in response to detecting that the first set of conditions are met and the first user interface that corresponds to the restricted state of the computer system, performing a first operation with respect to a first notification, including ceasing to display the representation of the first notification in the first user interface, and forgoing performing the first operation with respect to the second notification, in response to detecting a first user input directed to the first user interface object, and in accordance with a determination that the first user input includes a first movement input that meets first criteria, and in accordance with a determination that the first user input is directed to a location that corresponds to the representation of the first notification in the first user interface object, and performing the second operation with respect to the second notification and forgoing performing the second operation with respect to the first notification, in response to detecting a first user input directed to the first user interface object and in accordance with a determination that the first user input is directed to a location that corresponds to the second notification in the first user interface object, reduces the numbers of inputs required by the user to review notifications (e.g., displaying notifications on the user interface in a highlighted manner only if the notifications meet the relevance criteria inform the user of important and relevant content, and removing the notification from the wake screen after a movement input from the user on the highlighted notifications reduces the steps the user takes to remove the notification from the wake screen), improves the efficiency of the device, and provides improved visual feedback to the user by removing the notification from the wake screen.

In some embodiments, performing the respective operation of the plurality of operations associated with the first notification includes (14036): in accordance with a determination that the first movement input meets second criteria (e.g., that are different from the first criteria) (e.g., movement is in a first direction relative to the representation of the first notification with a magnitude that does not meet the first distance threshold and/or with a speed that does not meet the first threshold speed), displaying one or more selectable options that correspond to one or more operations associated with the first notification (e.g., a first option that, when selected, causes the computer system to display a menu of options for the first notification, and a second option that, when selected, causes the computer system to clear the representation of the first notification from the first user interface). In some embodiments, clearing the first notification includes ceasing to display the representation of the first notification in the first user interface object, when the first user interface object is restored (e.g., displaying the representation of the second notification) after the termination of the movement input); and optionally, after the representation of the first notification is removed from the first user interface object and the first user interface, deleting the first notification from the computer system or storing it in a notification history of the computer system. For example, in FIG. 9M, in response to detecting a user input 9034 directed to the affordance 9028 (e.g., after detecting the user input 9024 in FIG. 9L), the computer system 100 displays additional options for interacting with representation of the portion 9010 (e.g., an option to configure settings relating to delivery of notifications and/or notification content relating to the email application M, which corresponds to the portion 9010; an option to configure settings relating to whether content for the email application M can and/or should appear in the region 9000; an option to indicate that content of the portion 9010 and/or content that is related to the content of the portion 9010 should or should not appear in the region 9000; and/or an option to configure settings relating to what content is or is not included in the region 9000). Displaying a representation of the first notification and a representation of the second notification within a first user interface object, in accordance with a determination that a plurality of notifications available to be displayed in the first user interface includes a first notification with first notification content that meets the relevance criteria, in response to detecting that the first set of conditions are met and the first user interface that corresponds to the restricted state of the computer system, performing a first operation with respect to a first notification, including displaying one or more selectable options corresponding to one or more operations associated with the first notification, and forgoing performing the first operation with respect to the second notification, in response to detecting a first user input directed to the first user interface object, and in accordance with a determination that the first user input includes a first movement input that meets second criteria, and in accordance with a determination that the first user input is directed to a location that corresponds to the representation of the first notification in the first user interface object, and performing the second operation with respect to the second notification and forgoing performing the second operation with respect to the first notification, in response to detecting a first user input directed to the first user interface object and in accordance with a determination that the first user input is directed to a location that corresponds to the second notification in the first user interface object, reduces the numbers of inputs required by the user to review notifications (e.g., displaying notifications on the user interface in a highlighted manner only if the notifications meet the relevance criteria inform the user of important and relevant content, and providing a plurality of options with respect to the movement input from the user on the highlighted notifications reduces the steps the user takes to remove the notification from the wake screen), improves the efficiency of the device, and provides improved visual feedback to the user by providing a plurality of options.

In some embodiments, in response to detecting (14038) the first user input: in accordance with a determination that the first user input includes the first movement input, the computer system changes a shape of the first user interface object in accordance with the first movement input (e.g., stretching the first user interface object in a vertical direction of the first user interface object in accordance with a sideways movement input, and increasing the vertical spacing between representations of notifications in the first user interface object with increasing magnitude of the movement input in the sideways direction). In some embodiments, the computer system also stretches the first user interface object in the vertical direction of the first user interface object in accordance with a substantially vertical movement input that scrolls or moves the first user interface object in the vertical direction. In some embodiments, the change in shape of the first user interface object occurs gradually and increases in magnitude as the movement input increases in magnitude (e.g., as the movement input increases in distance and/or speed). For example, in FIG. 9L, in response to detecting the user input 9024 (e.g., which includes movement), the computer system 100 deforms the border of the region 9000 (e.g., changes a shape of the border of the region 9000, in accordance with the movement of the user input 9024). Changing a shape of the first user interface object in accordance with a first movement input, in response to detecting the first user input and in accordance with a determination that the first user input includes the first movement input, provides improved visual feedback to the user (e.g., by gradually expanding the region in which the highlighted notifications are displayed on the user interface, to indicate that the first user input is detected, and/or to indicate a location corresponding to a notification in the first user interface object with which the user is interacting with and/or about to interact with).

In some embodiments, in response to detecting (14040) the first user input: in accordance with a determination that the first movement input meets a first movement threshold (e.g., one third of a width of the first user interface object, or another movement threshold), the computer system splits the first user interface object into individual representations of notifications, including an individual representation of the first notification and an individual representation of the second notification (e.g., stretching the first user interface object in a vertical direction of the first user interface object in accordance with a sideways movement input, and increasing the vertical spacing between representations of notifications in the first user interface object with increasing magnitude of the movement input in the sideways direction, until the first user interface object is split apart into individual representations of the notifications previously included in the boundary of the first user interface object). In some embodiments, the computer system stretches the first user interface object in the vertical direction of the first user interface object in accordance with a substantially vertical movement input that scrolls or moves the first user interface object in the vertical direction, and optionally, splits the first user interface object into individual representations of the notifications in accordance with a determination that the movement input exceeds a threshold magnitude or speed in the vertical direction. In some embodiments, when the movement input has not met the first movement threshold, the computer system only stretches the first user interface object but does not split the first user interface object apart. For example, in FIG. 9M, if (e.g., and/or when) the user input 9024 meets and/or exceeds a threshold amount of movement, the computer system 100 displays separate representations of each portion of the region 9000. Splitting the first user interface object into individual representations of notifications, including an individual representation of the first notification and an individual representation of the second notification, in response to detecting the first user input and in accordance with a determination that the first movement input meets a first movement threshold, provides improved visual feedback to the user (e.g., splitting the region in which the highlighted notifications are displayed into individual representations provides improved visual feedback regarding a particular individual representation with which the user is interacting).

In some embodiments, the computer system detects (14042) a termination of the first user input, including detecting a termination of the first movement input. In response to detecting the termination of the first user input: in accordance with a determination that the first movement input did not meet the first movement threshold (e.g., one third of a width of the first user interface object, or another movement threshold) prior to the termination of the first movement input, the computer system reverses at least a portion of a change in the shape of the first user interface object that was made in response to the first movement input (e.g., reversing at least a portion of the stretching of the first user interface object that was made in accordance with the sideways movement input, and decreasing the vertical spacing between representations of notifications in the first user interface object until the first user interface object is restored to its original size and shape). In some embodiments, the computer system also stretches the first user interface object in the vertical direction of the first user interface object in accordance with a substantially vertical movement input that scrolls or moves the first user interface object in the vertical direction, and reverses the stretching of the first user interface object after the termination of the movement input, if the movement input did not meet the threshold magnitude or speed in the vertical direction before the termination of the movement input. For example, in FIG. 9N, the user input 9024 terminates before meeting and/or exceeding the threshold amount of movement. In response to detecting the termination of the user input 9024, the computer system 100 ceases to display the animation that includes the border of the region 9000 deforming in accordance with the user input 9024 (e.g., and any deformation of the border of the region 9000 is undone and/or reverted, such that the region 9000 has the same appearance as in FIG. 9K, prior to detecting the user input 9024). Reversing at least a portion of a change in the shape of the first user interface object that was made in response to a first movement input, in response to detecting termination of the first movement input and in accordance with a determination that the first movement input did not meet the first movement threshold prior to the termination of the first movement input, provides improved visual feedback to the user (e.g., that the computer system has detected termination of the first movement input without the first movement input having met the first movement threshold).

In some embodiments, while displaying the first user interface, including concurrently displaying (e.g., in accordance with the determination that the first notification and the second notification met the relevance criteria), via the one or more display generation components, the representation of the first notification and the representation of the second notification within the first user interface object (optionally, along with a third notification having third notification content that does not meet the relevance criteria, displayed outside of the first user interface object), the computer system detects (14044), via the one or more input devices, a second user input (e.g., the first user input, or another user input different from the first user input) directed to the first user interface object (e.g., a tap, a swipe in a first direction, a swipe in a second direction, a swipe in a third direction, an air tap gesture, an air pinch gesture, a pinch and drag gesture, a tap and hold gesture, or another type of input, that is directed to the first user interface object (e.g., based on the location of the input and/or the location of a focus selector or gaze)). In response to detecting the second user input directed to the first user interface object: in accordance with a determination that the second user input includes a second movement input that meets scroll criteria (e.g., the second movement input is the vertical direction, and/or in a direction that is a scroll direction of the notifications displayed in the notification display region of the first user interface, and the second user input started at a location that corresponds to a portion of the first user interface object, optionally on the representation of the first notification or the representation of the second notification inside the first user interface object), the computer system moves the first user interface object as individual representations of notifications in the first user interface object (e.g., including an individual representation of the first notification and an individual representation of the second notification that are not bounded by a same boundary of the first user interface object), in a respective direction in accordance with the second movement input (e.g., stretching the first user interface object in a vertical direction of the first user interface object in accordance with a substantially vertical movement input, and increasing the vertical spacing between representations of notifications in the first user interface object with increasing magnitude of the movement input in the substantially vertical direction, until the first user interface object is split apart into individual representations of the notifications previously included in the boundary of the first user interface object and moving in unison in the respective direction in accordance with the substantially vertical movement input). In some embodiments, in response to detecting the second user input directed to the first user interface object: in accordance with a determination that the second user input includes a movement input that does not meet the scroll criteria, the computer system forgoes moving the first user interface object as individual representations of notifications in the first user interface object in accordance with the movement input. In some embodiments, a user input that includes a movement input that meets the scroll criteria, but is directed to a location outside of the first user interface object on the first user interface, causes the first user interface object, other notifications, and/or other objects displayed in the first user interface to scroll in the characteristic direction of the movement input on the first user interface, and also causes the first user interface object to stretch or split into individual representations of notifications that were previously displayed in the first user interface object (e.g., the stretched highlight platter moves as a whole along with other regular notifications and/or other objects (e.g., representations of ongoing activities, critical alerts, media playback module, and/or other elements of the first user interface) on the first user interface, until the stretched highlight platter is split into individual representations of notifications when the movement input meets a respective movement threshold (e.g., distance and/or speed threshold)). In some embodiments, a user input that includes a movement input that meets the scroll criteria, but is directed to a location outside of the first user interface object on the first user interface, causes the first user interface object, other notifications, and/or other objects displayed in the first user interface to scroll in the characteristic direction of the movement input on the first user interface, without causing the first user interface object to stretch or split into individual representations of notifications that were previously displayed in the first user interface object (e.g., the highlight platter moves as a whole along with other regular notifications and/or other objects (e.g., representations of ongoing activities, critical alerts, media playback module, and/or other elements of the first user interface) on the first user interface, without being stretched or split apart irrespective of the magnitude or speed of the movement input. For example, in FIG. 9O, in response to detecting the user input 9038 (e.g., shown in FIG. 9N), the computer system 100 displays separate representations of the portions of the region 9000. In some embodiments, the user input 9038 is not directed to a specific portion of the region 9000, and instead the user input 9038 includes movement in a specific (e.g., predefined) direction. For example, the user input 9038 is an upward or downward swipe along or within the region 9000 (e.g., that may cross into and/or through multiple portions of the region 9000). Moving the first user interface object as individual representations of notifications in the first user interface object, in a respective direction in accordance with the second movement input, in response to detecting the second user input directed to the first user interface object and in accordance with a determination that the second user input includes a second movement input that meets scroll criteria, provides additional control options without cluttering the UI with additional displayed controls (e.g., additional displayed controls for displaying individual representations of notifications in the first user interface object).

In some embodiments, in response to detecting (14046) the second user input directed to the first user interface object: in accordance with the determination that the second user input includes the second movement input that meets the scroll criteria (e.g., the second movement input is the vertical direction, and/or in a direction that is a scroll direction of the notifications displayed in the notification display region of the first user interface, and the second user input started at a location that corresponds to a portion of the first user interface object, optionally on the representation of the first notification or the representation of the second notification inside the first user interface object), the computer system changes a shape of the first user interface object in accordance with the second movement input (e.g., stretching the first user interface object in the vertical direction, before splitting the first user interface object into individual representations of notifications, including the representation of the first notification and the representation of the second notification). For example, in some embodiments, the computer system stretches the first user interface object in a vertical direction of the first user interface object in accordance with a substantially vertical movement input, and increasing the vertical spacing between representations of notifications in the first user interface object with increasing magnitude of the movement input in the substantially vertical direction (e.g., until the first user interface object is split apart into individual representations of the notifications previously included in the boundary of the first user interface object). In some embodiments, in response to detecting the second user input directed to the first user interface object: in accordance with a determination that the second user input includes a movement input that does not meet the scroll criteria, the computer system forgoes changing the shape of the first user interface object in accordance with the movement input. For example, as described with reference to FIGS. 9N and 9O, in some embodiments, the border of the region 9000 deforms in accordance with movement of the user input 9038, until the user input 9038 meets and/or exceeds a movement threshold, at which point the computer system 100 displays the separate representations of the region 9000. Changing a shape of the first user interface object in accordance with the second movement input, in response to detecting the second user input directed to the first user interface object and in accordance with the determination that the second user input includes the second movement input that meets the scroll criteria, provides improved visual feedback to the user (e.g., improved visual feedback that the second user input has been detected, and/or improved visual feedback regarding progress of the second movement input towards meeting the scroll criteria).

In some embodiments, in response to detecting (14048) the second user input directed to the first user interface object: in accordance with the determination that the second user input includes the second movement input that meets the scroll criteria (e.g., the second movement input is the vertical direction, and/or in a direction that is a scroll direction of the notifications displayed in the notification display region of the first user interface, and the second user input started at a location that corresponds to a portion of the first user interface object, optionally on the representation of the first notification or the representation of the second notification inside the first user interface object), and that the second movement meets a second movement threshold (e.g., a movement threshold that is greater than the movement threshold used for triggering scrolling of objects on the first user interface (e.g., a movement threshold used in the scroll criteria)), the computer system splits the first user interface object into the individual representations of notifications (e.g., after moving the first user interface object as a whole and/or changing the shape of the first user interface object in accordance with the initial portion of the second movement input). For example, in some embodiments, the scroll criteria include a directional requirement that a movement input is in a scrolling direction (e.g., substantially vertical direction, or another direction that objects on the first user interface can be scrolled), and a first movement threshold (e.g., a first threshold speed or a first threshold distance) that needs to be met by a movement input, in order to trigger scrolling of the objects on the first user interface. In order to trigger the splitting of the first user interface object, the movement input needs to meet the scroll criteria and also meet a second movement threshold that is greater than the first movement threshold. In some embodiments, the computer system changes the shape of the first user interface object dynamically in accordance with a current characteristic value of the movement input, e.g., stretching or reversing a stretch on the first user interface object in accordance with the distance and direction (e.g., forward scroll or backward scroll) of the movement input, until the second movement threshold is met and the first user interface object is split into individual representations of notifications. In some embodiments, in response to detecting the second user input directed to the first user interface object: in accordance with a determination that the second user input does not include a movement input that meets the scroll criteria and/or that the movement input does not meet the second movement threshold, the computer system forgoes splitting the first user interface object into the individual representations of notifications. For example, as described with reference to FIGS. 9N and 9O, in some embodiments, the border of the region 9000 deforms in accordance with movement of the user input 9038, until the user input 9038 meets and/or exceeds a movement threshold, at which point the computer system 100 displays the separate representations of the region 9000. Splitting the first user interface object into individual representations of notifications, in response to detecting the second user input and in accordance with the determination that the second user input includes the second movement input that meets the scroll criteria, and that the second movement input meets a second movement threshold, provides additional control options without cluttering the UI with additional displayed controls (e.g., additional displayed controls for displaying individual representations of notifications in the first user interface object).

In some embodiments, the computer system detects (14050) a termination of the second user input, including detecting a termination of the second movement input. In response to detecting the termination of the first user input: in accordance with a determination that the second movement input did not meet the second movement threshold prior to the termination of the second movement input, the computer system reverses at least a portion of a change in the shape of the first user interface object that was made in response to the second movement input (e.g., reversing at least a portion of the stretching of the first user interface object after the termination of the movement input, if the movement input did not meet the threshold magnitude or speed in the vertical direction before the termination of the movement input). In some embodiments, in response to detecting the termination of the first user input, in accordance with a determination that the second movement input met the second movement threshold prior to the termination of the second movement input, the computer system maintains the representations of the notifications in the split state. For example, as described with reference to FIGS. 9N and 9O, in some embodiments, the border of the region 9000 deforms in accordance with movement of the user input 9038, until the user input 9038 meets and/or exceeds a movement threshold, at which point the computer system 100 displays the separate representations of the region 9000; and if the user input 9038 terminates before meeting and/or exceeding the movement threshold, the computer system 9000 (e.g., at least partially) reverses the deformation of the border of the region 9000). Reversing at least a portion of a change in the shape of the first user interface object that was made in response to the second movement input, in response to detecting termination of the second user input, and in accordance with a determination that the second movement input did not meet the second movement threshold prior to the termination of the second movement input, provides improved visual feedback to the user (e.g., improved visual feedback that the computer system has detected the termination of the second movement input terminated without meeting the second movement threshold).

In some embodiments, the relevance criteria are based (14052) on a current context of the computer system (e.g., including a current location, a time of day, a notification delivery mode, a current calendar event, and past interactions with other notifications, and other contextual information). For example, as described with reference to FIG. 9B, in some embodiments, content appears in the region 9000 if the content meets relevance criteria. In some embodiments, the computer system 100 determines “relevance” based on one or more factors, including (e.g., but not limited to): the text of a notification or summary, a current location (e.g., at which an event corresponding to a notification or summary is detected), a time of day (e.g., at which the event corresponding to the notification or summary is detected), an active mode ((e.g., that controls delivery of and/or suppression of notifications) of the computer system 100 is active when the event corresponding to the notification or summary is detected), past user interaction with similar or related notifications (e.g., notifications with the same source, corresponding to the same application, and/or containing similar content), or other contextual information. Displaying a representation of the first notification and a representation of the second notification within a first user interface object, in accordance with a determination that a plurality of notifications available to be displayed in the first user interface includes a first notification with first notification content that meets relevance criteria that is based on a current context of the computer system, in response to detecting that the first set of conditions are met and the first user interface that corresponds to the restricted state of the computer system, performing a first operation with respect to a first notification and forgoing performing the first operation with respect to the second notification, in response to detecting a first user input directed to the first user interface object and in accordance with a determination that the first user input is directed to a location that corresponds to the representation of the first notification in the first user interface object, and performing the second operation with respect to the second notification and forgoing performing the second operation with respect to the first notification, in response to detecting a first user input directed to the first user interface object and in accordance with a determination that the first user input is directed to a location that corresponds to the second notification in the first user interface object, reduces the numbers of inputs required by the user to review notifications (e.g., displaying notifications on the user interface in a highlighted manner only if the notifications meet the relevance criteria inform the user of important and relevant content, and the user can understand the content of the relevant notification without a need for interaction with and/or opening the device and sorting through the notifications), improves the efficiency of the device, and provides improved visual feedback to the user by alerting the user only to relevant notification content.

In some embodiments, concurrently displaying the representation of the first notification and the representation of the second notification (and optionally, one or more representations of other notifications that also meet the relevance criteria) within the first user interface object includes (14054) arranging the representation of the first notification and the representation of the second notification in the first user interface object (and optionally, one or more representations of other notifications that also meet the relevance criteria) in accordance with an order determined in accordance with the relevance criteria (e.g., the relevance criteria determines whether the notifications available to be displayed in the first user interface are sufficiently important, relevant, and/or urgent, to be included in the first user interface object, and for the notifications that meet the relevance criteria and included in the first user interface object, their representations are sorted in the first user interface object in accordance with the relative importance, relevance, and/or urgency, as determined in accordance with the relevance criteria, or criteria similar to the relevance criteria (e.g., a scoring system based on the relevance criteria, as opposed to a threshold based on the relevance criteria)). For example, as described with reference to FIG. 9B, in some embodiments, the portions of the region 9000 are ordered temporally (e.g., with the portion corresponding to the most recently detected event listed first, and with portions corresponding to older events listed later). In some embodiments, the portions of the region 9000 are ordered in a priority order (e.g., based on a determined importance or current relevance). In some embodiments, the portions of the region 9000 are ordered based on relevance criteria (e.g., the same and/or analogous criteria as the relevance criteria used to determine whether or not content should appear in the region 9000). In some embodiments, the order of the portion of the region 9000 changes (e.g., and/or is updated), when a new event is detected and/or as time passes (e.g., at set time intervals and/or preset times). Displaying the representation of the first notification and the representation of the second notification within the first user interface object with an order determined in accordance with the relevance criteria, reduces the numbers of inputs required by the user to access contextually relevant content (e.g., by ensuring contextually relevant notifications are displayed in the first user interface object, optionally ordered by relevance) (e.g., ordering notifications in accordance with the relevance criteria minimizes the need for the user to perform additional user inputs to re-arrange or re-order contextually relevant notifications), improves the efficiency of the device, and provides improved visual feedback to the user (e.g., improved visual feedback regarding notifications that meet relevance criteria, and optionally, which notifications are more and/or most relevant based on relevance criteria).

In some embodiments, concurrently displaying the representation of the first notification that meets the relevance criteria and the representation of the second notification that meet the relevance criteria in the first user interface object includes (14056): in accordance with a determination that more than a first threshold number of notifications from the plurality of notifications available to be displayed in the first user interface meet the relevance criteria, displaying, concurrently with the first user interface object (e.g., as text or a graphical indicator, inside the first user interface object, attached to the first user interface object, or adjacent to the first user interface object), a first indication that one or more additional notifications that meet the relevance criteria are available to be displayed (e.g., will be displayed inside the first user interface object when the first indication is selected and the first user interface object is expanded); and In some embodiments, the first indication that one or more additional notifications that meet the relevance criteria are available to be displayed is concurrently displayed with the first user interface object, and the first user interface object includes the first threshold number of representations of notifications (e.g., including the representation of the first notification and the representation of the second notification). For example, if the first threshold number is five, then the first user interface object includes a representation of each of five notifications of the plurality of notifications. The first indication indicates that one or more additional (e.g., sixth, seventh, eighth, etc.) notifications are available to be displayed. In some embodiments, concurrently displaying the representation of the first notification that meets the relevance criteria and the representation of the second notification that meet the relevance criteria in the first user interface object includes: in accordance with a determination that fewer than (or, optionally exactly) the first threshold number of notifications from the plurality of notifications available to be displayed in the first user interface meet the relevance criteria, forgoing displaying the first indication with the first user interface object (e.g., concurrently displaying the representations of the notifications that meet the relevance criteria in the first user interface object, without displaying the first indication). For example, in FIG. 9I, the region 9000 includes three portions (e.g., which is exactly the maximum number of portions that can be displayed), and does not include an indication of additional content. In FIG. 9J, the region 9000 includes four portions (e.g., which exceeds the maximum number of portions that can be displayed), so the computer system 100 displays three portions (e.g., the portion 9018, the portion 9010, and the portion 9016), along with the indicator 9020 (e.g., which indicates that at least one additional portion is available for display, but is not currently displayed). Displaying, concurrently with the first user interface object, a first indication that one or more additional notifications that meet the relevance criteria are available to be displayed, in accordance with a determination that more than a first threshold number of notifications from the plurality of notifications available to be displayed in the first user interface meet the relevance criteria, and forgoing displaying the first indication with the first user interface object in accordance with a determination that fewer than the first threshold number of notifications from the plurality of notifications available to be displayed in the first user interface meet the relevance criteria, reduces the numbers of inputs required by the user to review notifications (e.g., displaying a limited amount of notifications on the user interface in a highlighted manner only if the notifications meet the relevance criteria, and alerting the user that there are more notifications that meet the relevancy criteria but are just not being displayed, inform the user of important and relevant content, and the user can understand the content of the relevant notification without a need for interaction with and/or opening the device and sorting through the notifications) without cluttering display of the UI (e.g., by ensuring the first user interface object is displayed with a substantially consistent size, based on the threshold number of notifications).

In some embodiments, the computer system detects (14058) that a second set of conditions, different from the first set of conditions, for displaying the first user interface that corresponds to the restricted state of the computer system are met. In response to detecting that the second set of conditions are met, the computer system displays, via the display generation component, the first user interface that corresponds to the restricted state of the computer system, including: in accordance with a determination that the plurality of notifications available to be displayed in the first user interface includes a seventh notification that meets revised relevance criteria different from the relevance criteria (and optionally, a fourth notification that meets the revised relevance criteria), wherein the seventh notification does not meet the relevance criteria (and optionally, at least one of the first notification and the second notification does not meet the revised relevance criteria), displaying a representation of the seventh notification in the first user interface object (optionally, concurrently with a representation of an eighth notification that meets the revised relevance criteria, and without the representation of the first notification or the second notification that does not meet the relevance criteria). In some embodiments the relevance criteria are associated with the first set of conditions for displaying the first user interface, and the revised relevance criteria are associated with the second set of conditions for displaying the first user interface, and optionally other sets of relevance criteria are associated with other sets of conditions for displaying the first user interface; and as a result, when the same plurality of notifications are available to be displayed in the first user interface, different sets of relevance criteria are used to evaluate the plurality of notifications and determine which subset of notifications are to be represented in the first user interface objects. In some embodiments, the first user interface is displayed in response to satisfaction of a respective set of conditions that ends a DND mode resumes a regular mode of the computer system (e.g., displaying a version of the first user interface that corresponds to the regular mode of the computer system), or vice versa (e.g., displaying another version the first user interface that corresponds to the DND mode of the computer system), and the set of relevance criteria that are used to evaluate importance, urgency, and/or relevance of notifications for inclusion in the highlight platter are changed accordingly. In some embodiments, the first user interface is displayed in response to satisfaction of a respective set of conditions that deactivates an airplane mode and resumes a regular network connection mode of the computer system, or vice versa, and the set of relevance criteria that are used to evaluate importance, urgency, and/or relevance of notifications for inclusion in the highlight platter are changed accordingly. In some embodiments, the first user interface is displayed in response to satisfaction of a respective set of conditions that wake the display without changing a current mode of the computer system (e.g., a respective mode of a plurality of different notification delivery modes of the computer system), and the set of relevance criteria that are used to evaluate importance, urgency, and/or relevance of notifications for inclusion in the highlight platter are chosen based on the current mode of the computer system. In some embodiments, in response to detecting that the second set of conditions are met, displaying, via the display generation component, the first user interface that corresponds to the restricted state of the computer system, includes: in accordance with a determination that the plurality of notifications available to be displayed in the first user interface includes an eighth notification that does not meet the revised relevance criteria, wherein the eighth notification meets the relevance criteria, forgoing displaying a representation of the eighth notification in the first user interface object. For example, in FIG. 9R, the portion 9047 of the region 9044 corresponds to the notification 9012 (e.g., shown in FIG. 9E), and the notification 9012 does not meet the relevance criteria (e.g., the notification 9012 is displayed outside of the region 9000 in FIG. 9F, because the notification 9012 does not meet the relevance criteria and/or the computer system 100 determines that the notification 9012 should not be prioritized and/or highlighted). Displaying the first user interface that corresponds to the restricted state of the computer system, including displaying a representation of the seventh notification in the first user interface object, in response to detecting that the second set of conditions are met and in accordance with a determination that the plurality of notifications available to be displayed in the first user interface includes a seventh notification that meets revised relevance criteria different from the relevance criteria, wherein the seventh notification does not meet the relevance criteria, reduces the numbers of inputs required by the user to review notifications (e.g., the user does not need to perform additional inputs to display new notifications that are contextually relevant, and/or to update display of the first user interface object to include new notifications over time).

In some embodiments, concurrently displaying the representation of the first notification and the representation of the second notification (and optionally, one or more representations of other notifications that also meet the relevance criteria) within the first user interface object includes (14060) arranging the representation of the first notification and the representation of the second notification in the first user interface object (and optionally, one or more representations of other notifications that also meet the relevance criteria) in accordance with relative relevancy of the first notification and the second notification (e.g., higher relevancy corresponds to a higher position in the first user interface object). In some embodiments, the relative relevancy of the notifications the meet the relevance criteria are determined based on the same or a similar set of factors included the relevance criteria. In some embodiments, as the contextual conditions change, the set of relevance criteria that are used to evaluate the notifications are changed as well, and even if a pair of notifications may meet the relevance criteria and the modified relevance criteria, their relative relevance may change, and as a result, the relative order of the representations of the pair of notifications in the first user interface object may change. For example, as described with reference to FIG. 9B, in some embodiments, the portions of the region 9000 are ordered temporally (e.g., with the portion corresponding to the most recently detected event listed first, and with portions corresponding to older events listed later). In some embodiments, the portions of the region 9000 are ordered in a priority order (e.g., based on a determined importance or current relevance). In some embodiments, the portions of the region 9000 are ordered based on relevance criteria (e.g., the same and/or analogous criteria as the relevance criteria used to determine whether or not content should appear in the region 9000). In some embodiments, the order of the portion of the region 9000 changes (e.g., and/or is updated), when a new event is detected and/or as time passes (e.g., at set time intervals and/or preset times). Concurrently displaying the representation of the first notification and the representation of the second notification, including arranging the representation of the first notification and the representation of the second notification in the first user interface object in accordance with relative relevancy of the first notification and the second notification, reduces the numbers of inputs required by the user to review notifications (e.g., ordering notifications in accordance with relative relevancy ensures high priority and/or highly relevant content appears in the first user interface object, which minimizes the need for the user to perform additional user input to access high priority and/or relevant content).

In some embodiments, displaying the first user interface in response to detecting that the first set of conditions are met, includes (14062): in accordance with a determination that a first set of one or more notifications from the plurality of notifications (e.g., critical alerts, system alerts, urgent notifications that are selected based on enhanced relevance criteria different from the relevance criteria) have higher relevance than notifications included in the first user interface object based on the relevance criteria, displaying the first set of one or more notifications on a first side of the first user interface object outside of the first user interface object (e.g., displaying the first set of notifications above the first user interface object); and in accordance with a determination that a second set of one or more notifications from the plurality of notifications (e.g., regular notifications that did not meet the relevance criteria or the enhanced relevance criteria) have lower relevance than the notifications included in the first user interface object based on the relevance criteria, displaying the second set of one or more notifications on a second side of the first user interface object, different from the first side of the first user interface object, outside of the first user interface object (e.g., displaying the second set of notifications below the first user interface object). For example, in FIG. 9P, “critical” notifications such as the notification 9040 are displayed on a first side (e.g., above, or on a top side) of the region 9000, because the “critical” notifications are determined to be higher priority (e.g., to have a higher relevance than content in the region 9000). Normal notifications (e.g., the notification 9012 and the notification 5014) are displayed on a second side (E.g., below, or on a bottom side) of the region 9000, because the normal notifications are determined to be lower priority (e.g., to have a lower relevance than the region 9000). Displaying the first set of one or more notifications on a first side of the first user interface object outside of the first user interface object, in accordance with a determination that a first set of one or more notifications from the plurality of notifications have higher relevance than notifications included in the first user interface object based on the relevance criteria, and displaying the second set of one or more notifications on a second side of the first user interface object, different from the first side of the first user interface object, in accordance with a determination that a second set of one or more notifications from the plurality of notifications have lower relevance than the notifications included in the first user interface object based on the relevance criteria, reduces the numbers of inputs required by the user to review notifications (e.g., displaying notifications on the user interface in a highlighted manner only if the notifications meet the relevance criteria, by displaying the most relevant notifications on one side of the region and the least relevant notifications on the other side of the display, inform the user of important and relevant content, and the user can understand the content of the relevant notification without a need for interaction with and/or opening the device and sorting through the notifications), improves the efficiency of the device, and provides improved visual feedback to the user (e.g., improved visual feedback regarding the relative priority of notifications).

In some embodiments, displaying the first user interface in response to detecting that the first set of conditions are met, includes (14064): displaying a second user interface object that corresponds to a first ongoing activity (e.g., a subscribed sports event with live score updates, a delivery event that include updates for different stages of the delivery task as they occur, a rideshare event that includes updates for different stages of the ride, or other subscribed live events), concurrently with the first user interface object (e.g., above the first user interface object), wherein: the first ongoing activity generates a plurality of updates over time, and displaying the second user interface objects include displaying first updated content in the second user interface object in accordance with a first update of the plurality of updates at a first time (e.g., after the occurrence of the first update, and before occurrence of a second update and a third update), and displaying second updated content in the second user interface object in accordance with a second update of the plurality of updates at a second time later than the first time (e.g., after the occurrence of the second update, and before occurrence of the third update). In some embodiments, the content of the second user interface object is updated as the second user interface object remains displayed in the first user interface (e.g., the updating is ongoing and live). In some embodiments, different content of the second user interface object is displayed in the second user interface object when the update to the content was received between the times that the second user interface object was displayed and then redisplayed in the first user interface. For example, in FIG. 9Q, the region 9000 is concurrently displayed with the summary 9042. The summary 9024 includes content that is updated periodically over time. For example, the summary 9024 corresponds to a food delivery application F, and updates over time to reflect the current status of a food delivery (e.g., placed on and/or via the computer system 100). Since the summary 9024 updates periodically over time (e.g., in order to provide real-time feedback to the user regarding the food order), the summary 9024 is displayed above (e.g., with a higher level of prominence than) the region 9000. Displaying a second user interface object that corresponds to a first ongoing activity, concurrently with the first user interface object, wherein the first ongoing activity generates a plurality of updates over time, displaying the second user interface objects include displaying first updated content in the second user interface object in accordance with a first update of the plurality of updates at a first time, and displaying second updated content in the second user interface object in accordance with a second update of the plurality of updates at a second time later than the first time, reduces the numbers of inputs required by the user to review notifications (e.g., the second user interface object automatically generates updates over time, without requiring user inputs to refresh display of the second user interface object and/or to access updated information relating to the updates).

In some embodiments, the computer system displays (14066) the first user interface (e.g., in response to detecting that the first set of conditions are met, and/or that the second set of conditions are met), including: in accordance with a determination that display of the first user interface object in the first user interface is enabled (e.g., enabled by a user in a settings user interface for notification delivery), displaying the first user interface object in the first user interface, including representations of notifications that meet the relevance criteria; and in accordance with a determination that display of the first user interface object in the first user interface is disabled (e.g., disabled by a user in the settings user interface for notification delivery), forgoing displaying the first user interface object in the first user interface, without regard to whether or not one or more notifications that meet the relevance criteria are available for display. For example, as described with reference to FIG. 9B, in some embodiments, what notification content is prioritized and/or highlighted in the region 9000 can be customized and/or configured by the user of the computer system 100 (e.g., the user of the computer system 100 can configure what notification content should or should not be displayed in the region 9000). In some embodiments, the computer system 100 is configured to prioritize and/or highlight notification content based at least in part on the content of the notification content (e.g., an evaluation of the content of the notification content) (e.g., as opposed to non-content notification characteristics, such as an application, a corresponding user/contact/sender, or a time of receipt/detection). In some embodiments, the computer system 100 can be configured not to display the region 9000 (e.g., at all). Displaying the first user interface, in accordance with a determination that display of the first user interface object in the first user interface is enabled, and forgoing display of the first user interface, in accordance with a determination that displays of the first user interface object in the first user interface is disabled, reduces the numbers of inputs required by the user to display contextually relevant content (e.g., the computer system displays the first user interface only when enabled, which minimizes the need for the user to perform additional user inputs to display the first user interface (e.g., and/or access content that would be displayed in the first user interface) when the first user interface is incorrectly not displayed; or to cease displaying the first user interface when the first user interface is incorrectly displayed).

In some embodiments, the computer system displays (14068) the first user interface object (e.g., in response to detecting that the first set of conditions are met, and/or that the second set of conditions are met), including: in accordance with a determination that a first setting that enables notifications for a first application to be included in the first user interface object, is activated (e.g., activated in a settings user interface for notification delivery by a user), displaying a representation of a respective notification of the first application in accordance with a determination that the respective notification of the first application meets the relevance criteria; and in accordance with a determination that the first setting that enables notifications for the first application to be included in the first user interface object, is deactivated (e.g., deactivated in a settings user interface for notification delivery by a user), forgoing displaying the representation of the respective notification of the first application without regard to whether or not the respective notification of the first application meets the relevance criteria. For example, as described with reference to FIG. 9B, in some embodiments, what notification content is prioritized and/or highlighted in the region 9000 can be customized and/or configured by the user of the computer system 100 (e.g., the user of the computer system 100 can configure what notification content should or should not be displayed in the region 9000). In some embodiments, the computer system 100 is configured to prioritize and/or highlight notification content based at least in part on the content of the notification content (e.g., an evaluation of the content of the notification content) (e.g., as opposed to non-content notification characteristics, such as an application, a corresponding user/contact/sender, or a time of receipt/detection). In some embodiments, the computer system 100 can be configured not to display the region 9000 (e.g., at all). Displaying a representation of a respective notification of the first application in accordance with a determination that the respective notification of the first application meets the relevance criteria, in accordance with a determination that a first setting that enables notifications for a first application to be included in the first user interface object, and forgoing displaying the representation of the respective notification of the first application without regard to whether or not the respective notification of the first application meets the relevance criteria, in accordance with a determination that the first setting that enables notifications for the first application to be included in the first user interface object is deactivated, reduces the numbers of inputs required by the user to display appropriate content (e.g., by allowing the user to configure the computer system to automatically display or suppress content for specific applications, which minimizes the need for the user to manually access relevant content, and/or manually clear or remove content).

In some embodiments, the representation of the first notification includes (14070) a first automatically generated summary (e.g., automatically generated text content and/or generative text content) (e.g., generated based on an artificial intelligence model, machine learning, and/or generative artificial intelligence techniques (e.g., using an AI process or generative AI process)) that is based on the first notification content of the first notification (e.g., in accordance with a determination that the first notification content meets a first content length threshold, and/or other summarization criteria (e.g., the notification content includes duplicate content, includes multiple sections, and/or includes a main idea and other peripheral content unrelated to the main idea)). For example, in FIG. 9B, the portion 9002 of the region 9000 corresponds to the notification 5012, and includes summary content that is analogous to the summary content of the summary 5024 in FIG. 5C. Displaying a representation of the first notification, including a first automatically generated summary that is based on the first notification content of the first notification, and a representation of the second notification within a first user interface object, reduces the numbers of inputs required by the user to review notifications (e.g., displaying notifications on the user interface in a highlighted manner, included automatically generated summaries based on the first content, only if the notifications meet the relevance criteria inform the user of important and relevant content, and the user can understand the content of the relevant notification without a need for interaction with and/or opening the device and sorting through the notifications), improves the efficiency of the device, and provides improved visual feedback to the user by alerting the user only to relevant notification content and providing a summary of the content of the notification.

In some embodiments, the representation of the second notification includes the second notification content of the second notification, without including an automatically generated summary that is based on the second notification content of the first notification (e.g., in accordance with a determination that the second notification content does not meet the first content length threshold, and/or does not meet the other summarization criteria (e.g., the notification content does not include duplicate content, does not include multiple sections, and/or does not include peripheral content unrelated to a main idea)). The computer system displays (14072) a first visual indication (e.g., displaying the representations of notifications with or without an indicator, and/or displaying the representations of notifications with different sets of visual characteristics) that visually distinguishes the representation of the first notification from the representation of the second notification, in a manner that representations of one or more notifications that include automatically generated summaries (e.g., summaries that are generated based on one or more artificial intelligence models, machine learning models, large language models, and/or other generative artificial intelligence and machine learning models and processes) are visually distinguished in the first user interface from representations of one or more other notifications that do not include automatically generated summaries. For example, in FIG. 9B, the portion 9002 of the region 9000 corresponds to the notification 5012, and includes summary content that is analogous to the summary content of the summary 5024 in FIG. 5C. Both the portion 9002 of the region 9000 in FIG. 9B, and the summary 5024 in FIG. 5C, include an indicator (e.g., a triangle with a line) that indicates summary content is displayed. In contrast, the portion 9004 of the region 9000 in FIG. 9B does not include the indicator (e.g., because the notification content of the notification 5018 is reproduced in the portion 9004 without summarization). Displaying a first visual indication that visually distinguishes the representation of the first notification from the representation of the second notification, in a manner that representations of one or more notifications that include automatically generated summaries are visually distinguished in the first user interface from representations of one or more other notifications that do not include automatically generated summaries, reduces the numbers of inputs required by the user to review notifications (e.g., displaying notifications on the user interface, wherein some notifications that have automatically generated summaries are visually different from the notifications that do not have automatically generated summaries, and meet the relevance criteria inform the user of important and relevant content, and the user can understand the content of the relevant notification without a need for interaction with and/or opening the device and sorting through the notifications), improves the efficiency of the device, and provides improved visual feedback to the user (e.g., improved visual feedback regarding whether or not a representation includes an automatically generated summary).

In some embodiments, displaying the first user interface object (e.g., in response to detecting that the first set of conditions are met, and/or the second set of conditions are met) includes concurrently displaying a representation of a first group of related notifications that meet the relevance criteria, and a representation of an individual notification (e.g., the first notification, the second notification, or another notification that meets the relevance criteria) that meets the relevance criteria. The computer system displays (14074) a second visual indication (e.g., displaying the representations of groups of notifications with badges, displaying representations of individual notifications without the badges; and/or displaying the representations of groups of notifications with a first set of visual characteristics and displaying the representations of individual notifications with a second set of visual characteristics different from the first set of visual characteristics) indicating that the representation of the first group of notifications represents multiple related notifications, and the representation of the individual notification represents a single notification (e.g., the second visual indication visually distinguishes the representation of the first group of notifications from the representation of the single notification, in a manner that representations of one or more groups of notifications are visually distinguished in the first user interface from representations of one or more single notifications). For example, in FIG. 9H, the portion 9016 of the region 9000 includes a badge that indicates that content from two events (e.g., corresponding to two notifications and/or summaries) are combined. In contrast, the portion 9010 of the region 9000, and the portion 9004 of the region 9000, do not include a badge, as content from a single event (e.g., corresponding to a single notification or summary) is included in the portion 9010 and the portion 9004. Displaying the first user interface object, including concurrently displaying a representation of a first group of related notifications that meet the relevance criteria and a representation of an individual notification that meets the relevance criteria, and displaying a second visual indication indicating that the representation of the first group of notifications represents multiple related notifications, and that the representation of the individual notification represents a single notification, reduces the numbers of inputs required by the user to review notifications (e.g., displaying notifications on the user interface, wherein notifications that correspond to a first group of notifications are visually different from a notifications that corresponds to a single notification, and meet the relevance criteria inform the user of important and relevant content, and the user can understand the content of the relevant notification without a need for interaction with and/or opening the device and sorting through the notifications), improves the efficiency of the device, and provides improved visual feedback to the user (e.g., improved visual feedback regarding whether a representation represents multiple related notifications, or a singular notification).

In some embodiments, while displaying the first user interface, including the first user interface object (e.g., including representations of one or more groups of notifications that meet the relevance criteria and/or representations of one or more individual notifications that meet the relevance criteria), the computer system detects (14076) availability of a new notification other than the plurality of notifications at the computer system (e.g., detecting occurrence of an event that causes the new notification to be generated at the computer system). In response to detecting the availability of the new notification: the computer system displays a respective animated visual effect in the first user interface in accordance with whether notification content of the new notification meets the relevance criteria (e.g., different animated visual effects (e.g., including different animated movements and/or different visual changes to the shape and/or other visual characteristics of the first user interface object) for new notifications that meet the relevance criteria than for new notifications that do not meet the relevance criteria)). For example, as described with reference to FIG. 9C, in some embodiments, prior to displaying the summary 9008 (e.g., or concurrently with displaying the summary 9008), the computer system 100 displays an animated visual effect in the region 9000 (e.g., movement of, a change in shape of, or another change in visual appearance of, the region 9000). In some embodiments, prior to displaying the summary 9008 (e.g., or concurrently with displaying the summary 9008), the computer system 100 displays the animated visual effect in the region 9000 if the computer system 100 determines that the content of the summary 9008 should be prioritized and/or highlighted (e.g., the content of the summary 9008 should also appear in the region 9000, since the content of the summary 9008 relates to the same work report mention in the content appearing in the portion 5014 of the region 9000, and thus meets relevance criteria). Displaying a respective animated visual effect in the first user interface, in response to detecting the availability of a new notification, and in accordance with whether notification content of the new notification meets the relevance criteria, reduces the numbers of inputs required by the user to review notifications (e.g., alerting the user to the region that displays the highlighted notifications if they meet the relevancy criteria, inform the user of important and relevant content, and the user can understand the content of the relevant notification without a need for interaction with and/or opening the device and sorting through the notifications), improves the efficiency of the device, and provides improved visual feedback to the user (e.g., improved visual feedback that a new notification has been detected and/or improved visual feedback regarding whether or not the notification content of the new notification meets the relevance criteria).

In some embodiments, displaying the respective animated visual effect in the first user interface object includes (14078): in accordance with a determination that the new notification meets the relevance criteria, displaying a first animated visual effect showing a representation of the new notification merging into the first user interface object (e.g., expanding the first user interface object and allowing the representation of the new notification to be absorbed into the first user interface object, reducing visual prominence of the representations of notifications in the first user interface object before the representation of the new notification is merged into the first user interface object; and after the representation of the new notification is merged into the first user interface object, the visual prominence of the other representations in the first user interface object is restored). For example, as described with reference to FIG. 9D, in some embodiments, the computer system 100 displays an animated transition of the summary 9008 merging with and/or into the summary region 9000. Displaying a respective animated visual effect. including displaying a first animated visual effect showing a representation of the new notification merging into the first user interface object, in accordance with a determination that the new notification meets the relevance criteria, reduces the numbers of inputs required by the user to review notifications (e.g., alerting the user to the region and the new notification joining the region that displays the highlighted notifications if they meet the relevancy criteria, inform the user of important and relevant content, and the user can understand the content of the relevant notification without a need for interaction with and/or opening the device and sorting through the notifications), improves the efficiency of the device, and provides improved visual feedback to the user by alerting the user only to relevant notification content and visually distinguishing relevant notifications.

In some embodiments, displaying the respective animated visual effect in the first user interface object includes (14080): in accordance with a determination that the new notification meets the relevance criteria, reducing visual prominence of representations of notifications (e.g., the representation of the first notification, the representation of the second notification, and/or representations of other notifications or groups of notifications that meet the relevance criteria) in the first user interface object, relative to the representation of the new notification, before merging (and optionally, while merging) the representation of the new notification into the first user interface object (e.g., expanding the first user interface object and allowing the representation of the new notification to be absorbed into the first user interface object, reducing visual prominence of the representations of notifications in the first user interface object before the representation of the new notification is merged into the first user interface object; and after the representation of the new notification is merged into the first user interface object, the visual prominence of the other representations in the first user interface object is restored). For example, as described with reference to FIG. 9C, in some embodiments, when the (e.g., new) summary 9008 is displayed, the region 9000 is displayed with a lower level of prominence (e.g., with a dimmer appearance, with smaller font, with a blur effect, and/or with a different color) as compared to a default (e.g., normal or regular) appearance of the region 9000, and optionally, the summary 9008. After a threshold amount of time (e.g., 1 second, 2 seconds, 5 seconds, 10 seconds, or 15 seconds), the region 9000 is displayed with the default appearance (e.g., ceases to be displayed with the lower level of prominence). In some embodiments (e.g., after the threshold amount of time, and optionally, before displaying/redisplaying the region 9000 with the default appearance), the computer system 100 displays an animated transition of the summary 9008 merging into and/or with the region 9000 (e.g., as described in further detail below with reference to FIG. 9D) (e.g., and after merging the summary 9008 and the region 9000, the region 9000 is displayed with the default appearance). Displaying a respective animated visual effect, including reducing visual prominence of representations of notifications in the first user interface object, relative to the representation of the new notification, before merging the representation of the new notification into the first user interface object in accordance with a determination that the new notification meets the relevance criteria, provides improved visual feedback to the user (e.g., improved visual feedback that assists the user in quickly identifying the new notification, and that the new notification includes relevant notification content).

In some embodiments, displaying the respective animated visual effect in the first user interface object includes (14082): in accordance with a determination that the new notification does not meet the relevance criteria, displaying a second animated visual effect showing the new notification joining a subset of the plurality of notifications that do not meet the relevance criteria in the first user interface (e.g., moving the first user interface object and allowing the new notification to slide underneath the first user interface object to join one or more notifications that were displayed outside of the first user interface object for not meeting the relevance criteria). For example, in FIG. 9F, the computer system 100 determines that the content of the notification 9012 should not be prioritized and/or highlighted, and the computer system 100 moves the notification 9012 from an initial position (e.g., above the region 9000, as shown in FIG. 9E) to a different position that is below the region 9000 (e.g., the region 9000 returns to its fixed position in the user interface 5000). For example, in FIG. 9Z, the computer system 100 determines that the content of the notification 9080 should not be prioritized and/or highlighted, and the computer system 100 move the region 9000 to overlap the notification 9080. Displaying a respective animated visual effect, including displaying a second animated visual effect showing the new notification joining a subset of the plurality of notifications that do not meet the relevance criteria in the first user interface, in accordance with a determination that the new notification does not meet the relevance criteria, reduces the numbers of inputs required by the user to review notifications (e.g., alerting the user that the notification being added to the display is not relevant, as well as displaying the highlighted notifications in a region if they meet the relevancy criteria, inform the user of important and relevant content, and the user can understand the content of the relevant notification without a need for interaction with and/or opening the device and sorting through the notifications), improves the efficiency of the device, and provides improved visual feedback to the user (e.g., improved visual feedback regarding whether or not the new notification includes relevant notification content).

In some embodiments, displaying the respective animated visual effect in the first user interface object includes (14084): in accordance with the determination that the new notification does not meet the relevance criteria, displaying animated movement of the first user interface object over the subset of the plurality of notifications in the first user interface, after the new notification has joined the subset of the plurality of notifications that do not meet the relevance criteria (e.g., sliding the first user interface object back down to obscure the subset of notifications that do not meet the relevance criteria, including the new notification). For example, in FIG. 9Z, the computer system 100 displays an animation of the region 9000 as “lifting up” (e.g., moving closer to the perspective of the user, and or rising relative to the display of the computer system 100), and moving to (e.g., partially) overlap the notification 9012. The notification 9080 is “pushed back” (e.g., to take the original location of the notification 9012), and (e.g., partially) overlaps the notification 9012. At least a portion of the notification 9080 and the notification 9012 are visible (e.g., to indicate that additional content, including the notification 9080 and the notification 9012, is available for display. Displaying a respective animated visual effect including displaying animated movement of the first user interface object over the subset of the plurality of notifications in the first user interface, after the new notification has joined the subset of the plurality of notifications that do not meet the relevance criteria, in accordance with a determination that the new notification does not meet the relevance criteria, reduces the numbers of inputs required by the user to review notifications (e.g., alerting the user that the notification being added to the display is not relevant, as well as displaying the highlighted notifications in a region over the non relevant notifications if they meet the relevancy criteria, inform the user of important and relevant content, and the user can understand the content of the relevant notification without a need for interaction with and/or opening the device and sorting through the notifications), improves the efficiency of the device, and provides improved visual feedback to the user (e.g., improved visual feedback regarding whether or not the new notification includes relevant notification content).

It should be understood that the particular order in which the operations in FIGS. 14A-14J have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, and 13000) are also applicable in an analogous manner to method 14000 described above with respect to FIGS. 14A-14J. For example, the application (content), notification (content), summary (content, applications, notifications, summaries, and user inputs, described above with reference to method 800 optionally have one or more of the characteristics of the application (content), notification (content), summary (content, applications, notifications, summaries, and user inputs, described herein with reference to other methods described herein (e.g., 10000, 11000, 12000, and 13000). For brevity, these details are not repeated here.

The operations described above with reference to FIGS. 10A-10I, 11A-11I, 12A-12E, 13A-13F, and 14A-14J are, optionally, implemented by components depicted in FIGS. 1A-1B. For example, detection operation 10002, detection operation 11002, detection operation 12002, detection operation 13002, and detection operation 14002 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve providing notifications to users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve providing notifications to users. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing notifications, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, notifications and/or notification summaries can be provided based on non-personal information data or a bare minimum amount of personal information, such as the content being requested by the device associated with a user, other non-personal information available to the service, or publicly available information.

What is claimed is:

1. A method, comprising:
at a computer system that is in communication with a display generation component and one or more sensors for detecting user inputs:
detecting occurrence of a first event of a first event type; and
in response to detecting the occurrence of the first event of the first event type:
in accordance with a determination that the computer system is operating in a first mode in which notifications corresponding to events of the first event type are permitted, generating a first notification corresponding to the first event;
in accordance with a determination that the computer system is operating in a second mode in which notifications corresponding to events of the first event type are suppressed and the first event includes first content that meets relevance criteria, generating the first notification corresponding to the first event; and
in accordance with a determination that the computer system is operating in the second mode in which notifications corresponding to events of the first event type are suppressed and the first event does not include content that meets the relevance criteria, forgoing generating the first notification corresponding to the first event.

2. The method of claim 1, wherein notifications corresponding to a second event type, different from the first event type, are permitted in the second mode, and wherein the method includes:
detecting occurrence of a second event of the second event type; and
in response to detecting the occurrence of the second event of the second event type:
in accordance with a determination that the computer system is operating in the second mode in which notifications corresponding to events of the first event type are suppressed and that notifications corresponding to events of the second event type are permitted in the second mode, generating a second notification for the second event.

3. The method of claim 1, including:
detecting occurrence of a third event of a third event type, different from the first event type; and
in response to detecting the occurrence of the third event of the third event type:
in accordance with a determination that the computer system is operating in a third mode in which the relevance criteria are not used to determine whether to display notifications, and that notifications corresponding to events of the third event type are permitted in the third mode, generating a third notification for the third event; and
in accordance with a determination that the computer system is operating in a fourth mode in which the relevance criteria are not used to determine whether to display notifications, and that notifications corresponding to events of the third event type are suppressed in the fourth mode, forgoing generating the third notification for the third event.

4. The method of claim 1, including:
detecting occurrence of a first plurality of events, corresponding to a first plurality of event types;
in response to detecting the occurrence of the first plurality of events:
in accordance with a determination that the computer system is operating in a fifth mode in which the relevance criteria are used to determine whether to display notifications, evaluating respective events of the first plurality of events in accordance with the relevance criteria, irrespective of respective event types that correspond to the respective events of the first plurality of events;
in accordance with a determination that a first subset of the first plurality of events meet the relevance criteria, displaying a first set of notifications corresponding to the first subset of the first plurality of events; and
in accordance with a determination that a second subset of the first plurality of events do not meet the relevance criteria, forgoing display a second set of notifications corresponding to the second subset of the first plurality of events.

5. The method of claim 4, including:
in accordance with a determination that the first subset of the first plurality of events meet the relevance criteria, displaying the first set of one or more notifications corresponding to the first subset of the first plurality of events, along with one or more indications that the first set of one or more notifications are displayed in accordance with the relevance criteria that are in use.

6. The method of claim 4, wherein the fifth mode is enabled without requiring activation of a mode in which modification of notification delivery is based on event types of notifications.

7. The method of claim 5, wherein the computer system has a sixth mode in which modification of notification delivery is based on event types of detected events, and wherein the fifth mode has fewer configuration options than the sixth mode.

8. The method of claim 1, wherein generating the first notification for the first event includes:
displaying the first notification for the first event on a first system user interface that is displayed in response to a request to transition the computer system into a restricted state of the computer system or in response to a request to transition out of a low power state into the restricted state of the computer system.

9. The method of claim 8, including:
displaying, in the first system user interface, an indication of one or more events for which notification delivery is suppressed in accordance with an active mode of the computer system.

10. The method of claim 1, wherein the relevance criteria include a first set of criteria that correspond to a first set of user-specified categories for event content, and wherein a determination of whether content of a respective event meets the relevance criteria is based on whether the content of the respective event belongs to the first set of user-specified categories of event content.

11. The method of claim 10, including:
displaying a first configuration user interface for a respective mode in which notification delivery is modified, wherein the first set of user-specified categories for event content includes a first category of event content and a second category of event content, different from the first category of event content, at a time when the first configuration user interface is displayed;
while displaying the first configuration user interface, detecting a first user input that adds a third category of event content to the first set of user-specified categories for event content, and detecting a second user input that deletes the first category of event content from the first set of user-specified categories for event content, without deleting the second category of event content from the first set of user-specified categories of event content; and
in response to detecting the first user input and the second user input, updating the first set of user-specified categories of event content to include the second category of event content and the third category of event content, without including the first category of event content.

12. The method of claim 11, wherein displaying the first configuration user interface includes displaying a plurality of selectable options that correspond to a plurality of available categories of event content, wherein selection of a respective selectable option of the plurality of selectable options causes a respective available category of event content to be added or removed from the first set of categories of event content.

13. The method of claim 10, including:
detecting occurrence of a second plurality of events, corresponding to a second plurality of event types; and
after detecting the occurrence of the second plurality of events:
in accordance with a determination that the computer system is operating in a sixth mode in which the first set of user-specified categories of event content are used to determine whether to display notifications, evaluating respective events of the second plurality of events to determine if the second plurality of events include content that belong to the first set of user-specified categories of event content.

14. The method of claim 10, including:
displaying a second system user interface that includes representations of a plurality of notifications, including a plurality of previously displayed notifications and stored notifications for a plurality of previously detected events for which notifications were suppressed, wherein the representations of the plurality of notifications are grouped in accordance with a plurality categories of event content.

15. The method of claim 1, wherein notifications for events of the first event type are suppressed in the second mode based on a first set of event properties, wherein the relevance criteria includes a set of permitted content categories, wherein the first event of the first event type meets the relevance criteria when the content of the first event belongs to the set of permitted content categories, and wherein the first event of the first event type does not meet the relevance criteria when the content of the first event does not belong to the set of permitted content categories.

16. The method of claim 1, wherein generating the first notification corresponding to the first event includes generating a summary of the content of the first event, and displaying the first notification of the first event, including displaying the summary of the content of the first event in the first notification of the first event.

17. The method of claim 1, including:
displaying a respective system user interface, including:
in accordance with a determination that a currently active notification delivery mode is subject to a respective set of relevance criteria, displaying a first indication in the respective system user interface indicating that relevance-based notification delivery is active; and
in accordance with a determination that the currently active notification delivery mode is not subject to a respective set of relevance criteria, forgoing displaying the first indication in the respective system user interface.

18. An electronic device, comprising:
a display generation component;
one or more sensors for detecting user inputs;
one or more processors; and
memory storing one or more programs, wherein the one or more programs are configured to be executed by the one or more processors, the one or more programs including instructions for:
detecting occurrence of a first event of a first event type; and
in response to detecting the occurrence of the first event of the first event type:
in accordance with a determination that the computer system is operating in a first mode in which notifications corresponding to events of the first event type are permitted, generating a first notification corresponding to the first event;
in accordance with a determination that the computer system is operating in a second mode in which notifications corresponding to events of the first event type are suppressed and the first event includes first content that meets relevance criteria, generating the first notification corresponding to the first event; and
in accordance with a determination that the computer system is operating in the second mode in which notifications corresponding to events of the first event type are suppressed and the first event does not include content that meets the relevance criteria, forgoing generating the first notification corresponding to the first event.

19. A computer readable storage medium storing one or more programs, the one or more programs comprising instructions that, when executed by an electronic device in communication with a display generation component and one or more sensors for detecting user inputs, cause the electronic device to:
detect occurrence of a first event of a first event type; and
in response to detecting the occurrence of the first event of the first event type:
in accordance with a determination that the computer system is operating in a first mode in which notifications corresponding to events of the first event type are permitted, generate a first notification corresponding to the first event;
in accordance with a determination that the computer system is operating in a second mode in which notifications corresponding to events of the first event type are suppressed and the first event includes first content that meets relevance criteria, generate the first notification corresponding to the first event; and
in accordance with a determination that the computer system is operating in the second mode in which notifications corresponding to events of the first event type are suppressed and the first event does not include content that meets the relevance criteria, forgo generating the first notification corresponding to the first event.
